(19) United States
(12) Patent Application Publication
(10) Pub. No.: US 2024/0259879 A1
(43) Pub. Date: Aug. 1, 2024

(54) RADIO ACCESS NETWORK INTELLIGENT APPLICATION MANAGER

(71) Applicant: Intel Corporation, Santa Clara, CA (US)

(72) Inventors: Sunku RANGANATH, Beaverton, OR (US); Hassnaa MOUSTAFA, San Jose, CA (US); Hosein NIKOPOUR, San Jose, CA (US); John BROWNE, Limerick (IE); Stephen T. PALERMO, Chandler, AZ (US); Valerie J. PARKER, Portland, OR (US)

(21) Appl. No.: 18/563,085

(22) PCT Filed: Nov. 18, 2022
(86) PCT No.: PCT/US2022/050395

§ 371 Date: Nov. 21, 2023

Related U.S. Application Data
(60) Provisional application No. 63/281,204, filed on Nov. 19, 2021.

(51) Int. Cl. H04W 28/18; H04W 24/10; H04W 28/24

(52) U.S. Cl. CPC H04W 28/18; H04W 24/10; H04W 28/24

(57) ABSTRACT

The present disclosure is related to edge and cloud computing frameworks, telemetry and telemetering systems, telemetry awareness and intelligence in managing telemetering systems, and Radio Access Network (RAN) and RAN intelligent controller (RIC) implementations. In particular, the present disclosure provides RIC-based resource management for individual RIC applications, which is based on the collection and analysis of platform telemetry data as well as measurements collected by user equipment and access network infrastructure elements.

### RELATED APPLICATIONS

The present disclosure claims priority to U.S. Provisional App. No. 63/281,204 filed on Nov. 19, 2021, the contents of which is hereby incorporated by reference in its entirety.

### TECHNICAL FIELD

The present disclosure is generally related to edge computing, cloud computing, network communication, data centers, network topologies, communication systems, telemetry and telemetering systems, Radio Access Network (RAN) and RAN intelligent controller (RIC) implementations, and in particular, to a RIC-based application and resource management through collection and analysis of platform telemetry data and network measurements.

### BACKGROUND

As mobile traffic increases, mobile networks and the equipment that runs them is becoming software-driven, virtualized, flexible, intelligent and energy efficient. Operator-defined Open and Intelligent Radio Access Networks (referred to as “Open RAN” or “ORAN”) is the movement in mobile networks and telecommunications to improve the efficiency of RAN deployments and operations. The O-RAN Alliance e.V. (hereinafter “O-RAN”) was created to develop radio access networks (RANs) making them more open and smarter than previous generations. The O-RAN architecture utilizes real-time analytics that drive embedded machine learning systems and artificial intelligence back end modules to empower network intelligence. The O-RAN architecture also includes virtualized network elements with open, standardized interfaces. The O-RAN architecture is based on O-RAN standards that fully support and compliment standards promoted by 3GPP, ETSI, and other industry standards organizations.

### BRIEF DESCRIPTION OF THE DRAWINGS

In the drawings, which are not necessarily drawn to scale, like numerals may describe similar components in different views. Like numerals having different letter suffixes may represent different instances of similar components. Some example implementations are illustrated by way of example, and not limitation, in the figures of the accompanying drawings in which:

FIG. 1 depicts an example O-RAN Alliance architecture.

FIG. 2 depicts an example NexRAN Open RAN open source RAN slicing. FIG. 3a depicts an example RAN intelligent xApp manager in an O-RAN architecture Lower Layer Split (LLS). FIG. 3b depicts an example RAN intelligent xApp manager in a 3GPP next generation radio access network split architecture.

FIG. 3c depicts an example RAN Intelligent Controller (RIC) for edge computing.

FIG. 4 depicts an example xApp manager deployment in an O-RAN RIC architecture.

FIG. 5 depicts an example near-real-time (RT) RIC control loop.

FIG. 6 depicts an example Xeon® Acceleration Complex (XAC) architecture.

FIG. 7 illustrates an example edge computing environment.

FIG. 8 depicts an O-RAN system architecture.

FIGS. 9 and 10 depict logical arrangements of the O-RAN system architecture of FIG. 8.

FIG. 11 depicts an O-RAN xApp framework.

FIG. 12 depicts an example near-RT RIC architecture.

FIG. 13 illustrates an example cellular network architecture.

FIG. 14 depicts example RAN split architecture aspects.

FIG. 15 depicts example cellular network architecture with vRAN analytics.

FIG. 16 illustrates an example software distribution platform.

FIG. 17 depicts example components of an example compute node.

FIG. 18 depicts an example neural network (NN).

FIG. 19 depicts an example reinforcement learning architecture.

### DETAILED DESCRIPTION

The following example implementations generally related to edge computing, cloud computing, network communication, data centers, network topologies, communication systems, telemetry and telemetering systems, telemetry awareness and intelligence in managing telemetering systems, Radio Access Network (RAN) and RAN intelligent controller (RIC) implementations. In particular, the present disclosure provides RIC-based resource management mechanisms for individual RIC applications, where the resource management for the individual RIC applications is based on the collection and analysis of platform telemetry data as well as measurements collected by user equipment and access network infrastructure elements.

### 1. RAN Intelligent Controller (RIC) Aspects

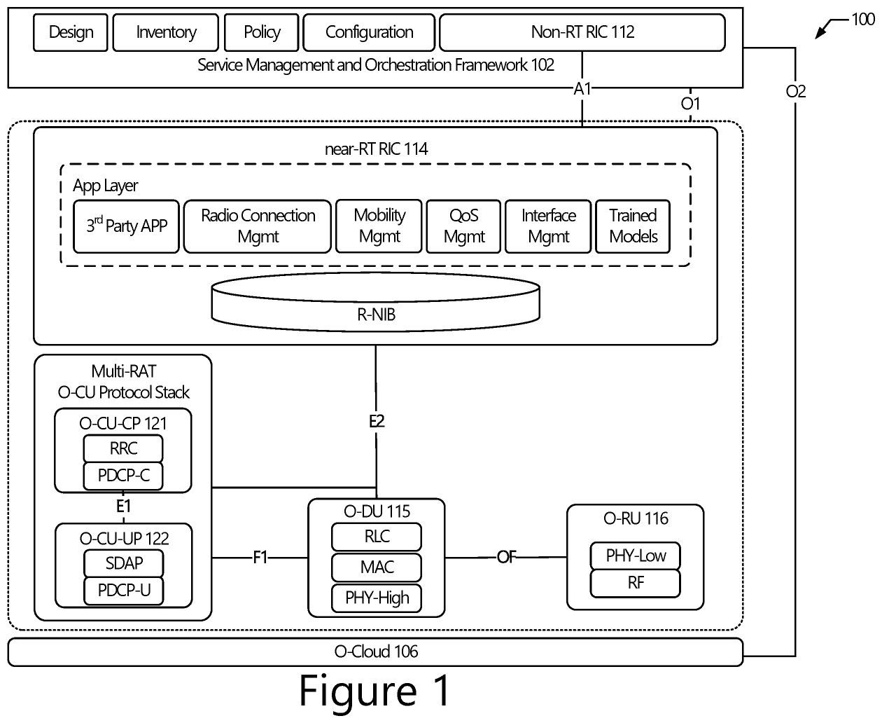

In O-RAN architectures, a near-Real Time (RT) RIC (see e.g., FIGS. 1-12 discussed infra) executes xApps to enable intelligent RAN operations. The xApps, defined by O-RAN specifications (see e.g., [O-RAN]), form the intelligent control functions for O-RAN access network while ensuring latencies are kept in order of sub-seconds to seconds. O-RAN specifications do not describe interfaces to hardware (HW) and/or software (SW) telemetry data from the RIC platform and/or RAN nodes, which can impact performance of xApps running on the near-RT RIC.

The present disclosure introduces an xApp manager that leverages the platform telemetry, capabilities and/or application traces to provide helpful information the xApps such as noisy neighbors, NIC congestion, platform reliability, dynamic power management, as well as active ephemeral user equipment (UE) communication traffic to sustain uplink and downlink connections and associated UE-to-distributed unit (DU) and/or UE-to-remote unit (RU) measurements that can be used for intelligent RAN analytics. Existing O-RAN standards focus on xApps that provide network intelligence. By contrast, the example xApp manager discussed herein obtains various telemetry data, arbitrates the telemetry data, determines intelligence and/or insights using the arbitrated telemetry data, and feeds the intelligence/insights to other xApps who consume use the intelligence/insights for better functioning. For example, resources allocated to individual xApps can be redirected and/or reallocated by the xApp manager based on various platform telemetry data and/or measurement data obtained from network nodes (e.g., UEs, RAN nodes, network functions (NFs), and/or the like) including active real-time measurements and/or the like. In some implementations, the xApp manager is implemented in real-time control loops and/or near real-time control loops because, in many cases, real-time measurements need to be used within a relatively short amount of time (e.g., 1 millisecond (ms) or less) for xApp resource allocations to be relevant to existing network conditions. The various implementations discussed herein provide network operators the ability to remotely collect measurements and metrics, and optimize their networks based on the collected measurements/metrics. These and other concepts discussed herein improve O-RAN deployment performance through leveraging platform capabilities and also enhances the xApps performance running on edge compute nodes. Additionally, the concepts discussed herein adds performance improvements and efficiencies in O-RAN deployments through leveraging edge node platform capabilities such as, for example, O-RAN deployments that are Intel® FlexRAN reference-based as some of the xApp manager analytics utilize measurements that may be enabled by FlexRAN on active UE connections such as channel estimation, RSRP, RSRQ, SNR, and/or other metrics/measurements such as any of those discussed herein.

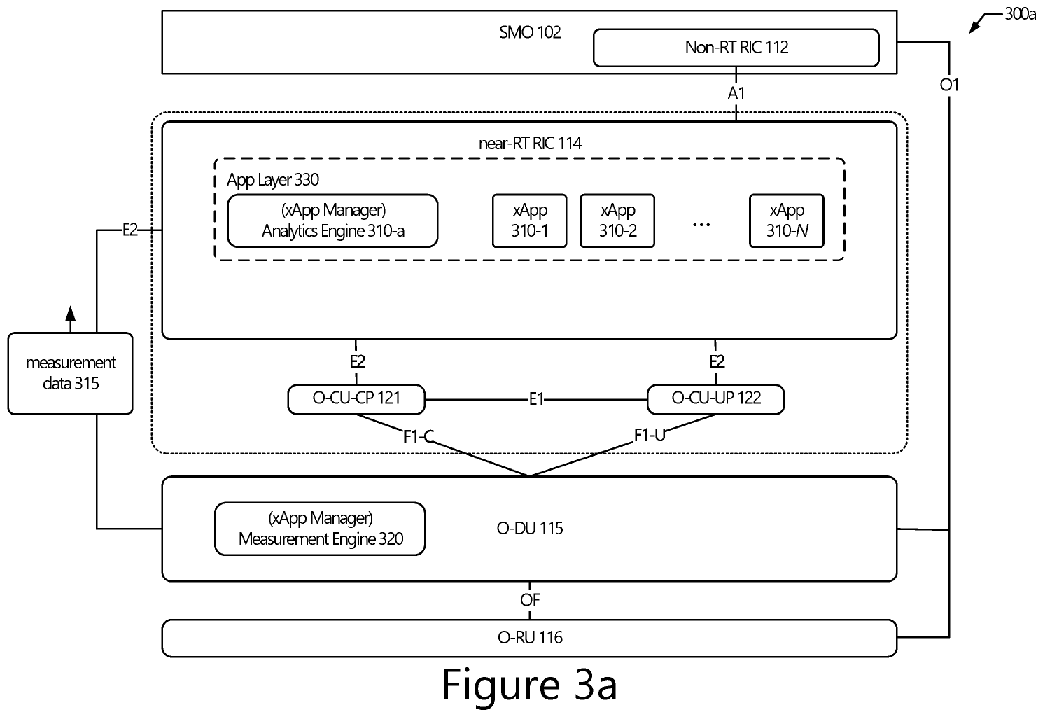

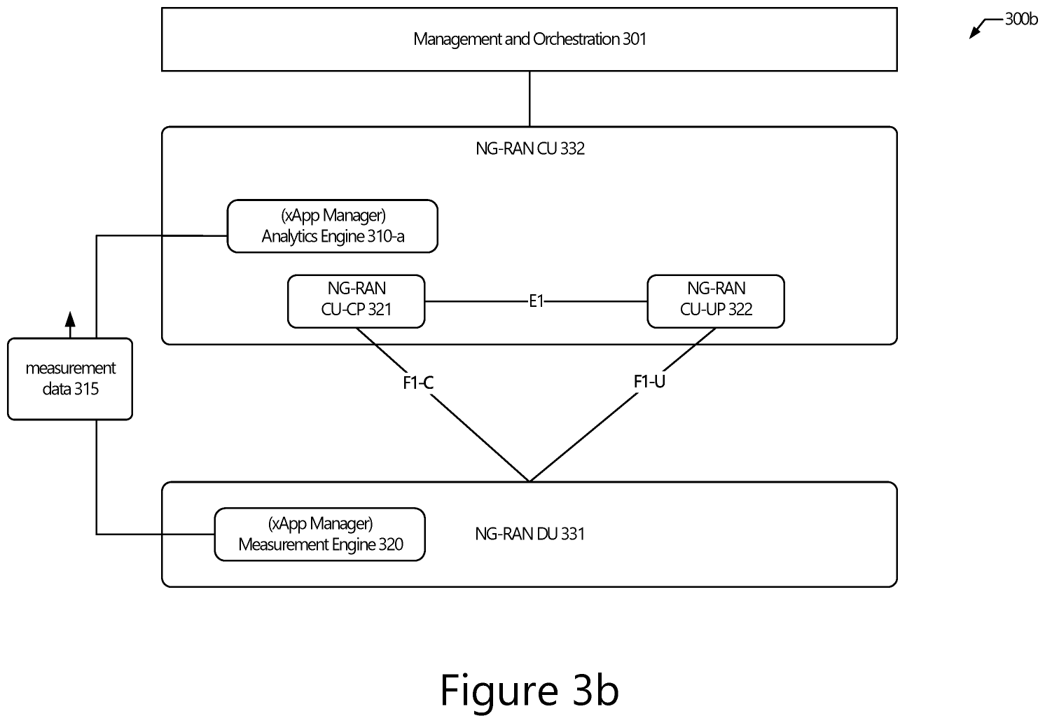

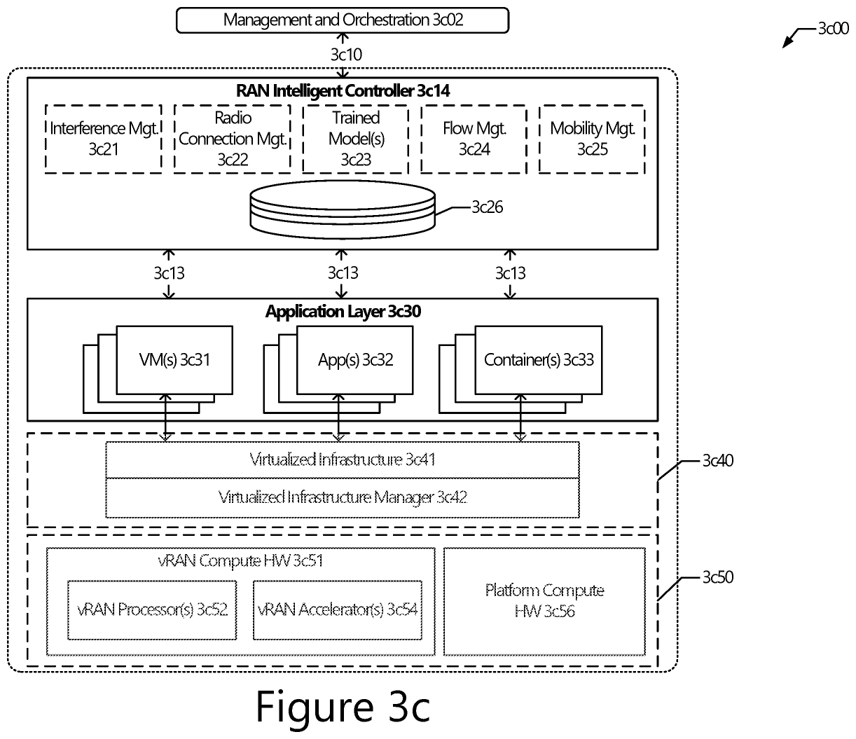

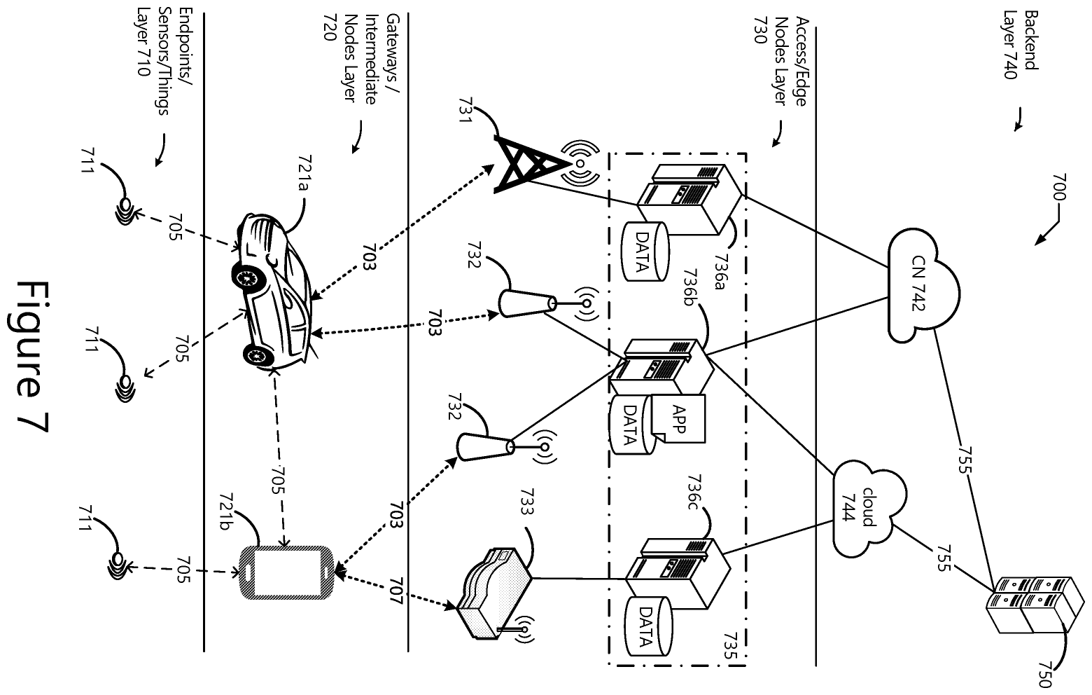

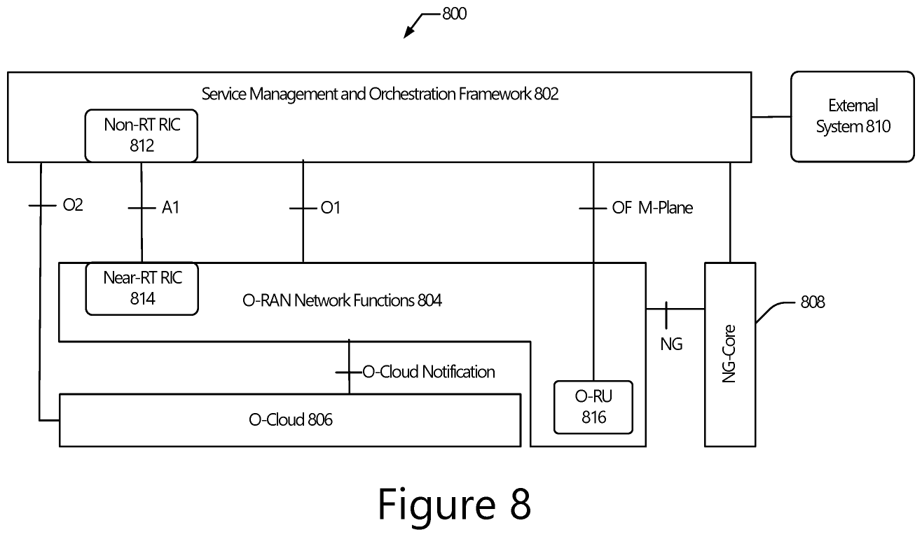

FIG. 1 depicts an example O-RAN architecture 100 including various interfaces between a RAN Intelligent Controller (RIC) 114 and service management and orchestration framework (SMO) 102. The SMO 102 may be the same or similar as the SMO 802, 902, 1002 and/or the MO 301, 3c02 discussed infra. The RIC 114 is an NF that also includes intelligent applications (apps) such as network ML/AI apps functioning with it to automate various NFs for predictive maintenance, enhanced operation, and the like. The O-RAN architecture 100 describes a model for RAN resource control, managed at the upper level by orchestration and automation components of the SMO 102 (e.g., policy, configuration, inventory, design, and non-RT RIC 112). These components control and communicate with the near-RT RIC 114 via the A1 interface. The near-RT RIC 114 provides management of and connectivity to RAN nodes (e.g., eNB/gNB 910, RU 816, DU 916, and the like). In some implementations, the near-RT RIC 114 may be the same or similar as the near-RT RIC 814 of FIG. 8 and/or the RIC 3c14 of FIG. 3c, and some aspects of the near-RT RIC 114 may be described infra w.r.t FIG. 3c. Additionally, a core set of services provided by the near-RT RIC 114 is extensible by custom third-party xApps, which are instantiated as cloud services and have low-latency connectivity to RAN nodes. xApps communicate with the RIC 114 and its managed RAN nodes via the E2 interface. O-RAN defines and clarifies the usage of various interfaces in the O-RAN architecture 100. These interfaces are summarized by Table 1.

TABLE 1

| Interface | Termination Point 1 | Termination Point 2 |
|---|---|---|
| A1 | Orchestrator (e.g., | RAN components (e.g., |
| | SMO 102) | near-RT RIC 114) |
| E1 | CU-control plane (CP) | CU-user plane (UP) |
| | (e.g., O-CU-CP 121) | (e.g., O-CU-UP 122) |
| E2 | RIC (e.g., near-RT | CU (e.g., O-CU 121, 122)/DU |
| | RIC 114) | (e.g., O-DU 115) |
| F1 | CU (e.g., O-CU 121, 122) | DU (e.g., O-DU 115) |
| OF | DU (e.g., O-DU 115) | RU (e.g., O-DU 116) |
| O2 | Orchestrator (e.g., | Cloud Platform (e.g., |
| | SMO 102) | O-Cloud 106) |

The O-RAN architecture 100 also includes an O-RAN cloud platform 106, a non-RT RIC 112, an O-RAN central unit control plane entity (O-CU-CP) 121, an O-RAN central unit user plane entity (O-CU-UP) 122, an O-RAN distributed unit (O-DU) 115, and an O-RAN remote unit (O-RU) 115, which may be the same or similar as the O-Cloud 806, non-RT RIC 812, O-CU-CP 921, O-CU-UP 922, O-DU 915, and O-RU 816, 915, respectively. These and other elements shown by FIG. 1 are discussed infra w.r.t FIGS. 8-12.

Most cloud platforms today use standard telemetry collectors for the telemetry to be fed into the non-RT RIC using the O1 and O2 interfaces, which runs analytics and acts on the infrastructure telemetry every 10 seconds (s) or more. While the O2 interfaces acquire appropriate telemetry from the near-RT RIC 114, central unit (CU) 121, 122, and DU 115, the interval of 10 s or more essentially defeats the purpose of configuring and/or reallocating HW, SW, and/or network (NW) resources within sub-second intervals for real-time and near-real-time scenarios and/or use cases. Additionally, xApps that implement complex AI/ML algorithms for various use cases (e.g., traffic steering, traffic splitting, connection management, and/or the like) are not able obtain enough HW, SW, and/or NW resources to run to completion or in an optimal manner within a predefined and/or configured interval. Currently, there are no solutions to control/manage QoS within or among xApps.

One existing solution is the OpenShift Container Platform (OCP) provided by Red Hat, Inc.®, which deploys an app manager and alarm manager on the near real-time RIC that primarily targets application telemetry and events from key performance measurements (KPMs) from an E2 terminator. Each Kubernetes® worker would have xApp onboarder and Influxdb data base that manages policies for the xApps. OCP's approach is a common form of implementing application telemetry and event management. However, the OCP framework does not consider or guarantee an xApp's run time performance and/or resource management customized for xApps within the time limits necessary for real-time or near real-time operations. There is also research looking to implement a RAN slicing manager that controls xApp priorities and functionality based on network slicing requirements (see e.g., Johnson et al., NexRAN: Closed-loop RAN slicing in POWDER-A top-to-bottom open-source open-RAN use case, 15th ACM Workshop on Wireless Network Testbeds, Experimental evaluation & CHaracterization (WiNTECH '21), pp. 17-23 (31 Jan. 2022) (“[Johnson]”), the contents of which are hereby incorporated by reference in its entirety).

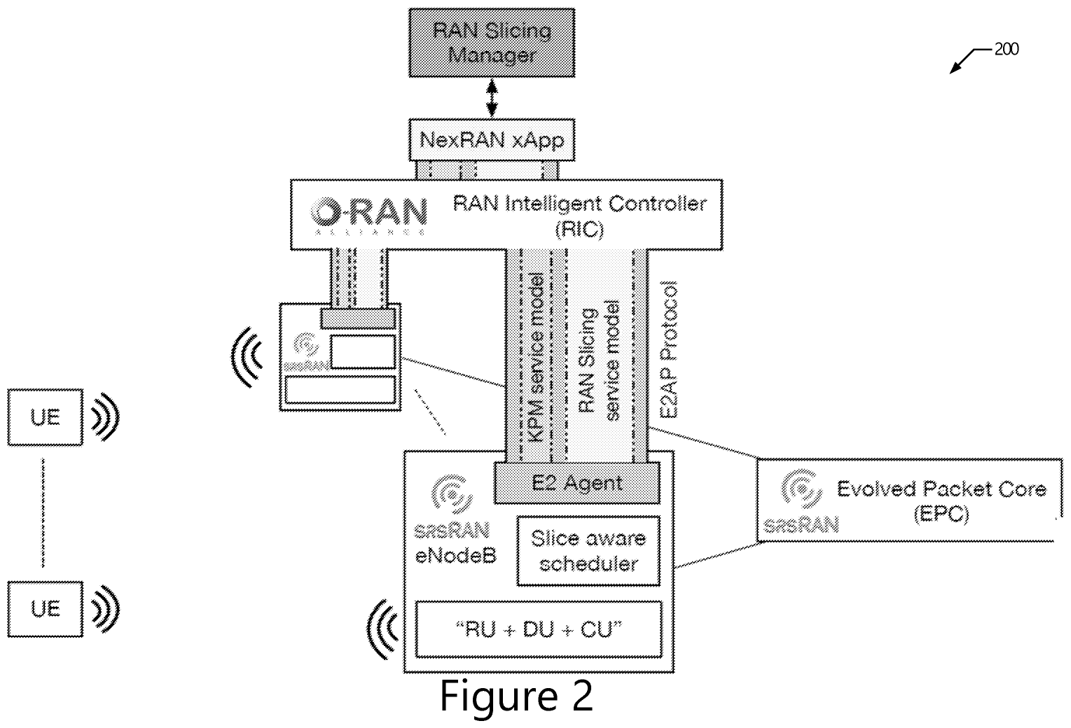

FIG. 2 depicts an example NexRAN 200 O-RAN framework (see e.g., [Johnson]) including a RAN slice manager with interfaces to xApps and E2 agents. The NexRAN 200 combines SW from the O-RAN Software Community and Software Radio Systems RAN (srsRAN). Here, a slice-aware scheduler and an O-RAN E2 agent is added to the srsRAN, and a custom xApp (e.g., “NexRAN xApp” in FIG. 2) is added to the RIC to control slicing. In this example, the E2 interface is a north-bound interface that connects the RIC with underlying radio equipment of the srsRAN. The E2 agent implements the core E2 Application Protocol (E2AP), has access to the internal RAN components in the srsRAN node stack to monitor and modify RAN parameters, and supports E2 service models to export RAN metrics and controls to xApps. NexRAN exposes this functionality, via a RESTful API, to a RAN slicing manager. The RAN slicing manager can create slices, bind/unbind slices to one or multiple RAN nodes, bind/unbind UEs to those slices, and dynamically modify slice resource allocations. Additional aspects of NexRAN 200 are discussed in [Johnson]. This and other existing techniques cannot be customized for managing HW resource QoS based on network slice requirements. The xApps run as a standalone entity either as containers or individual processes that continue to have equal priority regardless of the QoS requirements of various network slices.

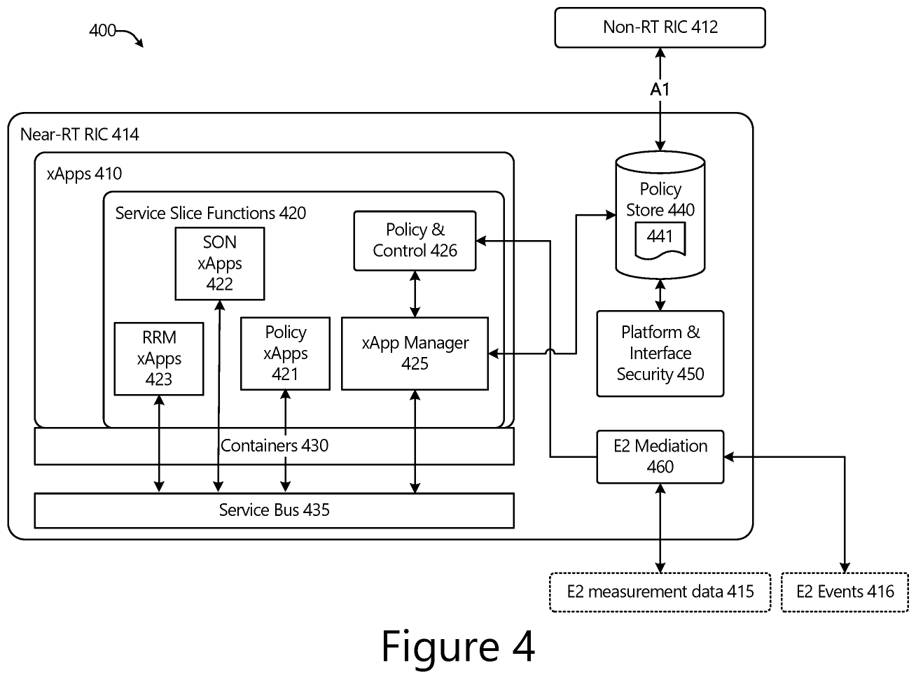

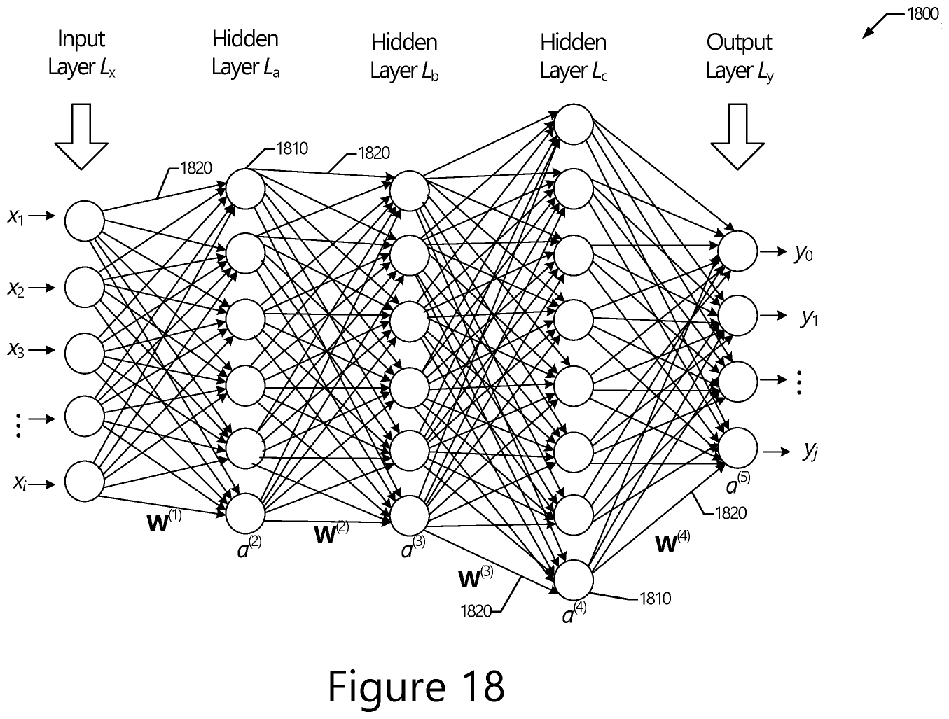

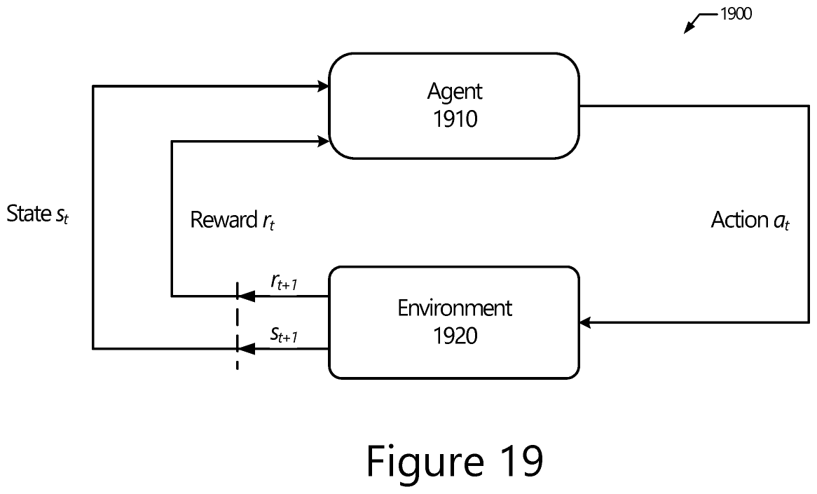

The present disclosure introduces an edge application manager (also referred to as a Telemetry Aware Scheduler (TAS)) (e.g., xApp manager 310, 320 in FIGS. 3a-3b, xApp manager 425 of FIG. 4, and so forth) that leverages telemetry data (e.g., telemetry data 515) from the underlying platform (e.g., edge compute node and/or cloud compute node operating the edge app manager) and/or other platforms (e.g., other edge compute nodes and/or other cloud compute nodes, application servers, RAN nodes, UEs, and/or the like) and measurement data (e.g., measurement data 315, 415) obtained from various network elements (e.g., E2 nodes, RAN nodes, access points, UEs, and/or the like), combines the telemetry and measurement data, and generates meaningful observability insights (e.g., inferences, predictions, and the like) using, for example, AI/ML mechanisms (e.g., heuristics, AI/ML models, optimization functions, and/or other predictive algorithms such as those discussed infra w.r.t FIGS. 18 and 19). In some examples, the edge app manager (or TAS) collects platform telemetry data collected from one or more telemetry collection agents, and exposes the telemetry data to a control plane entity. This exposes edge node telemetry data/metrics, which enabling service providers to implement rule-based workload placement for o performance and resilience. The control plane entity is able to monitor the performance of respective nodes, and dynamically deploy and/or migrate workloads for optimal performance. The exposure of the platform telemetry data in this way allows service providers and/or network operators to to implement rule-based workload placement for optimal performance and resilience including, for example, noisy neighbor situations, QoS and/or QoE tuning, platform resilience, and/or real-time resource management.

In the present disclosure, the telemetry data at least in some examples can include HW and/or SW data (e.g., raw data, measurements, and/or metrics) related to various parameters, performance, and/or other aspects of the underlying compute node/platform operating as a controller and/or operating various edge apps (e.g., xApps). As examples, the compute node/platform operating as a controller can be one or more edge compute nodes, one or more cloud compute nodes (or a cloud compute cluster), one or more application servers, one or more RAN nodes, a collection of hardware accelerators, and/or some other computing element, such as any of those discussed herein, and the controller may be a network controller, a network scheduler, a gateway, an O-RAN RIC, a MEC platform or MEC platform manager, and/or any other type of controller or management entity, such as any of those discussed herein. Additionally or alternatively, the telemetry data discussed herein at least in some examples includes HW and/or SW data related to various parameters, performance, and/or other aspects of other relevant compute nodes operating various edge apps (e.g., xApps, rApps, MEC apps, and/or the like) and/or providing various services. These other compute nodes at least in some examples can include, such as, for example, other edge compute node(s), other cloud compute node(s), other RAN node(s), NF(s), application function(s) (AF(s)), UE(s), a collection of hardware accelerators, and/or some other computing element, such as any of those discussed herein.

Furthermore, the measurement data discussed herein, at least in some examples, can include NW metrics and/or measurements and/or other data, metrics, and/or measurements collected or otherwise obtained by one or more network nodes (e.g., RAN nodes, UEs, NFs, AFs, gateways, network appliances, routers, switches, hubs, and/or other network elements, such as any of those discussed herein). In some examples, the measurement data may require some sort of processing of data, such as processing collected and/or captured measurements. As examples, the measurement data can include raw data, measurements, and/or metrics related to signal measurements, communication channel conditions, cell conditions and/or parameters, configuration parameters (e.g., MAC and/or RRC configuration data, downlink control information (DCI), uplink control information (UCI), and/or the like), core network conditions and/or parameters, congestion statistics and/or other data/metrics of individual NFs and/or RAN functions (RANFs), interface and/or reference points measurements/metrics (e.g., measurements/metrics related to fronthaul, midhaul, and/or backhaul interfaces and/or any other interface or reference point, such as any of those discussed herein), sensor data (including data from communications-related sensors and/or other sensors including any of the sensors discussed herein), and/or the like. Additionally or alternatively, the telemetry data and/or the measurement data discussed herein can include any type of data or information that is scheduled and/or measureable by a network node and/or compute node, even if that data or information is not related to an ongoing or already-established network connection, session, or service. Additional or alternative examples of measurement data and/or telemetry data are also provided infra.

The example implementations discussed herein provide the ability to customize and correlate HW, SW, and/or NW resources per network slice and network service (e.g., service slices) and/or on a per-xApp basis. Additionally, KPMs (e.g., number of UE requests, data volume measurements, and the like) and/or other collected measurements/metrics can be correlated with one another and/or with other data and/or statistics, which can be used to scale up or down physical and/or virtualized HW, SW, and/or NW resources for xApps to process relevant inputs. The example implementations discussed herein also enable faster reaction times to key platform events, improving, inter alia, resilience, service availability, faster root cause analysis (in comparison to existing technologies), faster time to repair (in comparison to existing technologies), and faster reallocation of resources (in comparison to existing technologies) based on, for example, load, fault conditions, resource exhaustion, thermal conditions, and/or other metrics/measurements such as any of those discussed herein. Moreover, the various example implementations discussed herein provide performance improvements and resource consumption efficiencies, and the opportunity to unlock data value from underlying platforms (e.g., Intel® Architecture (IA) (e.g., IA-32, IA-64, and so forth)) through having xApp manager deployed either in a container with root permissions or as a binary at run time.

FIG. 3a depicts an example RAN intelligent xApp manager architecture 300a in an O-RAN framework. In this example, the xApp manager architecture 300a includes an xApp manager analytics engine 310-a implemented as an xApp 310 in an app layer 330 of the near-RT RIC 114, and a counterpart xApp manager measurement engine 320 implemented by the O-DU 115. The app layer 330 also includes a set of xApps 310-1 to 310-N (where N is a number). The xApps 310-a, 310-1 to 310-N (collectively referred to as “xApps 310”) may be the same or similar as xApps 410, 1110, and 1210 of FIGS. 4, 11, and 12.

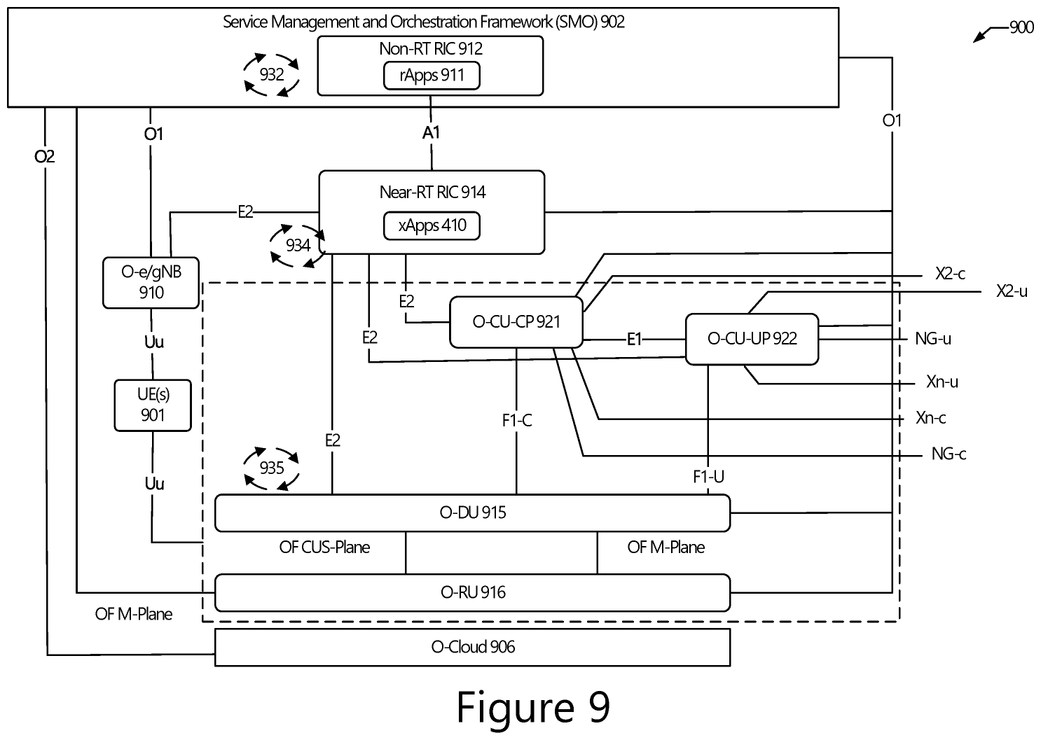

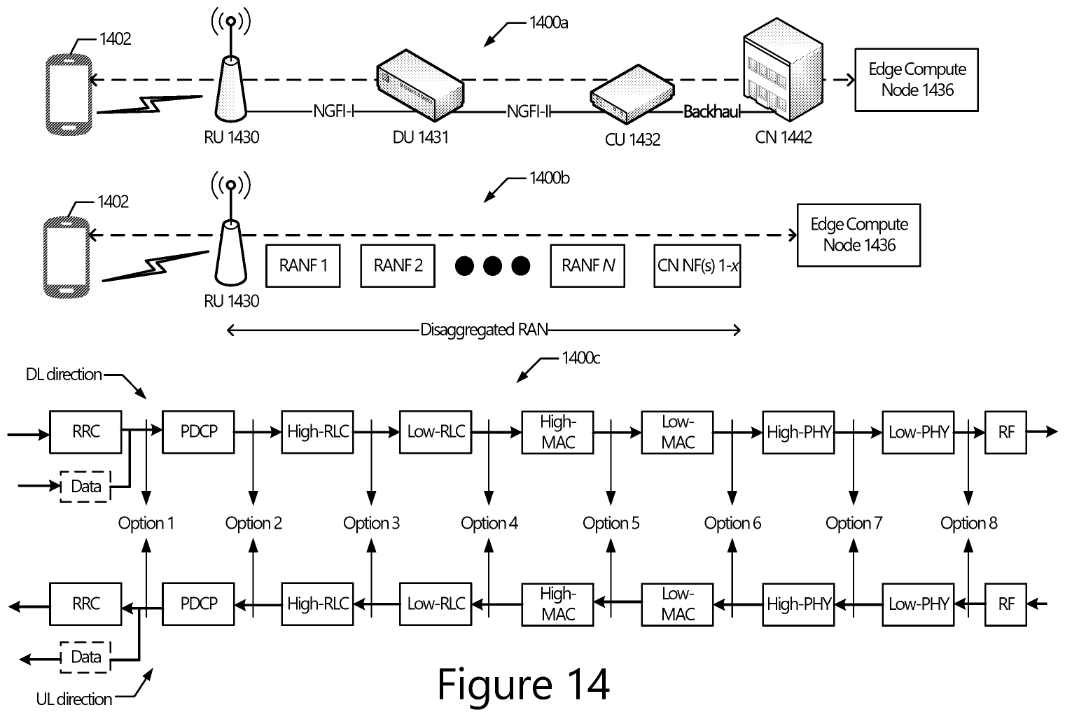

FIG. 3b depicts an example RAN intelligent xApp manager architecture 300b in a CU/DU split architecture of a next generation (NG)-RAN (see e.g., [TS38401]). Various options for split architectures are discussed infra w.r.t FIG. 14. The xApp manager architecture 300b includes a Management and Orchestration layer (MO) 301 (which may be the same or similar as the SMO 102 of FIG. 1, MO 3c02 or FIG. 3c, SMO 802 of FIG. 8, and/or SMO 902 of FIG. 9), an NG-RAN CU 332 (which may be the same or similar as the O-CU 121, 122 of FIGS. 1 and 3a, O-CU 921, 922 of FIG. 9, CU 1432 of FIG. 14, NANs 730 of FIG. 7, and/or the like), and an NG-RAN DU 331 (which may be the same or similar as the O-DU 915 of FIG. 9, the DU 1431 of FIG. 14, NANs 730 of FIG. 7, and/or the like). In some implementations, the NG-RAN CU 332 may be, or may be part of, a RAN Intelligent Controller (RIC) such as the near-RT RIC 114 and/or the RIC 3c14 of FIG. 3c. In the example of FIG. 3b, the xApp manager analytics engine 310-a is implemented as a RANF in the NG-RAN CU 332, and the counterpart xApp manager measurement engine 320 is implemented as a RANF in an NG-RAN DU 331.

In FIGS. 3a and 3b, the xApp manager measurement engine 320 collects and/or captures measurement data 315 of various network elements such as, for example, one or more UEs (e.g., UE 901, UEs 710, and/or the like), O-RUs 116 (or RRHs), O-DUs 115 and/or NG-RAN DUs 331, and/or the like. The xApp manager measurement engine 320 provides the measurement data 315 to the xApp manager analytics engine 310-a via a suitable interface (e.g., the E2 interface in FIG. 3a, the F1 interface in FIG. 3b, and/or some other interface such as an NG, Xn, X2, E1, and/or the like). For purposes of the present disclosure, the term “xApp manager” (with or without a reference label) may refer to the xApp manager analytics engine 310-a, the xApp manager measurement engine 320, or both the xApp manager analytics engine 310-a and the xApp manager measurement engine 320.

The xApp manager measurement engine 320 is responsible for processing active UE call flow data, and/or other network element measurements, metrics, or data into measurement data 315 to be consumed by the xApp manager analytics engine 310-a. Resulting measurement data 315 are provided via the O-RAN interface (see e.g., FIG. 3a) or a suitable 3GPP/NG-RAN interface (see e.g., FIG. 3b). The measurement data 315 can be carried by one or more suitable messages and/or PDUs between the measurement engine 320 and the analytics engine 310-a. Additionally, suitable messages/PDUs can also flow from the xApp manager analytics engine 310-a to other xApps 310.

As examples, the measurement data 315 in FIGS. 3a-3b can include traffic throughput measurement data, latency measurements for uplink (UL) and downlink (DL) communication pipelines, cell throughput time (TPT) measurement data, RU and/or DU baseband unit (BBU) measurements, metrics, or other data (e.g., BBU measurements and/or telemetry data, RU/DU platform telemetry data, and/or the like), vRAN fronthaul (FH) interface measurement data (e.g., L1 and/or layer 2 (L2) FH measurements, and/or the like), RU and/or DU measurement data (e.g., layer 1 (L1)/PHY measurements captured by RUs/DUs, and/or measurements/metrics discussed in [ISEO]), UE measurements (e.g., L1 and/or L2 measurements captured or collected by one or more UEs), and/or any other types of measurements, metrics, and/or data such as any of those discussed herein.

In various implementations, different types of measurement data 315 can be tiered or otherwise classified in such a way to accommodate different O-RAN control loop timings. Here, different types of measurement data 315 are classified or categorized according to how long such data 315 is useful or relevant, and/or based on how the different types of measurement data 315 are going to be used. For example, the measurement data 315 can be tiered and/or classified according to whether it is required for real-time (RT) control loops (e.g., referred to herein as “RT measurement data 315” or the like), near-RT control loops (e.g., referred to herein as “near-RT measurement data 315” or the like), or non-RT control loops (e.g., referred to herein as “non-RT measurement data 315” or the like). Various examples of tiered measurement data 315 and/or associated KPIs/metrics are discussed infra. However, these examples are not intended to limit the type and/or amount of measurement data 315 that can be used, as new types of measurement data 315 may be used in future access network technologies.

Examples of RT measurement data 315 include measurement data 315 that is used for analytics or other purposes that require live data between O-DUs 115/DUs 331 (e.g., gNB, ng-eNB, eNB, or the like) and UEs for one or more cells. An example of such RT measurement data 315 includes radiofrequency (RF) health reports, which may include, for example, a maximum number of concurrent clients count per radio band per time period (e.g., where the radio bands include 2.4 GHz, 5 GHz, 6 GHz, and the like). Other examples of RT measurement data 315 include transmit (Tx) power for physical uplink control channel (PUCCH), physical uplink shared channel (PUSCH), RSRQ, RSRP, SNR, channel estimation and/or beam-specific RSRP/RSRQ/SNR, and/or other signal measurements such as any of those discussed herein. In various implementations, RT measurement data 315 is used as soon as possible to make decisions at the analytics engine 310-a. As such, the xApp manager measurement engine 320 calculates and forwards this type of measurement data 315 to the xApp manager analytics engine 310-a before the measurement data 315 expires or is no longer useful for specific analytics purposes.

In some examples, RT measurement data 315 can be based on active and timely measurements collected or captured by various UEs (active and/or scheduled), RUs, and/or DUs such as channel estimation and beam health. Here, obtaining, measuring, and providing L1/L2 heuristics to perform remote vRAN intelligent analytics can reduce onsite analysis. Additionally or alternatively, the RT measurement data 315 can be used for sounding out or otherwise determining the bandwidth (BW) allocated to individual UEs outside of currently scheduled data transmissions. Depending on the carrier, channel, or BW part that the UE is scheduled to receive or send UL or DL transmissions, the RAN can switch the UE to a different BW part or channel if, for example, a different BW part/channel is available and has better signal/channel characteristics (e.g., less noise, less interference, and/or the like) in comparison to the already allocated BW part/channel.

Additionally or alternatively, the measurement data 315 can include near-RT heuristics that can be captured and provided via the E2 interface before their usefulness expires up to and including separate DL and UL sounding information either within current BW allocated within UE data channels or sounding out or otherwise determining other available BW (e.g., within the 100 MHz of the 5G NR numerology of 1 with a 30 kHz subcarrier scaling (μ=1); see [TS38300]) not currently used for ongoing data transfer. Heuristics that involve sounding or otherwise determining either DL (e.g., configured scheduling (CS)-CSI, CSI-RS, DMRS, PRS, PT-RS, PSS, SSS, and/or the like), UL (e.g., DMRS, PT-RS, SRS, and/or the like), and/or SL (e.g., DMRS, PRS, S-PSS, S-SSS, and/or the like) can be utilized in near real-time for the gNB (MAC) scheduler to take action such as, for example, using either UE codebook or non-codebook channel changes and/or the like.

In another example, near-RT measurement data 315 can include UL and/or DL reference signal measurements, which may be scheduled within UL or DL data channels (e.g., PUSCH, PDSCH, PSSCH, and/or the like), or periodic or non-periodic signals separate from existing data channels within the BW allocated for a specific UE and/or a specific carrier frequency for a specific numerology and frame structure (e.g., 5G numerology of 1 with 30 KHz subcarrier and 100 MHz BW; see [TS38300]). In another example, near-RT measurement data 315 can include the number of OFDM symbols per slot, slots per frame, slots per subframe, and/or relevant metadata. This near-RT measurement data 315 can be used to reconstruct and compare original sounding signals to the resulting signal form at the RAN node (e.g., gNB, eNB, RU, DU, or the like). Here, the differences between the reference and reported measurements can take the form of In-phase Quadrature (IQ) samples at respective antennas of the RAN node and/or respective antennas of the UE.

Additionally or alternatively, other layer 1 (L1) and/or layer 2 (L2) data may influence other control loops via E2 into the L2 MAC and be less timely. In these ways, the measurement engine 320 is able to capture and/or measure the L1 and/or L2 analytics measurement data 315 before those analytics measurement data 315 expire, which is typically measured in terms of the number of transmission timing intervals (TTIs). Additional examples of measurement data 315 are described infra.

FIG. 3c shows an example RAN intelligent controller (RIC) architecture 3c00. The RIC architecture 3c00 includes Management and Orchestration layer (MO) 3c01 (also referred to as “Operations, Administration, and Maintenance 3c01”, “OAM 3c01”, “SMO 3c01”, and/or the like), which includes a group of support NFs that monitor and sustain RAN domain operations, maintenance, and administration operations for the RIC architecture 3c00 (including the and/or automation of tasks). The MO 3c02 may be an O-RAN Service Management and Orchestration (SMO) (see e.g., [O-RAN]), ETSI Management and Orchestration (MANO) function (see e.g., [ETSINFV]), Open Network Automation Platform (ONAP) (see e.g., [ONAP]), a 3GPP Service Based Management Architecture (SBMA) (see e.g., [TS28533]), a network management system (NMS), a [IEEE802] OAM entity, and/or the like. The MO 3c02 sends management commands and data to the RIC 3c14 via interface 3c10, and receives relevant data from the RIC 3c14 via interface 3c10. As examples, in O-RAN implementations, the interface 3c10 may be the A1 interface and/or the O1 interface.

In some implementations, the MO 3c02 is responsible for some or all of the following functions: maintaining an overall view of the edge system/platform based on deployed/workloads, available resources, available edge services, and/or network topology; on-boarding of app packages including integrity and authenticity checks, validating application rules and requirements and adjusting them to comply with operator policies (if necessary), keeping a record/log of on-boarded packages, and preparing the VIM 3c42 to handle the applications; selecting appropriate edge functions, RANFs, NFs, and/or workloads for app instantiation based on one or more constraints (e.g., latency, data rate, bandwidth, and/or the like), available resources, and/or available services; and/or triggering app instantiation, relocation/migration, and termination. Additionally or alternatively, the MO 3c02 may also provide or perform failure detection, notification, location, and repairs that are intended to eliminate or reduce faults and keep a segment in an operational state and support activities required to provide the services of a subscriber access network to users/subscribers.

In O-RAN implementations, the MO 3c02 may include a non-RT RIC (e.g., non-RT RIC 812). The non-RT RIC provides non-RT control functionality (e.g., >1 second (s)) and near-RT control functions (e.g., <1 s) are decoupled in the non-RT RIC. Non-RT functions include service and policy management, RAN analytics and model-training for the near-RT RAN functionality. In some implementations, trained models 3c23 and real-time control functions produced in the non-RT RIC are distributed to a near-RT RIC (e.g., the RIC 3c14) for runtime execution via an A1 interface (e.g., interface 3c10) between the MO 3c02 containing non-RT RIC and the near-RT RIC 3c14. Network management applications in the MO 3c02 (e.g., in the non-RT RIC) are able to receive and act on highly reliable data from modular CUs and/or DUs in a standardized format over the A1 interface (e.g., interface 3c10). Messages generated from ML/AI-enabled policies and AI/ML-based training models in the non-RT RIC are conveyed to the near-RT RIC 3c14 (e.g., as trained model(s) 3c23) via the A1 interface (e.g., interface 3c10). Additionally, RAN behaviors can be modified by deployment of different models optimized to individual operator policies and/or optimization objectives.

The RIC architecture 3c00 also includes a RIC 3c14 (also referred to as “network controller 3c02”, “intelligent controller 3c02”, “intelligent coordinator 3c02”, “RAN controller 3c02”, “near-RT RIC”, or the like). In some implementations, the RIC 3c14 is a BBU, a cloud RAN controller, a C-RAN, an O-RAN RIC (e.g., a non-RT RIC and/or near-RT RIC), vRAN controller, an edge workload scheduler, some other edge computing technology (ECT) host/server (such as any of those discussed herein), and/or the like. The RIC 3c14 is responsible for RAN controller functionality, as well as provisioning compute resources for various RANFs, NFs, VM(s) 3c31, containers 3c33, and/or other applications (apps) 3c32. The RIC 3c14 also acts as the “brain” of the CU(s) (e.g., O-CU 921, 922 of FIGS. 1, 3a, and 9 and/or the CU 1432 of FIG. 14) and may also control some of the aspects of the core network (e.g., CN 1442 of FIG. 14 (or individual NFs 1-x of the CN 1442), CN 742 of FIG. 7, and/or the like). The RIC 3c14 also provides application layer support to coordinate and control CU(s) 1432 as well as provisioning compute resources for RANFs (see e.g., RANFs 1-N of FIG. 14), NFs, and/or other apps (e.g., VMs 3c31, apps 3c32, and/or containers 3c33). In some implementations, the RIC 3c14 can instantiate compute resources in a same or similar manner as is done with cloud computing services and/or using a similar framework for such purposes. Additionally, the RIC 3c14 can reserve and provision compute resources at individual RAN node deployments, for example, at locations of different RUs (e.g., O-RU 916 and/or RU 1430 of FIG. 14 and/or DUs (e.g., O-DU 915 and/or DU 1431 of FIG. 14). In these implementations, edge compute elements (e.g., edge compute nodes 736 of FIG. 7) may be disposed at RU and/or DU cell sites to provide such resources.

Furthermore, the RIC 3c14 provides radio resource management (RRM) functionality including, for example, radio bearer control, radio admission control, connection and mobility control (e.g., radio connection manager 3c22 and mobility manager 3c25), and dynamic resource allocation for UEs 1402 (e.g., scheduling). The RIC 3c14 also performs other functions such as, for example, routing user plane data and control plane data, generating and provisioning measurement configurations at individual UEs, session management, network slicing support operations, transport level packet marking, and the like.

The RIC 3c14 includes an interference manager 3c21 that performs interference detection and mitigation, and a mobility manager 3c25 that provides per-UE controlled load balancing, resource block (RB) management, mobility management, and/or other like RAN functionality. In addition, the RIC 3c14 provides RRM functions leveraging embedded intelligence, such as the flow manager 3c24 (also referred to as a “QoS manager 3c24”) that provides flow management (e.g., QoS flow management, mapping to data radio bearers (DRBs), and the like), and a radio connection manager 3c22 that provides connectivity management and seamless handover control. The Near-RT RIC delivers a robust, secure, and scalable platform that allows for flexible on-boarding of third-party control applications. The RIC 3c14 also leverages a Radio-Network Information Base (R-NIB) 3c26, which captures the near real-time state of the underlying network (e.g., from CUs 1432, DUs 1431, and/or RUs 1430) and commands from the MO 3c02 (e.g., the non-RT RIC in the MO 3c02). The RIC 3c14 also executes trained models 3c23 to change the functional behavior of the network and applications the network supports. As examples, the trained models 3c23 include traffic prediction, mobility track prediction, and policy decisions, and/or the like.

The RIC 3c14 communicates with the application (app) layer 3c30 via interface 3c13, which may include one or more APIs, server-side web APIs, web services (WS), and/or some other interface or reference point. As examples, the interface 3c13 may be one or more of Representational State Transfer (REST) APIs, RESTful web services, Simple Object Access Protocol (SOAP) APIs, Hypertext Transfer Protocol (HTTP) and/or HTTP secure (HTTPs), Web Services Description Language (WSDL), Message Transmission Optimization Mechanism (MTOM), MQTT (formerly “Message Queueing Telemetry Transport”), Open Data Protocol (OData), JSON-Remote Procedure Call (RPC), XML-RPC, Asynchronous JavaScript And XML (AJAX), and/or the like. Any other APIs and/or WS may be used including private and/or proprietary APIs/WS. Additionally or alternatively, the interface 3c10 could include any of the aforementioned API/WS technologies.

The application layer 3c30 includes one or more virtual machines (VMs) 3c31, one or more applications (apps) 3c32 (e.g., edge apps, xApps 410, rApps 911, and/or the like), and/or one or more containers 3c33. In some implementations, the VMs 3c31, apps 3c32, and/or containers 3c33 in the application layer 3c30 represent or otherwise correspond to a modular CU/DU/RU functions (in one or more split architecture options) and/or a disaggregated RANFs 1-N of FIG. 14. Additionally or alternatively, multi-RAT protocol stacks (or higher layers of such protocol stacks) may operate as, or in, the VMs 3c31, apps 3c32, and/or containers 3c33. For example, individual RANFs and/or CU/DU/RU functions may be operated within individual VMs 3c31 and/or containers 3c33, where each VM 3c31 or container 3c33 corresponds to an individual user/UE and/or session. Additionally or alternatively, each app 3c32 may correspond to individual protocol stack entities/layers of the network protocol stacks discussed herein (see e.g., the RRC, SDAP, PDCP-C, PDCP-U, RLC-MAC, PHY-High, PHY-Low, and RF entities in FIG. 1).

In O-RAN implementations, the interface 3c13 is the E2 interface between the Near-RT RIC 3c02 and a Multi-RAT CU 1432 protocol stack and the underlying RAN DU 1431, which feeds data, including various RAN measurements, to the Near-RT RIC 3c02 to facilitate RRM, it is also the interface through which the Near-RT RIC 3c02 may initiate configuration commands directly to CU 1431/DU 1432 or the disaggregated RANF 1-N (see e.g., FIG. 14).

The application layer 3c03 operates on top of a system SW layer 3c40 (also referred to as a “virtualization layer 3c40” or the like). The system SW layer 3c40 includes virtualized infrastructure 3c41 (also referred to as “virtual operating platform 3c41”, “virtual infrastructure 3c41”, “virtualized HW resources 3c41”, or the like), which is an emulation of one or more HW platforms on which the VMs 3c31, apps 3c32, and/or containers 3c33 operate. The virtualized infrastructure 3c41 operates on top of virtualized infrastructure manager (VIM) 3c42 that provides HW-level virtualization and/or OS-level virtualization for the VMs 3c31, apps 3c32, and/or containers 3c33. The VIM 3c42 may be an operating system (OS), hypervisor, virtual machine monitor (VMM), and/or some other virtualization management service or application.

The system SW layer 3c40 operates on top of the HW platform layer 3c50, which includes virtual (or virtualized) RAN (vRAN) compute HW 3c51 that operates one or more disaggregated RANFs 1-N using one or more vRAN processors 3c52 and vRAN accelerators 3c54. A vRAN is a type of RAN that includes various networking functions separated from the hardware it runs on. For purposes of the present disclosure, the term “virtual RAN” or “vRAN” may refer to a virtualized version of a RAN, which may be implemented using any suitable vRAN framework such as, for example, O-RAN Alliance (see e.g., [O-RAN]), Cisco® Open vRAN™, Telecom Infra Project (TIP) OpenRAN™, NexRAN 200, Intel® FlexRAN™, Red Hat® OCP™, and/or the like.

The vRAN processors 3c52 are processors that include (or are configured with) one or more optimizations for vRAN functionality. The vRAN processors 3c52 may be COTS HW or application-specific HW elements. As examples, the vRAN processors 3c52 may be Intel® Xeon® D processors, Intel® Xeon® Scalable processors, AMD® Epyc® 7000, AMD® “Rome” processors, and/or the like. The vRAN accelerators 3c54 are HW accelerators that are configured to accelerate 4G/LTE and 5G vRAN workloads. As examples, the vRAN accelerators 3c54 may be Forward Error Correction (FEC) accelerators (e.g., Intel® vRAN dedicated accelerator ACC100m Xolinx® T1 Telco Accelerator Card, and the like), low density parity check (LDPC) accelerators (e.g., AccelerComm® LE500 and LD500), networking accelerators (e.g., Intel® FPGA PAC N3000), and/or the like. Additionally or alternatively, the vRAN processors 3c52 may be the same or similar as processor(s) 1752 of FIG. 17, and the vRAN accelerators 3c54 may be the same or similar as the acceleration circuitry 1764 of FIG. 17. Interaction between the vRAN processors 3c52 and vRAN accelerators 3c54 may take place via an acceleration abstraction layer (AAL) for standardized interoperability, via an inline HW accelerator pipeline or functional chains, via virtual input/output (vI/O) interfaces, via single root I/O virtualization (SR-IOV) interfaces, and/or via some other interface or mechanism. The HW platform layer 3c50 also includes platform compute HW 3c56, which includes compute/processor, acceleration, memory, and storage resources that can be used for UE-specific data processing and/or RANF-specific data processing. The compute, acceleration, memory, and storage resources of the platform compute HW 3c56 correspond to the processor circuitry 1752, acceleration circuitry 1764, memory circuitry 1754, and storage circuitry 1758 of FIG. 17, respectively.

The example of FIG. 3c shows the RIC 3c14, app layer 3c30, SW layer 3c40, and HW layer 3c50 as being part of the same platform (e.g., as illustrated by the dashed bow around layers 3c14, 3c30, 3c40, and 3c50 in FIG. 3c). However, in other implementations, some or all of the layers 3c14, 3c30, 3c40, and 3c50 can be implemented in or by different computing elements. In some implementations, the vRAN compute HW 3c51 may be included in one or more vRAN servers, which may be COTS server HW or special-purpose server HW, and the edge compute HW 3c56 is enclosed or housed in suitable server platform(s) that are communicatively coupled with the vRAN server(s) via a suitable wired or wireless connection. In some implementations, the vRAN compute HW 3c51 and the edge compute HW 3c56 are enclosed, housed, or otherwise included in a same server enclosure. In these implementations, the additional sockets for processor, memory, storage, as and accelerator elements can be used to scale up or otherwise connect for the vRAN compute HW 3c51 and the edge compute HW 3c56 for edge computing over disaggregated RAN. In either implementation, the server(s) may be housed, enclosed, or otherwise included in a small form factor and ruggedized server housing/enclosure.

FIG. 4 shows an example near-RT RIC deployment 400 including the near-RT RIC 414 capable of interacting with a non-RT RIC 412 via the A1 interface. The non-RT RIC 412 performs orchestration and management functions as part of an SMO (e.g., SMO 102, 802 or MO 3c02). The near-RT RIC 414 is a logical function that enables near real-time control and optimization of E2 node functions (e.g., RANFs) and resources via fine-grained data collection (e.g., collection of E2 measurement data 415) and actions 416 over the E2 interface with control loops in the order of 10 milliseconds (ms) to 1 second (s). The near-RT RIC 414 implements an E2 mediation function 460 that terminates the E2 interface for collecting E2 measurement data 415 and issuing (or receiving) E2 events/actions 416. The E2 measurement data 415 may be the same or similar as the measurement data 315 discussed previously. Additionally or alternatively, measurement data 415 and/or events/actions 416 can be obtained from (or sent over) other interfaces such as, for example, A1, O1, O2, OF, and/or other interfaces. The non-RT RIC 412 and the near-RT RIC 414 may be the same or similar as the non-RT RIC 812 and the near-RT RIC 814, respectively, and additional aspects of the non-RT RIC 412 and the near-RT RIC 414 are discussed infra w.r.t FIGS. 8-12.

The near-RT RIC 414 provides a platform for user-developed RAN optimization SW elements (e.g., xApps 410). The xApps 410 provide services and/or microservices that can leverage the O-RAN defined E2 interface to perform various RANFs and/or RAN optimizations. The RAN optimizations are performed for specific services microservices and/or in response to changing RAN conditions. The near-RT RIC 414 hosts a set of xApps 410, which may be the same or similar as the xApps 310, 510, 1110, and 1210 of FIGS. 3, 5, 11, and 12. The xApps 410 operate within respective virtualization containers 430, which may be the same or similar as the container(s) 3c33 discussed previously. The virtualization containers 430 can be implemented using any suitable virtualization technology such as any of those discussed herein. In most implementations, each xApp 410 runs inside its own virtualization container 430. However, in some implementations, one or more xApps 410 can run inside the same container 430. Additionally or alternatively, one or more xApps 410 can run insider one or more VMs (e.g., VM(s) 3c31 of FIG. 3c) and/or or one or more containers 430 may run inside one or more VMs. Additionally, the xApps 410 and/or different functions of the near-RT RIC 414 can run on the same compute node or by a set of compute nodes within a compute cluster, where the compute nodes are one or more physical HW devices, one or more VMs. Additionally or alternatively, the xApp 410 and/or different functions of the near-RT RIC 414 can be run as a software processes on a physical or virtual machine, for example, when the different xApps 410 and/or different RIC functions have different sets of security rules, access rules, and/or policies 441 specifying how the metrics and logs could be sent out onto the service bus 435. The particular deployment of xApps 410 and/or RIC functions can be implementation-specific, and can vary according to use case and/or design choice.

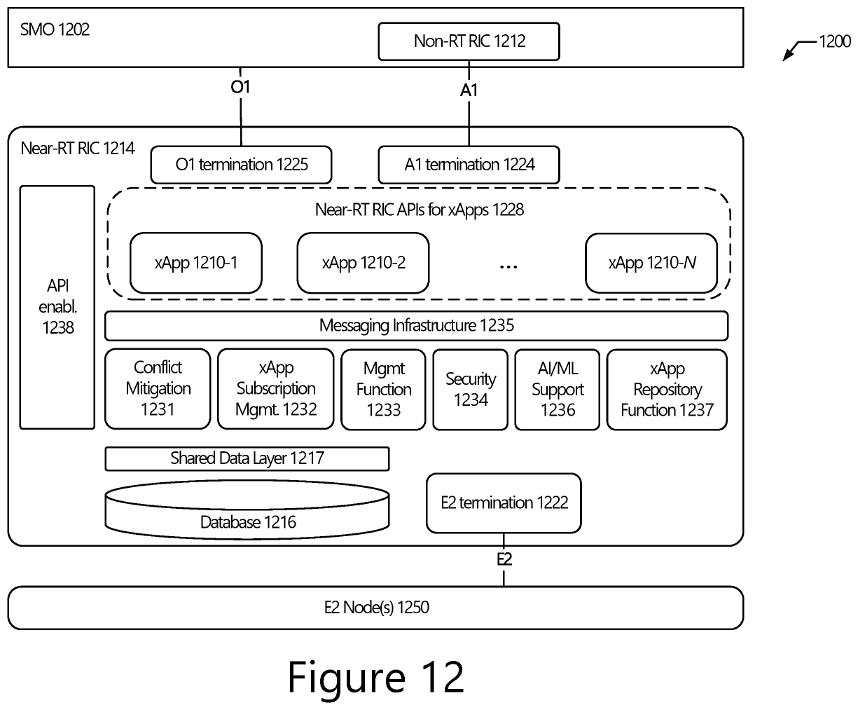

Each of the xApps 410 may communicate with one another via a service bus 435. The service bus 435 implements a communication system between the various services/microservices provided by individual xApps 410. As examples, the service bus 435 may provide some or all of the following functionality: routing messages between services; monitoring and controlling routing of message exchange between services; resolving contention between communicating services/components; controlling deployment and versioning of services; marshaling use of redundant services; providing commodity services such as, for example, event handling, data transformation and mapping, message and event queuing and sequencing, security and/or exception handling, protocol conversion, and enforcing proper quality (QoS) for communicating services. In some examples, the service bus 435 may be, or include, container network interfaces and/or other APIs to facilitate the communication among the xApps 410. Additionally or alternatively, the service bus 435 may be the same or similar as the messaging infrastructure 1235 of FIG. 12 discussed infra.

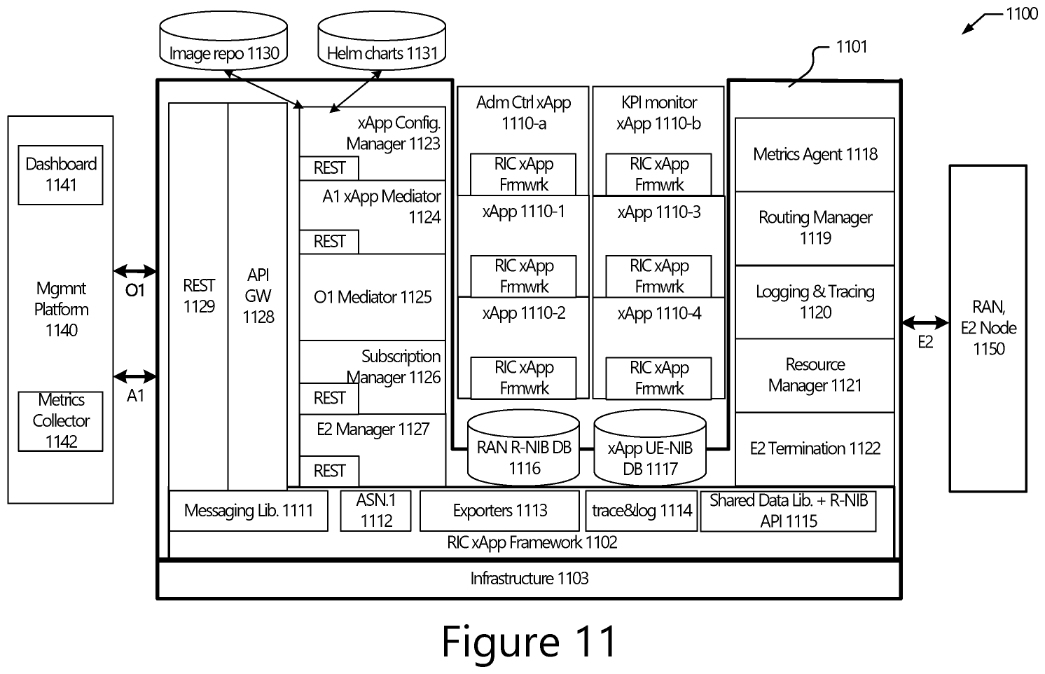

A subset of the xApps 410 includes those that are part of the service slice functions 420 (also referred to as “xApps 420”). The service slice functions 420 utilize real-time (or near real-time) information collected over the use E2 interface (e.g., E2 measurement data 415 collected from one or more UEs, E2 nodes, and the like) and/or other data (e.g., telemetry and/or profiling information) to provide value added services. In this example, the collection of xApps 420 includes policy xApps 421, self-organizing network (SON) xApps 422, Radio Resource Management (RRM) xApps 423, the xApp manager 425 (which may be the same or similar as the xApp manager 320 and/or 310-a discussed previously), and policy and control function 426. Additionally or alternatively, the set of xApps 420 can include the interference manager 3c21, radio connection manager 3c22, flow manager 3c24, and/or mobility manager 3c25 of FIG. 3c; and/or the administration control xApp 1110-a, KPI monitor xApp 1110-b, and/or other 3^{rd} party xApps 1110 as shown and described by FIG. 11.

The policy xApps 421 provide policy-driven closed-loop control of the RIC and/or the RAN. The policies 441 may be A1 policies, which are declarative policies expressed using formal statements that enable the non-RT RIC 412 in the SMO to guide the near-RT RIC 414, and hence the RAN, towards better fulfilment of RAN intent and/or goals. Additionally or alternatively, the policies 441 (including the A1 policies) can include or specify KPIs, KPMs, SLA requirements, QoS requirements, and/or the like for different network/service slices and/or for services provided by individual xApps 410. The policy and control function 426 may assist or operate in conjunction with the policy xApps 421 to provide the policy-driven closed-loop control. As an example, the policy xApps 421 and/or the policy and control function 426 can provide policy-based traffic steering and/or traffic splitting, which may be periodic or event-based.

The SON xApps 422 include those used for automated and optimized RAN node operation. Example SON xApps 422 include those providing coverage and capacity optimization (CCO), energy-saving management (ESM), load balancing optimization (LBO), handover parameter optimization, RACH optimization, SON coordination, NF and/or RANF self-establishment, self-optimization, self-healing, continuous optimization, automatic neighbor relation management, and/or the like (see e.g., 3GPP TS 32.500 v17.0.0 (2022 Apr. 4) (“[TS32500]”), 3GPP TS 32.522 v11.7.0 (2013 Sep. 20), 3GPP TS 32.541 v17.0.0 (2022 Apr. 5), 3GPP TS 28.627 v17.0.0 (2022 Mar. 31), 3GPP TS 28.313 v17.6.0 (2022 Sep. 23), 3GPP TS 28.628 v17.0.0 (2022 Mar. 31), 3GPP TS 28.629 v17.0.0 (2022 Mar. 31), the contents of each of which are hereby incorporated by reference in their entireties). The SON xApps 422 can also provide proprietary (e.g., trade secret) SON functions and/or SON functions not defined by relevant standards. The SON functions can be categorized based on their location/deployment, and as such, can be centralized SON functions (e.g., those that execute in a management system such as an SMO/MO layer), distributed SON functions (e.g., those that are located/deployed in one or more NFs), and/or hybrid SON functions (e.g., those that execute in centralized domain layer, cross-domain layer, and/or NFs).

The RRM xApps 423 provide RRM optimizations, which may include optimizations related to, for example, handover decisions, cell selection, mobility management, handover decisions, interference management, traffic steering and/or splitting, and/or other RRM decisions. In some implementations, the RRM xApps 423 are based on AI/ML models/algorithms (e.g., one or more trained AI/ML models 3c24 of FIG. 3c and/or the ML aspects discussed infra w.r.t FIGS. 18-19) that can learn intricate inter-dependencies and complex cross-layer interactions between various parameters from different RAN protocol stack layers, which is in contrast to previous RRM processes that were largely based on heuristics involving signaling, channel characteristics, and load thresholds.

The RRM functional allocation between the near-RT RIC 414 and the E2 node is subject to the capability of the E2 node exposed over the E2 interface by means of the E2 service model (E2SM) in order to support the use cases described in [O-RAN.WG1.Use-Cases]. The E2SM describes functions in an E2 node that may be controlled by the near-RT RIC 414 and related procedures, thus defining a function-specific RRM split between the E2 node and the near-RT RIC 414. For a function exposed in the E2SM (see e.g., [O-RAN.WG3.E2SM]), the near-RT RIC 414 may, for example, monitor, suspend/stop, override or control the behavior of an E2 node according to one or more policies 441. In the event of a near-RT RIC 414 failure, the E2 node will be able to provide services but there may be an outage for certain value-added services that may only be provided using the near-RT RIC 414.

Network slicing is a prominent feature that provides end-to-end (e2e) connectivity and data processing tailored to specific application, service, and/or business requirements. These requirements include customizable network capabilities such as the support for very high data rates, traffic densities, service availability and very low latency. According to 5G standardization efforts, a 5G system should support the needs of the business through the specification of several service KPIs such as data rate, traffic capacity, user density, latency, reliability, and availability. These capabilities are specified based on service level agreements (SLAs) between the mobile operator and their customers/subscribers, which has resulted in increased interest in mechanisms to ensure slice SLAs and prevent its possible violations. O-RAN's open interfaces combined with its AI/ML based architecture can enable such challenging RAN SLA assurance mechanisms.

Based on RAN-specific slice SLA requirements, the non-RT RIC 412 and the near-RT RIC 414 can fine-tune RAN behaviors to assure network slice SLAs dynamically. Utilizing slice specific performance metrics (e.g., based on measurement data 415 received from E2 nodes and/or UEs), the non-RT RIC 412 monitors long-term trends and patterns regarding RAN slice subnets' performance, and trains AI/ML models to be deployed at the near-RT RIC 414 (e.g. trained AI/ML models 3c24 of FIG. 3c). The AI/ML models 3c24 may include heuristics and/or inference/predictive algorithms, which may be based on any of those discussed herein such as those shown by FIGS. 18 and 19. In various implementations, one or more of the trained AI/ML models 3c24 may be part of the xApp manager 425, which uses slice specific performance metrics as well as telemetry data (or profiling information) of the underlying platform to determine resource allocations for individual xApps 410 and/or other elements. The output of the AI/ML models 3c24 can include new/updated resource usage/allocations for individual xApps 420, other xApps 410, rApps 911 implemented by the non-RT RIC 412, and/or xApps 410 or rApps 911 implemented by other RICs. In these ways, slice performance may be enhanced or optimized beyond what is possible when relying on measurement data 415 alone.

The non-RT RIC 412 also guides the near-RT RIC 414 using A1 policies 441 with possible inclusion of scope identifiers (e.g., Single Network Slice Selection Assistance Information (S-NSSAI), QoS Flow IDs, and/or the like) and statements (e.g., KPI targets, SLAs, and/or the like). The near-RT RIC 414 obtains the A1 policies 441 over the A1 interface and stores the A1 policies 441 in the policy store 440. The near-RT RIC 414 enables optimized RAN actions through execution of deployed AI/ML models 3c24, xApps 420, and/or other slice control/slice SLA assurance xApps 410/420 in real-time (or near-real-time) by considering both O1 configuration (e.g., static RRM policies and/or the like, which may be stored in the policy store 440) and the A1 policies 441, as well as received slice specific E2 measurements 415. These optimized RAN actions can be issued as events 416 including suitable instructions, commands, and/or applicable data/information through the policy and control function 426 and E2 mediation function 460. Additionally or alternatively, the optimized RAN actions can be issued as events 416, instructions, commands, and/or applicable data/information through the service bus 435. The O-RAN slicing architecture enables such challenging mechanisms to be implemented, which could help pave the way for operators to realize the opportunities of network slicing in an efficient manner, at least in terms of resource usage, energy consumption, and performance.

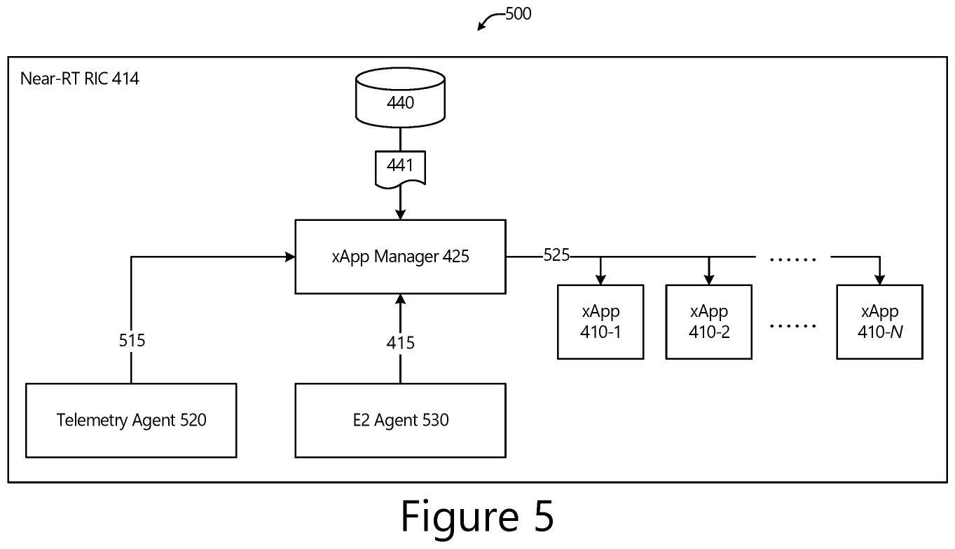

The xApps 420 also includes an xApp manager 425, which is a logical element/entity that leverages observation data, and generates meaningful insights/knowledge using one or more AI/ML models 3c24. The observation data can include measurement data 415 and/or platform telemetry data (or profiling information). For example, the xApp manager 425 collects E2 measurement data 415 via the E2 mediation function 460 and telemetry data via a collection agent (see e.g., FIG. 5), and analyzes the collected E2 measurement data 415 and telemetry data to determine HW, SW, and/or NW resource allocations for individual xApps 410. This may involve, for example, determining to scale up or down HW, SW, and/or NW resources for individual xApps 410, E2 nodes, and/or other elements in the O-RAN framework. The resource allocations can also be included in signaling and/or PDUs/messages that are provided to individual xApps 410 via the service bus 435, and/or in events 416 provided to individual E2 nodes via the E2 mediation function 460 and the E2 interface. In these implementations, the events 416 and/or PDUs/messages can include instructions, commands, and/or relevant information (e.g., scaling factors, configuration data, and/or the like) for re-allocating and/or adjusting HW, SW, and/or NW resources for individual xApps 410 and/or individual RANFs operating on or by one or more E2 nodes. The xApp manager 425 adjusts or otherwise determines HW, SW, and/or NW resource usage/allocations according to service requirements for one or more network slices or service slices. (e.g., as defined by KPIs, KPMs, and/or SLAs). The near-RT RIC's 414 (or the xApp manager's 425) control over xApps 410 and/or E2 nodes is steered or otherwise guided according to one or more policies 441 and/or enrichment information provided by the non-RT RIC 412 over the A1 interface.

The xApp manager 425 provides the ability to customize and correlate HW, SW, and/or NW resources per network slice, per network service, and/or per xApp. The xApp manager 425 provides platform performance improvements and efficiencies, and opportunity for privileged services utilizing platform telemetry. The xApp manager 425 provides the opportunity to unlock data value from the platform through having the xApp manager 425 deployed either in a container 430 with root permissions or as a binary at run time. Here, the xApp manager 425 provides closed control loop functions in real-time (or near real-time) by running/operating AI/ML models 3c24 to identify or determine increases or decreases in KPIs, KPMs, SLA requirements, and/or QoS requirements of individual network/service slices, and dynamically adjust assigned and/or allocated HW, SW, and/or NW resources and/or power levels allocated to individual xApps 410.

For example, the xApp manager 425 can utilize the AI/ML model(s) 3c24 to make various predictions/inferences about future resource requirements for individual xApps 410 through various correlations. A first example correlation can include correlating platform telemetry, app telemetry and traces, and xApp data logs to generate insights. A second example correlation can include correlating E2 measurement data 415 (e.g., the number of UEs, E2 KPMs such as radio resource utilization, measurements obtained per QoS flow, and/or the like) with platform telemetry to add to the aforementioned insights. A third example correlation can include correlating KPIs, KPMs, SLA requirements, and/or QoS requirements related to E2 measurement data 415 (e.g., a number of UE requests, data volume, and/or the like) with the scaling and/or de-scaling of HW, SW, and/or NW resources for xApps 410 to process the relevant inputs. A fourth example correlation can include correlating previous (historical) adjustments of HW, SW, and/or NW resources for individual xApps 410 with platform telemetry and/or E2 measurement data 415 measured or otherwise obtained after the HW, SW, and/or NW resources were adjusted, which could inform the impact of various resource adjustments/alterations so as to inform future predictions/inferences. A fifth example correlation can include correlating a network slice's KPIs, KPMs, SLA requirements, and/or QoS requirements with platform resource requirements for a set of xApps 410 of the corresponding network slice to function with little or no negative performance impact. Additionally or alternatively, the xApp manager 425 functionality includes enriching E2 data (e.g., enrichment information) using the AI/ML model(s) 3c24 from the HW, SW, and/or NW telemetry. For example, NIC congestion level telemetry can infer a number of UEs and/or the like.

Additionally or alternatively, the xApp manager 425 provides closed control loop functions in real time or near real-time by accepting run-time priority levels of each of the xApps 410, 420, and adjusts the HW, SW, and/or NW resources and/or QoS accordingly. In these ways, the xApp manager 425 enables faster reaction times to key platform events, improving resilience, service availability, faster root cause analysis, faster time to repair, and/or faster reallocation of resources based on, for example, current or predicted loads, current or predicted fault conditions, current or predicted resource exhaustion, current or predicted thermal conditions, and/or the like.

In some implementations, messages flow from the xApp manager 425 to the various xApps 410, and/or vice versa, via the service bus 435 and/or network interface(s). The inputs, metrics/measurements, and/or KPM aspects used for calculating and enforcing dynamic xApp resource allocations and/or QoS within the near-RT RIC 414 may be conveyed using such messages or message flows. Additionally, product literature may indicate dynamic xApp resource allocations and/or QoS management based on infrastructure/HW, SW, NW telemetry and/or measurements/metrics, as well as network slice measurements/metrics.

FIG. 5 depicts an example control loop 500. In this example, the xApp manager 425 interacts with telemetry agent 520 and an E2 agent 530, as well as with xApps 410-1 to 410-N (where Nis a number). During operation, the telemetry agent 520 collects, samples, or oversamples various telemetry data 515 in response to detecting one or more events/conditions or on a periodic basis (e.g., according to one or more timescales, and/or during one or more time periods or durations). In some examples, the concept of timescales relates to an absolute value of an amount of data collected during a duration, time segment, or other amount of time. Additionally or alternatively, the concept of timescales can enable the ascertainment of a quantity of data. For example, first metrics/measurements may be collected over a first time duration, second metrics/measurements may be collected over a second time duration, and so forth. The telemetry agent 520 either provides raw telemetry data 515 to the xApp manager 425, or generates profile information that is then provided to the xApp manager 425. Additionally, the E2 agent 530 collects, samples, or oversamples various measurement data 415 in response to detecting one or more events/conditions or on a periodic basis (e.g., according to one or more timescales, and/or during one or more time periods or durations). The E2 agent 530 either provides raw measurement data 415 to the xApp manager 425, or generates analytics based on the measurement data 415, which is then provided to the xApp manager 425. Further, the xApp manager 425 reads or obtains one or more policies 441 from the policy store 440. The telemetry data 515, measurement data 415, and policies 441 can be obtained via the service bus 435, one or more APIs, and/or network interfaces. The xApp manager 425 uses the telemetry data 515 (or profile information 515) and the measurement data 415 (either raw or processed), and generates observability insights 525 using AI/ML mechanisms as discussed previously and in accordance with the one or more policies 441. The observability insights 525 are provided to one or more xApps 410, which use the insights 525 to adjust their performance. The insights 525 are provided to the xApps 410 via the service bus 435, one or more APIs, and/or network interfaces. In some implementations, the insights 525 can be provided to a hardware resource manager (e.g., a Resource Management Daemon (RMD)) as a dynamic policy to re-allocate resources as described in the policy (see e.g., Resource Management Daemon, User Guide, INTEL CORP. (21 Dec. 2019), (“[RMD]”), the contents of which is hereby incorporated by reference in its entirety).

The E2 agent 530 is responsible for collecting various measurement data 415 from various E2 nodes and/or other network elements (e.g., UEs and/or the like). In some examples, the E2 agent 530 is the same or similar as the E2 mediation function 460. The telemetry agent 520 includes one or more telemeters (or collection agents) of a telemetry system (see e.g., such as any of those discussed herein and/or those discussed in U.S. application Ser. No. 17/899,840 filed on Aug. 31, 2022 (“['840]”), the contents of which is hereby incorporated by reference in its entirety), and is responsible for collecting telemetry data 515 from the underlying RIC platform (e.g., the compute node hosting the xApp manager 425), system SW, applications (e.g., individual xApps 410 hosted by the underlying platform), and/or other platforms (e.g., other edge compute nodes, cloud compute nodes, and/or NFs in a core network; E2 nodes; and/or UEs) and/or their system SW and/or applications.

The telemetry data 515 can be conveyed to the telemetry agent 520 using any suitable communication means including wireless data transfer mechanisms (e.g., radio, ultrasonic, infrared, and so forth) and/or wired data transfer mechanisms (e.g., soldered connections and/or copper wires, optical links, power line carriers, telephone lines, computer network cables, and so forth). The telemetry agent 520 may be a physical or virtual device (or set of devices), including event capture means (e.g., sensor circuitry 1772, actuators 1774, input circuitry 1786, output circuitry 1784, processor circuitry 1752, acceleration circuitry 1764, and/or other components of FIG. 17), communication means (e.g., communication circuitry 1766, network interface 1768, external interface 1770, and/or positioning circuitry 1745 of FIG. 17), and/or other components such as output means (e.g., display device, output circuitry 1784 of FIG. 17, and/or the like), recording means (e.g., input circuitry 1786, processor circuitry 1752, memory circuitry 1754, and/or storage circuitry 1758 of FIG. 17), and/or control means (e.g., processor circuitry 1752, acceleration circuitry 1764, memory circuitry 1754 of FIG. 17, and/or the like).

In some implementations, the telemetry agent 520 could also include one or more performance analysis tools (also referred to as “profilers”, “analytics tools”, “performance counters”, “performance analyzers”, “analytics functions”, and/or the like), which analyze collected telemetry data 515 and provide a statistical summary or other analysis of observed events (referred to as a “profile” or the like) and/or a stream of recorded events (sometimes referred to as a “trace” or the like) to the xApp manager 425. These profilers may use any number of different analysis techniques to generate profiling information or analytics data such as, for example, event-based, statistical, instrumented, and/or simulation methods. The profiling information (e.g., profile and/or traces) can be used for performance prediction, performance tuning, performance optimization, power savings (e.g., optimizing performance while avoiding power throttling and/or thermal-related throttling), and/or for other purposes. The telemeters and/or profilers can use a wide variety of techniques to collect telemetry data 515 including, for example, hardware interrupts, code instrumentation, instruction set simulation, hooks, performance counters, timer injections, telemetry mechanisms, among many others.

As examples, the telemetry data (or profiling information), can include, for example, HW, SW, and/or NW measurements or metrics. Examples of the HW measurements/metrics can include system-based metrics such as for example, assists (e.g., FP assists, MS assists, and the like), available core time, average core BW, core frequency, core usage, frame time, latency, logical core utilization, physical core utilization, effective processor utilization, effective physical core utilization, effective time, elapsed time, execution stalls, task time, back-end bound, memory BW, contested accesses (e.g., intra-compute tile, intra-core, and/or the like), cache metrics/measurements for individual cache devices/elements (e.g., cache hits, cache misses, cache hit rate, cache bound, stall cycles, cache pressure, and the like), pressure metrics (e.g., memory pressure, cache pressure, register pressure, and the like), translation lookaside buffer (TLB) overhead (e.g., average miss penalty, memory accesses per miss, and so forth), input/output TLB (IOTLB) overhead, first-level TLB (UTLB) overhead, port utilization for individual ports, BACLEARS (e.g., fraction of cycles lost due to the Branch Target Buffer (BTB) prediction corrected by a later branch predictor), bad speculation (e.g., cancelled pipeline slots, back-end bound pipeline slots), FP metrics (e.g., FP arithmetic, FP assists, FP scalars, FP vector, FP x87, and the like), microarchitecture usage, microcode sequencer (MS) metrics, GPU and/or xPU metrics, OpenCL™ kernel analysis metrics, energy analysis metrics, user interface metrics, and/or any other metrics such as those discussed herein and/or those discussed in Intel® VTune™ Profiler User Guide, INTEL CORP., version 2022 (2 Jun. 2022) (“[VTune]”), the contents of which are hereby incorporated by reference in its entirety. Additionally or alternatively, the HW measurements/metrics can include security and/or resiliency related events such as, for example, voltage drops, a memory error correction rate being above a threshold, thermal events (e.g., temperature of a device or component exceeding a threshold), detection of physical SoC intrusion (e.g., at individual sensors and/or other components), vibration levels exceeding a threshold, and/or the like. Additionally or alternatively, the HW measurements/metrics can include performance extrema events such as, for example, loss of heartbeat signals for a period of time, timeouts reported from HW elements (e.g., due to congestion or loss of a wakeup event following a blocking I/O operation), and/or the like.

Examples of the SW measurements/metrics can include formal code metrics (e.g., application size, application complexity, instruction path length, and the like), application crash rate, exception rate, fault rate, error rate, time between failures, time to recover, time to repair, endpoint incidents, throughput, system response time, request rate, user transactions, wait time or latency, load time, concurrent users, processor utilization/usage, memory utilization/usage, memory accesses/transactions, input/output accesses/transactions, passed/failed transactions, queue-related metrics/measurements, number of user sessions, and/or the like. Additionally or alternatively, the SW measurements/metrics can be based on run-time metrics/measurements, trace metrics/measurements, application events, logs and traces, and/or the like.

Examples of the NW measurements/metrics can include signal and/or channel measurements (see e.g., [TS36214], [TS38215], [TS38314], [IEEE80211]), various RAN node and/or NF performance measurements (see e.g., [TS28552]), management service events (see e.g., [TS28532]), fault supervision events (see e.g., [TS28532]), ETSI NFV testing metrics/measurements (see e.g., ETSI GR NFV-TST 006 V1.1.1 (2020 January), ETSI GS NFV-TST 008 V3.5.1 (2021 December), ETSI GS NFV-TST 009 V3.4.1 (2020 December), and ETSI GS NFV-IFA 027 V4.3.1 (2022 June) (collectively referred to as “[NFVTST]”), the contents of each of which are hereby incorporated by reference in their entireties), and/or the like. The aforementioned HW, SW, and/or NW measurements/metrics may be measured, calculated, or otherwise obtained in the form of raw values, means, averages, peaks, maximums, minimums, and/or processed using any suitable scientific formula or other data manipulation techniques.

The observation data 515, 415 is/are fed into the xApp manager 425 along with KPIs, KPMs, SLAs, and/or the like (e.g. indicated by policies 441). The xApp manager 425 combines the observation data 515, 415 with the KPIs, KPMs, SLA requirements, and the like to determine appropriate HW, SW, and/or NW resource allocations 525 for individual xApps 410 on a real-time or near real-time basis. The generated resource allocations 525 can provide optimized performance in terms of e2e QoS or quality of experience (QE) or otherwise adhere to the KPIs KPMs, and SLA requirements. Examples of the KPIs, KPMs, and/or SLA requirements can include desired metrics/measurements related to accessibility, availability, latency, reliability, user experienced data rates, area traffic capacity, integrity, utilization, retainability, mobility, energy efficiency, QoS, QoE, any of the metrics/measurements discussed in [TS22261] and/or [TS28554], and/or any of the metrics/measurements discussed herein.

The resource allocations 525 for individual xApps 410 can include instructions, commands, scaling factors, and/or other data related to one or more of dedicating more or less HW resources to individual xApps 410 (e.g., in terms of processor time, number of processor cores, memory allocation, and/or the like), increasing or decreasing NW/radio resources (e.g., in terms of BW, frequency, and/or time) for individual xApps 410, increasing or decreasing power levels for individual xApps 410, changing cell management aspects, and/or the like. Additionally or alternatively, the resource allocations 525 can be in the form of suggestions, policies, or guidance based on any type of inference to impact operational parameters of individual xApps 410. Additionally or alternatively, the resource allocations 525 can be in the form of updated KPMs and/or KPIs based on previous (historical) trends and/or the like. Additionally or alternatively, the xApp manager 425 can manage resource allocations for multiple RAN nodes and/or cells, and the resource allocations could be segmented per-cell or per-RAN node, or could be aggregated based on a number of cells. Additionally or alternatively, the insights 525 generated/determined by the xApp manager 425 can take into consideration the number of cells and/or RAN nodes that individual xApps 410, 420 may affect or influence.

In a first example, the RRM xApp 423 may be used to manage cell load of a group of cells provided by a set of RAN nodes. In this example, the xApp manager 425 may be trained to detect, based on a set of measurement data 415, that a first RAN node in the set of RAN nodes is experiencing congestion or high user loads and a second RAN node in the set of RAN nodes is experiencing relatively low user/data volumes. Here, the xApp manager 425 may instruct or indicate, to the RRM xApp 423, to scale-up HW, SW, and/or NW resources for the first RAN node and scale-down the HW, SW, and/or NW resources of the second RAN node. Additionally or alternatively, the xApp manager 425 may be trained to scale-up different HW, SW, and/or NW resources allocated to the RRM xApp 423 itself so it can better manage the radio resources for the set of RAN nodes under its control.

In a second example, the xApp manager 425 may be trained to trigger the SON xApp 422 to rearrange the antenna orientations/angles of different RAN nodes and/or place some RAN nodes in an energy saving state based on certain measurement data 415 and/or channel conditions. Additionally or alternatively, the xApp manager 425 may be trained to scale-up or down different HW, SW, and/or NW resources allocated to the SON xApp 422 so it can better handle SON functions and SON coordination among the set of RAN nodes under its control.

In a third example, the xApp manager 425 may be trained to predict HW and/or SW reliability issues with individual platform components/devices and/or field replaceable units (FRUs), and the resources allocations can instruct or indicate to move one or more xApps 410 from one or more processing elements and/or FRUs to another (safer) set of processing elements and/or FRUs. In this example, the reliability predictions can be based on RAS/RAM data and/or any other type (or combination) of telemetry data such as any of those discussed herein.

In either of the aforementioned examples, the HW/SW resources could include a pool of accelerators that are designated to operate as virtual RAM for the xApps 410 and/or the near-RT RIC 414, and the HW/SW resources to be scaled-up could include allocating additional HW accelerator resources or virtual memory resources to the desired RAN node(s), desired xApp(s) 410, and/or the near-RT RIC 414 itself. Additionally or alternatively, the NW resources could include access to one or more physical network interfaces, and the NW resources to be scaled-up could include granting more or less access to the one or more of the physical network interfaces to different xApps 410. Additionally or alternatively, the NW resources could include radio resources (or virtual radio resources) that the xApp manager 425 grants to different xApps 410 when communicating the external compute nodes. In these examples, scaling and descaling of HW, SW, and/or NW resources could be attributable to relieving network congestion, energy consumption, and the like.

Additionally or alternatively, the determined resource allocations 525 for individual xApps 410 can be fed back into a container controller/orchestrator, cluster controller, management functions (e.g., mgmt function 1233 of FIG. 12, local HW/system resource managers, and/or the like), and/or the orchestration layer (e.g., SMO/MO 102, 301, 3c02, 802, 902, 1002, 1202 and/or the like) to manage the resource allocations at various levels (e.g., local levels and/or global levels). This feedback may be applied at various levels/layers based on desired impacts or effects of applying different policies 441. Here, the policy store 440 and the policy related information 441 stored therein could be used to control HW, SW, and/or NW resources for individual xApps 410 at multiple orchestration layers at various layers local to the near-RT RIC 414 itself. The manner in which resources are adjust or re-allocated, and the particular entities/elements to which the resource allocations/feedback are sent, may be based on the policies 441 that are provided via the A1 interface. Moreover, these policies 441 can be update or changed at runtime. In these ways, the xApp manager 425 can apply different resource allocations and/or policies 441 to different xApps 410 of the near-RT RIC 414 and/or other RICs while simultaneously determining future resource allocations for future HW, SW, and/or NW states or conditions. This may be especially useful for xApps 410 that operate in real-time or near real-time control loops.

The example control loop control 500 can be used to control various O-RAN control loops such as, for example, non-RT control loops 932, near-RT control loops 934, and RT control loops 935 which is closer to the FH interface than the non-RT control loops 932 and near RT control loops 934 (see e.g., FIG. 9 discussed infra). Example use cases for non-RT control loops (e.g., RT control loops 932) can include capacity planning, peering planning, cache placement, SON functionality, and/or the like. Example use cases for near-RT control loops (e.g., RT control loops 934) can include traffic engineering, network optimization, demand deployment and/or placement, workload deployment and/or placement, SON functionality, and/or the like. Example use cases for RT control loops (e.g., RT control loops 935) can include service assurance, security operations, radio resource management, and/or the like. The control loops 932, 934, 935 may be defined based on the controlling entity (e.g., the xApp manager 425 and/or the like) and different configured or predefined policies 441. In one example, one or more control loops can be defined to adjust or alter the HW and/or SW resources of the platform that hosts the near-RT RIC 414 and/or the xApp manager 425. In another example, one or more control loops can be defined to influence the resource allocations within a compute node hosting one or more xApps 410 or within a cluster of compute nodes across which one or more xApps 410 are distributed. In these ways, the xApp manager 425 can impact policies 441 across individual compute nodes or across multiple compute clusters.

As alluded to previously, measurement data and/or telemetry data can be arranged or categorized into multiple tiers or levels. Here, different measurement data 415 and/or telemetry data can be grouped or classified in different ways to support the different control loops 932, 934, 935, for example, according to their respective timing requirements. In some implementations, different levels of policies 441 can be created to impact different nodes or clusters based on the different levels of data that is consumed.

In some examples, a first data tier (tier 1) involves data/KPIs that require real-time calculation and/or processing such as, for example, pre-processing with the xApp manager measurement engine 320 that forwards measurement data 315, 415 via the E2 interface to the xApp manager analytics engine 310. Examples of tier 1 data/KPIs includes user statistics (stats) with UL and/or DL scheduling information including modulation and coding schemes (MCS), new radio (NR) resource blocks, number of OFDM symbols per slot, slots per frame, slots per subframe, channel quality indicators (QCI); rank indicators (RI) for antenna quality and the like, SNRs and/or other noise-related measurements, timing advance (TA) data, and/or the like. Additionally or alternatively, another tier (e.g., tier 0) data/KPIs can include real-time reference and response signaling/data such as, for example, IQ samples including UL IQ data and the like.

In some examples, a second data tier (tier 2) involves data/KPIs that require near-real-time calculation and/or processing. Examples of tier 2 data/KPIs includes radio layer (L1) stats including how long did the application take to process uplink and downlink pipelines on the vRAN distributed unit (DU). Additionally or alternatively, tier 2 type data/KPIs (e.g., those that get processed later and not in real-time) may include random access channel (RACH) metrics (e.g., TA, power, access delay, success, and the like), beam and/or bandwidth part (BWP) stats, LTE vs 5G utilization, night vs day loads, and/or the like.

In some examples, a third tier (tier 3) involves data/KPIs that is/are used for non-real-time calculation/processing. Examples of tier 3 data/KPIs includes vRAN DU (e.g., O-DU 915) stats, and O-RAN stats, and platform stats. Examples of the vRAN DU stats include the number of processor cores that are allocated to individual processes or apps, the processor utilization per core, DU memory utilization, and/or the like including [VTune] stats of individual DUs. Examples of the O-RAN stats include packet throughputs and latencies between an RU (e.g., O-RU 916) and DU (e.g., O-DU 915). Examples of the platform stats include power consumption stats that are exposed from the physical L1 radio layer and/or the like.

Additional or alternative examples of the telemetry data, profiling information, and/or observation stats (e.g., telemetry data 515) under consideration include one or more of single root I/O virtualization (SR-IOV) metrics (e.g., virtual function (VF) stats); network interface controller (NIC) metrics (e.g., packets/second, errors/second, Tx/Rx queue metrics, and/or the like); last level cache (LLC) and/or memory device metrics/data (e.g., BW, utilization, and/or other like data/metrics); reliability, availability, and serviceability (RAS) and/or reliability, availability, and maintainability (RAM) telemetry data (e.g., corrected errors, memory errors, and/or the like); interconnect (e.g., PCI, CXL, and the like) telemetry data (e.g., errors, link/lane BW, and/or the like); power utilization stats (e.g., power consumption over time, per thread, and/or the like); core and uncore frequency data/metrics; non-uniform memory access (NUMA) awareness information (e.g., processor, SR-IOV virtual functions (VFs), and/or other device resources for one or more quality of service (QoS) classes and/or NUMA nodes); performance monitoring unit (PMU) data/metrics; application metrics, logging, traces, and/or alarm data/metrics; Data Plane Development Kit (DPDK) interface metrics/data (e.g., packet rates, packet drops, and/or the like); dynamic load balancing (DLB) metrics/data; memory utilization; thermal and/or cooling sensor information; node lifecycle management data/metrics; latency stats (e.g., L1 DL/UL link latency, and the like); cell stats (e.g., L1 cell stats such as cell throughput, MAC-to-PHY, PHY-to-MAC, and the like); BBU stats (e.g., L1 BBU core usage stats such as processor core utilization percentages, and/or the like); vRAN stats (e.g., L1 vRAN RU number of packets, Rx packets per second (PPS)/TPT, Tx PPS/TPT, L1 vRAN antenna port physical channel and/or physical signal (e.g., reference signals, synchronization signals, and/or the like) measurements, and/or the like); UE data (e.g., UE ID, UE RNTI, UE Index, UE Doppler shifts, UE carrier frequency offsets, UE PUCCH and PUCCH timing advance measurements, mobile country and network code, PHY cell ID, subcarrier spacing, number of allocated resource blocks, UL/DL/SL frequencies and FFT sizes, timing intervals, number of physical channel and/or physical signal symbols, number of physical channel and/or physical signal Tx/Rx antennas and/or antenna ports, number of physical channel and/or physical signal Rx/Tx ports, physical channel and/or physical signal slot and frame numbers, physical channel and/or physical signal hopping information, physical channel and/or physical signal TC, physical channel and/or physical signal BW indexes, physical channel and/or physical signal hopping type, physical channel and/or physical signal periodicity, physical channel and/or physical signal power, number of RUs and/or DUs captured, and/or the like); and/or other metrics such as those discussed herein. For any of the aforementioned examples and any other example discussed herein, the physical channels and/or physical signals can include any of the physical channels (e.g., UL, DL, and/or SL channels) and/or physical signals (e.g., reference signals, synchronization signals, discovery signals, and/or the like) discussed herein. Any of the telemetry data, observation stats, and/or measurements/metrics discussed herein may be measured, calculated, or otherwise obtained in the form of raw values, means, averages, peaks, maximums, minimums, and/or processed using any suitable scientific formula or other data manipulation techniques, and/or measured using any suitable standard unit. Any of the aforementioned telemetry data 515, profiling information, and/or observation stats may be reported to, and/or collected by, HW and/or SW telemetry collectors such as those in OpenTelemetry™, OpenStack®, collectd, and/or other like collectors such as those discussed in ['840] and/or [NFVTST].

In some examples, the measurement data 415 is ephemeral within a near-RT control loop (e.g., control loop 934 and/or control loop 500) as it is used to direct xApp 410 resources (e.g., using resource allocations 525) before that measurement data 415 expires or is otherwise considered to be less useful. This can be critical for UL and DL traffic in cellular networks (e.g., 3GPP 4G/LTE and/or 5G). Without real-time or near-RT action on the xApp resource allocations 525, some or all of the measurement data 415 may expire or become stale. As alluded to previously, examples of such ephemeral measurement data can include any of the signal power, signal quality, and/or signal noise measurements of the various RSs and/or PCHs such as any of those discussed herein, and/or can involve sounding out the BW of one or more UEs that is not currently in use for better xAPP resource allocation such as is the case with the uplink SRS.

Example use cases may include deterministic performance on individual nodes (e.g., RUs, DUs, CUs, and/or the like); dynamic platform QoS adjustment based on E2 data; platform slicing of HW resources for xApps 410 to correlate with network/service slices; dynamic based NIC bandwidth assignment (e.g., SR-IOV VFs, Tx/Rx queues, and/or the like) using xApp manager's 425 feedback for each of the xApps 410; predictive detection of HW reliability issues (e.g., using RAS metrics) with memory or PCIe cards or other field replaceable units (FRUs), in order to move xApps 410 to appropriate nodes or move to a safer set of FRUs; dynamically increasing or decreasing power and/or frequency levels for xApps 410 that require higher or lower compute capabilities based on E2 data and vice versa, using frequency scaling; and/or dynamic adjustment of LLC, memory bandwidth, PCIe bandwidth, for each of the xApps 410 at run time based on E2 KPMs/KPIs using, for example, [RMD], Intel® Resource Director Technology (RDT) (see e.g., Are Noisy Neighbors in Your Data Center Keeping You Up at Night? Control virtual-machine resources with Intel® Resource Director Technology, INTEL CORP., White Paper (9 May 2017), Gasparakis et al., Deterministic Network Functions Virtualization with Intel® Resource Director Technology, INTEL CORP. White Paper 335187-003US (12 May 2017), and Intel® Resource Director Technology (Intel® RDT) on 2nd Generation Intel® Xeon® Scalable Processors Reference Manual, INTEL CORP., Reference Manual, Revision 1.0 (April 2019), the contents of each of which are hereby incorporated by reference in their entireties), and/or Intel® Infrastructure Management Technologies® (e.g., Intel® Node Manager, Intel® Management Engine, Intel® Rapid Storage Technology, Intel® Run Sure Technology, and/or the like).

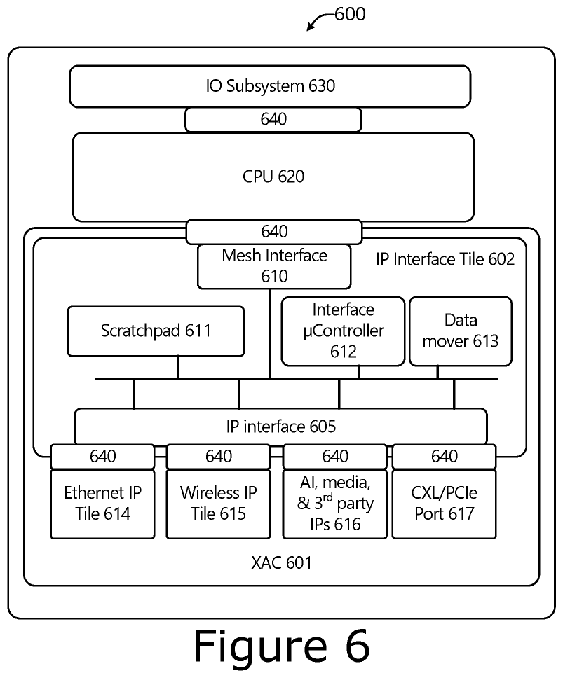

In some examples, an HW based dynamic resource control subsystem can be fed with any combination of these metrics and/or any other measurements/metrics discussed herein to make appropriate adjustments in HW, SW, and/or NW resources. The example implementations herein are also applicable to future platforms such as those shown by FIG. 6.

FIG. 6 shows an example Intel® Xeon® Acceleration Complex (XAC) architecture 600. The XAC architecture 600 includes an input/output (IO) subsystem 630 (e.g., standard Xeon® IO subsystem), a CPU 620 (e.g., Xeon® CPU), and XAC circuitry 601 (referred to herein as “XAC 601”). The CPU 620 is connected to the XAC 601 and the IO subsystem 630 via respective on-package die-die interfaces 640. In particular, an on-package die-die interface 640 connects the CPU 620 to a mesh interface 610 (e.g., Xeon® mesh interface (I/f)) of an IP interface tile 602 of the XAC 601. The IP interface tile 602 also includes a scratchpad memory 611, interface microcontroller (μController) 612, data mover 613, and an IP interface subsystem 605. The IP interface subsystem 605 may implement a suitable IX technology such as CXL, AXI, and/or some other suitable IX technology such as any of those discussed herein (see e.g., IX 1756 of FIG. 17). The IP interface subsystem 605 also connects the IP interface tile 602 with an Ethernet IP tile 614, a wireless IPs tile 615, an ML/AI, media, & 3rd party IPs 616, and a CXL/PCIe port 617 via respective on-package die-die interfaces 640.

The XAC 600 incorporates multiple hardware sub-components customized for wireless IPs 615. The XAC 600 may perform various relatively complex control functions and workload. In some implementations, the XAC 600 may include Intel® Deep Learning Boost (Intel DL Boost) acceleration built-in specifically for the flexibility to run complex AI/ML workloads on the same hardware as existing workloads. In various example implementations, metrics and telemetry from these hardware sub-components from the XAC 600 can be fed into the xApp manager 425 to help customize run time execution, assigned resources and environment to rest of the xApps.

Although the example implementations of the xApp manager discussed previously are described in terms of the O-RAN framework, and in particular, as being implemented as an xApp operated by a Near-RT RIC. However, the embodiments herein can be straightforwardly applied to other ECTs/frameworks. For example, some or all of the functionalities of the xApp manager can be implemented as one or multiple rApps 911 at a non-RT RIC in the O-RAN framework (see e.g., [O-RAN]). Additionally or alternatively, the xApp manager can be implement as an edge application (app) such as a MEC app operating in a MEC host (see e.g., [MEC]), an Edge Application Server (EAS) and/or Edge Configuration Server (ECS) in a 3GPP edge computing framework (see e.g., [SA6Edge]), or as a management function based on Zero-touch System Management (ZSM) architecture (see e.g., [ZSM]). Additionally or alternatively, the xApp manager can be implement as an ONAP module in the Linux Foundation® Open Network Automation Platform (ONAP) (see e.g., ONAP Architecture, Rev. 9e77fad2 (updated 7 Jun. 2022, the contents of which are hereby incorporated by reference in its entirety). The xApp manager concepts described in this disclosure can be applied to any or all of the aforementioned frameworks and/or other suitable edge computing frameworks and/or cloud computing frameworks.

### 2. Edge Computing System Configurations and Arrangements

Edge computing refers to the implementation, coordination, and use of computing and resources at locations closer to the “edge” or collection of “edges” of a network. Deploying computing resources at the network's edge may reduce application and network latency, reduce network backhaul traffic and associated energy consumption, improve service capabilities, improve compliance with security or data privacy requirements (especially as compared to conventional cloud computing), and improve total cost of ownership.

Individual compute platforms or other components that can perform edge computing operations (referred to as “edge compute nodes,” “edge nodes,” or the like) can reside in whatever location needed by the system architecture or ad hoc service. In many edge computing architectures, edge nodes are deployed at NANs, gateways, network routers, and/or other devices that are closer to endpoint devices (e.g., UEs, IoT devices, and/or the like) producing and consuming data. As examples, edge nodes may be implemented in a high performance compute data center or cloud installation; a designated edge node server, an enterprise server, a roadside server, a telecom central office; or a local or peer at-the-edge device being served consuming edge services.

Edge compute nodes may partition resources (e.g., memory, CPU, GPU, interrupt controller, I/O controller, memory controller, bus controller, network connections or sessions, and/or the like) where respective partitionings may contain security and/or integrity protection capabilities. Edge nodes may also provide orchestration of multiple applications through isolated user-space instances such as containers, partitions, virtual environments (VEs), virtual machines (VMs), Function-as-a-Service (FaaS) engines, Servlets, servers, and/or other like computation abstractions. Containers are contained, deployable units of software that provide code and needed dependencies. Various edge system arrangements/architecture treats VMs, containers, and functions equally in terms of application composition. The edge nodes are coordinated based on edge provisioning functions, while the operation of the various applications are coordinated with orchestration functions (e.g., VM or container engine, and/or the like). The orchestration functions may be used to deploy the isolated user-space instances, identifying and scheduling use of specific hardware, security related functions (e.g., key management, trust anchor management, and/or the like), and other tasks related to the provisioning and lifecycle of isolated user spaces.

Applications that have been adapted for edge computing include but are not limited to virtualization of traditional network functions including include, for example, Software Defined Networking (SDN), Network Function Virtualization (NFV), distributed RAN units and/or RAN clouds, and the like. Additional example use cases for edge computing include computational offloading, Content Data Network (CDN) services (e.g., video on demand, content streaming, security surveillance, alarm system monitoring, building access, data/content caching, and/or the like), gaming services (e.g., AR/VR, and/or the like), accelerated browsing, IoT and industry applications (e.g., factory automation), media analytics, live streaming/transcoding, and V2X applications (e.g., driving assistance and/or autonomous driving applications).

The present disclosure provides specific examples relevant to various edge computing configurations provided within and various access/network implementations. Any suitable standards and network implementations are applicable to the edge computing concepts discussed herein. For example, many edge computing/networking technologies may be applicable to the present disclosure in various combinations and layouts of devices located at the edge of a network. Examples of such edge computing/networking technologies include Multi-access Edge Computing (MEC); Content Delivery Networks (CDNs) (also referred to as “Content Distribution Networks” or the like); Mobility Service Provider (MSP) edge computing and/or Mobility as a Service (MaaS) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be used for purposes of the present disclosure.

FIG. 7 illustrates an example edge computing environment 700 including different layers of communication, starting from an endpoint layer 710a (also referred to as “sensor layer 710a”, “things layer 710a”, or the like) including one or more IoT devices 711 (also referred to as “endpoints 710a” or the like)(e.g., in an Internet of Things (IoT) network, wireless sensor network (WSN), fog, and/or mesh network topology); increasing in sophistication to intermediate layer 710b (also referred to as “client layer 710b”, “gateway layer 710b”, or the like) including various user equipment (UEs) 712a, 712b, and 712c (also referred to as “intermediate nodes 710b” or the like), which may facilitate the collection and processing of data from endpoints 710a; increasing in processing and connectivity sophistication to access layer 730 including a set of network access nodes (NANs) 731, 732, and 733 (collectively referred to as “NANs 730” or the like); increasing in processing and connectivity sophistication to edge layer 737 including a set of edge compute nodes 736a-c (collectively referred to as “edge compute nodes 736” or the like) within an edge computing framework 735 (also referred to as “edge computing technology 735”, “ECT 735”, and/or the like); and increasing in connectivity and processing sophistication to a backend layer 740 including core network (CN) 742, cloud 744, and server(s) 750. The processing at the backend layer 740 may be enhanced by network services as performed by one or more remote servers 750, which may be, or include, one or more CN network functions (NFs), cloud compute nodes or clusters, application (app) servers, and/or other like systems and/or devices. Some or all of these elements may be equipped with or otherwise implement some or all features and/or functionality discussed herein.

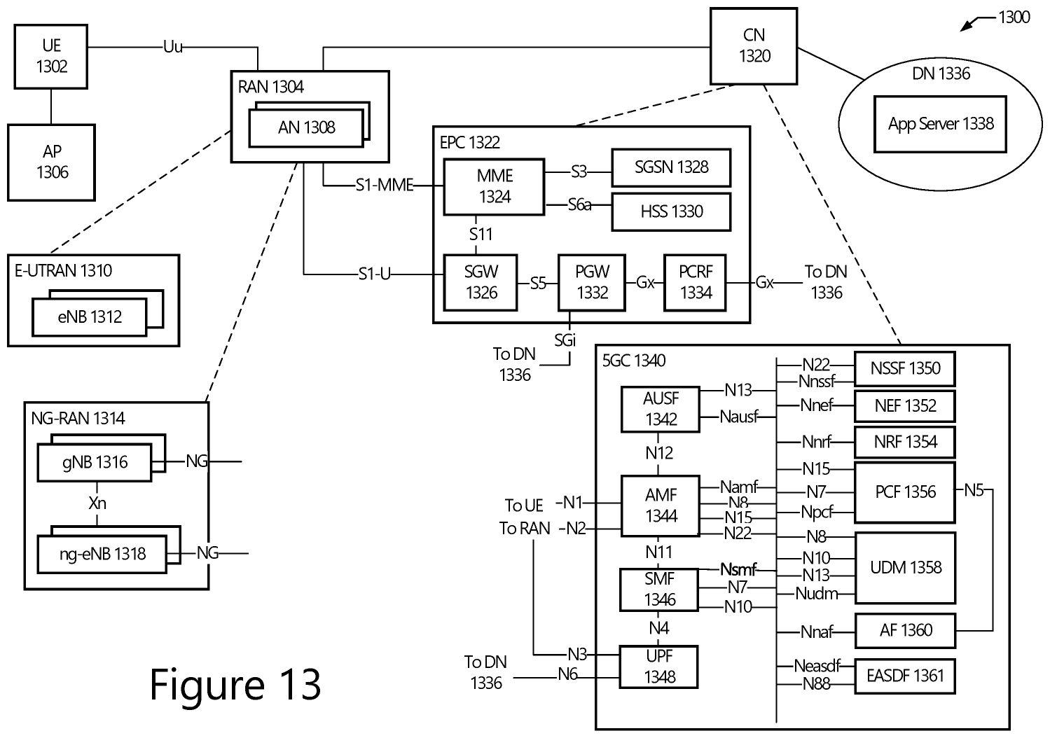

The environment 700 is shown to include end-user devices such as intermediate nodes 710b and endpoint nodes 710a (collectively referred to as “nodes 710”, “UEs 710”, or the like), which are configured to connect to (or communicatively couple with) one or more communication networks (also referred to as “access networks,” “radio access networks,” or the like) based on different access technologies (or “radio access technologies”) for accessing application, edge, and/or cloud services. The UEs 710 may be the same or similar as the UE(s) 901 of FIG. 9, UE 1302 of FIG. 13, and/or UE 1402 of FIG. 14, and/or some other compute node(s) or elements/entities discussed herein. These access networks may include one or more NANs 730, which are arranged to provide network connectivity to the UEs 710 via respective links 703a and/or 703b (collectively referred to as “channels 703”, “links 703”, “connections 703”, and/or the like) between individual NANs 730 and respective UEs 710.

As examples, the communication networks and/or access technologies may include cellular technology such as LTE, MuLTEfire, and/or NR/5G (e.g., as provided by Radio Access Network (RAN) node 731 and/or RAN nodes 732), WiFi or wireless local area network (WLAN) technologies (e.g., as provided by access point (AP) 733 and/or RAN nodes 732), and/or the like. Different technologies exhibit benefits and limitations in different scenarios, and application performance in different scenarios becomes dependent on the choice of the access networks (e.g., WiFi, LTE, and the like) and the used network and transport protocols (e.g., Transfer Control Protocol (TCP), Virtual Private Network (VPN), Multi-Path TCP (MPTCP), Generic Routing Encapsulation (GRE), and the like).

The intermediate nodes 710b include UE 712a, UE 712b, and UE 712c (collectively referred to as “UE 712” or “UEs 712”). In this example, the UE 712a is illustrated as a vehicle system (also referred to as a vehicle UE or vehicle station), UE 712b is illustrated as a smartphone (e.g., handheld touchscreen mobile computing device connectable to one or more cellular networks), and UE 712c is illustrated as a flying drone or unmanned aerial vehicle (UAV). However, the UEs 712 may be any mobile or non-mobile computing device, such as desktop computers, workstations, laptop computers, tablets, wearable devices, PDAs, pagers, wireless handsets smart appliances, single-board computers (SBCs) (e.g., Raspberry Pi, Arduino, Intel Edison, and the like), plug computers, and/or any type of computing device such as any of those discussed herein.

The endpoints 710 include UEs 711, which may be IoT devices (also referred to as “IoT devices 711”), which are uniquely identifiable embedded computing devices (e.g., within the Internet infrastructure) that comprise a network access layer designed for low-power IoT applications utilizing short-lived UE connections. The IoT devices 711 are any physical or virtualized, devices, sensors, or “things” that are embedded with HW and/or SW components that enable the objects, devices, sensors, or “things” capable of capturing and/or recording data associated with an event, and capable of communicating such data with one or more other devices over a network with little or no user intervention. As examples, IoT devices 711 may be abiotic devices such as autonomous sensors, gauges, meters, image capture devices, microphones, light emitting devices, audio emitting devices, audio and/or video playback devices, electro-mechanical devices (e.g., switch, actuator, and the like), EEMS, ECUs, ECMs, embedded systems, microcontrollers, control modules, networked or “smart” appliances, MTC devices, M2M devices, and/or the like. The IoT devices 711 can utilize technologies such as M2M or MTC for exchanging data with an MTC server (e.g., a server 750), an edge server 736 and/or ECT 735, or device via a public land mobile network (PLMN), ProSe or D2D communication, sensor networks, or IoT networks. The M2M or MTC exchange of data may be a machine-initiated exchange of data.

The IoT devices 711 may execute background applications (e.g., keep-alive messages, status updates, and the like) to facilitate the connections of the IoT network. Where the IoT devices 711 are, or are embedded in, sensor devices, the IoT network may be a WSN. An IoT network describes an interconnecting IoT UEs, such as the IoT devices 711 being connected to one another over respective direct links 705. The IoT devices may include any number of different types of devices, grouped in various combinations (referred to as an “IoT group”) that may include IoT devices that provide one or more services for a particular user, customer, organizations, and the like. A service provider (e.g., an owner/operator of server(s) 750, CN 742, and/or cloud 744) may deploy the IoT devices in the IoT group to a particular area (e.g., a geolocation, building, and the like) in order to provide the one or more services. In some implementations, the IoT network may be a mesh network of IoT devices 711, which may be termed a fog device, fog system, or fog, operating at the edge of the cloud 744. The fog involves mechanisms for bringing cloud computing functionality closer to data generators and consumers wherein various network devices run cloud application logic on their native architecture. Fog computing is a system-level horizontal architecture that distributes resources and services of computing, storage, control, and networking anywhere along the continuum from cloud 744 to Things (e.g., IoT devices 711). The fog may be established in accordance with specifications released by the OFC, the OCF, among others. Additionally or alternatively, the fog may be a tangle as defined by the IOTA foundation.

The fog may be used to perform low-latency computation/aggregation on the data while routing it to an edge cloud computing service (e.g., edge nodes 730 and/or edge cloud 1763 of FIG. 17) and/or a central cloud computing service (e.g., cloud 744) for performing heavy computations or computationally burdensome tasks. On the other hand, edge cloud computing consolidates human-operated, voluntary resources, as a cloud. These voluntary resource may include, inter-alia, intermediate nodes 720 and/or endpoints 710, desktop PCs, tablets, smartphones, nano data centers, and the like. In various implementations, resources in the edge cloud may be in one to two-hop proximity to the IoT devices 711, which may result in reducing overhead related to processing data and may reduce network delay.

Additionally or alternatively, the fog may be a consolidation of IoT devices 711 and/or networking devices, such as routers and switches, with high computing capabilities and the ability to run cloud application logic on their native architecture. Fog resources may be manufactured, managed, and deployed by cloud vendors, and may be interconnected with high speed, reliable links. Moreover, fog resources reside farther from the edge of the network when compared to edge systems but closer than a central cloud infrastructure. Fog devices are used to effectively handle computationally intensive tasks or workloads offloaded by edge resources. Additionally or alternatively, the fog may operate at the edge of the cloud 744. The fog operating at the edge of the cloud 744 may overlap or be subsumed into an edge network 730 of the cloud 744. The edge network of the cloud 744 may overlap with the fog, or become a part of the fog. Furthermore, the fog may be an edge-fog network that includes an edge layer and a fog layer. The edge layer of the edge-fog network includes a collection of loosely coupled, voluntary and human-operated resources (e.g., the aforementioned edge compute nodes 736 or edge devices). The Fog layer resides on top of the edge layer and is a consolidation of networking devices such as the intermediate nodes 720 and/or endpoints 710 of FIG. 7.

Data may be captured, stored/recorded, and communicated among the IoT devices 711 or, for example, among the intermediate nodes 720 and/or endpoints 710 that have direct links 705 with one another as shown by FIG. 7. Analysis of the traffic flow and control schemes may be implemented by aggregators that are in communication with the IoT devices 711 and each other through a mesh network. The aggregators may be a type of IoT device 711 and/or network appliance. In the example of FIG. 7, the aggregators may be edge nodes 730, or one or more designated intermediate nodes 720 and/or endpoints 710. Data may be uploaded to the cloud 744 via the aggregator, and commands can be received from the cloud 744 through gateway devices that are in communication with the IoT devices 711 and the aggregators through the mesh network. Unlike the traditional cloud computing model, in some implementations, the cloud 744 may have little or no computational capabilities and only serves as a repository for archiving data recorded and processed by the fog. In these implementations, the cloud 744 centralized data storage system and provides reliability and access to data by the computing resources in the fog and/or edge devices. Being at the core of the architecture, the Data Store of the cloud 744 is accessible by both Edge and Fog layers of the aforementioned edge-fog network.

As mentioned previously, the access networks provide network connectivity to the end-user devices 720, 710 via respective NANs 730, which may be part of respective access networks. The access networks may be cellular Radio Access Networks (RANs) such as an NG RANs or a 5G RANs for RANs that operate in a 5G/NR cellular network, E-UTRANs for a RANs that operate in an LTE or 4G cellular network, or legacy RANs such as a UTRANs or GERANs for GSM or CDMA cellular networks. The access networks or RANs may be referred to as an Access Service Network for WiMAX implementations. Additionally or alternatively, all or parts of the RAN may be implemented as one or more software entities running on server computers as part of a virtual network, which may be referred to as a cloud RAN (CRAN), Cognitive Radio (CR), a virtual baseband unit pool (vBBUP), and/or the like. Additionally or alternatively, the CRAN, CR, or vBBUP may implement a RANF split (see e.g., FIG. 14), wherein one or more communication protocol layers are operated by the CRAN, CR, vBBUP, CU, or edge compute node, and other communication protocol entities are operated by individual RAN nodes 731, 732. This virtualized framework allows the freed-up processor cores of the NANs 731, 732 to perform other virtualized applications, such as virtualized applications for various elements discussed herein. In some examples, the (R)ANs of FIG. 7 may correspond to the XAC architecture 600 of FIG. 6; (R)AN 1304 of FIG. 13, one or more O-RAN NFs 804 of FIG. 8; one or more RANFs 1-N of FIG. 14; and/or may implement any of the RICs discussed herein such as the near-RT RIC 114, 414, 814, 914, 1014, 1200; the non-RT RIC 112, 412, 812, 912, 1012; the RIC of FIG. 2; the RIC 3c14, and/or some other compute node(s) or elements/entities discussed herein.

The UEs 710 may utilize respective connections (or channels) 703a, each of which comprises a physical communications interface or layer. The connections 703a are illustrated as an air interface to enable communicative coupling consistent with cellular communications protocols, such as 3GPP LTE, 5G/NR, Push-to-Talk (PTT) and/or PTT over cellular (POC), UMTS, GSM, CDMA, and/or any of the other communications protocols discussed herein. Additionally or alternatively, the UEs 710 and the NANs 730 communicate data (e.g., transmit and receive) data over a licensed medium (also referred to as the “licensed spectrum” and/or the “licensed band”) and an unlicensed shared medium (also referred to as the “unlicensed spectrum” and/or the “unlicensed band”). To operate in the unlicensed spectrum, the UEs 710 and NANs 730 may operate using LAA, enhanced LAA (eLAA), and/or further eLAA (feLAA) mechanisms. The UEs 710 may further directly exchange communication data via respective direct links 705, which may be LTE/NR Proximity Services (ProSe) link or PC5 interfaces/links, or WiFi based links or a personal area network (PAN) based links (e.g., [IEEE802154] based protocols including ZigBee, IPv6 over Low power Wireless Personal Area Networks (6LoWPAN), WirelessHART, MiWi, Thread, and the like; WiFi-direct; Bluetooth/Bluetooth Low Energy (BLE) protocols).

Additionally or alternatively, individual UEs 710 provide radio information to one or more NANs 730 and/or one or more edge compute nodes 736 (e.g., edge servers/hosts, and the like). The radio information may be in the form of one or more measurement reports, and/or may include, for example, signal strength measurements, signal quality measurements, and/or the like. Each measurement report is tagged with a timestamp and the location of the measurement (e.g., the UEs 710 current location). As examples, the measurements collected by the UEs 710 and/or included in the measurement reports may include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (Eb/NO), energy per chip to interference power density ratio (Ec/I0), energy per chip to noise power density ratio (Ec/N0), peak-to-average power ratio (PAPR), reference signal received power (RSRP), reference signal received quality (RSRQ), received signal strength indicator (RSSI), received channel power indicator (RCPI), reference signal time difference (RSTD), received signal to noise indicator (RSNI), Received Signal Code Power (RSCP), average noise plus interference (ANPI), GNSS timing of cell frames for UE positioning for E-UTRAN or 5G/NR (e.g., a timing between an AP or RAN node reference time and a GNSS-specific reference time for a given GNSS), GNSS code measurements (e.g., the GNSS code phase (integer and fractional parts) of the spreading code of the ith GNSS satellite signal), GNSS carrier phase measurements (e.g., the number of carrier-phase cycles (integer and fractional parts) of the ith GNSS satellite signal, measured since locking onto the signal; also called Accumulated Delta Range (ADR)), channel interference measurements, thermal noise power measurements, received interference power measurements, power histogram measurements, channel load measurements, STA statistics, and/or other like measurements. The RSRP, RSSI, RSRQ, RCPI, RSTD, RSNI, and/or ANPI measurements may include RSRP, RSSI, RSRQ, RCPI, RSTD, RSNI, and/or ANPI measurements of one or more reference signals (e.g., including any of those discussed herein), synchronization signals (SS) or SS blocks, and/or physical channels (e.g., including any of those discussed herein), for 3GPP networks (e.g., LTE or 5G/NR), and RSRP, RSSI, RSRQ, RCPI, RSTD, RSNI, and/or ANPI measurements of various beacon, Fast Initial Link Setup (FILS) discovery frames, or probe response frames for WLAN/WiFi (e.g., [IEEE80211]) networks. Other measurements may be additionally or alternatively used, such as those discussed in 3GPP TS 36.211 v17.2.0 (2022 Jun. 23) (“[TS36211]”), 3GPP TS 38.211 v17.3.0 (2022 Sep. 21) (“[TS38211]”), 3GPP TS 36.214 v17.0.0 (2022 Mar. 31) (“[TS36214]”), 3GPP TS 38.215 v17.2.0 (2022 Sep. 21) (“[TS38215]”), 3GPP TS 38.314 v17.1.0 (2022 Jul. 17) (“[TS38314]”), IEEE Standard for Information Technology—Telecommunications and Information Exchange between Systems—Local and Metropolitan Area Networks—Specific Requirements—Part 11: Wireless IAN Medium Access Control (MAC) and Physical Layer (PHY) Specifications, IEEE Std 802.11-2020, pp. 1-4379 (26 Feb. 2021) (“[IEEE80211]”), and/or the like. Additionally or alternatively, any of the aforementioned measurements (or combination of measurements) may be collected by one or more NANs 730 and provided to the edge compute node(s) 736.

Additionally or alternatively, the measurements and/or parameters can include one or more of the following: Data Radio Bearer (DRB) related measurements and/or parameters (e.g., number of DRBs attempted to setup, number of DRBs successfully setup, number of released active DRBs, in-session activity time for DRB, number of DRBs attempted to be resumed, number of DRBs successfully resumed, and the like); Radio Resource Control (RRC) related measurements and/or parameters (e.g., mean number of RRC connections, maximum number of RRC connections, mean number of stored inactive RRC connections, maximum number of stored inactive RRC connections, number of attempted, successful, and/or failed RRC connection establishments, and the like); UE Context (UECNTX) related measurements and/or parameters; Radio Resource Utilization (RRU) related measurements and/or parameters (e.g., DL total PRB usage, UL total PRB usage, distribution of DL total PRB usage, distribution of UL total PRB usage, DL PRB used for data traffic, UL PRB used for data traffic, DL total available PRBs, UL total available PRBs, and the like); Registration Management (RM) related measurements and/or parameters; Session Management (SM) related measurements and/or parameters (e.g., number of PDU sessions requested to setup; number of PDU sessions successfully setup; number of PDU sessions failed to setup, and the like); GTP Management (GTP) related measurements and/or parameters; IP Management (IP) related measurements and/or parameters; Policy Association (PA) related measurements and/or parameters; Mobility Management (MM) related measurements and/or parameters (e.g., for inter-RAT, intra-RAT, and/or Intra/Inter-frequency handovers and/or conditional handovers: number of requested, successful, and/or failed handover preparations; number of requested, successful, and/or failed handover resource allocations; number of requested, successful, and/or failed handover executions; mean and/or maximum time of requested handover executions; number of successful and/or failed handover executions per beam pair, and the like); Virtualized Resource(s) (VR) related measurements and/or parameters; Carrier (CARR); measurements related to QoS Flows (QF) related measurements and/or parameters (e.g., number of released active QoS flows, number of QoS flows attempted to release, in-session activity time for QoS flow, in-session activity time for a UE 710, number of QoS flows attempted to setup, number of QoS flows successfully established, number of QoS flows failed to setup, number of initial QoS flows attempted to setup, number of initial QoS flows successfully established, number of initial QoS flows failed to setup, number of QoS flows attempted to modify, number of QoS flows successfully modified, number of QoS flows failed to modify, and the like); Application Triggering (AT) related measurements and/or parameters; Short Message Service (SMS) related measurements and/or parameters; Power, Energy and Environment (PEE) related measurements and/or parameters; NF service (NFS) related measurements and/or parameters; Packet Flow Description (PFD) related measurements and/or parameters; Random Access Channel (RACH) related measurements and/or parameters; Measurement Report (MR) related measurements and/or parameters; Layer 1 Measurement (L1M) related measurements and/or parameters; Network Slice Selection (NSS) related measurements and/or parameters; Paging (PAG) related measurements and/or parameters; Non-IP Data Delivery (NIDD) related measurements and/or parameters; external parameter provisioning (EPP) related measurements and/or parameters; traffic influence (TI) related measurements and/or parameters; Connection Establishment (CE) related measurements and/or parameters; Service Parameter Provisioning (SPP) related measurements and/or parameters; Background Data Transfer Policy (BDTP) related measurements and/or parameters; Data Management (DM) related measurements and/or parameters; and/or any other performance measurements and/or parameters such as those discussed in, for example, 3GPP TS 28.532 v17.1.0 (2022 Jun. 16) (“[TS28532]”), 3GPP TS 28.552 v18.0.0 (2022 Sep. 23) (“[TS28552]”), 3GPP TS 28.554 v17.8.0 (2022 Sep. 23) (“[TS28554]”), and/or 3GPP TS 32.425 v17.1.0 (2021 Jun. 24) (“[TS32425]”), the contents of each of which are hereby incorporated by reference in their entireties.

The radio information may be reported in response to a trigger event and/or on a periodic basis. Additionally or alternatively, individual UEs 710 report radio information either at a low periodicity or a high periodicity depending on a data transfer that is to take place, and/or other information about the data transfer. Additionally or alternatively, the edge compute node(s) 736 may request the measurements from the NANs 730 at low or high periodicity, or the NANs 730 may provide the measurements to the edge compute node(s) 736 at low or high periodicity. Additionally or alternatively, the edge compute node(s) 736 may obtain other relevant data from other edge compute node(s) 736, core network functions (NFs), application functions (AFs), and/or other UEs 710 such as KPIs, KPMs, and the like with the measurement reports or separately from the measurement reports.

Additionally or alternatively, in cases where is discrepancy in the observation data from one or more UEs, one or more RAN nodes, and/or core network NFs (e.g., missing reports, erroneous data, and the like) simple imputations may be performed to supplement the obtained observation data such as, for example, substituting values from previous reports and/or historical data, apply an extrapolation filter, and/or the like. Additionally or alternatively, acceptable bounds for the observation data may be predetermined or configured. For example, CQI and MCS measurements may be configured to only be within ranges defined by suitable 3GPP standards. In cases where a reported data value does not make sense (e.g., the value exceeds an acceptable range/bounds, or the like), such values may be dropped for the current learning/training episode or epoch. For example, on packet delivery delay bounds may be defined or configured, and packets determined to have been received after the packet delivery delay bound may be dropped.

In any of the examples discussed herein, any suitable data collection and/or measurement mechanism(s) may be used to collect the observation data. For example, data marking (e.g., sequence numbering, and the like), packet tracing, signal measurement, data sampling, and/or timestamping techniques may be used to determine any of the aforementioned metrics/observations. The collection of data may be based on occurrence of events that trigger collection of the data. Additionally or alternatively, data collection may take place at the initiation or termination of an event. The data collection can be continuous, discontinuous, and/or have start and stop times. The data collection techniques/mechanisms may be specific to a HW configuration/implementation or non-HW-specific, or may be based on various software parameters (e.g., OS type and version, and the like). Various configurations may be used to define any of the aforementioned data collection parameters. Such configurations may be defined by suitable specifications/standards, such as 3GPP (e.g., [SA6Edge]), ETSI (e.g., [MEC], [ETSINFV], [OSM], [ZSM], and/or the like), O-RAN (e.g., [O-RAN]), Intel® Smart Edge Open (formerly OpenNESS) (e.g., [ISEO]), IETF (e.g., [MAMS]), IEEE/WiFi (e.g., [IEEE80211], [WiMAX], [IEEE16090], and the like), and/or any other like standards such as those discussed herein.

The UE 712b is shown as being capable of accessing access point (AP) 733 via a connection 703b. In this example, the AP 733 is shown to be connected to the Internet without connecting to the CN 742 of the wireless system. The connection 703b can comprise a local wireless connection, such as a connection consistent with any IEEE 802.11 protocol (e.g., [IEEE80211] and variants thereof), wherein the AP 733 would comprise a WiFi router. Additionally or alternatively, the UEs 710 can be configured to communicate using suitable communication signals with each other or with any of the AP 733 over a single or multicarrier communication channel in accordance with various communication techniques, such as, but not limited to, an OFDM communication technique, a single-carrier frequency division multiple access (SC-FDMA) communication technique, and/or the like, although the scope of the present disclosure is not limited in this respect. The communication technique may include a suitable modulation scheme such as Complementary Code Keying (CCK); Phase-Shift Keying (PSK) such as Binary PSK (BPSK), Quadrature PSK (QPSK), Differential PSK (DPSK), and the like; or Quadrature Amplitude Modulation (QAM) such as M-QAM; and/or the like.

The one or more NANs 731 and 732 that enable the connections 703a may be referred to as “RAN nodes” or the like. The RAN nodes 731, 732 may comprise ground stations (e.g., terrestrial access points) or satellite stations providing coverage within a geographic area (e.g., a cell). The RAN nodes 731, 732 may be implemented as one or more of a dedicated physical device such as a macrocell base station, and/or a low power base station for providing femtocells, picocells or other like cells having smaller coverage areas, smaller user capacity, or higher bandwidth compared to macrocells. In this example, the RAN node 731 is embodied as a NodeB, evolved NodeB (eNB), or a next generation NodeB (gNB), and the RAN nodes 732 are embodied as relay nodes, distributed units, or Road Side Unites (RSUs). Any other type of NANs can be used. In some examples, the RAN nodes 731, 732 may be the same or similar as the CU-CPs 121, 321, 921, 1021, 1432c; CU-UPs 122, 322 922, 1022, 1432u; DUs 115, 331, 915, 1015, 1431; RUs 116, 816, 916, 1016, 1430; the srsRAN and/or RU, DU, or CU of FIG. 2; AP 1306, AN 1308, eNB 1312, gNB 1316, and/or ng-eNB 1318; one or more RANFs 1-N of FIG. 14, and/or some other compute node(s) or elements/entities discussed herein.

Any of the RAN nodes 731, 732 can terminate the air interface protocol and can be the first point of contact for the UEs 712 and IoT devices 711. Additionally or alternatively, any of the RAN nodes 731, 732 can fulfill various logical functions for the RAN including, but not limited to, RANF(s) (e.g., radio network controller (RNC) functions and/or NG-RANFs) for radio resource management, admission control, UL and DL dynamic resource allocation, radio bearer management, data packet scheduling, and the like. The RANFs can also include O-RAN RANFs such as, for example, E2SM-KPM, E2SM cell configuration and control (E2SM-CCC), E2SM RAN control, E2SM RAN Function Network Interface (NI), and the like (see e.g., [O-RAN]). Additionally or alternatively, the UEs 710 can be configured to communicate using OFDM communication signals with each other or with any of the NANs 731, 732 over a multicarrier communication channel in accordance with various communication techniques, such as, but not limited to, an OFDMA communication technique (e.g., for DL communications) and/or an SC-FDMA communication technique (e.g., for UL and ProSe or sidelink (SL) communications), although the scope of the present disclosure is not limited in this respect.

For most cellular communication systems, the RANF(s) operated by a RAN computing element and/or individual NANs 731-732 organize DL transmissions (e.g., from any of the RAN nodes 731, 732 to the UEs 710) and UL transmissions (e.g., from the UEs 710 to RAN nodes 731, 732) into radio frames (or simply “frames”) with 10 millisecond (ms) durations, where each frame includes ten 1 ms subframes. Each transmission direction has its own resource grid that indicate physical resource in each slot, where each column and each row of a resource grid corresponds to one symbol and one subcarrier, respectively. The duration of the resource grid in the time domain corresponds to one slot in a radio frame. The resource grids comprises a number of resource blocks (RBs), which describe the mapping of certain physical channels to resource elements (REs). Each RB may be a physical RB (PRB) or a virtual RB (VRB) and comprises a collection of REs. An RE is the smallest time-frequency unit in a resource grid. The RNC function(s) dynamically allocate resources (e.g., PRBs and modulation and coding schemes (MCS)) to each UE 710 at each transmission time interval (TTI). A TTI is the duration of a transmission on a radio link 703a, 705, and is related to the size of the data blocks passed to the radio link layer from higher network layers.

The NANs 731, 732 may be configured to communicate with one another via respective interfaces or links (not shown), such as an X2 interface for LTE implementations (e.g., when CN 742 is an Evolved Packet Core (EPC)), an Xn interface for 5G or NR implementations (e.g., when CN 742 is an Fifth Generation Core (5GC)), or the like. The NANs 731 and 732 are also communicatively coupled to CN 742. Additionally or alternatively, the CN 742 may be an evolved packet core (EPC) network, a NextGen Packet Core (NPC) network, a 5G core (5GC), or some other type of CN. The CN 742 is a network of network elements and/or network functions (NFs) relating to a part of a communications network that is independent of the connection technology used by a terminal or user device. The CN 742 comprises a plurality of network elements/NFs configured to offer various data and telecommunications services to customers/subscribers (e.g., users of UEs 712 and IoT devices 711) who are connected to the CN 742 via a RAN. The components of the CN 742 may be implemented in one physical node or separate physical nodes including components to read and execute instructions from a machine-readable or computer-readable medium (e.g., a non-transitory machine-readable storage medium). Additionally or alternatively, Network Functions Virtualization (NFV) may be utilized to virtualize any or all of the above-described network node functions via executable instructions stored in one or more computer-readable storage mediums (described in further detail infra). A logical instantiation of the CN 742 may be referred to as a network slice, and a logical instantiation of a portion of the CN 742 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more CN 742 components/functions. In some examples, the CN 742 may be the same or similar as the SMO 102, MO 301, MO 3c02, SMO 802, SMO 902, SMO 1002, the NG-core 808, CN 1320, CN 1442 and/or CN NFs 1-x, EPC 1042a, and/or 5GC 1042b, and/or some other compute node(s) or elements/entities discussed herein.

The CN 742 is shown to be communicatively coupled to an application server 750 and a network 750 via an IP communications interface 755. the one or more server(s) 750 comprise one or more physical and/or virtualized systems for providing functionality (or services) to one or more clients (e.g., UEs 712 and IoT devices 711) over a network. The server(s) 750 may include various computer devices with rack computing architecture component(s), tower computing architecture component(s), blade computing architecture component(s), and/or the like. The server(s) 750 may represent a cluster of servers, a server farm, a cloud computing service, or other grouping or pool of servers, which may be located in one or more datacenters. The server(s) 750 may also be connected to, or otherwise associated with one or more data storage devices (not shown). Moreover, the server(s) 750 may include an operating system (OS) that provides executable program instructions for the general administration and operation of the individual server computer devices, and may include a computer-readable medium storing instructions that, when executed by a processor of the servers, may allow the servers to perform their intended functions. Suitable implementations for the OS and general functionality of servers are known or commercially available, and are readily implemented by persons having ordinary skill in the art. Generally, the server(s) 750 offer applications or services that use IP/network resources. As examples, the server(s) 750 may provide traffic management services, cloud analytics, content streaming services, immersive gaming experiences, social networking and/or microblogging services, and/or other like services. In addition, the various services provided by the server(s) 750 may include initiating and controlling software and/or firmware updates for applications or individual components implemented by the UEs 712 and IoT devices 711. The server(s) 750 can also be configured to support one or more communication services (e.g., Voice-over-Internet Protocol (VoIP) sessions, PTT sessions, group communication sessions, social networking services, and the like) for the UEs 712 and IoT devices 711 via the CN 742. As examples, the server(s) 750 may correspond to the SMO 102, MO 301, MO 3c02, SMO 802, external system 810, SMO 902, SMO 1002, DN 1336 or app server 1338, edge compute node 1436, and/or some other compute node(s) or elements/entities discussed herein.

The Radio Access Technologies (RATs) employed by the NANs 730, the UEs 710, and the other elements in FIG. 7 may include, for example, any of the communication protocols and/or RATs discussed herein. Different technologies exhibit benefits and limitations in different scenarios, and application performance in different scenarios becomes dependent on the choice of the access networks (e.g., WiFi, LTE, and the like) and the used network and transport protocols (e.g., Transfer Control Protocol (TCP), Virtual Private Network (VPN), Multi-Path TCP (MPTCP), Generic Routing Encapsulation (GRE), and the like). These RATs may include one or more V2X RATs, which allow these elements to communicate directly with one another, with infrastructure equipment (e.g., NANs 730), and other devices. In some implementations, at least two distinct V2X RATs may be used including WLAN V2X (W-V2X) RAT based on IEEE V2X technologies (e.g., DSRC for the U.S. and ITS-G5 for Europe) and 3GPP C-V2X RAT (e.g., LTE, 5G/NR, and beyond). In one example, the C-V2X RAT may utilize a C-V2X air interface and the WLAN V2X RAT may utilize an W-V2X air interface.

The W-V2X RATs include, for example, IEEE Guide for Wireless Access in Vehicular Environments (WAVE) Architecture, IEEE STANDARDS ASSOCIATION, IEEE 1609.0-2019 (10 Apr. 2019) (“[IEEE16090]”), V2X Communications Message Set Dictionary, SAE INT'L (23 Jul. 2020) (“[J2735_202007]”), Intelligent Transport Systems in the 5 GHz frequency band (ITS-G5), the [IEEE80211p] (which is the layer 1 (L1) and layer 2 (L2) part of WAVE, DSRC, and ITS-G5), and/or IEEE Standard for Air Interface for Broadband Wireless Access Systems, IEEE Std 802.16-2017. pp. 1-2726 (2 Mar. 2018) (“[WiMAX]”). The term “DSRC” refers to vehicular communications in the 5.9 GHz frequency band that is generally used in the United States, while “ITS-G5” refers to vehicular communications in the 5.9 GHz frequency band in Europe. Since any number of different RATs are applicable (including [IEEE80211p] RATs) that may be used in any geographic or political region, the terms “DSRC” (used, among other regions, in the U.S.) and “ITS-G5” (used, among other regions, in Europe) may be used interchangeably throughout this disclosure. The access layer for the ITS-G5 interface is outlined in ETSI EN 302663 V1.3.1 (2020 January) (hereinafter “[EN302663]”) and describes the access layer of the ITS-S reference architecture. The ITS-G5 access layer comprises [IEEE80211] (which now incorporates [IEEE80211p]), as well as features for Decentralized Congestion Control (DCC) methods discussed in ETSI TS 102 687 V1.2.1 (2018 April) (“[TS102687]”). The access layer for 3GPP LTE-V2X based interface(s) is outlined in, inter alia, ETSI EN 303 613 V1.1.1 (2020 January), 3GPP TS 23.285 v16.2.0 (2019 December); and 3GPP 5G/NR-V2X is outlined in, inter alia, 3GPP TR 23.786 v16.1.0 (2019 June) and 3GPP TS 23.287 v16.2.0 (2020 March).

The cloud 744 may represent a cloud computing architecture/platform that provides one or more cloud computing services. Cloud computing refers to a paradigm for enabling network access to a scalable and elastic pool of shareable computing resources with self-service provisioning and administration on-demand and without active management by users. Computing resources (or simply “resources”) are any physical or virtual component, or usage of such components, of limited availability within a computer system or network. Examples of resources include usage/access to, for a period of time, servers, processor(s), storage equipment, memory devices, memory areas, networks, electrical power, input/output (peripheral) devices, mechanical devices, network connections (e.g., channels/links, ports, network sockets, and the like), operating systems, virtual machines (VMs), software/applications, computer files, and/or the like. Cloud computing provides cloud computing services (or cloud services), which are one or more capabilities offered via cloud computing that are invoked using a defined interface (e.g., an API or the like). Some capabilities of cloud 744 include application capabilities type, infrastructure capabilities type, and platform capabilities type. A cloud capabilities type is a classification of the functionality provided by a cloud service to a cloud service customer (e.g., a user of cloud 744), based on the resources used. The application capabilities type is a cloud capabilities type in which the cloud service customer can use the cloud service provider's applications; the infrastructure capabilities type is a cloud capabilities type in which the cloud service customer can provision and use processing, storage or networking resources; and platform capabilities type is a cloud capabilities type in which the cloud service customer can deploy, manage and run customer-created or customer-acquired applications using one or more programming languages and one or more execution environments supported by the cloud service provider. Cloud services may be grouped into categories that possess some common set of qualities. Some cloud service categories that the cloud 744 may provide include, for example, Communications as a Service (CaaS), which is a cloud service category involving real-time interaction and collaboration services; Compute as a Service (CompaaS), which is a cloud service category involving the provision and use of processing resources needed to deploy and run software; Database as a Service (DaaS), which is a cloud service category involving the provision and use of database system management services; Data Storage as a Service (DSaaS), which is a cloud service category involving the provision and use of data storage and related capabilities; Firewall as a Service (FaaS), which is a cloud service category involving providing firewall and network traffic management services; Infrastructure as a Service (IaaS), which is a cloud service category involving infrastructure capabilities type; Network as a Service (NaaS), which is a cloud service category involving transport connectivity and related network capabilities; Platform as a Service (PaaS), which is a cloud service category involving the platform capabilities type; Software as a Service (SaaS), which is a cloud service category involving the application capabilities type; Security as a Service, which is a cloud service category involving providing network and information security (infosec) services; and/or other like cloud services.

Additionally or alternatively, the cloud 744 may represent one or more cloud servers, application servers, web servers, and/or some other remote infrastructure. The remote/cloud servers may include any one of a number of services and capabilities such as, for example, any of those discussed herein. Additionally or alternatively, the cloud 744 may represent a network such as the Internet, a local area network (LAN), a wide area network (WAN), a wireless local area network (WLAN), or a wireless wide area network (WWAN) including proprietary and/or enterprise networks for a company or organization, or combinations thereof. The cloud 744 may be a network that comprises computers, network connections among the computers, and software routines to enable communication between the computers over network connections. In this regard, the cloud 744 comprises one or more network elements that may include one or more processors, communications systems (e.g., including network interface controllers, one or more transmitters/receivers connected to one or more antennas, and the like), and computer readable media. Examples of such network elements may include wireless access points (WAPs), home/business servers (with or without RF communications circuitry), routers, switches, hubs, radio beacons, base stations, picocell or small cell base stations, backbone gateways, and/or any other like network device. Connection to the cloud 744 may be via a wired or a wireless connection using the various communication protocols discussed infra. More than one network may be involved in a communication session between the illustrated devices. Connection to the cloud 744 may require that the computers execute software routines which enable, for example, the seven layers of the OSI model of computer networking or equivalent in a wireless (cellular) phone network. Cloud 744 may be used to enable relatively long-range communication such as, for example, between the one or more server(s) 750 and one or more UEs 710. Additionally or alternatively, the cloud 744 may represent the Internet, one or more cellular networks, local area networks, or wide area networks including proprietary and/or enterprise networks, TCP/Internet Protocol (IP)-based network, or combinations thereof. In these implementations, the cloud 744 may be associated with network operator who owns or controls equipment and other elements necessary to provide network-related services, such as one or more base stations or access points, one or more servers for routing digital data or telephone calls (e.g., a core network or backbone network), and the like The backbone links 755 may include any number of wired or wireless technologies, and may be part of a LAN, a WAN, or the Internet. In one example, the backbone links 755 are fiber backbone links that couple lower levels of service providers to the Internet, such as the CN 712 and cloud 744. As examples, the cloud 744 may correspond to the O-cloud 106, 806, 906; DN 1336; network 1610, edge cloud 1763, and/or some other computing system or service.

As shown by FIG. 7, each of the NANs 731, 732, and 733 are co-located with edge compute nodes (or “edge servers”) 736a, 736b, and 736c, respectively. These implementations may be small-cell clouds (SCCs) where an edge compute node 736 is co-located with a small cell (e.g., pico-cell, femto-cell, and the like), or may be mobile micro clouds (MCCs) where an edge compute node 736 is co-located with a macro-cell (e.g., an eNB, gNB, and the like). The edge compute node 736 may be deployed in a multitude of arrangements other than as shown by FIG. 7. In a first example, multiple NANs 730 are co-located or otherwise communicatively coupled with one edge compute node 736. In a second example, the edge servers 736 may be co-located or operated by RNCs, which may be the case for legacy network deployments, such as 3G networks. In a third example, the edge servers 736 may be deployed at cell aggregation sites or at multi-RAT aggregation points that can be located either within an enterprise or used in public coverage areas. In a fourth example, the edge servers 736 may be deployed at the edge of CN 742. These implementations may be used in follow-me clouds (FMC), where cloud services running at distributed data centers follow the UEs 710 as they roam throughout the network.

In any of the implementations discussed herein, the edge servers 736 provide a distributed computing environment for application and service hosting, and also provide storage and processing resources so that data and/or content can be processed in close proximity to subscribers (e.g., users of UEs 710) for faster response times The edge servers 736 also support multitenancy run-time and hosting environment(s) for applications, including virtual appliance applications that may be delivered as packaged virtual machine (VM) images, middleware application and infrastructure services, content delivery services including content caching, mobile big data analytics, and computational offloading, among others. Computational offloading involves offloading computational tasks, workloads, applications, and/or services to the edge servers 736 from the UEs 710, CN 742, cloud 744, and/or server(s) 750, or vice versa. For example, a device application or client application operating in a UE 710 may offload application tasks or workloads to one or more edge servers 736. In another example, an edge server 736 may offload application tasks or workloads to one or more UE 710 (e.g., for distributed ML computation or the like).

The edge compute nodes 736 may include or be part of an edge system 735 that employs one or more ECTs 735. The edge compute nodes 736 may also be referred to as “edge hosts 736” or “edge servers 736.” The edge system 735 includes a collection of edge servers 736 and edge management systems (not shown by FIG. 7) necessary to run edge computing applications within an operator network or a subset of an operator network. The edge servers 736 are physical computer systems that may include an edge platform and/or virtualization infrastructure, and provide compute, storage, and network resources to edge computing applications. Each of the edge servers 736 are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to UEs 710. The VI of the edge servers 736 provide virtualized environments and virtualized resources for the edge hosts, and the edge computing applications may run as VMs and/or application containers on top of the VI.

The edge compute nodes may include or be part of an edge system (e.g., an edge cloud 1763 and/or the like) that employs one or more edge computing technologies (ECTs). The edge compute nodes may also be referred to as “edge hosts”, “edge servers”, and/or the like The edge system (e.g., edge cloud 1763 and/or the like) can include a collection of edge compute nodes and edge management systems (not shown) necessary to run edge computing applications within an operator network or a subset of an operator network. The edge compute nodes are physical computer systems that may include an edge platform and/or virtualization infrastructure, and provide compute, storage, and network resources to edge computing applications. Each of the edge compute nodes are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to data source devices (e.g., UEs 710). The VI of the edge compute nodes provide virtualized environments and virtualized resources for the edge hosts, and the edge computing applications may run as VMs and/or application containers on top of the VI. As examples, the edge compute nodes 736 may correspond to, or host, the SMO 102, MO 301, MO 3c02, SMO 802, external system 810, SMO 902, SMO 1002, DN 1336 or app server 1338, edge compute node 1436, the near-RT RIC 114, 414, 814,914, 1014, 1200; the non-RT RIC 112, 412, 812, 912, 1012; the RIC of FIG. 2; the RIC 3c14, and/or some other compute node(s) or elements/entities discussed herein.

In one example implementation, the ECT 735 operates according to the MEC framework, as discussed in ETSI GS MEC 003 V3.1.1 (2022 March), ETSI GS MEC 009 V3.1.1 (2021 June), ETSI GS MEC 010-1 v1.1.1 (2017 October), ETSI GS MEC 010-2 v2.2.1 (2022 February), ETSI GS MEC 011 v2.2.1 (2020 December), ETSI GS MEC 012 V2.2.1 (2022 February), ETSI GS MEC 013 v2.2.1 (2022 January), ETSI GS MEC 014 V1.1.1 (2021 February), ETSI GS MEC 015 v2.1.1 (2020 June), ETSI GS MEC 016 v2.2.1 (2020 April), ETSI GS MEC 021 v2.2.1 (2022 February), ETSI GS MEC 028 v2.2.1 (2021 July), ETSI GS MEC 029 v2.2.1 (2022 January), ETSI MEC GS 030 v2.2.1 (2022 May), ETSI GS NFV-MAN 001 v1.1.1 (2014 December), U.S. Provisional App. No. 63/003,834 filed Apr. 1, 2020 (“['834]”), and Int'l App. No. PCT/US2020/066969 filed on Dec. 23, 2020 (“['969]”) (collectively referred to herein as “[MEC]”), the contents of each of which are hereby incorporated by reference in their entireties. This example implementation (and/or in any other example implementation discussed herein) may also include NFV and/or other like virtualization technologies such as those discussed in ETSI GR NFV 001 V1.3.1 (2021 March), ETSI GS NFV 002 V1.2.1 (2014 December), ETSI GR NFV 003 V1.6.1 (2021 March), ETSI GS NFV 006 V2.1.1 (2021 January), ETSI GS NFV-INF 001 V1.1.1 (2015 January), ETSI GS NFV-INF 003 V1.1.1 (2014 December), ETSI GS NFV-INF 004 V1.1.1 (2015 January), ETSI GS NFV-MAN 001 v1.1.1 (2014 December), and/or Open Source MANO documentation, version 12 (June 2022), https://osm.etsi.org/docs/user-guide/v12/index.html (“[OSM]”) (collectively referred to as “[ETSINFV]”), the contents of each of which are hereby incorporated by reference in their entireties. Other virtualization technologies and/or service orchestration and automation platforms may be used such as, for example, those discussed in E2E Network Slicing Architecture, GSMA, Official Doc. NG.127, v1.0 (3 Jun. 2021), https://www.gsma.com/newsroom/wp-content/uploads//NG.127-v1.0-2.pdf, Open Network Automation Platform (ONAP) documentation, Release Istanbul, v9.0.1 (17 Feb. 2022), https://docs.onap.org/en/latest/index.html (“[ONAP]”), 3GPP Service Based Management Architecture (SBMA) as discussed in 3GPP TS 28.533 v17.2.0 (2022 Mar. 22)(“[TS28533]”), the contents of each of which are hereby incorporated by reference in their entireties; and/or a management function based on Zero-touch System Management (ZSM) architecture (see e.g., ETSI GS ZSM 001 V1.1.1 (2019 October), ETSI GS ZSM 002 v1.1.1 (2019-August), ETSI GS ZSM 003 v1.1.1 (2021 June) ETSI GS ZSM 009-1 V1.1.1 (2021 June), ETSI GS ZSM 009-2 V1.1.1 (2022 June), ETSI GS ZSM 007 V1.1.1 (2019-August) (collectively referred to as “[ZSM]”), the contents of each of which are hereby incorporated by reference in their entireties.

In another example implementation, the ECT 735 operates according to the O-RAN framework. Typically, front-end and back-end device vendors and carriers have worked closely to ensure compatibility. The flip-side of such a working model is that it becomes quite difficult to plug-and-play with other devices and this can hamper innovation. To combat this, and to promote openness and inter-operability at every level, several key players interested in the wireless domain (e.g., carriers, device manufacturers, academic institutions, and/or the like) formed the Open RAN alliance (“O-RAN”) in 2018. The O-RAN network architecture is a building block for designing virtualized RAN on programmable hardware with radio access control powered by AI. Various aspects of the O-RAN architecture are described in O-RAN Architecture Description v07.00, O-RAN ALLIANCE WG1 (October 2022) (“[O-RAN.WG1.O-RAN-Architecture-Description]”); O-RAN Operations and Maintenance Architecture Specification v04.00, O-RAN ALLIANCE WG1 (February 2021) (“[O-RAN.WG1.OAM-Architecture]”); O-RAN Operations and Maintenance Interface Specification v04.00, O-RAN ALLIANCE WG1 (February 2021) (“[O-RAN.WG1.O1-Interface.0]”); O-RAN Information Model and Data Models Specification v01.00, O-RAN ALLIANCE WG1 (February 2021); O-RAN Working Group 1 Slicing Architecture v08.00 (October 2022); O-RAN Working Group 2 (Non-RT RIC and A1 interface WG) A1 interface: Application Protocol v03.02 (July 2021); O-RAN Working Group 1 Use Cases Detailed Specification v09.00 (October 2022) (“[O-RAN.WG1.Use-Cases]”); O-RAN Working Group 2 (Non-RT RIC and A1 interface WG) A1 interface: General Aspects and Principles v03.00 (October 2022) (“[O-RAN.WG2.A1GAP]”); O-RAN Working Group 2 (Non-RT RIC and A1 interface WG) A1 interface: Type Definitions v04.00 (October 2021); O-RAN Working Group 2 (Non-RT RIC and A1 interface WG) A1 interface: Transport Protocol v02.00 (October 2022); O-RAN Working Group 2 AI/ML workflow description and requirements v01.03 O-RAN ALLIANCE WG2 (October 2021) (“[O-RAN.WG2.AIML]”); O-RAN Working Group 2 (Non-RT RIC and A1 interface WG) Non-RT RIC Architecture v02.01 (October 2022); O-RAN Working Group 2 Non-RT RIC: Functional Architecture v01.01, O-RAN ALLIANCE WG2 (June 2021); O-RAN Working Group 2 (Non-RT RIC and A1 interface WG): R1 interface: General Aspects and Principles v03.00, O-RAN ALLIANCE WG2 (October 2022); O-RAN Working Group 3 Near-Real-time RAN Intelligent Controller Architecture & E2 General Aspects and Principles v02.02 (July 2022) (“[O-RAN.WG3.E2GAP]”); O-RAN Working Group 3 Near-Real-time Intelligent Controller E2 Service Model (E2SM) v02.01 (March 2022) (“[O-RAN.WG3.E2SM]”); O-RAN Working Group 3 Near-Real-time Intelligent Controller E2 Service Model (E2SM). Cell Configuration and Control v01.00 (October 2022) (“[O-RAN.WG3.E2SM-CCC]”); O-RAN Working Group 3 Near-Real-time Intelligent Controller E2 Service Model (E2SM) KPM v02.03 (October 2022) (“[O-RAN.WG3.E2SM-KPM]”); O-RAN Working Group 3 Near-Real-time Intelligent Controller E2 Service Model (E2SM) RAN Function Network Interface (NI) v01.00 (February 2020) (“[ORAN-WG3.E2SM-NI]”); O-RAN Working Group 3 Near-Real-time Intelligent Controller E2 Service Model (E2SM) RAN Control v01.03 (October 2022) (“[O-RAN.WG3.E2SM-RC]”); O-RAN Working Group 3. Near-Real-time Intelligent Controller. E2 Application Protocol (E2AP) v02.03 (October 2022) (“[O-RAN.WG3.E2AP]”); O-RAN Working Group 3 (Near-Real-time RAN Intelligent Controller and E2 Interface Working Group): Near-RT RIC Architecture v03.00 (October 2022) (“[O-RAN.WG3.RICARCH]”); O-RAN Working Group 4 (Open Fronthaul Interfaces WG) Control. User and Synchronization Plane Specification v09.00 (July 2022) (“[O-RAN-WG4.CUS.0]”); O-RAN Fronthaul Working Group 4 Cooperative Transport Interface Transport Control Plane Specification v02.00, O-RAN ALLIANCE WG4 (June 2021); O-RAN Fronthaul Working Group 4 Cooperative Transport Interface Transport Management Plane Specification v02.00 (June 2021); O-RAN Fronthaul Working Group 4 (Open Fronthaul Interfaces WG): Management Plane Specification v09.00 (July 2022) (“[O-RAN.WG4.MP.0]”); O-RAN Alliance Working Group 5O1 Interface specification for O-CU-UP and O-CU-CP v04.00 (October 2022); O-RAN Alliance Working Group 5 O1 Interface specification for O-DU v05.00 (October 2022); O-RAN Open F1/W1/E1/X2/Xn Interfaces Working Group Transport Specification v01.00, O-RAN ALLIANCE WG5 (April 2020); O-RAN Working Group 6 (Cloudifcation and Orchestration) Cloud Architecture and Deployment Scenarios for O-RAN Virtualized RAN v04.00 (October 2022) (“[O-RAN.WG6.CADS]”); O-RAN Cloud Platform Reference Designs v02.00, O-RAN ALLIANCE WG6 (February 2021); O-RAN Working Group 6 O2 Interface General Aspects and Principles v02.00 (October 2022); O-RAN Working Group 6 (Cloudication and Orchestration Work Group); O-RANAcceleration Abstraction Layer General Aspects and Principles v04.00 (October 2022); O-RAN Working Group 6: O-Cloud Notification API Specification for Event Consumers v03.00 (“[O-RAN.WG6.O-Cloud Notification API]”); O-RAN White Box Hardware Working Group Hardware Reference Design Specification for Indoor Pico Cell with Fronthaul Split Option 6 v02.00, O-RAN ALLIANCE WG7 (October 2021) (“[O-RAN.WG7.IPC-HRD-Opt6]”); O-RAN WG7 Hardware Reference Design Specification for Indoor Picocell (FR1) with Split Architecture Option 7-2 v03.00, O-RAN ALLIANCE WG7 (October 2021) (“[O-RAN.WG7.IPC-HRD-Opt7-2]”); O-RAN WG7 Hardware Reference Design Specification for Indoor Picocell (FR1) with Split Architecture Option 8 v03.00 (October 2021) (“[O-RAN.WG7.IPC-HRD-Opt8]”); O-RAN White Box Hardware Working Group Hardware Reference Design Specification for Outdoor Micro Cell with Split Architecture Option 7.2 v03.00, O-RAN ALLIANCE WG7 (October 2022) (“[O-RAN.WG7.OMC-HRD-Opt7-2]”); O-RAN White Box Hardware Working Group Hardware Reference Design Specification for Outdoor Macro Cell with Split Architecture Option 7.2 v03.00, O-RAN ALLIANCE WG7 (July 2022) (“[O-RAN.WG7.OMAC-HRD]”); O-RAN Open X-haul Transport Working Group Management interfaces for Transport Network Elements v04.00, O-RAN ALLIANCE WG9 (July 2022); O-RAN Open X-haul Transport Working Group Synchronization Architecture and Solution Specification v02.00, O-RAN ALLIANCE WG9 (March 2022); O-RAN Open Xhaul Transport WG9 WDM-based Fronthaul Transport v2.0, O-RAN ALLIANCE WG9 (March 2022); O-RAN Open Transport Working Group 9Xhaul Packet Switched Architectures and Solutions v03.00, O-RAN ALLIANCE WG9 (July 2022) (“[O-RAN.WG9.XPSAAS]”); O-RAN Operations and Maintenance Architecture v07.00, O-RAN ALLIANCE WG10 (July 2022) (“[O-RAN.WG10.OAM-Architecture]”); O-RAN Operations and Maintenance Interface Specification v07.00, O-RAN ALLIANCE WG10 (July 2022); O-RAN Operations and Maintenance Interface Specification v08.00, O-RAN ALLIANCE WG10 (October 2022) (“[O-RAN.WG10.O1-Interface.0]”); O-RAN: Towards an Open and Smart RAN, O-RAN ALLIANCE, White Paper (October 2018); and U.S. application Ser. No. 17/484,743 filed on 24 Sep. 2021 (collectively referred to as “[O-RAN]”) the contents of each of which are hereby incorporated by reference in their entireties.

In another example implementation, the ECT 735 operates according to the 3^{rd} Generation Partnership Project (3GPP) System Aspects Working Group 6 (SA6) Architecture for enabling Edge Applications (referred to as “3GPP edge computing”) as discussed in 3GPP TS 23.558 v18.0.0 (2022 Sep. 23) (“[TS23558]”), 3GPP TS 23.501 v17.6.0 (2022 Sep. 22) (“[TS23501]”), 3GPP TS 23.548 v17.4.0 (2022 Sep. 22) (“[TS23548]”), and U.S. application Ser. No. 17/484,719 filed on 24 Sep. 2021 (“['719]”) (collectively referred to as “[SA6Edge]”), the contents of each of which is hereby incorporated by reference in their entireties.

In another example implementation, the ECT 735 operates according to the Intel® Smart Edge Open framework (formerly known as OpenNESS) as discussed in Intel® Smart Edge Open Developer Guide, version 21.09 (30 Sep. 2021), available at: <https://smart-edge-open.github.io/> (“[ISEO]”), the contents of which are hereby incorporated by reference in its entirety.

In another example implementation, the ECT 735 operates according to the Multi-Access Management Services (MAMS) framework as discussed in Kanugovi et al., Multi-Access Management Services (MAMS), INTERNET ENGINEERING TASK FORCE (IETF), Request for Comments (RFC) 8743 (March 2020) (“[RFC8743]”), Ford et al., TCP Extensions for Multipath Operation with Multiple Addresses, IETF RFC 8684, (March 2020), De Coninck et al., Multipath Extensions for QUIC (MP-QUIC), IETF DRAFT-DECONINCK-QUIC-MULTIPATH-07, IETA, QUIC Working Group (3 May 2021), Zhu et al., User-Plane Protocols for Multiple Access Management Service, IETF DRAFT-ZHU-INTAREA-MAMS-USER-PROTOCOL-09, IETA, INTAREA (4 Mar. 2020), and Zhu et al., Generic Multi-Access (GMA) Convergence Encapsulation Protocols, IETF DRAFT-ZHU-INTAREA-GMA-14, IETA, INTAREA/Network Working Group (24 Nov. 2021) (collectively referred to as “[MAMS]”), the contents of each of which are hereby incorporated by reference in their entireties. In these implementations, an edge compute node and/or one or more cloud computing nodes/clusters may be one or more MAMS servers that includes or operates a Network Connection Manager (NCM) for downstream/DL traffic, and the client include or operate a Client Connection Manager (CCM) for upstream/UL traffic. An NCM is a functional entity that handles MAMS control messages from clients (e.g., a client that configures the distribution of data packets over available access paths and (core) network paths, and manages user-plane treatment (e.g., tunneling, encryption, and/or the like) of the traffic flows (see e.g., [MAMS]). The CCM is the peer functional element in a client (e.g., a client that handles MAMS control-plane procedures, exchanges MAMS signaling messages with the NCM, and configures the network paths at the client for the transport of user data (e.g., network packets, and/or the like) (see e.g., [MAMS]).

It should be understood that the aforementioned edge computing frameworks and services deployment examples are only one illustrative example of edge computing systems/networks 735, and that the present disclosure may be applicable to many other edge computing/networking technologies in various combinations and layouts of devices located at the edge of a network including the various edge computing networks/systems described herein. Further, the techniques disclosed herein may relate to other IoT edge network systems and configurations, and other intermediate processing entities and architectures may also be applicable to the present disclosure.

It should be understood that the aforementioned edge computing frameworks/ECTs and services deployment examples are only illustrative examples of ECTs, and that the present disclosure may be applicable to many other or additional edge computing/networking technologies in various combinations and layouts of devices located at the edge of a network including the various edge computing networks/systems described herein. Further, the techniques disclosed herein may relate to other IoT edge network systems and configurations, and other intermediate processing entities and architectures may also be applicable to the present disclosure.

FIG. 8 illustrates an example Open RAN (O-RAN) system architecture 800. The O-RAN architecture 800 includes four O-RAN defined interfaces, namely, the A1 interface, the O1 interface, the O2 interface, and the Open FrontHaul (OF) Management (M)-plane interface, which connect the service management and orchestration framework (SMO) 802 to O-RAN network functions (NFs) 804 and the O-Cloud 806. The non-RT RIC function 812 resides in the SMO layer 802 that also handles deployment and configuration, as well as data collection of RAN observables and the like. The SMO 802 also includes functions that handle AI/ML workflow (e.g., training and update of ML models), as well as functions for deployment of ML models and other applications as described in [O-RAN.WG2.AIML]. The SMO 802 may also have access to enrichment information (e.g., data other than that available in the RAN NFs), and this enrichment information can be used to enhance the RAN guidance and optimization functions. The enrichment information may come from the data analytics based on the historical RAN data collected over O1 interface or from RAN external data sources. The SMO 802 also includes functions to optimize the RAN performance towards fulfilment of SLAs in the RAN intent. The A1 interface enables the non-RT RIC 812 to provide policy-based guidance (e.g., A1-P), ML model management (e.g., A1-ML), and enrichment information (e.g., A1-EI) to the near-RT RIC 814 so that the RAN can optimize various RANFs (e.g., RRM, and the like) under certain conditions.

The O1 interface is an interface between orchestration & management entities (e.g., Orchestration/NMS) and O-RAN managed elements, for operation and management, by which FCAPS management, software management, file management and other similar functions shall be achieved (see e.g., [O-RAN.WG1.O-RAN-Architecture-Description], [O-RAN.WG6.CADS]). The O2 interface is an interface between the SMO 802 and the O-Cloud 806 (see e.g., [O-RAN.WG1.O-RAN-Architecture-Description], [O-RAN.WG6.CADS]). The A1 interface is an interface between the non-RT RIC 812 and the near-RT RIC 814 to enable policy-driven guidance of near-RT RIC apps/functions, and support AI/ML workflows. The O-Cloud 806 can include elements such as, for example, virtual network functions (VNF), cloud network functions (CNF), physical network functions (PNF), and/or the like. Additionally, the O-Cloud 806 includes an O-Cloud notification interface, which is available for the relevant O-RAN NFs 804 (e.g., near-RT RIC 814 and/or the O-CU-CP 921, O-CU-UP 922, and O-DU 915 of FIG. 9) to receive O-Cloud 806 related notifications (see e.g., [O-RAN.WG6.O-Cloud Notification API]).

The SMO 802 (see e.g., [O-RAN.WG1.O1-Interface.0]) also connects with an external system 810, which provides enrichment data to the SMO 802. FIG. 8 also illustrates that the A1 interface terminates at an O-RAN Non-Real Time (RT) RAN Intelligent Controller (RIC) 812 in or at the SMO 802 and at the O-RAN Near-RT RIC 814 in or at the O-RAN NFs 804. The O-RAN NFs 804 can be VNFs such as VMs or containers, sitting above the O-Cloud 806 and/or Physical Network Functions (PNFs) utilizing customized hardware. All O-RAN NFs 804 are expected to support the O1 interface when interfacing the SMO 802. The O-RAN NFs 804 connect to the NG-Core 808 via the NG interface (which is a 3GPP defined interface).

The OF management plane (M-plane) interface between the SMO 802 and the O-RAN Radio Unit (O-RU) 816 supports the O-RU 816 management in the O-RAN hybrid model as specified in [O-RAN.WG4.MP.0]. The OF M-plane interface is an optional interface to the SMO 802 that is included for backward compatibility purposes as per [O-RAN.WG4.MP.0], and is intended for management of the O-RU 816 in hybrid mode only. The management architecture of flat mode (see e.g., [O-RAN.WG1.OAM-Architecture], [O-RAN.WG10.OAM-Architecture]) and its relation to the O1 interface for the O-RU 816 is for future study. The O-RU 816 termination of the O1 interface towards the SMO 802 as specified in [O-RAN.WG1.OAM-Architecture] (see also, e.g., [O-RAN.WG10.OAM-Architecture]).

FIG. 9 illustrates a logical architecture 900 of the O-RAN system architecture 800 of FIG. 8. In FIG. 9, the SMO 902 corresponds to the SMO 802, O-Cloud 906 corresponds to the O-Cloud 806, the non-RT RIC 912 corresponds to the non-RT RIC 812, the near-RT RIC 914 corresponds to the near-RT RIC 814, and the O-RU 916 corresponds to the O-RU 816 of FIG. 9, respectively. The O-RAN logical architecture 900 includes a radio portion and a management portion.

The management side of the architecture 900 includes the SMO 902 containing the non-RT RIC 912, and may include the O-Cloud 906. The O-Cloud 906 is a cloud computing platform including a collection of physical infrastructure nodes to host relevant O-RAN functions (e.g., the near-RT RIC 914, O-CU-CP 921, O-CU-UP 922, the O-DU 915, and the like), supporting software components (e.g., OSs, VMMs, container runtime engines, ML engines, and/or the like), and appropriate management and orchestration functions. The radio side of the logical architecture 900 includes the near-RT RIC 914, the O-RAN Distributed Unit (O-DU) 915, the O-RU 916, the O-RAN Central Unit-Control Plane (O-CU-CP) 921, and the O-RAN Central Unit-User Plane (O-CU-UP) 922 functions. The radio portion/side of the logical architecture 900 may also include the O-e/gNB 910. The O-eNB supports O-DU and O-RU functions with an OF interface between them.

The O-DU 915 is a logical node hosting RLC, MAC, and higher PHY layer entities/elements (High-PHY layers) based on a lower layer functional split. The O-RU 916 is a logical node hosting lower PHY layer entities/elements (Low-PHY layer) (e.g., FFT/iFFT, PRACH extraction, and/or the like) and RF processing elements based on a lower layer functional split. Virtualization of O-RU 916 is FFS. The O-CU-CP 921 is a logical node hosting the RRC and the control plane (CP) part of the PDCP protocol. The O-CU-UP 922 is a logical node hosting the user plane part of the PDCP protocol and the SDAP protocol.

An E2 interface terminates at a plurality of E2 nodes. The E2 interface connects the near-RT RIC 914 and one or more O-CU-CPs 921, one or more O-CU-UP 922, one or more O-DU 915, and one or more O-e/gNB 910. The E2 nodes are logical nodes/entities that terminate the E2 interface. As examples, the E2 nodes can include: for NR/5G access, O-CU-CP 921, O-CU-UP 922, O-DU 915, or any combination of elements as defined in [O-RAN.WG3.E2GAP]; and for E-UTRA access, the E2 nodes include the O-e/gNB 910. As shown in FIG. 9, the E2 interface also connects the O-e/gNB 910 to the Near-RT RIC 914. The protocols over E2 interface are based exclusively on control plane (CP) protocols. The E2 functions are grouped into the following categories: (a) near-RT RIC 914 services (REPORT, INSERT, CONTROL and POLICY, as described in [O-RAN.WG3.E2GAP]); and (b) near-RT RIC 914 support functions, which include E2 Interface Management (e.g., E2 Setup, E2 Reset, Reporting of General Error Situations, and/or the like) and Near-RT RIC service update (e.g., capability exchange related to the list of E2 node functions exposed over E2). A RIC service is a service provided by or on an E2 node to provide access to messages and measurements and/or enable control of the E2 node from the near-RT RIC 914.

FIG. 9 shows the Uu interface between a UE 901 and O-e/gNB 910 as well as between the UE 901 and O-RAN components. The Uu interface is a 3GPP defined interface (see e.g., sections 5.2 and 5.3 of 3GPP TS 38.401 v17.2.0 (2022 Sep. 23) (“[TS38401]”)), which includes a complete protocol stack from L1 to L3 and terminates in the NG-RAN or E-UTRAN. The O-e/gNB 910 is an LTE eNB (see e.g., 3GPP TS 36.401 v17.1.0 (2022 Jun. 23) (“[TS36401]”)) or a 5G gNB or ng-eNB (see e.g., [TS38300]) that supports the E2 interface.

The O-e/gNB 910 may be the same or similar as NANs 731-733, and UE 901 may be the same or similar as any of UEs 721, 711 discussed w.r.t FIG. 7, and/or the like. There may be multiple UEs 901 and/or multiple O-e/gNB 910, each of which may be connected to one another the via respective Uu interfaces. Although not shown in FIG. 9, the O-e/gNB 910 supports O-DU 915 and O-RU 916 functions with an OF interface between them.

The OF interface(s) is/are between O-DU 915 and O-RU 916 functions (see e.g., [O-RAN.WG4.MP.0], [O-RAN-WG4.CUS.0]). The OF interface(s) includes the Control User Synchronization (CUS) Plane and Management (M) Plane. FIGS. 8 and 9 also show that the O-RU 916 terminates the OF M-Plane interface towards the O-DU 915 and optionally towards the SMO 902 as specified in [O-RAN.WG4.MP.0]. The O-RU 916 terminates the OF CUS-Plane interface towards the O-DU 915 and the SMO 902.

The F1 control plane interface (F1-C) connects the O-CU-CP 921 with the O-DU 915. As defined by 3GPP, the F1-C is between the gNB-CU-CP and gNB-DU nodes (see e.g., [TS38401]), 3GPP TS 38.470 v17.2.0 (2022 Sep. 23) (“[TS38470]”). However, for purposes of O-RAN, the F1-C is adopted between the O-CU-CP 921 with the O-DU 915 functions while reusing the principles and protocol stack defined by 3GPP and the definition of interoperability profile specifications.

The F1 user plane interface (F1-U) connects the O-CU-UP 922 with the O-DU 915. As defined by 3GPP, the F1-U is between the gNB-CU-UP and gNB-DU nodes [TS38401], [TS38470]. However, for purposes of O-RAN, the F1-U is adopted between the O-CU-UP 922 with the O-DU 915 functions while reusing the principles and protocol stack defined by 3GPP and the definition of interoperability profile specifications.

The NG-C interface is defined by 3GPP as an interface between the gNB-CU-CP and the AMF in the 5GC, and the NG-C is also referred as the N2 interface (see e.g., [TS38300]). The NG-U interface is defined by 3GPP, as an interface between the gNB-CU-UP and the UPF in the 5GC, and the NG-u interface is referred as the N3 interface (see e.g., [TS38300]). In O-RAN, NG-C and NG-U protocol stacks defined by 3GPP are reused and may be adapted for O-RAN purposes.

The X2-C interface is defined in 3GPP for transmitting control plane information between eNBs or between eNB and en-gNB in EN-DC. The X2-U interface is defined in 3GPP for transmitting user plane information between eNBs or between eNB and en-gNB in EN-DC (see e.g., 3GPP TS 36.420 v17.0.0 (2022 Apr. 6), [TS38300], [TS36300]). In O-RAN, X2-c and X2-u protocol stacks defined by 3GPP are reused and may be adapted for O-RAN purposes

The Xn-c interface is defined in 3GPP for transmitting control plane information between gNBs, ng-eNBs, or between an ng-eNB and gNB. The Xn-u interface is defined in 3GPP for transmitting user plane information between gNBs, ng-eNBs, or between ng-eNB and gNB (see e.g., 3GPP TS 38.420 v17.2.0 (2022 Sep. 23), [TS38300]). In O-RAN, Xn-C and Xn-U protocol stacks defined by 3GPP are reused and may be adapted for O-RAN purposes

The E1 interface is defined by 3GPP as being an interface between the gNB-CU-CP (e.g., gNB-CU-CP 3728) and gNB-CU-UP (see e.g., [TS38300], 3GPP TS 38.460 v17.0.0 (2022 Apr. 6)). In O-RAN, E1 protocol stacks defined by 3GPP are reused and adapted as being an interface between the O-CU-CP 921 and the O-CU-UP 922 functions.

The O-RAN Non-Real Time (RT) RAN Intelligent Controller (RIC) 912 is a logical function within the SMO 802, 902 that enables non-real-time control and optimization of RAN elements and resources; AI/machine learning (ML) workflow(s) including model training, inferences, and updates; and policy-based guidance of applications/features in the Near-RT RIC 914. The O-RAN near-RT RIC 914 enables near-real-time control and optimization of RAN elements and resources via fine-grained data collection and actions over the E2 interface. The near-RT RIC 914 may include one or more AI/ML workflows including model training, inferences, and updates.

The non-RT RIC 912 can include and/or operate one or more non-RT RIC applications (rApps) 911. The rApps 911 are modular apps that leverage functionality exposed via the non-RT RIC framework's R1 interface to provide added value services relative to RAN operation, such as driving the A1 interface, recommending values and actions that may be subsequently applied over the O1/O2 interface(s), and generating “enrichment information” for the use of other rApps 911. The rApp 911 functionality within the non-RT RIC 912 enables non-RT control and optimization of RAN elements (or RANFs) and resources and policy-based guidance to the applications/features in the near-RT RIC 914. The non-RT RIC framework refers to functionality internal to the SMO 902 that logically terminates the A1 interface to the near-RT RIC 914 and exposes the set of internal SMO services needed for their runtime processing to rApps 911 via its R1 interface. The non-RT RIC framework functionality within the non-RT RIC 912 provides AI/ML workflow(s) including model training, inference, and updates needed for rApps 911.

The non-RT RIC 912 can be an ML training host to host the training of one or more ML models. ML training can be performed offline using data collected from the RIC, O-DU 915 and O-RU 916. For supervised learning, non-RT RIC 912 is part of the SMO 902, and the ML training host and/or ML model host/actor can be part of the non-RT RIC 912 and/or the near-RT RIC 914. For unsupervised learning, the ML training host and ML model host/actor can be part of the non-RT RIC 912 and/or the near-RT RIC 914. For reinforcement learning (see e.g., FIG. 19), the ML training host and ML model host/actor may be co-located as part of the non-RT RIC 912 and/or the near-RT RIC 914. In some implementations, the non-RT RIC 912 may request or trigger ML model training in the training hosts regardless of where the model is deployed and executed. ML models may be trained and not currently deployed.

In some implementations, the non-RT RIC 912 provides a query-able catalog for an ML designer/developer to publish/install trained ML models (e.g., executable software components). In these implementations, the non-RT RIC 912 may provide discovery mechanism if a particular ML model can be executed in a target ML inference host (MF), and what number and type of ML models can be executed in the MF. For example, there may be three types of ML catalogs made discoverable by the non-RT RIC 912: a design-time catalog (e.g., residing outside the non-RT RIC 912 and hosted by some other ML platform(s)), a training/deployment-time catalog (e.g., residing inside the non-RT RIC 912), and a run-time catalog (e.g., residing inside the non-RT RIC 912). The non-RT RIC 912 supports necessary capabilities for ML model inference in support of ML assisted solutions running in the non-RT RIC 912 or some other ML inference host. These capabilities enable executable software to be installed such as VMs, containers, and/or the like. The non-RT RIC 912 may also include and/or operate one or more AI/ML engines, which are packaged software executable libraries that provide methods, routines, data types, and/or the like, used to run ML models. The non-RT RIC 912 may also implement policies to switch and activate AI/ML model instances under different operating conditions.

The non-RT RIC 912 is be able to access feedback data (e.g., FM and PM statistics) over the O1 interface on ML model performance and perform necessary evaluations. If the ML model fails during runtime, an alarm can be generated as feedback to the non-RT RIC 912. How well the ML model is performing in terms of prediction accuracy or other operating statistics it produces can also be sent to the non-RT RIC 912 over O1. The non-RT RIC 912 can also scale ML model instances running in a target MF over the O1 interface by observing resource utilization in MF. The environment where the ML model instance is running (e.g., the MF) monitors resource utilization of the running ML model. This can be done, for example, using an ORAN-SC component called ResourceMonitor in the near-RT RIC 914 and/or in the non-RT RIC 912, which continuously monitors resource utilization. If resources are low or fall below a certain threshold, the runtime environment in the near-RT RIC 914 and/or the non-RT RIC 912 provides a scaling mechanism to add more ML instances. The scaling mechanism may include a scaling factor such as an number, percentage, and/or other like data used to scale up/down the number of ML instances. ML model instances running in the target ML inference hosts may be automatically scaled by observing resource utilization in the MF. For example, the Kubernetes® (K8s) runtime environment typically provides an auto-scaling feature.

The A1 interface is between the non-RT RIC 912 (within or outside the SMO 902) and the near-RT RIC 914. The A1 interface supports three types of services as defined in [O-RAN.WG2.A1GAP], including an A1 policy management service (“A1-P”), an A1 enrichment information service (“A1-EI”), and an A1 ML model management service (“A1-ML”). A1 policies have the following characteristics compared to persistent configuration (see e.g., [O-RAN.WG2.A1GAP]): A1 policies are not critical to traffic; A1 policies have temporary validity; A1 policies may handle individual UE or dynamically defined groups of UEs; A1 policies act within and take precedence over the configuration; and A1 policies are non-persistent (e.g., do not survive a restart of the near-RT RIC).

The O-RAN architecture 900 supports various control loops including at least the following control loops involving different O-RAN functions: non-RT control loops 932, near-RT control loops 934, and real-time (RT) control loops 935. The control loops 932, 934, 935 are defined based on the controlling entity and the architecture shows the other logical nodes with which the control loop host interacts. Control loops 932, 934, 935 exist at various levels and run simultaneously. Depending on the use case, the control loops 932, 934, 935 may or may not interact with each other. Examples of the use cases for the non-RT control loop 932 and near-RT control loop 934 and the interaction between the RICs for these use cases are defined by the O-RAN use cases analysis report (see e.g., [O-RAN.WG1.Use-Cases]). This use case report also defines relevant interaction for the O-CU-CP control loops (not shown) and O-DU control loops 935, responsible for call control and mobility, radio scheduling, HARQ, beamforming, and the like, along with relatively slower mechanisms involving SMO management interfaces. The timing of these control loops is use case dependent. Typical execution time for use cases involving the non-RT control loops 932 are Is or more; near-RT control loops 934 are in the order of 10 ms or more; control loops in the E2 nodes (e.g., control loop 935) can operate below 10 ms. (e.g., O-DU radio scheduling and/or the like). For any specific use case, however, a stable solution may involve the loop time in the non-RT RIC 912 and/or SMO 902 management plane processes to be significantly longer than the loop time for the same use case in the control entities.

Furthermore, AI/ML related functionalities can be mapped into the control loops 932, 934, 935. The location of the ML model training and the ML model inference for a use case depends on the computation complexity, on the availability and the quantity of data to be exchanged, on the response time requirements and on the type of ML model. For example, online ML model for configuring RRM algorithms operating at the TTI timescale could run in O-DU 915, while the configuration of system parameters such as beamforming configurations requiring a large amount of data with no response time constraints can be performed using the combination of the non-RT RIC 912 and SMO 902 where intensive computation means can be made available. In some examples, ML model training can be performed by the non-RT RIC 912 and/or the near-RT RIC 914, and the trained ML models can be operated to generate predictions/inferences in control loops 932, 934, and/or 935. The (trained) ML model runs in the near-RT RIC 914 for control loop 934, and the (trained) ML model runs in the O-DU 915 for control loop 935. In some implementations, ML models could be run in the O-RU 916.

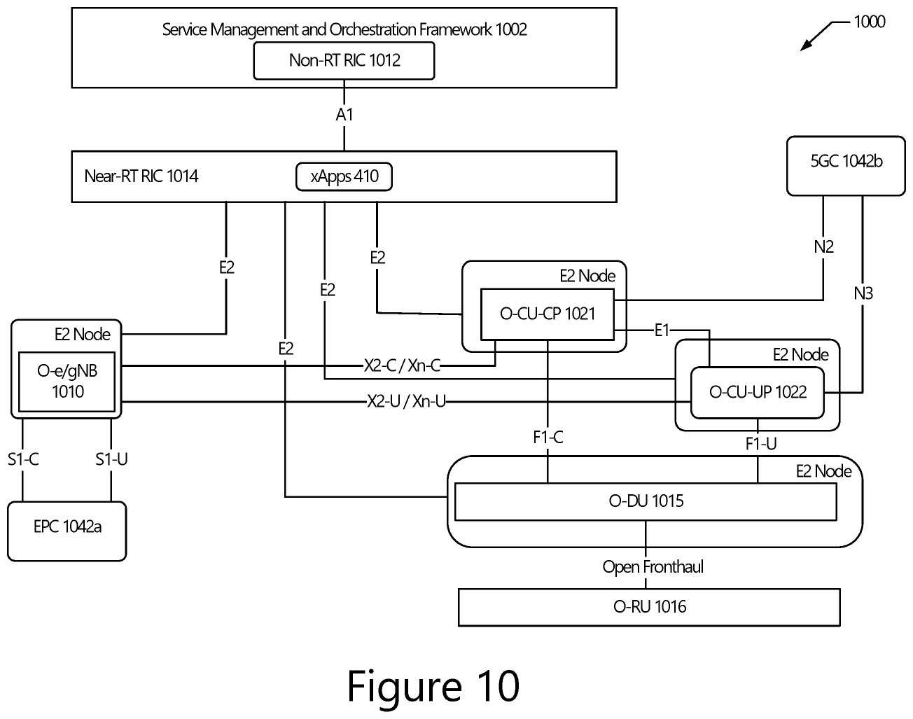

FIG. 10 illustrates an example O-RAN Architecture 1000 including Near-RT RIC interfaces. The Near-RT RIC 1014 is connected to the Non-RT RIC 1012 through the A1 interface (see e.g., [O-RAN.WG2.A1GAP]). The Near-RT RIC 1014 is a logical network node placed between the E2 nodes and the SMO 1002, which hosts the Non-RT RIC 1012. The Near-RT RIC 1014 may be the same or similar as the near-RT RIC 814 and near-RT RIC 914 of FIGS. 8 and 9, and the Non-RT RIC 1012 may be the same or similar as the Non-RT RIC 812 and/or the Non-RT RIC 912 of FIGS. 8 and 9. The SMO 1002 may be the same or similar to the SMO 802 and/or the SMO 902 of FIGS. 8 and 9. In some implementations, a near-RT RIC 1014 is connected to only one non-RT RIC 1012.

As mentioned previously, E2 is a logical interface connecting the Near-RT RIC 1014 with an E2 node. The Near-RT RIC 1014 is connected to the O-CU-CP 1021, the near-RT RIC 1014 is connected to the O-CU-UP 1022, the near-RT RIC 1014 is connected to the O-DU 1015, and the near-RT RIC 1014 is connected to the O-e/gNB 1010. The O-DU 1015 is connected to the O-RU 1016. The O-CU-CP 1021, the O-CU-UP 1022, the O-DU 1015, and the O-e/gNB 1010 may be the same or similar to the O-CU-CP 921, the O-DU 915, and the O-e/gNB 910 of FIG. 9. The O-RU 1016 may be the same or similar to the O-RU 816 and/or the O-RU 916 of FIGS. 8 and 9.

In some implementations, an E2 node is connected to only one near-RT RIC 1014. Additionally or alternatively, a near-RT RIC 1014 can be connected to multiple E2 nodes (e.g., multiple O-CU-CPs 1021, O-CU-UPs 1022, O-DUs 1015, and O-e/gNBs 1010). F1 (e.g., F1 control plane (F1-C) and F1 user plane (F1-U)) and E1 are logical 3GPP interfaces, whose protocols, termination points and cardinalities are specified in [TS38401]. In addition, the Near-RT RIC 1014 and other RAN nodes have O1 interfaces as defined in [O-RAN.WG1.OAM-Architecture], [O-RAN.WG1.O-RAN-Architecture-Description], and [O-RAN.WG10.OAM-Architecture]. Additionally, the O-CU-CP 1021 is connected to the 5G Core Network (5GC) 1042b via an N2 interface, the O-CU-UP 1022 is connected to the 5GC 1042b via an N3 interface, and the O-gNBs 1010 is connected to the O-CU-CP 1021 via an Xn control plane interface (Xn-C), and is connected to the O-CU-UP 1022 via an Xn user plane interface (Xn-U); these interfaces are defined in [TS23501], [TS38300], and other 3GPP standards. Furthermore, the O-eNBs 1010 are connected to an Evolved Packet Core (EPC) 1042a via S1 control place (S1-C) and S1 user plane (S1-U) interfaces, and the O-eNBs 1010 is connected to the O-CU-CP 1021 via an X2 control plane interface (X2-C) and/or an Xn control plane interface (Xn-C), and is connected to the O-CU-UP 1022 via an X2 user plane interface (X2-U) and/or an Xn user plane interface (Xn-U); these interfaces are discussed in 3GPP TS 36.300 v17.2.0 (2022 Sep. 30) (“[TS36300]”) and/or other other 3GPP standards.

The near-RT RIC 1014 hosts one or more xApps 410 (sometimes referred to as “near-RT RIC apps” or the like) that use the E2 interface to collect near real-time information (e.g., UE basis, cell basis, and the like) and provide value added services. The near-RT RIC 1014 may receive declarative policies and obtain data enrichment information over the A1 interface (see e.g., [O-RAN.WG2.A1GAP]). The protocols over E2 interface are based on control plane protocols and are defined in [O-RAN.WG3.E2AP]. On E2 or near-RT RIC 1014 failure, the E2 node will be able to provide services but there may be an outage for certain value-added services that may only be provided using the near-RT RIC 1014.

The near-RT RIC 1014 provides a database function (e.g., DB 1216 of FIG. 12) that stores the configurations relating to E2 nodes, cells, bearers, flows, UEs, and the mappings between them. The near-RT RIC 1014 provides ML tools that support data pipelining (e.g., AI/ML support function 1236 of FIG. 12). The near-RT RIC 1014 also provides a messaging infrastructure 1235; security functions 1234; conflict management functions security functions 1231 to resolve potential conflicts and/or overlaps that may be caused by the requests from xApps 410; as well as functionality for logging, tracing, and metrics collection from the near-RT RIC 1014 framework and xApps 410 to the SMO 1002. The near-RT RIC 1014 also provides an open API enabling the hosting of 3rd party xApps 410 and xApps 410 from the near-RT RIC 1014 platform vendor (e.g., API enablement function 1238). The near-RT RIC 1014 also provides an open API decoupled from specific implementation solutions, including a Shared Data Layer (SDL) 1217 that works as an overlay for underlying databases and enables simplified data access.

An xApp 410 is an app designed to run on the near-RT RIC 1014. Such an app is likely to include or provide one or more services and/or microservices, and at the point of on-boarding identifies data it consumes and which data it provides. An xApp 410 is independent of the near-RT RIC 1014 and may be provided by any third party. The E2 enables a direct association between an xApp 410 and the RAN functionality. At least in some examples, a RANF is a specific function in an E2 node and/or a function that performs some RAN-related functions, operations, tasks, workloads, and the like. Examples of RANFs include termination of network interfaces (e.g., X2, F1, S1, Xn, NG and/or NGc, E1, A1, O1, and/or the like); RAN internal functions (e.g., paging function, multicast group paging function, UE context management function, mobility management function, PDU session management function, non-access stratum (NAS) transport function, NAS node selection function, network interface management function, warning message transmission function, configuration transfer function, trace function, AMF management function, AMF load function, AMF re-allocation function, AMF CP relocation indication function, TNL association support function, location reporting function, UE radio capability function, NRPPa signaling transport function, overload control function, remote interference management (RIM) information transfer function, UE information retrieval function, RAN CP relocation indication function, suspend-resume function, connection establishment function, NR MBS session management function, QMC support function, functions related to individual RAN protocol stack layers; E2SM-KPM, E2SM-CCC, E2SM RAN control, E2SM-NI, and/or the like such as those discussed in [TS38410].

The architecture of an xApp 410 comprises code implementing the xApp's 410 logic and the RIC libraries that allow the xApp 410 to, for example, send and receive messages; read from, write to, and obtain/get notifications from the SDL layer 1217; and write log messages (e.g., to the xApp 410 itself, other xApps 410, DB 1216, the non-RT RIC 1012, and/or the like). Additional libraries will be available in future versions including libraries for setting and resetting alarms and sending statistics. Furthermore, xApps 410 can use access libraries to access specific name-spaces in the SDL layer. For example, the R-NIB that provides information about which E2 nodes (e.g., CU, DU, RU) the RIC is connected to and which SMs are supported by each E2 node, can be read by using the R-NIB access library.

The O-RAN standard interfaces (e.g., O1, A1, E2, and so forth) may be exposed to the xApps 410 as follows: first, an xApp 410 receives its configuration via a configuration (e.g., K8s ConfigMap). The configuration can be updated while the xApp 410 is running and the xApp 410 can be notified of this modification by using the inotify( ) method/function. Next, the xApp 410 can send statistics (e.g., PM) either by sending it directly to VES collector in VES format, and/or by exposing statistics via a REST interface for Prometheus to collect. Then, the xApp 410 receives A1 policy guidance via a RIC Message Router (RMR) message of a specific kind (e.g., policy instance creation and deletion operations). The RMR is a thin library that allows apps (e.g., xApps 410, rApps 911, and/or the like) to send messages to other apps (e.g., xApps 410, rApps 911, and/or the like). RMR provides insulation from the actual message transport system (e.g., Nanomsg, NNG, or the like), as well as providing endpoint selection based on message type. Next, the xApp 410 can subscribe to E2 events by constructing an E2 subscription ASN.1 payload and sending it as a message (RMR). The xApp 410 receives E2 messages (e.g., E2 INDICATION) as RMR messages with the ASN.1 payload. Additionally or alternatively, the xApp 410 can issue E2 control messages.

In addition to A1 and E2 related messages, xApps 410 can send messages that are processes by other xApps 410 and can receive messages produced by other xApps 410 via a messaging infrastructure 1235 and/or service bus 435. Communication inside the RIC is policy driven, that is, an xApp 410 cannot specify the target of a message; instead, an xApp 410 simply sends a message of a specific type and the routing policies specified for the RIC instance will determine to which destinations this message will be delivered (e.g., logical pub/sub).

Some xApps 410 may enhance the RRM capabilities of the near-RT RIC 1014. Some xApps 410 provide logging, tracing and metrics collection to the near-RT RIC 1014. In addition to these basic requirements, an xApp 410 may do any of the following: read initial configuration parameters (passed in the xApp descriptor); receive updated configuration parameters; send and receive messages; read and write into a persistent shared data storage (key-value store); receive A1-P policy guidance messages (e.g., specifically operations to create or delete a policy instance (JSON payload on an RMR message)) related to a given policy type; define a new A1 policy type; make subscriptions via E2 interface to the RAN, receive E2 INDICATION messages from the RAN, and issue E2 POLICY and CONTROL messages to the RAN; and report metrics related to its own execution or observed RAN events.

The lifecycle of xApp 410 development and deployment consists of the following states: development (e.g., design, implementation, local testing) and released (e.g., the xApp code and xApp descriptor are committed to an LF Gerrit repo and included in an O-RAN release). The xApp 410 is packaged as a container image (e.g., Docker® container and its image released to LF Release registry); on-boarded/distributed (e.g., the xApp descriptor (and potentially helm chart) is customized for a given RIC environment and the resulting customized helm chart is stored in a local helm chart repo used by the RIC environment's xApp manager); and/or run-time parameters configuration (e.g., before the xApp 410 can be deployed, run-time helm chart parameters will be provided by the operator to customized the xApp Kubernetes® deployment instance). This procedure is mainly used to configure run-time unique helm chart parameters such as instance UUID, liveness check, east-bound and north-bound service endpoints (e.g., DBAAS entry, VES collector endpoint) and so on); and deployed (e.g., the xApp 410 has been deployed via the xApp manager and the xApp pod is running on a RIC instance). For xApps 410, the deployed status may be further divided into additional states controlled via xApp configuration updates (e.g., running, stopped, terminated, and/or the like).

The general principles guiding the definition of the near-RT RIC architecture as well as the interfaces between the near-RT RIC 1014, E2 nodes 1250, and SMO 1002 can include the following: the near-RT RIC 1014 and E2 node functions are fully separated from transport functions; addressing scheme used in the near-RT RIC 1014 and the E2 nodes are not tied to the addressing schemes of transport functions; the E2 nodes support all protocol layers and interfaces defined within 3GPP RANs (e.g., eNB for E-UTRAN and gNB/ng-eNB for NG-RAN). The near-RT RIC 1014 and hosted xApp(s) 410 use a set of services exposed by an E2 node that is/are described by a series of RANFs and/or Radio Access Technology (RAT) dependent E2SMs. Additionally, the near-RT RIC 1014 interfaces are defined along the following principles: the functional division across the interfaces have as few options as possible; interfaces are based on a logical model of the entity controlled through this interface; and one physical network element can implement multiple logical nodes.

Logically, an xApp 410 is an entity that implements a well-defined function. Mechanically, an xApp 410 is cluster or pod (e.g., a K8s pod) that includes one or multiple containers. Each xApp 410 includes an xApp descriptor and xApp image. The xApp image is the software package that contains all the files needed to deploy an xApp 410. Additionally or alternatively, the xApp image can include information the RIC platform needs to configure the RIC platform for the xApp 410. An xApp 410 can have multiple versions of an xApp image, which are tagged by the xApp image version number.

The xApp descriptor describes the xApp's 410 configuration parameters, and may be in any suitable formate (e.g., JSON, XML, and/or the like). The xApp developer also provides a schema for the xApp descriptor. The xApp descriptor describes the packaging format of the corresponding xApp image. The xApp descriptor also provides the necessary data to enable management and orchestration. The xApp descriptor provides xApp management services with necessary information for the LCM of the xApp 410, such as deployment, deletion, upgrade and/or the like. The xApp descriptor also provides extra parameters related to the health management of the xApp 410, such as auto scaling when the load of the xApp 410 is too heavy and auto healing when the xApp 410 becomes unhealthy. The xApp descriptor can also provide FCAPS and control parameters to xApps 410 when the xApp 410 is launched. In some implementations, the definition of an xApp descriptor includes one or more of: xApp basic information, FCAPS management specifications, and control specifications. The basic information of xApp (e.g., name, version, provider, and/or the like), URL of a corresponding xApp image, virtual resource requirements (e.g., HW, SW, and/or NW resource requirements), and/or the like. The basic information of the xApp 410 is used to support LCM of xApps and can include or indicate configuration data, metrics, and control data about the xApp 410. The FCAPS management specifications specify the options of configuration, performance metrics collection, and/or the other parameters for the xApp 410. The control specifications specify the data types consumed and provided by the xApp 410 for control capabilities (e.g., performance management (PM) data that the xApp 410 subscribes, the message type of control messages, and so forth).

Additionally or alternatively, the xApp descriptor components include xApp configuration, xApp controls specification, and xApp metrics. The xApp configuration specification includes a data dictionary for the configuration data (e.g., metadata such as a yang definition or a list of configuration parameters and their semantics). Additionally, the xApp configuration may include an initial configuration of the xApp 410. The xApp controls specification includes the types of data it consumes and provides that enable control capabilities (e.g., xApp URL, parameters, input/output type, and the like). The xApp metrics specification shall include a list of metrics (e.g., metric name, type, unit and semantics) provided by the xApp 410.

FIG. 11 depicts an example O-RAN xApp architecture 1100 for adding and operating xApps 1110. The xApp architecture 1100 provides an xApp framework 1102 for 3rd parties to add xApps 1110 to NAN products, which can be assembled from components from different suppliers. In FIG. 11, the O-RAN architecture 1100 includes a RIC platform 1101 on top of infrastructure 1103. The RIC platform 1101 includes a RIC xApp framework 1102, a Radio-Network Information Base (R-NIB) database (DB) 1116, an xApp UE Network Information Base (UE-NIB) DB 1117, a metrics agent 1118 (e.g., a VNF Event Stream (VES) agent, VES Prometheus Adapter (VESPA), and/or the like), a routing manager 1119 (e.g., Prometheus event monitoring and alerting system, and/or the like), a logger/tracer 1120 (e.g., OpenTracing, and/or the like), a resource manager 1121, an E2 termination function 1122, an xApp configuration manager 1123, an A1 xApp mediator 1124, an O1 mediator 1125, a subscription manager 1126, an E2 manager 1127, and API gateway (GW) 1128 (e.g., Kong and/or the like), and a REST function 1129. The xApp configuration manager 1123 communicates with an image repository 1130 and a Helm charts repository 1131 using, for example, REST APIs and/or some other APIs, WS, or other communication mechanisms (such as any of those discussed herein).

The near-RT RIC 1101 and some xApps 1110 may generate or access or access UE-related information to be stored in the UE-NIB 1117. The UE-NIB 1117 maintains a list of UEs and associated data, and maintains tracking and correlation of the UE identities associated with the connected E2 nodes 1150. The near-RT RIC 1101 and some xApps 1110 may generate or access network related information to be stored in the R-NIB 1116. The R-NIB 1116 stores the configurations and near real-time information relating to connected E2 Nodes and the mappings between them.

The RIC xApp framework 1102 includes a messaging library (lib.) 1111, an ASN.1 module 1112, one or more exporters 1113 (e.g., Prometheus exporters and/or the like), a trace and log element 1114, and a shared library with R-NIB APIs 1115, and/or the like. The RIC platform 1101 communicates with a management platform 1140 over the O1 interface and/or the A1 interface, and also communicates with a RAN and/or E2 nodes 1150 over the E2 interface. The management platform 1140 may include dashboards 1141 and/or metrics collectors 1142. Furthermore, various xApps 1110 operate on top of the RIC xApp framework 1102. The xApps 1110 can include, for example an administration control xApp 1110-a, a KPI monitor xApp 1110-b, as well as one or more other xApps 1110-1 to 1110-4, which may be developed by one or more 3^{rd} party developers, network operators, or service providers. In some examples, the xApps 1110-a, 1110-b, 1110-1 to 1110-4 (collectively referred to as “xApps 1110”) can include the collection of xApps 310, 410 (including the xApp manager 425) and 1210 of FIGS. 3, 4, 5, and 12.

FIG. 12 depicts an example Near-RT RIC internal architecture 1200, which includes a near-RT RIC 1214, an SMO 1202 (which includes a non-RT RIC 1212), and E2 nodes 1250.

The near-RT RIC 1214 includes a DB 1216 and a shared data layer (SDL) 1217. The DB 1216 may be the same or similar as the UE-NIB 1117 and/or the R-NIB 1116. The SDL 1217 is used by xApps 1210 to subscribe to DB notification services and to read, write, and modify information stored on the DB 1216. UE-NIB 1117, R-NIB 1116, and other use case specific information may be exposed using the SDL services.

The xApp subscription management function 1232 manages subscriptions from xApps 1210 to E2 nodes 1250, enforces authorization of policies controlling xApp access to messages, and enables merging of identical subscriptions from different xApps into a single subscription toward an E2 Node.

In the context of near-RT RIC 1214, conflict mitigation function 1231 addresses conflicting interactions between different xApps 1210 such as, for example, when an application (e.g., an xApp 1210) changes (or attempts to change) one or more parameters with the objective of optimizing a specific metric. Conflict mitigation 1231 is provided because objectives of one or more xApps 1210 may be chosen/configured such that they result in conflicting actions. The control target of the RRM can be, for example, a cell, a UE, a bearer, QoS flow, and/or the like. The control contents of the RRM can cover access control, bearer control, handover control, QoS control, resource assignment and so on. The control time span indicates the valid control duration which is expected by the control request.

Conflicts of control can be direct conflicts, indirect conflicts, and/or implicit conflicts. Direct conflicts are conflicts that can be observed directly by the conflict mitigation function 1231. One example of direct conflict involves two or more xApps 1210 request different settings for the very same configuration of one or more parameters of a control target. The conflict mitigation function 1231 processes the requests and decides on a resolution. Another example of direct conflict involves a new request from an xApp 1210 conflicting with the running configuration resulting from a previous request of another or the same xApp 1210. Another example of direct conflict involves total requested resources from different xApps 1210 may exceed the limitation of the RAN system (e.g., the sum of resources required by the two different xApps 1210 may be far beyond the resource limitation of the RAN system).

Indirect conflicts are conflicts that cannot be observed directly, nevertheless, some dependence among the parameters and resources that the xApps 1210 target can be observed. The conflict mitigation function 1231 may anticipate the possible conflicts and take actions to mitigate them. For instance, different xApps 1210 target different configuration parameters to optimize the same metric according to the respective objective. Even though this will not result in conflicting parameter settings, it may have uncontrollable or inadvertent system impacts. One example of such indirect conflicts can occur when the changes required by one xApp 1210 create a system impact which is equivalent to a parameter change targeted by another xApp 1210 (e.g., antenna tilts and measurement offsets are different control points, but they both impact the handover boundary).

Implicit conflicts are conflicts that cannot be observed directly, even the dependence between xApps 1210 are not obvious. For instance, different xApps 1210 may optimize different metrics and (re-)configure different parameters. Nonetheless, optimizing one metric may have implicit, unwanted, and may be adversary side effects on one of the metrics optimized by another xApp 1210 (e.g., protecting throughput metrics for GBR users may degrade non-GBR metrics or even cell throughput).

For mitigating these conflicts, the conflict mitigation component 1231 can take different approaches. For example, direct conflicts may be mitigated by pre-action coordination, wherein the xApps 1210 or the conflict mitigation component 1231 needs to make the final determination on whether any specific change is made, or in which order the changes are applied. Indirect conflicts can be resolved by post-action verification. Here, the actions are executed and the effects on the target metric are observed. Based on the observations, the system has to decide on potential corrections (e.g., rolling back one of the xApp 1210 actions). Implicit conflicts are the most difficult to mitigate since these dependencies are difficult or impossible to observe and therefore hard to model in any mitigation scheme. In some cases, it may be possible to design around such conflicts by ensuring that use cases (xApps 1210) target different parameters, thus, falling back to the previous (indirect conflict) approach, but a generic approach to managing such conflicts can be established. The individual xApp 1210 goals are defined by A1 policies, but utility metrics can be defined that incorporate the relative importance of each of the metrics targeted by the xApps 1210 as well as the importance of the optimization (use case). The conflict mitigation function 1231 may also use AI/ML approaches to conflict resolution such as, for example, reinforcement learning (see e.g., FIG. 19), to a-priori assess, for each proposed change, the likely probability of degrading a metric versus the potential improvement.

The messaging infrastructure 1235 provides low-latency message delivery service(s) between internal endpoints of the near-RT RIC 1214. The messaging infrastructure 1235 supports registration (e.g., endpoints register themselves to the messaging infrastructure), discovery (e.g., endpoints are discovered by the messaging infrastructure initially and registered to the messaging infrastructure), and deletion of endpoints (e.g., endpoints are deleted once they are not used anymore). As examples, the messaging infrastructure 1235 provides the following APIs: an API for sending messages to the messaging infrastructure 1235, and an API for receiving messages from the messaging infrastructure 1235. Additionally or alternatively, the messaging infrastructure 1235 supports multiple messaging modes such as, for example, point-to-point mode (e.g. message exchange among endpoints) and publish/subscribe mode (e.g., real-time data dispatching from E2 termination to multiple subscriber xApps 1235). Additionally or alternatively, the messaging infrastructure 1235 provides message routing, namely according to the message routing information, messages can be dispatched to different endpoints. Additionally or alternatively, the messaging infrastructure 1235 supports message robustness to avoid data loss during a messaging infrastructure outage/restart or to release resources from the messaging infrastructure once a message is outdated. Additionally or alternatively, the messaging infrastructure 1235 may be the same or similar as the service bus 435 discussed previously.

The security function 1234 is provided to prevent (or at least reduce the likelihood of) malicious xApps 1210 from abusing radio network information (e.g. exporting to unauthorized external systems) and/or control capabilities over RANFs. The security requirements of the X may be the same or similar as those discussed in 3GPP TS 33.401 v17.3.0 (2022 Sep. 22) and [TS33501], the contents of which are hereby incorporated by reference in their entireties.

The management function 1233 performs various operations and maintenance (OAM) management functions to manage aspects of the near-RT RIC 1215, which may be based on, for example, interactions with the SMO 1202. The OAM management management functions include, for example, fault, configuration, accounting, performance, file, security and other management plane services. OAM management follows O1 related management aspects defined in [O-RAN.WG10.OAM-Architecture] and/or [O-RAN.WG1.OAM-Architecture]

To support OAM management services, the near-RT RIC 1215 provides at least some of the following capabilities: fault management, configuration management, logging, tracing, and metrics collection. For fault management, the near-RT RIC 1215 provides near-RT RIC platform fault supervision management services (MnS) over the O1 interface as defined in [O-RAN.WG10.OAM-Architecture]). For configuration management, the near-RT RIC 1215 provides near-RT RIC platform provisioning MnS over the O1 interface as defined in [O-RAN.WG10.OAM-Architecture].

The logging capability is to capture information needed to operate, troubleshoot, and report on the performance of the Near-RT RIC platform 1215 and its constituent components. Log records may be viewed and consumed directly by users and systems, indexed and loaded into a data storage, and used to compute metrics and generate reports. The near-RT RIC 1215 components may log events according to a common logging format. Additionally, different logs can be generated (e.g., audit log, metrics log, error log and debug log). The tracing capability includes tracing mechanisms used to monitor transactions and/or workflows. An example subscription workflow can be broken into two traces namely, a subscription request trace followed by a response trace. Individual traces can be analysed to understand timing latencies as the workflow traverses a particular Near-RT RIC component. The metrics collection capability includes to mechanisms to collect and report metrics. The metrics collection capability collects metrics for performance and fault management specific to each xApp logic and other internal functions are collected and published for authorized consumer (e.g., SMO 1202, xApp manager discussed previously, and/or the like).

The E2 termination 1222 terminates E2 connections (e.g., SCTP connections and/or other like connections of other access technologies and/or protocols such as any of those discussed herein) from respective E2 nodes 1250; routes messages from xApps 1210 through the E2 connections to an E2 node; decodes the payload of an incoming ASN.1 messages (or other messages) at least enough to determine message type; handles incoming E2 messages related to E2 connectivity; receives and respond to the E2 setup requests from individual E2 nodes 1250; notifies xApps 1210 of the list of RANF supported by individual E2 nodes 1250 based on information derived from the E2 setup and RIC service update procedures (see e.g., [O-RAN.WG3.E2AP]); and notifies the newly connected E2 Node of the list of accepted functions.

A1 termination 1224 provides a generic API by means of which the near-RT RIC 1214 can receive and send messages via the A1 interface (see e.g., [O-RAN.WG2.A1GAP]). These include, for example, A1 policies and enrichment information received from the non-RT RIC 1212, and/or A1 policy feedback sent towards the non-RT RIC 1212.

An implementation of O1 termination 1225 at the near-RT RIC 1214 depends on the deployment options described in [O-RAN.WG10.OAM-Architecture] such as, for example, when the near-RT RIC 1214 is modelled as a stand-alone managed element. The O1 termination 1225 communicates with the SMO 1202 via the O1 interface and exposes O1-related management services [O-RAN.WG10.O1-Interface.0] and/or [O-RAN.WG1.O1-Interface.0] from Near-RT RIC. For the following O1 MnS, the near-RT RIC 1214 is the MnS producer and the SMO 1202 is the MnS consumer: a first O1 MnS includes the O1 termination 1225 exposing provisioning management services from the near-RT RIC 1214 to O1 provisioning management service consumer; a second O1 MnS includes the O1 termination 1225 supporting translation of O1 management services to the near-RT RIC 1214 internal APIs; a third O1 termination 1225 exposes FM services to report faults and events from the near-RT RIC 1214 to O1 FM service consumer; a fourth O1 termination 1225 exposes PM services to report bulk and real-time PM data from the near-RT RIC 1214 to O1 PM service consumer(s); a fifth O1 MnS includes the O1 termination 1225 exposing file management services to download ML files, software files, and/or the like and upload log/trace files to/from file MnS consumer; and a sixth O1 MnS includes the O1 termination 1225 exposing communication surveillance services to O1 communication surveillance service consumer.

The AI/ML support function 1236 provides an AI/ML pipeline and training services for AI/ML models. The AI/ML data pipeline in the near-RT RIC 1214 offers data ingestion and preparation services for applications (e.g., xApps 1210, rApps, and/or the like). The input to the AI/ML data pipeline may include E2 node data collected over the E2 interface (e.g., measurement data 315, 415), enrichment information over A1 interface, information from applications (e.g., xApps 1210, rApps, and/or the like), data retrieved from the near-RT RIC DB 1216 through the messaging infrastructure 1235, and/or data (observability insights) retrieved from the xApp manager 425 through the messaging infrastructure 1235 (or service bus 435). Additionally or alternatively, the AI/ML pipeline may provide the various information/data to the xApp manager 425 (or an associated AI/ML model) for training. The output of the AI/ML data pipeline may be provided to the AI/ML training capability in the near-RT RIC 1214. Additionally or alternatively, the output of the AI/ML data pipeline may be provided to the xApp manager 425 for generating insights regarding HW, SW, and/or NW resource allocations as discussed previously. The AI/ML training in the near-RT RIC 1214 offers training of applications (e.g., xApps 1210, rApps, and/or the like) within or by the near-RT RIC 1214 (see e.g., [O-RAN.WG3.RICARCH] and [O-RAN.WG2.AIML]). The AI/ML training provides generic and use case-independent capabilities to AI/ML-based applications that may be useful to multiple use cases. The various AI/ML models/algorithms (before and after training) may be based on the various example AI/ML models/algorithms discussed herein such as those shown FIGS. 18 and 19.

The xApp repository function 1237 performs selection of xApps for A1 message routing based on policy type and/or operator policies; provides the policy types supported in or by the near-RT RIC 1214 to the A1 termination function 1224; and enforces xApp access control to requested A1-EI type based on operator policies. The supported policy types are based on policy types supported by the registered xApps 1210 and/or operator policies.

The API enablement (enabl.) 1238 provides near-RT RIC APIs that can be categorized based on the interaction with the near-RT RIC platform 1214, and such APIs can be related to E2-related services, A1-related services, management function 1233 services, and database 1216 services. The API enablement (enabl.) 1238 provides support for registration, discovery and consumption of the near-RT RIC 1214 APIs within the near-RT RIC 1214 scope. In particular, the API enablement 1238 services include: repository and/or registry services for the near-RT RIC APIs; services that allow discovery of registered near-RT RIC APIs; services to authenticate xApps 1210 for use of the near-RT RIC APIs; services that enable generic subscription and event notification; and means to avoid compatibility clashes between xApps 1210 and the services they access. The API enablement services 1238 can be accessed by the xApps 1210 via one or more enablement APIs. The provided enablement APIs may need to consider the level of trust related to individual xApps 1210 (e.g., 3rd party xApps 1210, RIC-owned xApps 1210, and/or the like), and as such, may provide access to the near-RT RIC platform 1214 based on permissions, authorizations, and/or the like associated with individual xApps 1210.

The near-RT RIC APIs are a collection of well-defined interfaces providing near-RT RIC platform services. These APIs need to explicitly define the possible types of information flows and data models. The near-RT RIC APIs are essential to host 3rd party xApps 1210 in an inter-operable way on different Near-RT RIC platforms. In various implementations, the near-RT RIC 1214 provides the following Near-RT RIC APIs for xApps 1210: A1 related APIs (e.g., APIs allowing to access to A1 related functionality such as A1 termination 1224); E2 related APIs (e.g., APIs allowing to access to E2 related functionality such as E2 termination 1222 and associated xApp subscription management function 1232 and the conflict mitigation function 1231); management APIs (e.g., APIs allowing to access to the management function 1233); SDL APIs (e.g., APIs allowing to access to the SDL function 1217); and enablement APIs (e.g., APIs between individual xApps 1210 and the API enablement function 1238). Additional aspects related to the near-RT RIC APIs are discussed in [O-RAN.WG3.RICARCH].

The O-RAN system/architecture/framework of FIGS. 8-12 may provide one or more E2 service models (E2SMs) (see e.g., [O-RAN.WG3.E2SM]). An E2SM is a description of the services exposed by a specific RANF within an E2 node over the E2 interface towards the Near-RT RIC 814. A given RANF offers a set of services to be exposed over the E2 (e.g., REPORT, INSERT, CONTROL, POLICY, and/or the like) using E2AP defined procedures (see e.g., [O-RAN.WG3.E2AP] § 8) and E2AP message formats and IEs (see e.g., [O-RAN.WG3.E2AP] § 9).

E2SM-KPM is for the RANF handling reporting of the cell-level performance measurements for 5G networks defined in [TS28552] and for EPC networks defined in [TS32425], and their possible adaptation of UE-level or QoS flow-level measurements. The RANF KPM is used to provide RIC service exposure of the performance measurement logical function of the E2 nodes. Based on the O-RAN deployment architecture, available measurements could be different. Figure A.1-1 in [O-RAN.WG3.E2SM-KPM] shows the target deployment architecture for E2SM-KPM. FIG. 10 shows another deployment architecture for E2SM-KPM, wherein the E2 nodes are connected to the EPC 1042a and the 5GC 1042b as discussed previously. For each logical function the E2 node(s) uses the RAN Function Definition IE to declare the list of available measurements and a set of supported RIC services (REPORT). The contents of RANF specific E2SM-KPM data fields and/or IEs are discussed in [O-RAN.WG3.E2SM-KPM].

The E2SM-KPM supports O-CU-CP 921, O-CU-UP 922, and O-DU 915 as part of NG-RAN connected to a 5GC or as part of a E-UTRAN connected to an EPC. The E2 node hosts the RANF “KPM Monitor,” which performs the following functionalities: exposure of available measurements from O-DU, O-CU-CP, and/or O-CU-UP via the RAN Function Definition IE; and periodic reporting of measurements subscribed from Near-RT RIC. The E2SM-KPM also exposes a set of services described in [O-RAN.WG3.E2SM-KPM] § 6.2. The E2SM-KPM set of services includes report services, which include: E2 node measurement; E2 node measurement for a single UE; condition-based UE-level E2 node measurement; common condition-based UE-level E2 node measurement; and E2 node measurements for multiple UEs. These services may be initiated according to periodical event(s). A KPM report is (or includes) the performance measurements for 4G LTE and 5G NR NFs. Additional aspects of the E2SM-KPM are discussed in [O-RAN.WG3.E2SM-KPM].

For the purposes of the E2SM-NI, the E2 node terminating the E2 Interface is assumed to host one or more instances of the RANF “Network Interface,” which performs the following functionalities: exposure of Network Interfaces; modification of both incoming and outgoing network interface message contents; and/or execution of policies that may result in change of network behavior. The E2SM-NI provides a set of RANF exposure services described in clause 6.2 of [ORAN-WG3.E2SM-NI] and is assumed that the same E2SM may be used to describe either a single RANF handling all network interfaces or more than one RANF with each one handling a subset of the NIs terminated on the E2 node. Additional aspects of the E2SM-NI are discussed in [ORAN-WG3.E2SM-NI].

For the purposes of the E2SM-RC, the E2 node terminating the E2 interface is assumed to host one or more instances of the RANF “RAN Control,” which performs the following functionalities: E2 REPORT services used to expose RAN control and UE context related information; E2 INSERT services used to suspend RAN control related call processes; E2 CONTROL services used to resume or initiate RAN control related call processes, modify RAN configuration and/or E2 service-related UE context information; and E2 POLICY services used to modify the behaviour of RAN control related processes. The E2SM-RC also includes a set of RANF exposure services described in [O-RAN.WG3.E2SM-RC] § 6.2, wherein a single RANF in the E2 node handles all RC-related call processes, or more than one RANF in the E2 node where each instance handles a subset of the RC-related call processes on the E2 node. Additional aspects of the E2SM-RC services are discussed in more detail in [O-RAN.WG3.E2SM-RC].

For the purposes of the E2SM-CCC, the E2 node terminating the E2 interface is assumed to host one or more instances of the RANF “Cell Configuration and Control,” which performs the following functionalities: E2 REPORT services used to expose node level and cell level configuration information; and E2 CONTROL services used to initiate control and/or configuration of node level and cell level parameters. The E2SM-CCC also includes a set of RANF exposure services described in [O-RAN.WG3.E2SM-CCC] § 6.2, wherein a single RANF in the E2 node handles all RAN CCC-related processes or more than one RANF in the E2 node where each instance handles a subset of the CCC-related processes on the E2 node. Additional aspects of the E2SM-CCC services are discussed in more detail in [O-RAN.WG3.E2SM-CCC].

### 3. Cellular Network Aspects

FIG. 13 illustrates an example network architecture 1300. The network 1300 may operate in a manner consistent with 3GPP technical specifications for LTE or 5G/NR systems. However, the examples discussed herein are not limited in this regard and the described example implementations may apply to other networks that benefit from the principles described herein, such as future 3GPP systems, or the like.

The network 1300 includes a UE 1302, which is any mobile or non-mobile computing device designed to communicate with a RAN 1304 via an over-the-air connection. The UE 1302 is communicatively coupled with the RAN 1304 by a Uu interface, which may be applicable to both LTE and NR systems. Examples of the UE 1302 include, but are not limited to, a smartphone, tablet computer, wearable computer, desktop computer, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, and/or the like. The network 1300 may include a plurality of UEs 1302 coupled directly with one another via a D2D, ProSe, PC5, and/or sidelink (SL) interface. These UEs 1302 may be M2M, D2D, MTC, IoT devices and/or vehicular systems that communicate using physical SL channels such as those discussed in [TS38300]. The UE 1302 may perform blind decoding attempts of SL channels/links.

In some examples, the UE 1302 may additionally communicate with an AP 1306 via an over-the-air (OTA) connection. The AP 1306 manages a WLAN connection, which may serve to offload some/all network traffic from the RAN 1304. The connection between the UE 1302 and the AP 1306 may be consistent with any IEEE 802.11 protocol. Additionally, the UE 1302, RAN 1304, and AP 1306 may utilize cellular-WLAN aggregation/integration (e.g., LWA/LWIP). cellular-WLAN aggregation may involve the UE 1302 being configured by the RAN 1304 to utilize both cellular radio resources and WLAN resources.

The RAN 1304 includes one or more access network nodes (ANs) 1308. The ANs 1308 terminate air-interface(s) for the UE 1302 by providing access stratum protocols including RRC, PDCP, RLC, MAC, and PHY/L1 protocols. The air interfaces between ANs 1308 and UEs 1302, or between individual UEs 1302 can include physical channels and physical signals. The various physical channels can include UL physical channels (e.g., physical uplink shared channel (PUSCH), narrowband PUSCH (NPUSCH), physical uplink control channel (PUCCH), short PUCCH (SPUCCH), physical random access channel (PRACH), narrowband PRACH (NPRACH), and/or the like), DL physical channels (e.g., physical downlink shared channel (PDSCH), narrowband PDSCH (NPDSCH), physical broadcast channel (PBCH), narrowband PBCH (NPBCH), physical multicast channel (PMCH), physical control format indicator channel (PCFICH), physical hybrid ARQ indicator channel (PHICH), physical downlink control channel (PDCCH), enhanced PDCCH (EPDCCH), MTC PDCCH (MPDCCH), short PDCCH (SPDCCH), narrowband PDCCH (NPDCCH), and/or the like), and/or sidelink physical channels (e.g., physical sidelink shared channel (PSSCH), physical sidelink broadcast channel (PSBCH), physical sidelink control channel (PSCCH), physical sidelink feedback channel (PSFCH), physical sidelink discovery channel (PSDCH), and/or the like). The various physical signals can include reference signals (e.g., cell-specific reference signals (CRS), channel state information reference signals (CSI-RS), demodulation reference signals (DMRS), narrowband DMRS, MBSFN reference signals, positioning reference signals (PRS), narrowband PRS (NPRS), phase-tracking reference signals (PT-RS), sounding reference signals (SRS), tracking RS (TRS)), synchronization signals (SS) or SS blocks (e.g., primary SS (PSS), secondary SS (SSS), sidelink PSS (S-PSS), sidelink SSS (S-SSS), narrowband SS (NSS), resynchronization signal (RSS), and/or the like), discovery signals, wake-up signals (e.g., MTC wake-up signal (MWUS), narrowband wake-up signals (NWUS), and/or the like). In this manner, the AN 1308 enables data/voice connectivity between CN 1320 and the UE 1302. The ANs 1308 may be a macrocell base station or a low power base station for providing femtocells, picocells or other like cells having smaller coverage areas, smaller user capacity, or higher bandwidth compared to macrocells; or some combination thereof. In these implementations, an AN 1308 be referred to as a BS, gNB, RAN node, eNB, ng-eNB, NodeB, RSU, TRxP, and/or the like.

One example implementation is a “CU/DU split” architecture where the ANs 1308 are embodied as a gNB-central unit (CU) that is communicatively coupled with one or more gNB-distributed units (DUs), where each DU may be communicatively coupled with one or more radio units (RUs) (also referred to herein as TRPs, RRHs, RRUs, or the like) (see e.g., [TS38401]). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The ANs 1308 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), vRAN, and/or the like (although these terms may refer to different implementation concepts). Any other type of architectures, arrangements, and/or configurations can be used.

The plurality of ANs may be coupled with one another via an X2 interface (if the RAN 1304 is an LTE RAN or Evolved Universal Terrestrial Radio Access Network (E-UTRAN) 1310) or an Xn interface (if the RAN 1304 is a NG-RAN 1314). The X2/Xn interfaces, which may be separated into control/user plane interfaces in some examples, may allow the ANs to communicate information related to handovers, data/context transfers, mobility, load management, interference coordination, and/or the like. The ANs of the RAN 1304 may each manage one or more cells, cell groups, component carriers, and/or the like to provide the UE 1302 with an air interface for network access. The UE 1302 may be simultaneously connected with a plurality of cells provided by the same or different ANs 1308 of the RAN 1304. For example, the UE 1302 and RAN 1304 may use carrier aggregation to allow the UE 1302 to connect with a plurality of component carriers, each corresponding to a Pcell or Scell. In dual connectivity scenarios, a first AN 1308 may be a master node that provides an MCG and a second AN 1308 may be secondary node that provides an SCG. The first/second ANs 1308 may be any combination of eNB, gNB, ng-eNB, and/or the like.

The RAN 1304 may provide the air interface over a licensed spectrum or an unlicensed spectrum. To operate in the unlicensed spectrum, the ANs 1308 and UEs 1302 may use LAA, eLAA, and/or feLAA mechanisms based on CA technology with PCells/Scells; prior to accessing the unlicensed spectrum, the nodes may perform medium/carrier-sensing operations based on, for example, a listen-before-talk (LBT) protocol.

In examples where the RAN 1304 is an E-UTRAN 1310 with one or more eNBs 1312, the E-UTRAN 1310 provides an LTE air interface (Uu) with the parameters and characteristics at least as discussed in [TS36300]. In examples where the RAN 1304 is an next generation (NG)-RAN 1314 with a set of gNBs 1316. Each gNB 1316 connects with 5G-enabled UEs 1302 using a 5G-NR air interface (which may also be referred to as a Uu interface) with parameters and characteristics as discussed in [TS38300], among many other 3GPP standards. Where the NG-RAN 1314 includes a set of ng-eNBs 1318, the one or more ng-eNBs 1318 connect with a UE 1302 via the 5G Uu and/or LTE Uu interface. The gNBs 1316 and the ng-eNBs 1318 connect with the 5GC 1340 through respective NG interfaces, which include an N2 interface, an N3 interface, and/or other interfaces. The gNB 1316 and the ng-eNB 1318 are connected with each other over an Xn interface. Additionally, individual gNBs 1316 are connected to one another via respective Xn interfaces, and individual ng-eNBs 1318 are connected to one another via respective Xn interfaces. In some examples, the NG interface may be split into two parts, an NG user plane (NG-U) interface, which carries traffic data between the nodes of the NG-RAN 1314 and a UPF 1348 (e.g., N3 interface), and an NG control plane (NG-C) interface, which is a signaling interface between the nodes of the NG-RAN 1314 and an AMF 1344 (e.g., N2 interface).

In some implementations, individual gNBs 1316 can include a gNB-CU (e.g., CU 1432 of FIG. 14) and a set of gNB-DUs (e.g., DU 1431 of FIG. 14). Additionally or alternatively, gNBs 1316 can include one or more RUs (e.g., RU 1430 of FIG. 14). In these implementations, the gNB-CU may be connected to each gNB-DU via respective F1 interfaces. In case of network sharing with multiple cell ID broadcast(s), each cell identity associated with a subset of PLMNs corresponds to a gNB-DU and the gNB-CU it is connected to, share the same physical layer cell resources. For resiliency, a gNB-DU may be connected to multiple gNB-CUs by appropriate implementation. Additionally, a gNB-CU can be separated into gNB-CU control plane (gNB-CU-CP) and gNB-CU user plane (gNB-CU-UP) functions. The gNB-CU-CP is connected to a gNB-DU through an F1 control plane interface (F1-C), the gNB-CU-UP is connected to the gNB-DU through an F1 user plane interface (F1-U), and the gNB-CU-UP is connected to the gNB-CU-CP through an E1 interface. In some implementations, one gNB-DU is connected to only one gNB-CU-CP, and one gNB-CU-UP is connected to only one gNB-CU-CP. For resiliency, a gNB-DU and/or a gNB-CU-UP may be connected to multiple gNB-CU-CPs by appropriate implementation. One gNB-DU can be connected to multiple gNB-CU-UPs under the control of the same gNB-CU-CP, and one gNB-CU-UP can be connected to multiple DUs under the control of the same gNB-CU-CP. Data forwarding between gNB-CU-UPs during intra-gNB-CU-CP handover within a gNB may be supported by Xn-U.

Similarly, individual ng-eNBs 1318 can include an ng-eNB-CU (e.g., CU 1432 of FIG. 14) and a set of ng-eNB-DUs (e.g., DU 1431 of FIG. 14). In these implementations, the ng-eNB-CU and each ng-eNB-DU are connected to one another via respective W1 interface. An ng-eNB can include an ng-eNB-CU-CP, one or more ng-eNB-CU-UP(s), and one or more ng-eNB-DU(s). An ng-eNB-CU-CP and an ng-eNB-CU-UP is connected via the E1 interface. An ng-eNB-DU is connected to an ng-eNB-CU-CP via the W1-C interface, and to an ng-eNB-CU-UP via the W1-U interface. The general principle described herein w.r.t gNB aspects also applies to ng-eNB aspects and corresponding E1 and W1 interfaces, if not explicitly specified otherwise.

The node hosting user plane part of the PDCP protocol layer (e.g., gNB-CU, gNB-CU-UP, and for EN-DC, MeNB or SgNB depending on the bearer split) performs user inactivity monitoring and further informs its inactivity or (re)activation to the node having control plane connection towards the core network (e.g., over E1, X2, or the like). The node hosting the RLC protocol layer (e.g., gNB-DU) may perform user inactivity monitoring and further inform its inactivity or (re)activation to the node hosting the control plane (e.g., gNB-CU or gNB-CU-CP).

In these implementations, the NG-RAN 1314, is layered into a Radio Network Layer (RNL) and a Transport Network Layer (TNL). The NG-RAN 1314 architecture (e.g., the NG-RAN logical nodes and interfaces between them) is part of the RNL. For each NG-RAN interface (e.g., NG, Xn, F1, and the like) the related TNL protocol and the functionality are specified, for example, in [TS38401]. The TNL provides services for user plane transport and/or signalling transport. In NG-Flex configurations, each NG-RAN node is connected to all AMFs 1344 of AMF sets within an AMF region supporting at least one slice also supported by the NG-RAN node. The AMF Set and the AMF Region are defined in [TS23501].

The RAN 1304 is communicatively coupled to CN 1320 that includes network elements and/or network functions (NFs) to provide various functions to support data and telecommunications services to customers/subscribers (e.g., UE 1302). The components of the CN 1320 may be implemented in one physical node or separate physical nodes. In some examples, NFV may be utilized to virtualize any or all of the functions provided by the network elements of the CN 1320 onto physical compute/storage resources in servers, switches, and/or the like. A logical instantiation of the CN 1320 may be referred to as a network slice, and a logical instantiation of a portion of the CN 1320 may be referred to as a network sub-slice.

The CN 1320 may be an LTE CN 1322 (also referred to as an Evolved Packet Core (EPC) 1322). The EPC 1322 may include MME 1324, SGW 1326, SGSN 1328, HSS 1330, PGW 1332, and PCRF 1334 coupled with one another over interfaces (or “reference points”) as shown. The NFs in the EPC 1322 are briefly introduced as follows. The MME 1324 implements mobility management functions to track a current location of the UE 1302 to facilitate paging, bearer activation/deactivation, handovers, gateway selection, authentication, and/or the like. The SGW 1326 terminates an S1 interface toward the RAN 1310 and routes data packets between the RAN 1310 and the EPC 1322. The SGW 1326 may be a local mobility anchor point for inter-RAN node handovers and also may provide an anchor for inter-3GPP mobility. Other responsibilities may include lawful intercept, charging, and some policy enforcement. The SGSN 1328 tracks a location of the UE 1302 and performs security functions and access control. The SGSN 1328 also performs inter-EPC node signaling for mobility between different RAT networks; PDN and S-GW selection as specified by MME 1324; MME 1324 selection for handovers; and/or the like. The S3 reference point between the MME 1324 and the SGSN 1328 enable user and bearer information exchange for inter-3GPP access network mobility in idle/active states. The HSS 1330 includes a database for network users, including subscription-related information to support the network entities' handling of communication sessions. The HSS 1330 can provide support for routing/roaming, authentication, authorization, naming/addressing resolution, location dependencies, and/or the like. An S6a reference point between the HSS 1330 and the MME 1324 may enable transfer of subscription and authentication data for authenticating/authorizing user access to the EPC 1320. The PGW 1332 may terminate an SGi interface toward a data network (DN) 1336 that may include an application (app)/content server 1338. The PGW 1332 routes data packets between the EPC 1322 and the data network 1336. The PGW 1332 is communicatively coupled with the SGW 1326 by an S5 reference point to facilitate user plane tunneling and tunnel management. The PGW 1332 may further include a node for policy enforcement and charging data collection (e.g., PCEF). Additionally, the SGi reference point may communicatively couple the PGW 1332 with the same or different data network 1336. The PGW 1332 may be communicatively coupled with a PCRF 1334 via a Gx reference point. The PCRF 1334 is the policy and charging control element of the EPC 1322. The PCRF 1334 is communicatively coupled to the app/content server 1338 to determine appropriate QoS and charging parameters for service flows. The PCRF 1332 also provisions associated rules into a PCEF (via Gx reference point) with appropriate TFT and QCI.

The CN 1320 may be a 5GC 1340 including an AUSF 1342, AMF 1344, SMF 1346, UPF 1348, NSSF 1350, NEF 1352, NRF 1354, PCF 1356, UDM 1358, and AF 1360 coupled with one another over various interfaces as shown. In some implementations, the UPF 1348 may reside outside of the CN 1340.

The AUSF 1342 stores data for authentication of UE 1302 and handle authentication-related functionality. The AUSF 1342 may facilitate a common authentication framework for various access types.

The AMF 1344 allows other functions of the 5GC 1340 to communicate with the UE 1302 and the RAN 1304 and to subscribe to notifications about mobility events w.r.t the UE 1302. The AMF 1344 is also responsible for registration management (e.g., for registering UE 1302), connection management, reachability management, mobility management, lawful interception of AMF-related events, and access authentication and authorization. The AMF 1344 provides transport for SM messages between the UE 1302 and the SMF 1346, and acts as a transparent proxy for routing SM messages. AMF 1344 also provides transport for SMS messages between UE 1302 and an SMSF. AMF 1344 interacts with the AUSF 1342 and the UE 1302 to perform various security anchor and context management functions. Furthermore, AMF 1344 is a termination point of a RAN-CP interface, which includes the N2 reference point between the RAN 1304 and the AMF 1344. The AMF 1344 is also a termination point of NAS (N1) signaling, and performs NAS ciphering and integrity protection.

AMF 1344 also supports NAS signaling with the UE 1302 over an N3IWF interface. The N3IWF provides access to untrusted entities. N3IWF may be a termination point for the N2 interface between the (R)AN 1304 and the AMF 1344 for the control plane, and may be a termination point for the N3 reference point between the (R)AN 1314 and the 1348 for the user plane. As such, the AMF 1344 handles N2 signaling from the SMF 1346 and the AMF 1344 for PDU sessions and QoS, encapsulate/de-encapsulate packets for IPSec and N3 tunneling, marks N3 user-plane packets in the uplink, and enforces QoS corresponding to N3 packet marking taking into account QoS requirements associated with such marking received over N2. N3IWF may also relay UL and DL control-plane NAS signaling between the UE 1302 and AMF 1344 via an N1 reference point between the UE 1302 and the AMF 1344, and relay uplink and downlink user-plane packets between the UE 1302 and UPF 1348. The N3IWF also provides mechanisms for IPsec tunnel establishment with the UE 1302. The AMF 1344 may exhibit an Namf service-based interface, and may be a termination point for an N14 reference point between two AMFs 1344 and an N17 reference point between the AMF 1344 and a 5G-EIR (not shown by FIG. 13).

The SMF 1346 is responsible for SM (e.g., session establishment, tunnel management between UPF 1348 and AN 1308); UE IP address allocation and management (including optional authorization); selection and control of UP function; configuring traffic steering at UPF 1348 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1344 over N2 to AN 1308; and determining SSC mode of a session. SM refers to management of a PDU session, and a PDU session or “session” refers to a PDU connectivity service that provides or enables the exchange of PDUs between the UE 1302 and the DN 1336. The SMF 1346 may also include the following functionalities to support edge computing enhancements (see e.g., [TS23548]): selection of EASDF 1361 and provision of its address to the UE as the DNS server for the PDU session; usage of EASDF 1361 services as defined in [TS23548]; and for supporting the application layer architecture defined in [TS23558], provision and updates of ECS address configuration information to the UE. Discovery and selection procedures for EASDFs 1361 is discussed in [TS23501] § 6.3.23.

The UPF 1348 acts as an anchor point for intra-RAT and inter-RAT mobility, an external PDU session point of interconnect to data network 1336, and a branching point to support multi-homed PDU session. The UPF 1348 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs uplink traffic verification (e.g., SDF-to-QoS flow mapping), transport level packet marking in the uplink and downlink, and performs downlink packet buffering and downlink data notification triggering. UPF 1348 may include an uplink classifier to support routing traffic flows to a data network.

The NSSF 1350 selects a set of network slice instances serving the UE 1302. The NSSF 1350 also determines allowed NSSAI and the mapping to the subscribed S-NSSAIs, if needed. The NSSF 1350 also determines an AMF set to be used to serve the UE 1302, or a list of candidate AMFs 1344 based on a suitable configuration and possibly by querying the NRF 1354. The selection of a set of network slice instances for the UE 1302 may be triggered by the AMF 1344 with which the UE 1302 is registered by interacting with the NSSF 1350; this may lead to a change of AMF 1344. The NSSF 1350 interacts with the AMF 1344 via an N22 reference point; and may communicate with another NSSF 1350 in a visited network via an N31 reference point (not shown). Although not shown, the network 1300 can also include Network Slice Admission Control Function (NSACF) and a Network Slice-specific and SNPN Authentication and Authorization Function (NSSAAF), details of which are discussed in [TS23501].

The NEF 1352 securely exposes services and capabilities provided by 3GPP NFs for third party, internal exposure/re-exposure, AFs 1360, edge computing or fog computing systems (e.g., edge compute node, and/or the like. In such examples, the NEF 1352 may authenticate, authorize, or throttle the AFs. NEF 1352 may also translate information exchanged with the AF 1360 and information exchanged with internal network functions. For example, the NEF 1352 may translate between an AF-Service-Identifier and an internal 5GC information. NEF 1352 may also receive information from other NFs based on exposed capabilities of other NFs. This information may be stored at the NEF 1352 as structured data, or at a data storage NF using standardized interfaces. The stored information can then be re-exposed by the NEF 1352 to other NFs and AFs, or used for other purposes such as analytics.

The NRF 1354 supports service discovery functions, receives NF discovery requests from NF instances, and provides information of the discovered NF instances to the requesting NF instances. NRF 1354 also maintains information of available NF instances and their supported services. The NRF 1354 also supports service discovery functions, wherein the NRF 1354 receives NF Discovery Request from NF instance or an SCP (not shown), and provides information of the discovered NF instances to the NF instance or SCP.

The PCF 1356 provides policy rules to control plane functions to enforce them, and may also support unified policy framework to govern network behavior. The PCF 1356 may also implement a front end to access subscription information relevant for policy decisions in a UDR of the UDM 1358. In addition to communicating with functions over reference points as shown, the PCF 1356 exhibit an Npcf service-based interface.

The UDM 1358 handles subscription-related information to support the network entities' handling of communication sessions, and stores subscription data of UE 1302. For example, subscription data may be communicated via an N8 reference point between the UDM 1358 and the AMF 1344. The UDM 1358 may include two parts, an application front end and a UDR. The UDR may store subscription data and policy data for the UDM 1358 and the PCF 1356, and/or structured data for exposure and application data (including PFDs for application detection, application request information for multiple UEs 1302) for the NEF 1352. The Nudr service-based interface may be exhibited by the UDR 221 to allow the UDM 1358, PCF 1356, and NEF 1352 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1358 may exhibit the Nudm service-based interface.

Edge Application Server Discovery Function (EASDF) 1361 exhibits an Neasdf service-based interface, and is connected to the SMF 1346 via an N88 interface. One or multiple EASDF instances may be deployed within a PLMN, and interactions between 5GC NF(s) and the EASDF 1361 take place within a PLMN. The EASDF 1361 includes one or more of the following functionalities: registering to NRF 1354 for EASDF 1361 discovery and selection; handling the DNS messages according to the instruction from the SMF 1346; and/or terminating DNS security, if used. Handling the DNS messages according to the instruction from the SMF 1346 includes one or more of the following functionalities: receiving DNS message handling rules and/or BaselineDNSPattern from the SMF 1346; exchanging DNS messages from/with the UE 1302; forwarding DNS messages to C-DNS or L-DNS for DNS query; adding EDNS client subnet (ECS) option into DNS query for an FQDN; reporting to the SMF 1346 the information related to the received DNS messages; and/or buffering/discarding DNS messages from the UE 1302 or DNS Server. The EASDF has direct user plane connectivity (i.e. without any NAT) with the PSA UPF over N6 for the transmission of DNS signalling exchanged with the UE. The deployment of a NAT between EASDF 1361 and PSA UPF 1348 may or may not be supported. Additional aspects of the EASDF 1361 are discussed in [TS23548].

AF 1360 provides application influence on traffic routing, provide access to NEF 1352, and interact with the policy framework for policy control. The AF 1360 may influence UPF 1348 (re)selection and traffic routing. Based on operator deployment, when AF 1360 is considered to be a trusted entity, the network operator may permit AF 1360 to interact directly with relevant NFs. Additionally, the AF 1360 may be used for edge computing. In some implementations, the AF 1360 may reside outside of the CN 1340.

The 5GC 1340 may enable edge computing by selecting operator/3rd party services to be geographically close to a point that the UE 1302 is attached to the network. This may reduce latency and load on the network. In edge computing implementations, the 5GC 1340 may select a UPF 1348 close to the UE 1302 and execute traffic steering from the UPF 1348 to DN 1336 via the N6 interface. This may be based on the UE subscription data, UE location, and information provided by the AF 1360, which allows the AF 1360 to influence UPF (re)selection and traffic routing.

The data network (DN) 1336 may represent various network operator services, Internet access, or third party services that may be provided by one or more servers including, for example, application (app)/content server 1338. The DN 1336 may be an operator external public, a private PDN, or an intra-operator packet data network, for example, for provision of IMS services. In this example, the app server 1338 can be coupled to an IMS via an S-CSCF or the I-CSCF. In some implementations, the DN 1336 may represent one or more local area DNs (LADNs), which are DNs 1336 (or DN names (DNNs)) that is/are accessible by a UE 1302 in one or more specific areas. Outside of these specific areas, the UE 1302 is not able to access the LADN/DN 1336.

Additionally or alternatively, the DN 1336 may be an Edge DN 1336, which is a (local) Data Network that supports the architecture for enabling edge applications. In these examples, the app server 1338 may represent the physical hardware systems/devices providing app server functionality and/or the application software resident in the cloud or at an edge compute node that performs server function(s). In some examples, the app/content server 1338 provides an edge hosting environment that provides support required for Edge Application Server's execution.

In some examples, the 5GS can use one or more edge compute nodes (e.g., edge compute nodes 736 of FIG. 7 and/or the like) to provide an interface and offload processing of wireless communication traffic. In these examples, the edge compute nodes may be included in, or co-located with one or more RAN 1310, 1314. For example, the edge compute nodes can provide a connection between the RAN 1314 and UPF 1348 in the 5GC 1340. The edge compute nodes can use one or more NFV instances instantiated on virtualization infrastructure within the edge compute nodes to process wireless connections to and from the RAN 1314 and UPF 1348.

The interfaces of the 5GC 1340 include reference points and service-based interfaces. The reference points include: N1 (between the UE 1302 and the AMF 1344), N2 (between RAN 1314 and AMF 1344), N3 (between RAN 1314 and UPF 1348), N4 (between the SMF 1346 and UPF 1348), N5 (between PCF 1356 and AF 1360), N6 (between UPF 1348 and DN 1336), N7 (between SMF 1346 and PCF 1356), N8 (between UDM 1358 and AMF 1344), N9 (between two UPFs 1348), N10 (between the UDM 1358 and the SMF 1346), N11 (between the AMF 1344 and the SMF 1346), N12 (between AUSF 1342 and AMF 1344), N13 (between AUSF 1342 and UDM 1358), N14 (between two AMFs 1344; not shown), N15 (between PCF 1356 and AMF 1344 in case of a non-roaming scenario, or between the PCF 1356 in a visited network and AMF 1344 in case of a roaming scenario), N16 (between two SMFs 1346; not shown), and N22 (between AMF 1344 and NSSF 1350). Other reference point representations not shown in FIG. 13 can also be used. The service-based representation of FIG. 13 represents NFs within the control plane that enable other authorized NFs to access their services. The service-based interfaces (SBIs) include: Namf (SBI exhibited by AMF 1344), Nsmf (SBI exhibited by SMF 1346), Nnef (SBI exhibited by NEF 1352), Npcf (SBI exhibited by PCF 1356), Nudm (SBI exhibited by the UDM 1358), Naf (SBI exhibited by AF 1360), Nnrf (SBI exhibited by NRF 1354), Nnssf (SBI exhibited by NSSF 1350), Nausf (SBI exhibited by AUSF 1342). Other service-based interfaces (e.g., Nudr, N5g-eir, and Nudsf) not shown in FIG. 13 can also be used. In some examples, the NEF 1352 can provide an interface to edge compute nodes 1336x, which can be used to process wireless connections with the RAN 1314.

In some implementations, the system 1300 may include an SMSF, which is responsible for SMS subscription checking and verification, and relaying SM messages to/from the UE 1302 to/from other entities, such as an SMS-GMSC/IWMSC/SMS-router. The SMS may also interact with AMF 1342 and UDM 1358 for a notification procedure that the UE 1302 is available for SMS transfer (e.g., set a UE not reachable flag, and notifying UDM 1358 when UE 1302 is available for SMS).

The 5GS may also include an SCP (or individual instances of the SCP) that supports indirect communication (see e.g., 3GPP TS 23.501 section 7.1.1); delegated discovery (see e.g., [TS23501] § 7.1.1); message forwarding and routing to destination NF/NF service(s), communication security (e.g., authorization of the NF Service Consumer to access the NF Service Producer API) (see e.g., 3GPP TS 33.501 v17.7.0 (2022 Sep. 22) (“[TS33501]”)), load balancing, monitoring, overload control, and/or the like; and discovery and selection functionality for UDM(s), AUSF(s), UDR(s), PCF(s) with access to subscription data stored in the UDR based on UE's SUPI, SUCI or GPSI (see e.g., [TS23501] § 6.3). Load balancing, monitoring, overload control functionality provided by the SCP may be implementation specific. The SCP may be deployed in a distributed manner. More than one SCP can be present in the communication path between various NF Services. The SCP, although not an NF instance, can also be deployed distributed, redundant, and scalable.

FIG. 14 shows example network deployments including an example next generation fronthaul (NGF) deployment 1400a where a user equipment (UE) 1402 is connected to an RU 1430 (also referred to as a “remote radio unit 1430”, “a remote radio head 1430”, or “RRH 1430”) via an air interface, the RU 1430 is connected to a Digital Unit (DU) 1431 via a NGF interface (NGFI)-I, the DU 1431 is connected to a Central Unit (CU) 1432 via an NGFI-II, and the CU 1432 is connected to a core network (CN) 1442 via a backhaul interface. In 3GPP NG-RAN implementations (see e.g., [TS38401]), the DU 1431 may be a distributed unit (for purposes of the present disclosure, the term “DU” may refer to a digital unit and/or a distributed unit unless the context dictates otherwise). The UEs 1402 may be the same or similar as the nodes 720 and/or 710 discussed infra with respect to FIG. 7, and the CN 1442 may be the same or similar as CN 742 discussed infra with respect to FIG. 7.

In some implementations, the NGF deployment 1400a may be arranged in a distributed RAN (D-RAN) architecture where the CU 1432, DU 1431, and RU 1430 reside at a cell site and the CN 1442 is located at a centralized site. Alternatively, the NGF deployment 1400a may be arranged in a centralized RAN (C-RAN) architecture with centralized processing of one or more baseband units (BBUs) at the centralized site. In C-RAN architectures, the radio components are split into discrete components, which can be located in different locations. In one example C-RAN implementation, only the RU 1430 is disposed at the cell site, and the DU 1431, the CU 1432, and the CN 1442 are centralized or disposed at a central location. In another example C-RAN implementation, the RU 1430 and the DU 1431 are located at the cell site, and the CU 1432 and the CN 1442 are at the centralized site. In another example C-RAN implementation, only the RU 1430 is disposed at the cell site, the DU 1431 and the CU 1432 are located a RAN hub site, and the CN 1442 is at the centralized site.

The CU 1432 is a central controller that can serve or otherwise connect to one or multiple DUs 1431 and/or multiple RUs 1430. The CU 1432 is network (logical) nodes hosting higher/upper layers of a network protocol functional split. For example, in the 3GPP NG-RAN and/or O-RAN architectures, a CU 1432 hosts the radio resource control (RRC) (see e.g., 3GPP TS 36.331 v16.7.0 (2021 Dec. 23) and/or 3GPP TS 38.331 v16.7.0 (2021 Dec. 23) (“[TS38331]”)), Service Data Adaptation Protocol (SDAP) (see e.g., 3GPP TS 37.324 v16.3.0 (2021 Jul. 6)), and Packet Data Convergence Protocol (PDCP) (see e.g., 3GPP TS 36.323 v16.5.0 (2020 Jul. 24) and/or 3GPP TS 38.323 v16.5.0 (2021 Sep. 28)) layers of a next generation NodeB (gNB), or hosts the RRC and PDCP protocol layers when included in or operating as an E-UTRA-NR gNB (en-gNB). The SDAP sublayer performs mapping between QoS flows and a data radio bearers (DRBs) and marking QoS flow IDs (QFI) in both DL and UL packets. The PDCP sublayer performs transfers user plane or control plane data; maintains PDCP sequence numbers (SNs); header compression and decompression using the Robust Header Compression (ROHC) and/or Ethernet Header Compression (EHC) protocols; ciphering and deciphering; integrity protection and integrity verification; provides timer based SDU discard; routing for split bearers; duplication and duplicate discarding; reordering and in-order delivery; and/or out-of-order delivery. In various implementations, a CU 1432 terminates respective F1 interfaces connected with corresponding DUs 1431 (see e.g., [TS38401]).

A CU 1432 may include a CU-control plane (CP) entity (referred to herein as “CU-CP 1432”) and a CU-user plane (UP) entity (referred to herein as “CU-UP 1432”). The CU-CP 1432 is a logical node hosting the RRC layer and the control plane part of the PDCP protocol layer of the CU 1432 (e.g., a gNB-CU for an en-gNB or a gNB). The CU-CP terminates an E1 interface connected with the CU-UP and the F1-C interface connected with a DU 1431. The CU-UP 1432 is a logical node hosting the user plane part of the PDCP protocol layer (e.g., for a gNB-CU 1432 of an en-gNB), and the user plane part of the PDCP protocol layer and the SDAP protocol layer (e.g., for the gNB-CU 1432 of a gNB). The CU-UP 1432 terminates the E1 interface connected with the CU-CP 1432 and the F1-U interface connected with a DU 1431.

The DU 1431 controls radio resources, such as time and frequency bands, locally in real time, and allocates resources to one or more UEs. The DUs 1431 are network (logical) nodes hosting middle and/or lower layers of the network protocol functional split. For example, in the 3GPP NG-RAN and/or O-RAN architectures, a DU 1431 hosts the radio link control (RLC) (see e.g., 3GPP TS 38.322 v16.2.0 (2021 Jan. 6) and 3GPP TS 36.322 v16.0.0 (2020 Jul. 24)), medium access control (MAC) (see e.g., 3GPP TS 38.321 v16.7.0 (2021 Dec. 23) and 3GPP TS 36.321 v16.6.0 (2021 Sep. 27)(collectively referred to as “[TSMAC]”)), and high-physical (PHY)(see e.g., 3GPP TS 38.201 v16.0.0 (2020 Jan. 11) and 3GPP TS 36.201 v16.0.0 (2020 Jul. 14)) layers of the gNB or en-gNB, and its operation is at least partly controlled by the CU 1432. The RLC sublayer operates in one or more of a Transparent Mode (TM), Unacknowledged Mode (UM), and Acknowledged Mode (AM). The RLC sublayer performs transfer of upper layer PDUs; sequence numbering independent of the one in PDCP (UM and AM); error Correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; and/or protocol error detection (AM only). The MAC sublayer performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding. In some implementations, a DU 1431 can host a Backhaul Adaptation Protocol (BAP) layer (see e.g., 3GPP TS 38.340 v16.5.0 (2021 Jul. 7)) and/or a F1 application protocol (F1AP) (see e.g., 3GPP TS 38.470 v16.5.0 (2021 Jul. 1)), such as when the DU 1431 is operating as an Integrated Access and Backhaul (IAB) node. One DU 1431 supports one or multiple cells, and one cell is supported by only one DU 1431. A DU 1431 terminates the F1 interface connected with a CU 1432. Additionally or alternatively, the DU 1431 may be connected to one or more RRHs/RUs 1430.

The RU 1430 is a transmission/reception point (TRP) or other physical node that handles radiofrequency (RF) processing functions. The RU 1430 is a network (logical) node hosting lower layers based on a lower layer functional split. For example, in 3GPP NG-RAN and/or O-RAN architectures, the RU 1430 hosts low-PHY layer functions and RF processing of the radio interface based on a lower layer functional split. The RU 1430 may be similar to 3GPP's transmission/reception point (TRP) or RRH, but specifically includes the Low-PHY layer. Examples of the low-PHY functions include fast Fourier transform (FFT), inverse FFT (iFFT), physical random access channel (PRACH) extraction, and the like.

Each of the CUs 1432, DUs 1431, and RUs 1430 are connected through respective links, which may be any suitable wireless and/or wired (e.g., fiber, copper, and the like) links. In some implementations, various combinations of the CU 1432, DU 1431, and RU 1430 may correspond to one or more of the NANs 730 of FIG. 7. Additional aspects of CUs 1432, DUs 1431, and RUs 1430 are discussed in [O-RAN], [TS38401], 3GPP TS 38.410 v 17.1.0 (2022 Jun. 23) (“[TS38410]”), and [TS38300], the contents of each of which are hereby incorporated by reference in their entireties.

In some implementations, a fronthaul gateway function (FHGW) may be disposed between the DU 1431 and the RU/RRU 1430 (not shown by FIG. 14), where the interface between the DU 1431 and the FHGW is an Open Fronthaul (e.g., Option 7-2x) interface, the interface between FHGW function and the RU/RRU 1430 is an Open Fronthaul (e.g., Option 7-2x) interface or any other suitable interface (e.g., option 7, option 8, or the like) including those that do not support Open Fronthaul (e.g., Option 7-2x). The FHGW may be packaged with one or more other functions (e.g., Ethernet switching and/or the like) in a physical device or appliance. In some implementations, a RAN controller (e.g., RIC 3c02 of FIG. 3c) may be communicatively coupled with the CU 1432 and/or the DU 1431.

NGFI (also referred to as “xHaul” or the like) is a two-level fronthaul architecture that separates the traditional RRU 1430 to BBU connectivity in the C-RAN architecture into two levels, namely levels I and II. Level I connects the RU 1430 via the NGFI-I to the DU 1431, and level II connects the DU 1431 via the NGFI-II to the CU 1432 as shown by deployment 1400a in FIG. 14. The NGFI-I and NGFI-II connections may be wired connections or wireless connections, which may utilize any suitable RAT such as any of those discussed herein. The purpose of the two-level architecture is to distribute (split) the RAN node protocol functions between CU 1432 and DU 1431 such that latencies are relaxed, giving more deployment flexibilities. In general, the NGFI-I interfaces with the lower layers of the function split which have stringent delay and data rate requirements, whereas NGFI-II interfaces with higher layers of the function split relative to the layers of the NGFI-I, relaxing the requirements for the fronthaul link. Examples of the NGFI fronthaul interfaces and functional split architectures include O-RAN 7.2x fronthaul (see e.g., [O-RAN.WG9.XPSAAS] and [O-RAN-WG4.CUS.0]), Enhanced Common Radio Interface (CPRI) based C-RAN fronthaul (see e.g., Common Public Radio Interface: eCPRI Interface Specfication, ECPRI SPECIFICATION v2.0 (2019 May 10), Common Public Radio Interface: Requirements for the eCPRI Transport Network, ECPRI TRANSPORT NETWORK v1.2 (2018 Jun. 25), and [O-RAN-WG4.CUS.0]), Radio over Ethernet (RoE) based C-RAN fronthaul (see e.g., IEEE Standard for Radio over Ethernet Encapsulations and Mappings, IEEE STANDARDS ASSOCIATION, IEEE 1914.3-2018 (5 Oct. 2018) (“[IEEE1914.3]”)), and/or the like. Additional aspects of NGFI are also discussed in [O-RAN.WG9.XPSAAS], [O-RAN-WG4.CUS.0], IEEE Standard for Packet-based Fronthaul Transport Networks, IEEE STANDARDS ASSOCIATION, IEEE 1914.1-2019 (21 Apr. 2020) (“[IEEE1914.1]”), [IEEE1914.3], and Nasrallah et al., Ultra-Low Latency (ULL) Networks: A Comprehensive Survey Covering the IEEE TSN Standard and Related ULL Research, ARXIV:1803.07673v1 [CS.NI] (20 Mar. 2018) (“[Nasrallah]”), the contents of each of which are hereby incorporated by reference in their entireties.

In one example, the deployment 1400a may implement a low level split (LLS) (also referred to as a “Lower Layer Functional Split 7-2x” or “Split Option 7-2x”) that runs between the RU 1430 (e.g., an O-RU in O-RAN architectures) and the DU 1431 (e.g., an O-DU in O-RAN architectures) (see e.g., [O-RAN.WG7.IPC-HRD-Opt7-2], [O-RAN.WG7.OMAC-HRD], [O-RAN.WG7.OMC-HRD-Opt7-2], [O-RAN.WG7.OMC-HRD-Opt7-2]). In this example implementation, the NGFI-I is the Open Fronthaul interface described in the O-RAN Open Fronthaul Specification (see e.g., [O-RAN-WG4.CUS.0]). Other LLS options may be used such as the relevant interfaces described in other standards or specifications such as, for example, the 3GPP NG-RAN functional split (see e.g., [TS38401] and 3GPP TR 38.801 v14.0.0 (2017 Apr. 3)), the Small Cell Forum for Split Option 6 (see e.g., 5G small cell architecture and product definitions: Configurations and Specifications for companies deploying small cells 2020-2025, SMALL CELL FORUM, document 238.10.01 (5 Jul. 2020) (“[SCF238]”), 5G NR FR1 Reference Design: The case for a common, modular architecture for 5G NR FR1 small cell distributed radio units, SMALL CELL FORUM, document 251.10.01 (15 Dec. 2021) (“[SCF251]”), and [O-RAN.WG7.IPC-HRD-Opt6], the contents of each of which are hereby incorporated by reference in their entireties), and/or in O-RAN white-box hardware Split Option 8 (e.g., [O-RAN.WG7.IPC-HRD-Opt8]).

Additionally or alternatively, the CUs 1432, DUs 1431, and/or RUs 1430 may be IAB nodes. IAB enables wireless relaying in an NG-RAN where a relaying node (referred to as an “IAB-node”) supports access and backhauling via 3GPP 5G/new radio (NR) links/interfaces. The terminating node of NR backhauling on the network side is referred to as an “IAB-donor”, which represents a RAN node (e.g., a gNB) with additional functionality to support IAB. Backhauling can occur via a single or via multiple hops. All IAB-nodes that are connected to an IAB-donor via one or multiple hops form a directed acyclic graph (DAG) topology with the IAB-donor as its root. The IAB-donor performs centralized resource, topology and route management for the IAB topology. The IAB architecture is shown and described in [TS38300].

Although the NGF deployment 1400a shows the CU 1432, DU 1431, RRH 1430, and CN 1442 as separate entities, in other implementations some or all of these network nodes can be bundled, combined, or otherwise integrated with one another into a single device or element, including collapsing some internal interfaces (e.g., F1-C, F1-U, E1, E2, and the like). At least the following implementations are possible: (i) integrating the CU 1432 and the DU 1431 (e.g., a CU-DU), which is connected to the RRH 1430 via the NGFI-I; (ii) integrating the DU 1431 and the RRH 1430 integrated (e.g., CU-DU), which is connected to the CU 1432 via NGFI-II; (iii) integrating a RAN controller (e.g., RIC 3c02 of FIG. 3c) and the CU 1432, which is connected to the DU 1431 via NGFI-II; (iv) integrating the CU 1432, the DU 1431, and the RU 1430, which is connected to the CN 1442 via backhaul interface; and (v) integrating the network controller (or intelligent controller), the CU 1432, the DU 1431, and the RU 1430. Any of the aforementioned example implementations involving the CU 1432 may also include integrating the CU-CP 1432 and CP-UP 1432.

FIG. 14 also shows an example RAN disaggregation deployment 1400b (also referred to as “disaggregated RAN 1400b”) where the UE 1402 is connected to the RRH 1430, and the RRH 1430 is communicatively coupled with one or more of the RAN functions (RANFs) 1-N (where N is a number). The RANFs 1-N are disaggregated and distributed geographically across several component segments and network nodes. In some implementations, each RANF 1-Nis a software (SW) element operated by a physical compute node (e.g., computing node 1750 of FIG. 17) and the RRH 1430 includes radiofrequency (RF) circuitry (e.g., an RF propagation module for a particular RAT and/or the like). In this example, the RANF 1 is operated on a physical compute node that is co-located with the RRH 1430 and the other RANFs are disposed at locations further away from the RRH 1430. Additionally in this example, the CN 1442 is also disaggregated into CN NFs 1-x (where x is a number) in a same or similar manner as the RANFs 1-N, although in other implementations the CN 1442 is not disaggregated.

Network disaggregation (or disaggregated networking) involves the separation of networking equipment into functional components and allowing each component to be individually deployed. This may encompass separation of SW elements (e.g., NFs) from specific HW elements and/or using APIs to enable software defined network (SDN) and/or and NF virtualization (NFV). RAN disaggregation involves network disaggregation and virtualization of various RANFs (e.g., RANFs 1-N in FIG. 14). The RANFs 1-N can be placed in different physical sites in various topologies in a RAN deployment based on the use case. This enables RANF distribution and deployment over different geographic areas and allows a breakout of RANFs to support various use cases (e.g., low latency use cases and the like) as well as flexible RAN implementations. Disaggregation offers a common or uniform RAN platform capable of assuming a distinct profile depending on where it is deployed. This allows fewer fixed-function devices, and a lower total cost of ownership, in comparison with existing RAN architectures. Example RAN disaggregation frameworks are provided by Telecom Infra Project (TIP) OpenRAN™, Cisco® Open vRAN™, [O-RAN], Open Optical & Packet Transport (OOPT), Reconfigurable Optical Add Drop Multiplexer (ROADM), and/or the like.

In a first example implementation, the RANFs 1-N disaggregate RAN HW and SW with commercial off-the-shelf (COTS) HW and open interfaces (e.g., NGFI-I and NGFI-II, and the like). In this example implementation, each RANF 1-N may be a virtual BBU or vRAN controller operating on COTS compute infrastructure with HW acceleration for BBU/vRANFs.

In a second example implementation, the RANFs 1-N disaggregate layers of one or more RAT protocol stacks. As an example of this implementation, RANF 1 is a DU 1431 operating on first COTS compute infrastructure with HW acceleration for BBU/vRANFs, and RANF 2 is a virtual CU 1432 operating on second COTS compute infrastructure.

In a third example implementation, the RANFs 1-N disaggregate control plane and user plane functions. As an example of this implementation, the RANF 1 is a DU 1431 operating on COTS compute infrastructure with HW acceleration for BBU/vRANFs, RANF 2 is a virtual CU-CP 1432 operating on COTS compute infrastructure, and a third RANF (e.g., RANF 3 (not shown by FIG. 14)) is a virtual CU-UP 1432 operating on the same or different COTS compute infrastructure as the virtual CU-CP 1432. Additionally or alternatively, in this implementation, one or more CN NFs 1-x may be CN-UP functions and one or more other CN NFs 1-x may be CN-CP functions.

In a fourth example implementation, the RANFs 1-N disaggregate layers of an [IEEE802] RAT. As an example of this implementation, the RRH 1430 implements a WiFi PHY layer, RANF 1 implements a WiFi MAC sublayer, RANF 1 implements a WiFi logical link control (LLC) sublayer, RANF 2 implements one or more WiFi upper layer protocols (e.g., network layer, transport layer, session layer, presentation layer, and/or application layer), and so forth.

In a fifth example implementation, the RANFs 1-N disaggregate different O-RAN RANFs including E2SMs. As an example of this implementation, RANF 1 implements the near-RT RIC 414 (including the xApp manager 425), RANF 2 implements the E2SM-KPM, RANF 3 implements the E2SM-CCC, RANF 4 implements the E2SM RAN control, RANF 5 implements the E2SM-NI, RANF 6 implements functions for providing A1 services, and so forth.

In any of the implementations discussed herein, the lower layers of the RAN protocol stack can be characterized by real-time (RT) functions and relatively complex signal processing algorithms, and the higher layers of the RAN protocol stack can be characterized by non-RT functions. In these implementations, the RT functions and signal processing algorithms can be implemented in DUs 1431 and/or RRHs 1430 either using purpose-built network elements or in COTS hardware augmented with purpose-built HW accelerators (e.g., acceleration circuitry 1764 of FIG. 17 discussed infra).

FIG. 14 also shows various functional split options 1400c, for both DL and UL directions. The traditional RAN is an integrated network architecture based on a distributed RAN (D-RAN) model, where D-RAN integrates all RANFs into a few network elements. As alluded to previously, the disaggregated RAN architecture provides flexible function split options to overcome various drawbacks of the D-RAN model. The disaggregated RAN breaks up the integrated network system into several function components that can then be individually re-located as needed without hindering their ability to work together to provide a holistic network services. The split options 1400c are mostly split between the CU 1432 and the DU 1431, but can include a split between the CU 1432, DU 1431, and RU 1430. For each option 1400c, protocol entities on the left side of the figure are included in the RANF implementing the CU 1432 and the protocol entities on the right side of the figure are included in the RANF implementing the DU 1431. For example, the Option 2 function split includes splitting non-RT processing (e.g., RRC and PDCP layers) from RT processing (e.g., RLC, MAC, and PHY layers), where the RANF implementing the CU 1432 performs network functions of the RRC and PDCP layers, and the RANF implementing the DU 1431 performs the baseband processing functions of the RLC (including high-RLC and low-RLC), MAC (including high-MAC and low-MAC), and PHY layers. In some implementations, the PHY layer is further split between the DU 1431 and the RU 1430, where the RANF implementing the DU 1431 performs the high-PHY layer functions and the RU 1430 handles the low-PHY layer functions. In some implementations, the Low-PHY entity may be operated by the RU 1430 regardless of the selected functional split option. Under the Option 2 split, the RANF implementing the CU 1432 can connect to multiple DU 1431 (e.g., the CU 1432 is centralized), which allows RRC and PDCP anchor change to be eliminated during a handover across DUs 1431 and allows the centralized CU 1432 to pool resources across several DUs 1431. In these ways, the option 2 function split can improve resource efficiencies. The particular function split option used may vary depending on the service requirements and network deployment scenarios, and may be implementation specific. It should also be noted that in some implementations, all of the function split options can be selected where each protocol stack entity is operated by a respective RANF (e.g., a first RANF operates the RRC layer, a second RANF operates the PDCP layer, a third RANF operates the high-RLC layer, and so forth until an eighth RANF operates the low-PHY layer). Other split options are possible such as those discussed in [O-RAN.WG7.IPC-HRD-Opt6], [O-RAN.WG7.IPC-HRD-Opt7-2], [O-RAN.WG7.IPC-HRD-Opt8], [O-RAN.WG7.OMAC-HRD], and [O-RAN.WG7.OMC-HRD-Opt7-2].

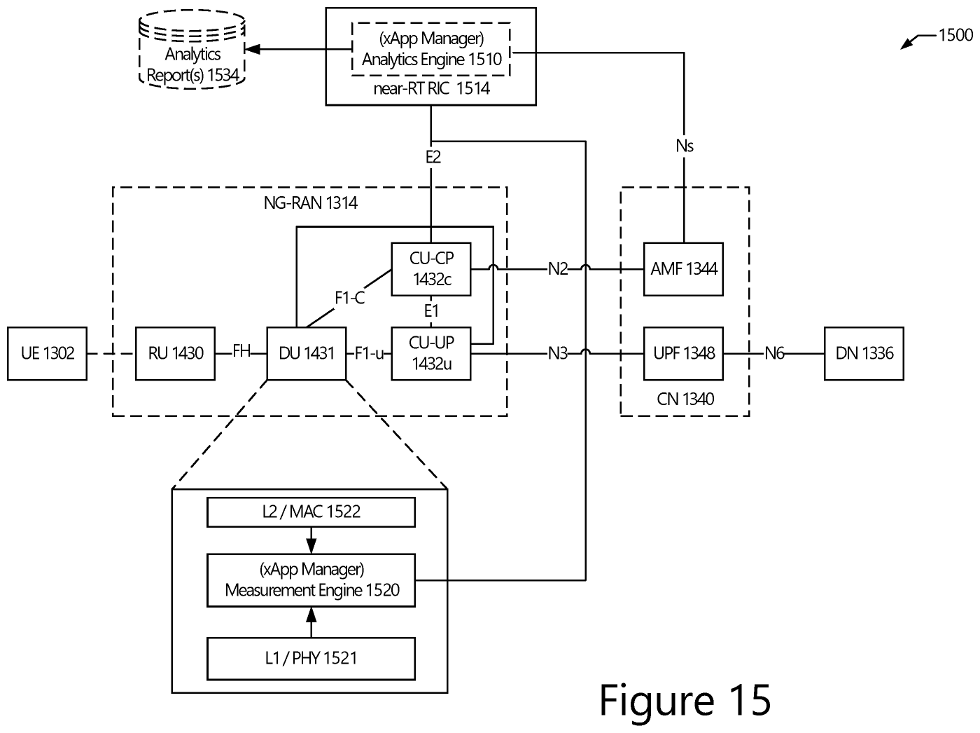

FIG. 15 depicts an example analytics network architecture 1500. The analytics network architecture 1500 includes a UE 1302, NG-RAN 1314, CN 1340, and DN 1336. The NG-RAN 1314 includes a CU-CP 1432c, CU-UP 1432u, DU 1431, and RU 1430. The DU 1431 is connected to the CU-CP 1432c via the F1-C, connected to the CU-UP 1432u via the F1-U, and connected to the RU 1430 via a FH interface. The CU-UP 1432u is connected to the CU-CP 1432c via the E1 interface. Additionally or alternatively, the NG-RAN 1314 can include a disaggregated RAN architecture as discussed previously. The CN 1340 includes an AMF 1344, UPF 1348, among many other NFs such as those discussed previously. In some implementations, the UPF 1348 may reside outside of the CN 1340. The AMF 1344 is connected to the CU-CP 1432c via an N2 interface. The UPF 1348 is connected to the CU-UP 1432u via an N3 interface, and connected to the DN 1336 via an N6 interface. In FIG. 15, like numbered elements are the same as those discussed previously.

The analytics network architecture 1500 also includes a near-RT RIC 1514, which may be the same or similar as any of the RICs discussed herein such as the the RIC 3c14, the near-RT RIC 114, 414, 814, 914, 1014, 1200, and/or some other RIC or elements/entities discussed herein. Here, the near-RT RIC 1514 is connected to the CU-CP 1432c via the E2 interface. The near-RT RIC 1514 includes an xApp manager analytics engine 1510, which may be the same or similar as the xApp manager analytics engine 310-a discussed previously. Here, the near-RT RIC 1514 (or the xApp manager analytics engine 1510) is connected to the AMF 1344 via an Ns interface. Further, the DU 1431 includes a counterpart xApp manager measurement engine 1520, which may be the same or similar as the counterpart xApp manager measurement engine 320. The DU 1431 also includes an L2/MAC function 1522 and an L1/PHY function 1521.

During operation, the NG-RAN 1314 configures (via the DU 1431 and/or the RU 1430) the UE 1302 to transmit and/or receive various signaling using to, for example, RRC messaging and according to RRC protocol procedures (see e.g., [TS38331]). As examples, RRC messages can include an SRS configuration specifying SRS transmissions with specific SRS periodicity, transmission comb, number of symbols, and/or the like. The configurations can also specify various measurements to be performed and collected by the UE 1302. Other signaling/channel configurations can be used as well. When configured, the UE 1302 transmits and/or receives the configured signals/transmissions (e.g., SRS and/or the like) in the configured radio resources to/from the NG-RAN 1314 (e.g., via the DU 1431 and/or the RU 1430). Some of the messages sent to the NG-RAN 1314 can include measurements performed and/or collected by the UE 1302 for various purposes. The L2/MAC function 1522 and L 1/PHY function 1521 also perform various measurements for various purposes as discussed herein. In some implementations, measurements take place the L 1/PHY level and are prioritized by longevity and/or timing requirements (e.g., RT, near-RT, and non-RT as discussed previously).

The L2/MAC function 1522, L1/PHY function 1521, and/or other protocol layers/entities (not shown) provide measurement data (e.g., measurement data 315, 415) to the xApp manager measurement engine 1520. The xApp manager measurement engine 1520 provides the measurement data to the xApp manager analytics engine 1510 via the E2 interface. The xApp manager analytics engine 1510 obtains the measurement data from the xApp manager measurement engine 1520, generates or determines analytics and/or metrics based on the measurement data, and may store the analytics and/or metrics data as one or more analytics reports in an analytics repository 1534. The xApp manager measurement engine 1520 and/or other applications (not shown) consume and acts on analytics in the analytics repository 1534. For example, the xApp manager measurement engine 1520 may handle and respond to O-RAN mission control requests by providing suitable analytics reports to an O-RAN mission control entity (e.g., the SMO/MO elements discussed previously). Additionally or alternatively, the xApp manager measurement engine 1520 can configure various control loops (e.g., control loops 932, 934, 935) based on the analytics and/or generates suitable resource configurations for various xApps and/or NG-RAN nodes based on the analytics.

### 4. Hardware Components, Configurations, and Arrangements

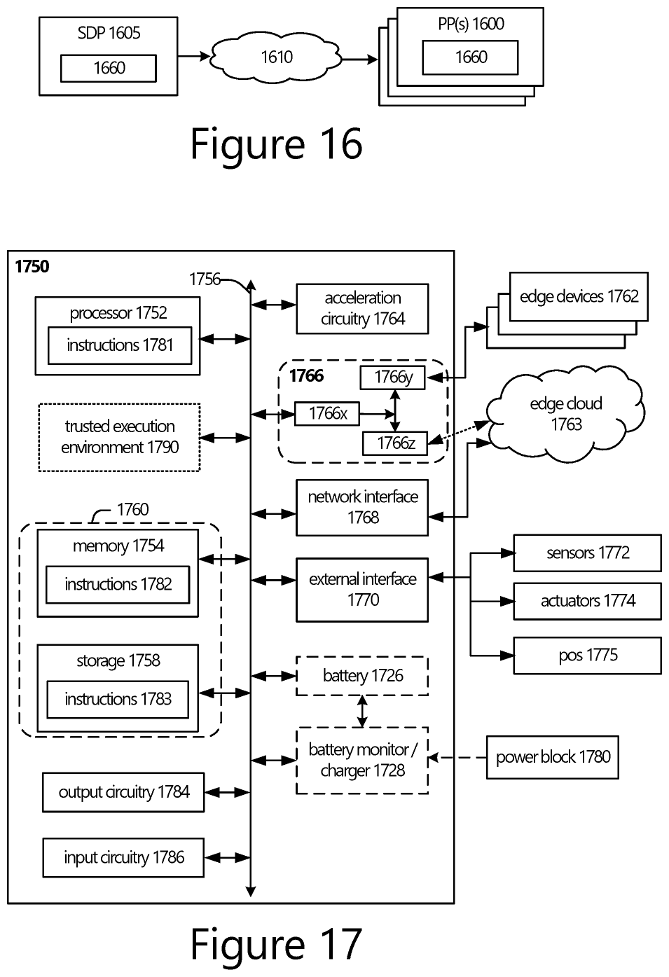

FIG. 16 illustrates an example software (SW) distribution platform (SDP) 1605 to distribute software 1660, such as the example computer readable instructions 1781, 1782, 1783 of FIG. 17, to one or more devices, such as example processor platform(s) (pp) 1600, connected edge devices 1762 (see e.g., FIG. 17), and/or any of the other computing systems/devices discussed herein. The SDP 1605 (or components thereof) may be implemented by any computer server, data facility, cloud service, CDN, edge computing framework, and/or the like, capable of storing and transmitting software (e.g., code, scripts, executable binaries, containers, packages, compressed files, and/or derivatives thereof) to other computing devices (e.g., third parties, the example connected edge devices 1762 of FIG. 17). The SDP 1605 (or components thereof) may be located in a cloud (e.g., data center, and/or the like), a local area network, an edge network, a wide area network, on the Internet, and/or any other location communicatively coupled with the pp 1600.

The pp 1600 and/or connected edge devices 1762 connected edge devices 1762 may include customers, clients, managing devices (e.g., servers), third parties (e.g., customers of an entity owning and/or operating the SDP 1605), IoT devices, and the like. The pp 1600/connected edge devices 1762 may operate in commercial and/or home automation environments. In some examples, a third party is a developer, a seller, and/or a licensor of software such as the example computer readable media 1781, 1782, 1783 of FIG. 17. The third parties may be consumers, users, retailers, OEMs, and/or the like that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), and/or the like). In some examples, the pp 1600/connected edge devices 1762 can be physically located in different geographic locations, legal jurisdictions, and/or the like.

In FIG. 16, the SDP 1605 includes one or more servers (referred to as “servers 1605”) and one or more storage devices (referred to as “storage 1605”). The storage 1605 store the computer readable instructions 1660, which may correspond to the instructions 1781, 1782, 1783 of FIG. 17. The servers 1605 are in communication with a network 1610, which may correspond to any one or more of the Internet and/or any of the example networks as described herein. The servers 1605 are responsive to requests to transmit the software to a requesting party as part of a commercial transaction. Payment for the delivery, sale and/or license of the software may be handled by the servers 1605 and/or via a third-party payment entity. The servers 1605 enable purchasers and/or licensors to download the computer readable instructions 1660 from the SDP 1605.

The servers 1605 are communicatively connected to one or more security domains and/or security devices through which requests and transmissions of the example computer readable instructions 1660 must pass. Additionally or alternatively, the servers 1605 periodically offer, transmit, and/or force updates to the software 1660 to ensure improvements, patches, updates, and/or the like are distributed and applied to the software at the end user devices. The computer readable instructions 1660 are stored on storage 1605 in a particular format. A format of computer readable instructions includes, but is not limited to a particular code language (e.g., Java, JavaScript, Python, C, C #, SQL, HTML, and/or the like), and/or a particular code state (e.g., uncompiled code (e.g., ASCII), interpreted code, linked code, executable code (e.g., a binary), and/or the like), and/or any other format such as those discussed herein. In some examples, the computer readable instructions 1660 stored in the SDP 1605 are in a first format when transmitted to the pp 1600. Additionally or alternatively, the first format is an executable binary in which particular types of the pp 1600 can execute. Additionally or alternatively, the first format is uncompiled code that requires one or more preparation tasks to transform the first format to a second format to enable execution on the pp 1600. For example, the receiving pp 1600 may need to compile the computer readable instructions 1660 in the first format to generate executable code in a second format that is capable of being executed on the pp 1600. Additionally or alternatively, the first format is interpreted code that, upon reaching the pp 1600, is interpreted by an interpreter to facilitate execution of instructions. Additionally or alternatively, different components of the computer readable instructions 1782 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

The various devices and/or systems discussed herein may be servers, appliances, network infrastructure, machines, robots, drones, and/or any other type of computing devices. For example, the edge cloud 1763 may include an appliance computing device that is a self-contained electronic device including a housing, a chassis, a case or a shell. In some circumstances, the housing may be dimensioned for portability such that it can be carried by a human and/or shipped. Alternatively, it may be a smaller module suitable for installation in a vehicle for example. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Smaller, modular implementations may also include an extendible or embedded antenna arrangement for wireless communications. Example housings and/or surfaces thereof may include or connect to mounting hardware to enable attachment to structures such as buildings, telecommunication structures (e.g., poles, antenna structures, and/or the like) and/or racks (e.g., server racks, blade mounts, and/or the like). Example housings and/or surfaces thereof may support one or more sensors (e.g., temperature sensors, vibration sensors, light sensors, acoustic sensors, capacitive sensors, proximity sensors, and/or the like). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, and/or the like) and/or articulating hardware (e.g., robot arms, pivotable appendages, and/or the like). In some circumstances, the sensors may include any type of input devices such as user interface hardware (e.g., buttons, switches, dials, sliders, and/or the like). In some circumstances, example housings include output devices contained in, carried by, embedded therein and/or attached thereto. Output devices may include displays, touchscreens, lights, LEDs, speakers, I/O ports (e.g., USB), and/or the like In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, and/or the like. Example hardware for implementing an appliance computing device is described in conjunction with FIG. 17. The edge cloud 1763 may also include one or more servers and/or one or more multi-tenant servers. Such a server may include an operating system and implement a virtual computing environment. A virtual computing environment may include a hypervisor managing (e.g., spawning, deploying, destroying, and/or the like) one or more virtual machines, one or more containers, and/or the like. Such virtual computing environments provide an execution environment in which one or more applications and/or other software, code or scripts may execute while being isolated from one or more other applications, software, code or scripts.

FIG. 17 illustrates an example of components that may be present in a computing node 1750 for implementing the techniques (e.g., operations, processes, methods, and methodologies) described herein. The compute node 1750 provides a closer view of the respective components of node 1700 when implemented as or as part of a computing device (e.g., as a mobile device, a base station, server, gateway, and/or the like). The compute node 1750 may include any combinations of the hardware or logical components referenced herein, and it may include or couple with any device usable with an edge communication network or a combination of such networks. The components may be implemented as integrated circuitry (ICs), a System on Chip (SoC), portions thereof, discrete electronic devices, or other modules, instruction sets, programmable logic or algorithms, hardware, hardware accelerators, software, firmware, or a combination thereof adapted in the compute node 1750, or as components otherwise incorporated within a chassis of a larger system.

As examples, the compute node 1750 may correspond to the the SMO 102, O-Cloud 106, RIC 114, O-CU-CP 121, O-CU-UP 122, O-DU 115, and/or O-RU 116 of FIG. 1; the RIC and/or srsRAN of FIG. 2; the MO 301, CU 332 (CU-CP 321, CU-UP 322), and/or NG-RAN DU 331 of FIG. 3b; the MO 3c02, RIC 3c14, and/or HW layer 3c50 of FIG. 3c; the near-RT RIC 414 and/or non-RT RIC 412 of FIGS. 4-5; the XAC architecture 600 of FIG. 6; UE 1302, (R)AN 1304, AN 1308, CN 1320 (or one or more NFs therein) and/or DN 1336 of FIG. 13; UE 1402, RU 1430, DU 1431, CU 1432 (CU-CP 1432c, CU-UP 1432u), CN 1442 and/or CN NFs 1-x, RANFs 1-N, and/or edge compute node 1436 of FIGS. 14-15; UEs 711, 721a, NANs 731-733, edge compute node(s) 736, CN 742 (or compute node(s) therein), and/or cloud 744 (or compute node(s) therein) of FIG. 7; SMO 802, O-RAN NFs NFs 804, O-Cloud 806, NG-core 808 (or one or more NFs therein), external system 810, non-RT RIC 812, near-RT RIC 814, and/or RU 816 of FIG. 8; UE(s) 901, SMO 902, O-Cloud 906, e/gNBs 910, Non-RT RIC 912, Near-RT RIC 914, O-DU 915, O-RU 916, O-CU-CP 921, and/or O-CU-UP 922 of FIG. 9; SMO 1002, 0-e/gNBs 1010, non-RT RIC 1012, near-RT RIC 1014, O-DU 1015, O-RU 1016, O-CU-CP 1021, O-CU-UP 1022, EPC 1042a (or one or more NFs therein), and/or 5GC 1042b (or one or more NFs therein) of FIG. 10; O-RAN architecture/framework 1100 of Figure FIG. 11; Near-RT RIC 1200 of FIG. 12; software distribution platform 1605 and/or processor platform(s) 1600 of FIG. 16; MEC hosts/servers and/or MEC platforms in [MEC] implementations; an EAS, EES, and/or ECS in [SA6Edge] implementations; and/or any other component, device, and/or system discussed herein. The compute node 1750 may be embodied as a type of device, appliance, computer, or other “thing” capable of communicating with other edge, networking, or endpoint components. For example, compute node 1750 may be embodied as a smartphone, a mobile compute device, a smart appliance, an in-vehicle compute system (e.g., a navigation system), an edge compute node, a NAN, switch, router, bridge, hub, and/or other device or system capable of performing the described functions.

The compute node 1750 includes processing circuitry in the form of one or more processors 1752. The processor circuitry 1752 includes circuitry such as, but not limited to one or more processor cores and one or more of cache memory, low drop-out voltage regulators (LDOs), interrupt controllers, serial interfaces such as SPI, I²C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 1752 may include one or more hardware accelerators (e.g., same or similar to acceleration circuitry 1764), which may be microprocessors, programmable processing devices (e.g., FPGA, ASIC, and/or the like), or the like. The one or more accelerators may include, for example, computer vision and/or deep learning accelerators. In some implementations, the processor circuitry 1752 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein

The processor circuitry 1752 may be, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low voltage processor, an embedded processor, a special purpose processing unit and/or specialized processing unit, or any other known processing elements, or any suitable combination thereof. In some implementations, the processor circuitry 1752 may be embodied as a specialized x-processing unit (xPU) (where “x” is a letter or character) such as, for example, a data processing unit (DPU), infrastructure processing unit (IPU), network processing unit (NPU), or the like. An xPU may be embodied as a standalone circuit or circuit package, integrated within an SoC, or integrated with networking circuitry (e.g., in a SmartNIC, or enhanced SmartNIC), acceleration circuitry, storage devices, storage disks, and/or AI hardware (e.g., GPUs or programmed FPGAs). The xPU may be designed to receive programming to process one or more data streams and perform specific tasks and actions for the data streams (e.g., hosting (micro)services, performing service management or orchestration, organizing or managing server or data center hardware, managing service meshes, or collecting and distributing telemetry), outside of a CPU or general purpose processing hardware. However, an xPU, a SoC, a CPU, and other variations of the processor circuitry 1752 may work in coordination with each other to execute many types of operations and instructions within and on behalf of the compute node 1750.

The processors (or cores) 1752 may be coupled with or may include memory/storage and may be configured to execute instructions stored in the memory/storage to enable various applications or operating systems to run on the platform 1750. The processors (or cores) 1752 is configured to operate application software to provide a specific service to a user of the platform 1750. Additionally or alternatively, the processor(s) 1752 may be a special-purpose processor(s)/controller(s) configured (or configurable) to operate according to the elements, features, and implementations discussed herein.

As examples, the processor(s) 1752 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 1752 may be a part of a system on a chip (SoC), System-in-Package (SiP), a multi-chip package (MCP), and/or the like, in which the processor(s) 1752 and other components are formed into a single integrated circuit, or a single package, such as the Edison™ or Galileo™ SoC boards from Intel® Corporation. Other examples of the processor(s) 1752 are mentioned elsewhere in the present disclosure.

The processor(s) 1752 may communicate with system memory 1754 over an interconnect (IX) 1756. Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Other types of RAM, such as dynamic RAM (DRAM), synchronous DRAM (SDRAM), and/or the like may also be included. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1758 may also couple to the processor 1752 via the IX 1756. In an example, the storage 1758 may be implemented via a solid-state disk drive (SSDD) and/or high-speed electrically erasable memory (commonly referred to as “flash memory”). Other devices that may be used for the storage 1758 include flash memory cards, such as SD cards, microSD cards, eXtreme Digital (XD) picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, or a combination of any of the above, or other memory. The memory circuitry 1754 and/or storage circuitry 1758 may also incorporate three-dimensional (3D) cross-point (XPOINT) memories from Intel® and Micron®.

In low power implementations, the storage 1758 may be on-die memory or registers associated with the processor 1752. However, in some examples, the storage 1758 may be implemented using a micro hard disk drive (HDD). Further, any number of new technologies may be used for the storage 1758 in addition to, or instead of, the technologies described, such resistance change memories, phase change memories, holographic memories, or chemical memories, among others.

The components of edge computing device 1750 may communicate over an interconnect (IX) 1756. The IX 1756 may represent any suitable type of connection or interface such as, for example, metal or metal alloys (e.g., copper, aluminum, and/or the like), fiber, and/or the like. The IX 1756 may include any number of IX, fabric, and/or interface technologies, including instruction set architecture (ISA), extended ISA (eISA), Inter-Integrated Circuit (I²C), serial peripheral interface (SPI), point-to-point interfaces, power management bus (PMBus), peripheral component interconnect (PCI), PCI express (PCIe), PCI extended (PCIx), Intel® Ultra Path Interconnect (UPI), Intel® Accelerator Link, Intel® QuickPath Interconnect (QPI), Intel® Omni-Path Architecture (OPA), Compute Express Link™ (CXLT™) IX technology, RapidIO™ IX, Coherent Accelerator Processor Interface (CAPI), OpenCAPI, cache coherent interconnect for accelerators (CCIX), Gen-Z Consortium IXs, HyperTransport IXs, NVLink provided by NVIDIA®, a Time-Trigger Protocol (TTP) system, a FlexRay system, PROFIBUS, ARM® Advanced eXtensible Interface (AXI), ARM® Advanced Microcontroller Bus Architecture (AMBA) IX, HyperTransport, Infinity Fabric (IF), and/or any number of other IX technologies. The IX 1756 may be a proprietary bus, for example, used in a SoC based system.

The IX 1756 couples the processor 1752 to communication circuitry 1766 for communications with other devices, such as a remote server (not shown) and/or the connected edge devices 1762. The communication circuitry 1766 is a hardware element, or collection of hardware elements, used to communicate over one or more networks (e.g., cloud 1763) and/or with other devices (e.g., edge devices 1762).

The transceiver 1766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1762. For example, a wireless local area network (WLAN) unit may be used to implement WiFi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1766 (or multiple transceivers) may communicate using multiple standards or radios for communications at a different range. For example, the compute node 1750 may communicate with close devices, e.g., within about 10 meters, using a local transceiver based on BLE, or another low power radio, to save power. More distant connected edge devices 1762, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1766 (e.g., a radio transceiver) may be included to communicate with devices or services in the edge cloud 1763 via local or wide area network protocols. The wireless network transceiver 1766 may be an LPWA transceiver that follows the IEEE 802.15.4, or IEEE 802.15.4g standards, among others. The compute node 1763 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1766, as described herein. For example, the transceiver 1766 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1766 may include radios that are compatible with any number of 3GPP specifications, such as LTE and 5G/NR communication systems, discussed in further detail at the end of the present disclosure. A network interface controller (NIC) 1768 may be included to provide a wired communication to nodes of the edge cloud 1763 or to other devices, such as the connected edge devices 1762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, or PROFINET, among many others. An additional NIC 1768 may be included to enable connecting to a second network, for example, a first NIC 1768 providing communications to the cloud over Ethernet, and a second NIC 1768 providing communications to other devices over another type of network.

Given the variety of types of applicable communications from the device to another component or network, applicable communications circuitry used by the device may include or be embodied by any one or more of components 1764, 1766, 1768, or 1770. Accordingly, in various examples, applicable means for communicating (e.g., receiving, transmitting, and/or the like) may be embodied by such communications circuitry.

The compute node 1750 may include or be coupled to acceleration circuitry 1764, which may be embodied by one or more AI accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as CPLDs or HCPLDs, and/or other forms of specialized processors or circuitry designed to accomplish one or more specialized tasks. These tasks may include AI processing (including machine learning, training, inferencing, and classification operations), visual data processing, network data processing, object detection, rule analysis, or the like. In FPGA-based implementations, the acceleration circuitry 1764 may comprise logic blocks or logic fabric and other interconnected resources that may be programmed (configured) to perform various functions, such as the procedures, methods, functions, and/or the like discussed herein. In such implementations, the acceleration circuitry 1764 may also include memory cells (e.g., EPROM, EEPROM, flash memory, static memory (e.g., SRAM, anti-fuses, and/or the like) used to store logic blocks, logic fabric, data, and/or the like in LUTs and the like.

The IX 1756 also couples the processor 1752 to a sensor hub or external interface 1770 that is used to connect additional devices or subsystems. The additional/external devices may include sensors 1772, actuators 1774, and positioning circuitry 1775.

The sensor circuitry 1772 includes devices, modules, or subsystems whose purpose is to detect events or changes in its environment and send the information (sensor data) about the detected events to some other a device, module, subsystem, and/or the like. Examples of such sensors 1772 include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors, including sensors for measuring the temperature of internal components and sensors for measuring temperature external to the compute node 1750); pressure sensors; barometric pressure sensors; gravimeters; altimeters; image capture devices (e.g., cameras); light detection and ranging (LiDAR) sensors; proximity sensors (e.g., infrared radiation detector and the like); depth sensors, ambient light sensors; optical light sensors; ultrasonic transceivers; microphones; and the like.

The actuators 1774, allow platform 1750 to change its state, position, and/or orientation, or move or control a mechanism or system. The actuators 1774 comprise electrical and/or mechanical devices for moving or controlling a mechanism or system, and converts energy (e.g., electric current or moving air and/or liquid) into some kind of motion. The actuators 1774 may include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 1774 may include one or more electromechanical devices such as pneumatic actuators, hydraulic actuators, electromechanical switches including electromechanical relays (EMRs), motors (e.g., DC motors, stepper motors, servomechanisms, and/or the like), power switches, valve actuators, wheels, thrusters, propellers, claws, clamps, hooks, audible sound generators, visual warning devices, and/or other like electromechanical components. The platform 1750 may be configured to operate one or more actuators 1774 based on one or more captured events and/or instructions or control signals received from a service provider and/or various client systems.

The positioning circuitry 1775 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), and/or the like), or the like. The positioning circuitry 1775 comprises various hardware elements (e.g., including hardware devices such as switches, filters, amplifiers, antenna elements, and the like to facilitate OTA communications) to communicate with components of a positioning network, such as navigation satellite constellation nodes. Additionally or alternatively, the positioning circuitry 1775 may include a Micro-Technology for Positioning, Navigation, and Timing (Micro-PNT) IC that uses a primary timing clock to perform position tracking/estimation without GNSS assistance. The positioning circuitry 1775 may also be part of, or interact with, the communication circuitry 1766 to communicate with the nodes and components of the positioning network. The positioning circuitry 1775 may also provide position data and/or time data to the application circuitry, which may use the data to synchronize operations with various infrastructure (e.g., radio base stations), for turn-by-turn navigation, or the like. When a GNSS signal is not available or when GNSS position accuracy is not sufficient for a particular application or service, a positioning augmentation technology can be used to provide augmented positioning information and data to the application or service. Such a positioning augmentation technology may include, for example, satellite based positioning augmentation (e.g., EGNOS) and/or ground based positioning augmentation (e.g., DGPS). In some implementations, the positioning circuitry 1775 is, or includes an INS, which is a system or device that uses sensor circuitry 1772 (e.g., motion sensors such as accelerometers, rotation sensors such as gyroscopes, and altimeters, magnetic sensors, and/or the like to continuously calculate (e.g., using dead by dead reckoning, triangulation, or the like) a position, orientation, and/or velocity (including direction and speed of movement) of the platform 1750 without the need for external references.

In some optional examples, various input/output (I/O) devices may be present within or connected to, the compute node 1750, which are referred to as input circuitry 1786 and output circuitry 1784 in FIG. 17. The input circuitry 1786 and output circuitry 1784 include one or more user interfaces designed to enable user interaction with the platform 1750 and/or peripheral component interfaces designed to enable peripheral component interaction with the platform 1750. Input circuitry 1786 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 1784 may be included to show information or otherwise convey information, such as sensor readings, actuator position(s), or other like information. Data and/or graphics may be displayed on one or more user interface components of the output circuitry 1784. Output circuitry 1784 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, and/or the like), with the output of characters, graphics, multimedia objects, and the like being generated or produced from the operation of the platform 1750. The output circuitry 1784 may also include speakers or other audio emitting devices, printer(s), and/or the like. Additionally or alternatively, the sensor circuitry 1772 may be used as the input circuitry 1784 (e.g., an image capture device, motion capture device, or the like) and one or more actuators 1774 may be used as the output device circuitry 1784 (e.g., an actuator to provide haptic feedback or the like). In another example, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, and/or the like. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1776 may power the compute node 1750, although, in examples in which the compute node 1750 is mounted in a fixed location, it may have a power supply coupled to an electrical grid, or the battery may be used as a backup or for temporary capabilities. The battery 1776 may be a lithium ion battery, or a metal-air battery, such as a zinc-air battery, an aluminum-air battery, a lithium-air battery, and the like.

A battery monitor/charger 1778 may be included in the compute node 1750 to track the state of charge (SoCh) of the battery 1776, if included. The battery monitor/charger 1778 may be used to monitor other parameters of the battery 1776 to provide failure predictions, such as the state of health (SoH) and the state of function (SoF) of the battery 1776. The battery monitor/charger 1778 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 1778 may communicate the information on the battery 1776 to the processor 1752 over the IX 1756. The battery monitor/charger 1778 may also include an analog-to-digital (ADC) converter that enables the processor 1752 to directly monitor the voltage of the battery 1776 or the current flow from the battery 1776. The battery parameters may be used to determine actions that the compute node 1750 may perform, such as transmission frequency, mesh network operation, sensing frequency, and the like.

A power block 1780, or other power supply coupled to a grid, may be coupled with the battery monitor/charger 1778 to charge the battery 1776. In some examples, the power block 1780 may be replaced with a wireless power receiver to obtain the power wirelessly, for example, through a loop antenna in the compute node 1750. A wireless battery charging circuit, such as an LTC4020 chip from Linear Technologies of Milpitas, California, among others, may be included in the battery monitor/charger 1778. The specific charging circuits may be selected based on the size of the battery 1776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1758 may include instructions 1783 in the form of software, firmware, or hardware commands to implement the techniques described herein. Although such instructions 1782, 1783 are shown as code blocks included in the memory 1754 and the storage 1758, any of the code blocks 1782, 1783 may be replaced with hardwired circuits, for example, built into an application specific integrated circuit (ASIC) or programmed into an FPGA, or the like.

In an example, the instructions 1781, 1782, 1783 provided via the memory 1754, the storage 1758, or the processor 1752 may be embodied as a non-transitory machine-readable medium (NTMRM) 1760 including code to direct the processor 1752 to perform electronic operations in the compute node 1750. The processor 1752 may access the NTMRM 1760 over the IX 1756. For instance, the NTMRM 1760 may be embodied by devices described for the storage 1758 or may include specific storage units such as storage devices and/or storage disks that include optical disks (e.g., digital versatile disk (DVD), compact disk (CD), CD-ROM, Blu-ray disk), flash drives, floppy disks, hard drives (e.g., SSDs), or any number of other hardware devices in which information is stored for any duration (e.g., for extended time periods, permanently, for brief instances, for temporarily buffering, and/or caching). The NTMRM 1760 may include instructions to direct the processor 1752 to perform a specific sequence or flow of actions, for example, as described w.r.t the flowchart(s) and block diagram(s) of operations and functionality depicted above. As used herein, the terms “machine-readable medium” and “computer-readable medium” are interchangeable. As used herein, the term “non-transitory computer-readable medium” is expressly defined to include any type of computer readable storage device and/or storage disk and to exclude propagating signals and to exclude transmission media.

Computer program code for carrying out operations of the present disclosure (e.g., computational logic and/or instructions 1781, 1782, 1783) may be written in any combination of one or more programming languages, including an object oriented programming language such as Python, Ruby, Scala, Smalltalk, Java™, C++, C #, or the like; a procedural programming languages, such as the “C” programming language, the Go (or “Golang”) programming language, or the like; a scripting language such as JavaScript, Server-Side JavaScript (SSJS), JQuery, PHP, Pearl, Python, Ruby on Rails, Accelerated Mobile Pages Script (AMPscript), Mustache Template Language, Handlebars Template Language, Guide Template Language (GTL), PHP, Java and/or Java Server Pages (JSP), Node.js, ASP.NET, JAMscript, and/or the like; a markup language such as Hypertext Markup Language (HTML), Extensible Markup Language (XML), Java Script Object Notion (JSON), Apex®, Cascading Stylesheets (CSS), JavaServer Pages (JSP), MessagePack™, Apache® Thrift, Abstract Syntax Notation One (ASN.1), Google® Protocol Buffers (protobuf), or the like; some other suitable programming languages including proprietary programming languages and/or development tools, or any other languages tools. The computer program code 1781, 1782, 1783 for carrying out operations of the present disclosure may also be written in any combination of the programming languages discussed herein. The program code may execute entirely on the system 1750, partly on the system 1750, as a stand-alone software package, partly on the system 1750 and partly on a remote computer or entirely on the remote computer or server. In the latter scenario, the remote computer may be connected to the system 1750 through any type of network, including a LAN or WAN, or the connection may be made to an external computer (e.g., through the Internet using an Internet Service Provider (ISP)).

In an example, the instructions 1781, 1782, 1783 on the processor circuitry 1752 (separately, or in combination with the instructions 1781, 1782, 1783) may configure execution or operation of a trusted execution environment (TEE) 1790. The TEE 1790 operates as a protected area accessible to the processor circuitry 1702 to enable secure access to data and secure execution of instructions. In some examples, the TEE 1790 may be a physical hardware device that is separate from other components of the system 1750 such as a secure-embedded controller, a dedicated SoC, or a tamper-resistant chipset or microcontroller with embedded processing devices and memory devices. Examples of such implementations include a Desktop and mobile Architecture Hardware (DASH) compliant Network Interface Card (NIC), Intel® Management/Manageability Engine, Intel® Converged Security Engine (CSE) or a Converged Security Management/Manageability Engine (CSME), Trusted Execution Engine (TXE) provided by Intel® each of which may operate in conjunction with Intel® Active Management Technology (AMT) and/or Intel® vPro™ Technology; AMD® Platform Security coProcessor (PSP), AMD® PRO A-Series Accelerated Processing Unit (APU) with DASH manageability, Apple® Secure Enclave coprocessor; IBM® Crypto Express3®, IBM® 4807, 4808, 4809, and/or 4765 Cryptographic Coprocessors, IBM® Baseboard Management Controller (BMC) with Intelligent Platform Management Interface (IPMI), Dell™ Remote Assistant Card II (DRAC II), integrated Dell™ Remote Assistant Card (iDRAC), and the like.

Additionally or alternatively, the TEE 1790 may be implemented as secure enclaves, which are isolated regions of code and/or data within the processor and/or memory/storage circuitry of the system 1750. Only code executed within a secure enclave may access data within the same secure enclave, and the secure enclave may only be accessible using the secure application (which may be implemented by an application processor or a tamper-resistant microcontroller). Various implementations of the TEE 1790, and an accompanying secure area in the processor circuitry 1752 or the memory circuitry 1754 and/or storage circuitry 1758 may be provided, for instance, through use of Intel® Software Guard Extensions (SGX), ARM® TrustZone® hardware security extensions, Keystone Enclaves provided by Oasis Labs™, and/or the like. Other aspects of security hardening, hardware roots-of-trust, and trusted or protected operations may be implemented in the device 1700 through the TEE 1790 and the processor circuitry 1752. Additionally or alternatively, the memory circuitry 1754 and/or storage circuitry 1758 may be divided into isolated user-space instances such as containers, partitions, virtual environments (VEs), and/or the like. The isolated user-space instances may be implemented using a suitable OS-level virtualization technology such as Docker® containers, Kubernetes® containers, Solaris® containers and/or zones, OpenVZ® virtual private servers, Linux® containers (LXC), Podman containers, Singularity containers, DragonFly BSD® virtual kernels and/or jails, chroot jails, and/or the like. Virtual machines could also be used in some implementations. In some examples, the memory circuitry 1704 and/or storage circuitry 1708 may be divided into one or more trusted memory regions for storing applications or software modules of the TEE 1790.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, and/or the like), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, and/or the like) on one or several remote servers. The source code packages may be encrypted when in transit over a network and decrypted, uncompressed, assembled (e.g., linked) if necessary, and compiled or interpreted (e.g., into a library, stand-alone executable, and/or the like) at a local machine, and executed by the local machine.

FIG. 17 depicts a high-level view of components of a varying device, subsystem, or arrangement of a compute node. However, some of the components shown may be omitted, additional components may be present, and a different arrangement of the components shown may occur in other implementations. Further, these arrangements are usable in a variety of use cases and environments, including those discussed below (e.g., a mobile UE in industrial compute for smart city or smart factory, among many other examples).

FIG. 17 depicts a high-level view of components of a varying device, subsystem, or arrangement of a compute node. However, some of the components shown may be omitted, additional components may be present, and a different arrangement of the components shown may occur in other implementations. Further, these arrangements are usable in a variety of use cases and environments, including those discussed below (e.g., a mobile UE in industrial compute for smart city or smart factory, among many other examples).

### 5. Artificial Intelligence and Machine Learning Aspects

Machine learning (ML) involves programming computing systems to optimize a performance criterion using example (training) data and/or past experience. ML refers to the use and development of computer systems that are able to learn and adapt without following explicit instructions, by using algorithms and/or statistical models to analyze and draw inferences from patterns in data. ML involves using algorithms to perform specific task(s) without using explicit instructions to perform the specific task(s), but instead relying on learnt patterns and/or inferences. ML uses statistics to build mathematical model(s) (also referred to as “ML models” or simply “models”) in order to make predictions or decisions based on sample data (e.g., training data). The model is defined to have a set of parameters, and learning is the execution of a computer program to optimize the parameters of the model using the training data or past experience. The trained model may be a predictive model that makes predictions based on an input dataset, a descriptive model that gains knowledge from an input dataset, or both predictive and descriptive. Once the model is learned (trained), it can be used to make inferences (e.g., predictions).

ML algorithms perform a training process on a training dataset to estimate an underlying ML model. An ML algorithm is a computer program that learns from experience with respect to some task(s) and some performance measure(s)/metric(s), and an ML model is an object or data structure created after an ML algorithm is trained with training data. In other words, the term “ML model” or “model” may describe the output of an ML algorithm that is trained with training data. After training, an ML model may be used to make predictions on new datasets. Additionally, separately trained AI/ML models can be chained together in a AI/ML pipeline (or ensemble) during inference or prediction generation. Although the term “ML algorithm” refers to different concepts than the term “ML model,” these terms may be used interchangeably for the purposes of the present disclosure. Any of the ML techniques discussed herein may be utilized, in whole or in part, and variants and/or combinations thereof, for any of the example embodiments discussed herein.

ML may require, among other things, obtaining and cleaning a dataset, performing feature selection, selecting an ML algorithm, dividing the dataset into training data and testing data, training a model (e.g., using the selected ML algorithm), testing the model, optimizing or tuning the model, and determining metrics for the model. Some of these tasks may be optional or omitted depending on the use case and/or the implementation used.

ML algorithms accept model parameters (or simply “parameters”) and/or hyperparameters that can be used to control certain properties of the training process and the resulting model. Model parameters are parameters, values, characteristics, configuration variables, and/or properties that are learnt during training. Model parameters are usually required by a model when making predictions, and their values define the skill of the model on a particular problem. Hyperparameters at least in some examples are characteristics, properties, and/or parameters for an ML process that cannot be learnt during a training process. Hyperparameter are usually set before training takes place, and may be used in processes to help estimate model parameters.

ML techniques generally fall into the following main types of learning problem categories: supervised learning, unsupervised learning, and reinforcement learning. Supervised learning involves building models from a set of data that contains both the inputs and the desired outputs. Unsupervised learning is an ML task that aims to learn a function to describe a hidden structure from unlabeled data. Unsupervised learning involves building models from a set of data that contains only inputs and no desired output labels. Reinforcement learning (RL) is a goal-oriented learning technique where an RL agent aims to optimize a long-term objective by interacting with an environment. Some implementations of AI and ML use data and artificial neural networks (ANNs) in a way that mimics the working of a biological brain. An example of such an implementation is shown by FIG. 18.

FIG. 18 illustrates an example NN 1800, which may be suitable for use by one or more of the computing systems (or subsystems) of the various implementations discussed herein, implemented in part by a HW accelerator, and/or the like. The NN 1800 may be deep neural network (DNN) used as an artificial brain of a compute node or network of compute nodes to handle very large and complicated observation spaces. Additionally or alternatively, the NN 1800 can be some other type of topology (or combination of topologies), such as a convolution NN (CNN), deep CNN (DCN), recurrent NN (RNN), Long Short Term Memory (LSTM) network, a Deconvolutional NN (DNN), gated recurrent unit (GRU), deep belief NN, a feed forward NN (FFN), a deep FNN (DFF), deep stacking network, Markov chain, perception NN, Bayesian Network (BN) or Bayesian NN (BNN), Dynamic BN (DBN), Linear Dynamical System (LDS), Switching LDS (SLDS), Optical NNs (ONNs), an NN for RL and/or deep RL (DRL), and/or the like. NNs are usually used for supervised learning, but can be used for unsupervised learning and/or RL.

The NN 1800 may encompass a variety of ML techniques where a collection of connected artificial neurons 1810 that (loosely) model neurons in a biological brain that transmit signals to other neurons/nodes 1810. The neurons 1810 may also be referred to as nodes 1810, processing elements (PEs) 1810, or the like. The connections 1820 (or edges 1820) between the nodes 1810 are (loosely) modeled on synapses of a biological brain and convey the signals between nodes 1810. Note that not all neurons 1810 and edges 1820 are labeled in FIG. 18 for the sake of clarity.

Each neuron 1810 has one or more inputs and produces an output, which can be sent to one or more other neurons 1810 (the inputs and outputs may be referred to as “signals”). Inputs to the neurons 1810 of the input layer Lₓ can be feature values of a sample of external data (e.g., input variables xᵢ). The input variables xᵢ can be set as a vector containing relevant data (e.g., observations, ML features, and the like). An “ML feature” (or simply “feature”) at least in some examples is an individual measureable property or characteristic of a phenomenon being observed. Features are usually represented using numbers/numerals (e.g., integers), strings, variables, ordinals, real-values, categories, and/or the like. Additionally or alternatively, ML features at least in some examples are individual variables, which may be independent variables, based on observable phenomenon that can be quantified and recorded. ML models use one or more features to make predictions or inferences. In some implementations, new features can be derived from old features. The inputs to individual hidden units 1810 of the hidden layers Lₐ, L_{b}, and L_{c} may be based on the outputs of other neurons 1810.

The outputs of the final output neurons 1810 of the output layer L_{y} (e.g., output variables yⱼ) include predictions, inferences, and/or accomplish a desired/configured task. The output variables yⱼ may be in the form of determinations, inferences, predictions, and/or assessments. Additionally or alternatively, the output variables yⱼ can be set as a vector containing the relevant data (e.g., determinations, inferences, predictions, assessments, and/or the like). For example, the output variables yⱼ may be the HW, SW, and/or NW resource allocations for individual xApps produced by the xApp manager 310-a, 320, 425 discussed previously.

Neurons 1810 may have a threshold such that a signal is sent only if the aggregate signal crosses that threshold. A node 1810 may include an activation function, which defines the output of that node 1810 given an input or set of inputs. Additionally or alternatively, a node 1810 may include a propagation function that computes the input to a neuron 1810 from the outputs of its predecessor neurons 1810 and their connections 1820 as a weighted sum. A bias term can also be added to the result of the propagation function.

The NN 1800 also includes connections 1820, some of which provide the output of at least one neuron 1810 as an input to at least another neuron 1810. Each connection 1820 may be assigned a weight that represents its relative importance. The weights may also be adjusted as learning proceeds. The weight increases or decreases the strength of the signal at a connection 1820.

The neurons 1810 can be aggregated or grouped into one or more layers L where different layers L may perform different transformations on their inputs. In FIG. 18, the NN 1800 comprises an input layer Lₓ, one or more hidden layers Lₐ, L_{b}, and L_{c}, and an output layer L_{y} (where a, b, c, x, and y may be numbers), where each layer L comprises one or more neurons 1810. Signals travel from the first layer (e.g., the input layer L₁), to the last layer (e.g., the output layer L_{y}), possibly after traversing the hidden layers Lₐ, L_{b}, and L_{c} multiple times. In FIG. 18, the input layer Lₐ receives data of input variables xᵢ (where i=1, . . . , p, where p is a number). Hidden layers Lₐ, L_{b}, and L_{c} processes the inputs xᵢ, and eventually, output layer L_{y} provides output variables yⱼ (where j=1, . . . , p′, where p′ is a number that is the same or different than p). In the example of FIG. 18, for simplicity of illustration, there are only three hidden layers Lₐ, L_{b}, and L_{c} in the NN 1800, however, the NN 1800 may include many more (or fewer) hidden layers Lₐ, L_{b}, and L_{c} than are shown.

FIG. 19 shows an RL architecture 1900 comprising an agent 1910 and an environment 1920. The agent 1910 (e.g., software agent or AI agent) is the learner and decision maker, and the environment 1920 comprises everything outside the agent 1910 that the agent 1910 interacts with. The environment 1920 is typically stated in the form of a Markov decision process (MDP), which may be described using dynamic programming techniques. An MDP is a discrete-time stochastic control process that provides a mathematical framework for modeling decision making in situations where outcomes are partly random and partly under the control of a decision maker.

RL is a goal-oriented learning based on interaction with environment. RL is an ML paradigm concerned with how software agents (or AI agents) ought to take actions in an environment in order to maximize a numerical reward signal. In general, RL involves an agent 1910 taking actions in an environment 1920 that is/are interpreted into a reward and a representation of a state, which is then fed back into the agent 1910. In RL, the agent 1910 aims to optimize a long-term objective by interacting with the environment based on a trial and error process. In many RL algorithms, the agent 1910 receives a reward in the next time step (or epoch) to evaluate its previous action. Examples of RL algorithms include Markov decision process (MDP) and Markov chains, deep RL, associative RL, inverse RL, safe RL, multi-armed bandit learning, Q-learning, deep Q networks, dyna-Q, state-action-reward-state-action (SARSA), temporal difference learning, actor-critic reinforcement learning, deep deterministic policy gradient, trust region policy optimization, Monte-Carlo tree search among many others.

The agent 1910 and environment 1920 continually interact with one another, wherein the agent 1910 selects actions A to be performed and the environment 1920 responds to these actions A and presents new situations (or states S) to the agent 1910. An action A comprises all possible actions, tasks, moves, operations, decisions, and/or the like that the agent 1910 can take for a particular context. The state S is a current situation such as a complete description of a system, a unique configuration of information in a program or machine, a snapshot of a measure of various conditions in a system, a view of network conditions/characteristics/state and/or node conditions/characteristics/states based on collected observation data (e.g., telemetry data 515 and/or measurement data 315, 415), and/or the like. In some implementations, the agent 1910 selects an action A to take based on a policy π. The policy π is a strategy that the agent 1910 employs to determine next action A based on the current state S. The environment 1920 also gives rise to rewards R, which are numerical values that the agent 1910 seeks to maximize over time through its choice of actions.

In the example of FIG. 19, the environment 1920 starts by sending a state Sₜ (e.g., a state S at time t) to the agent 1910. In some implementations, the environment 1920 also sends an initial a reward Rₜ (e.g., a reward R at time t, which may be based actions taken based on a previous state) to the agent 1910 with the state Sₜ. The agent 1910, based on its knowledge, takes an action Aₜ in response to that state Sₜ, (and reward Rₜ, if any). The action Aₜ is fed back to the environment 1920, and the environment 1920 sends a state-reward pair including a next state Sₜ₊₁ (e.g., a state S at time t+1) and next reward Rₜ₊₁ (e.g., a reward R at time t+1) to the agent 1910 based on the action Aₜ. The agent 1910 will update its knowledge with the reward Rₜ₊₁ returned by the environment 1920 to evaluate its previous action(s) A. The process repeats until the environment 1920 sends a terminal state S, which ends the process or episode. Additionally or alternatively, the agent 1910 may take a particular action A to optimize a value V. The value V may be an expected long-term return with discount, as opposed to the short-term reward R, wherein Vπ(S) is defined as the expected long-term return of the current state Sunder policy π.

The RL architecture 1900 can also be based on Q-learning, which is a model-free RL algorithm that learns the value of an action A in a particular state S. Q-learning does not require a model of an environment 1920, and can handle problems with stochastic transitions and rewards without requiring adaptations. The “Q” in Q-learning refers to the function that the algorithm computes, which is the expected reward(s) for an action A taken in a given state S. In Q-learning, a Q-value is computed using the state Sₜ and the action Aₜ at time t using the function Q_{π}(Sₜ, Aₜ). Q_{π}(Sₜ, Aₜ) is the long-term return of a current state S taking action A under policy π. For any finite MDP (FMDP), Q-learning finds an optimal policy π in the sense of maximizing the expected value of the total reward over any and all successive steps, starting from the current state S. Additionally, examples of value-based deep RL include deep Q-networks (DQN), double DQN, and dueling DQN. A DQN is formed by substituting the Q-function of the Q-learning with an ANN (see e.g., NN 1800) such as a CNN and/or any other type of ANN such as any of those discussed herein.

### 6. Example Implementations

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example [0313] includes a method of operating an application (app) manager hosted by an edge compute node, wherein the edge compute node hosts a set of edge apps, and the method comprises: receiving measurement data from a set of network access nodes (NANs) connected to the edge compute node; receiving telemetry data from one or more telemetry agents implemented by the edge compute node; determining a resource allocation for a corresponding edge app of the set of edge apps based on the measurement data and the telemetry data; and configuring at least one NAN of the set of NANs or the edge compute node according to the determined resource allocation such that resources indicated by the resource allocation are allocated to the corresponding edge app.

Example [0314] includes the method of example [0313] and/or some other example(s) herein, wherein the measurement data is ephemeral measurement data, and/or the telemetry data is ephemeral telemetry data.

Example [0315] includes the method of examples [0313]-[0314] and/or some other example(s) herein, wherein the resource allocation includes one or more of hardware, software, or resources to be scaled up or scaled down for the corresponding edge app.

Example [0316] includes the method of examples [0313]-[0314] and/or some other example(s) herein, wherein the method includes: receiving a policy from a orchestration function; and determining the resource allocation according to information included in the policy.

Example [0317] includes the method of example [0316] and/or some other example(s) herein, wherein the information included in the policy includes a set of key performance measurements (KPMs), key performance indicators (KPIs), service level agreement (SLA) requirements, or quality of service (QoS) requirements related to related to one or more of accessibility, availability, latency, reliability, user experienced data rates, area traffic capacity, integrity, utilization, retainability, mobility, energy efficiency, and quality of service.

Example [0318] includes the method of examples [0313]-[0317] and/or some other example(s) herein, wherein the method includes: operating one or more machine learning models to determine the resource allocation.

Example [0319] includes the method of example [0318] and/or some other example(s) herein, wherein operating the one or more machine learning models includes: correlating individual data items of the telemetry data with one or more other data items of the telemetry data; and/or correlating individual data items of the measurement data with one or more other data items of the measurement data.

Example [0320] includes the method of examples [0318]-[0319] and/or some other example(s) herein, wherein operating the one or more machine learning models includes: correlating individual data items of the measurement data with the individual data items of the telemetry data.

Example [0321] includes the method of examples [0319]-[0320] and/or some other example(s) herein, wherein operating the one or more machine learning models includes: correlating service management data with the telemetry data or the measurement data.

Example [0322] includes the method of example [0321] and/or some other example(s) herein, wherein operating the one or more machine learning models includes: correlating data items of the service management data related to the received measurement data with resource allocations previously generated for the edge app.

Example [0323] includes the method of example [0322] and/or some other example(s) herein, wherein operating the one or more machine learning models includes: correlating one or more data items of the service management data with one or more resource requirements of the of edge app; and/or correlating the one or more data items of the service management data with one or more resource requirements of a corresponding network slice in which the edge app is to operate.

Example [0324] includes the method of examples [0322]-[0323] and/or some other example(s) herein, wherein the service management data includes one or more of a set of KPIs, a set of KPMs, a set of SLA requirements, and a set of QoS requirements.

Example [0325] includes the method of examples [0318]-[0324] and/or some other example(s) herein, wherein operating the one or more machine learning models includes: correlating platform resource slices of the edge compute node with one or more network slices.

Example [0326] includes the method of examples [0318]-[0325] and/or some other example(s) herein, wherein operating the one or more machine learning models includes: predicting or inferring data to compensate missing data service management data.

Example [0327] includes the method of examples [0318]-[0325] and/or some other example(s) herein, wherein operating the one or more machine learning models includes: predicting a reliability of individual components of the edge compute node based at least on the telemetry data.

Example [0328] includes the method of example [0327] and/or some other example(s) herein, wherein the resource allocation indicates to move the corresponding edge app from being operated by a first processing element of the edge compute node to be operated by a second processing element of the edge compute node.

Example [0329] includes the method of examples [0313]-[0328] and/or some other example(s) herein, wherein the determining the resource allocation includes: determining adjustments to hardware, software, or network resources allocated to the edge app according to a run-time priority level assigned to the edge app.

Example [0330] includes the method of examples [0313]-[0329] and/or some other example(s) herein, wherein the resource allocation indicates to dynamically increase or decrease power levels or frequency levels of a processing element operating the corresponding edge app.

Example [0331] includes the method of examples [0313]-[0330], wherein the resource allocation indicates to dynamically adjust last level cache (LLC), memory bandwidth, or interface bandwidth allocated to the corresponding edge app.

Example [0332] includes the method of examples [0313]-[0329] and/or some other example(s) herein, wherein the configuring includes: configuring a real-time (RT) control loop operated by the at least one NAN; and configuring a near-RT control loop operated by the edge compute node.

Example [0333] includes the method of example [0332] and/or some other example(s) herein, wherein the near-RT control loop operates according to a first time scale, the RT control loop operates according to a second time scale, and the first time scale is larger than the second time scale.

Example [0334] includes the method of examples [0332]-[0333] and/or some other example(s) herein, wherein individual sets of the telemetry data are classified as belonging to a corresponding tier of a set of data tiers.

Example [0335] includes the method of examples [0332]-[0334] and/or some other example(s) herein, wherein individual sets of the measurement data are classified as belonging to a corresponding tier of a set of data tiers.

Example [0336] includes the method of examples [0334]-[0335], and/or some other example(s) herein wherein each tier of the set of data tiers corresponds to a timescale of a control loop of a set of control loops, wherein the set of control loops includes the RT control loop and the near-RT control loop.

Example [0337] includes the method of example [0336] and/or some other example(s) herein, wherein a first tier of the set of data tiers includes RT reference and response data.

Example [0338] includes the method of examples [0336]-[0337] and/or some other example(s) herein, wherein a second tier of the set of data tiers includes data that require RT calculation or processing.

Example [0339] includes the method of examples [0336]-[0338] and/or some other example(s) herein, wherein a third tier of the set of data tiers includes data that require near-RT calculation or processing.

Example [0340] includes the method of examples [0336]-[0339] and/or some other example(s) herein, wherein a fourth tier of the set of data tiers includes data that is used for non-RT calculation or processing.

Example [0341] includes the method of examples [0313]-[0340] and/or some other example(s) herein, wherein the telemetry data includes one or more of single root I/O virtualization (SR-IOV) data; network interface controller (NIC) data; last level cache (LLC) data; memory device data; reliability availability and serviceability (RAS) data; interconnect data; power utilization statistics; core and uncore frequency data; non-uniform memory access (NUMA) awareness information; performance monitoring unit (PMU) data; application, log, trace, and alarm data; Data Plane Development Kit (DPDK) interface data; dynamic load balancing (DLB) data; thermal and/or cooling sensor data; node lifecycle management data; latency statistics; cell statistics; baseband unit (BBU) data; virtual RAN (vRAN) statistics; and user equipment (UE) data.

Example [0342] includes the method of examples [0313]-[0341] and/or some other example(s) herein, wherein the measurement data includes one or more of a set of measurements collected by one or more UEs and a set of measurements collected by at least one NAN of the set of NANs.

Example [0343] includes the method of example [0342] and/or some other example(s) herein, wherein the set of measurements collected by the one or more UEs includes layer 1 (L1) or layer 2 (L2) measurements, and the set of measurements collected by the at least one NAN includes L1 or L2 measurements.

Example [0344] includes the method of examples [0313]-[0343] and/or some other example(s) herein, wherein the measurement data includes one or more of traffic throughput measurements, cell throughput time measurements, baseband unit (BBU) measurements or metrics, latency measurements for uplink (UL) communication pipelines, latency measurements for downlink (DL) communication pipelines, L1 fronthaul (FH) interface measurements, L2 FH interface measurements, L1 air interface measurements, L2 air interface measurements.

Example [0345] includes the method of examples [0313]-[0344] and/or some other example(s) herein, wherein the measurement data includes one or more of bandwidth, network or cell load, latency, jitter, round trip time, number of interrupts, out-of-order delivery of data packets, transmission power, bit error rate, bit error ratio, block error rate, packet error ratio, packet loss rate, packet reception rate, data rate, peak data rate, end-to-end delay, signal-to-noise ratio, signal-to-noise and interference ratio, signal-plus-noise-plus-distortion to noise-plus-distortion ratio, carrier-to-interference plus noise ratio, additive white gaussian noise, energy per bit to noise power density ratio, energy per chip to interference power density ratio, energy per chip to noise power density ratio, peak-to-average power ratio, reference signal received power, reference signal received quality, received signal strength indicator, received channel power indicator, received signal to noise indicator, received signal code power, average noise plus interference, GNSS timing of cell frames for UE positioning, GNSS code measurements, GNSS carrier phase or accumulated delta range, channel interference measurements, thermal noise power measurements, received interference power measurements, power histogram measurements, channel load, and station statistics.

Example [0346] includes the method of examples [0313]-[0345] and/or some other example(s) herein, wherein the measurement data includes one or more of one or more physical channel measurements, one or more reference signal measurements, one or more synchronization signal measurements, one or more beacon signal measurements, one or more discovery signal or frame measurements, and one or more probe frame measurements.

Example [0347] includes the method of examples [0313]-[0346] and/or some other example(s) herein, wherein the method includes: sending the resource allocation to a service management and orchestration framework for management of resources of multiple edge compute nodes.

Example [0348] includes the method of examples [0313]-[0347] and/or some other example(s) herein, wherein the set of edge apps include one or more artificial intelligence (AI) or machine learning apps.

Example [0349] includes the method of examples [0313]-[0348] and/or some other example(s) herein, wherein the set of edge apps include one or more of one or more radio resource management functions, one or more self-organizing network functions, one or more network function automation apps, and one or more policy apps, one or more interference management functions, one or more radio connection management functions, one or more flow management functions, and one or more mobility management functions.

Example [0350] includes the method of examples [0313]-[0349] and/or some other example(s) herein, wherein the set of NANs includes a set of radio access network functions (RANFs) of a next generation (NG) RAN architecture.

Example [0351] includes the method of example [0350] and/or some other example(s) herein, wherein the set of RANFs includes one or more of at least one centralized unit (CU), at least one distributed units (DU), and at least one remote unit (RU).

Example [0352] includes the method of examples [0313]-[0351] and/or some other example(s) herein, wherein the edge compute node operates a RAN intelligent controller (RIC) of an O-RAN Alliance (O-RAN) framework, and the set of edge apps include one or more non-RT RIC apps (xApps) or one or more non-RT RIC applications (rApps).

Example [0353] includes the method of example [0352] and/or some other example(s) herein, wherein the app manager hosted by the edge compute node is an xApp manager.

Example [0354] includes the method of examples [0352]-[0353] and/or some other example(s) herein, wherein the RIC operated by the edge compute node is an O-RAN near-RT RIC.

Example [0355] includes one or more computer readable media comprising instructions, wherein execution of the instructions by processor circuitry is to cause the processor circuitry to perform the method of examples [0313]-[0354] and/or some other example(s) herein.

Example [0356] includes a computer program comprising the instructions of example [0355] and/or some other example(s) herein.

Example [0357] includes an Application Programming Interface defining functions, methods, variables, data structures, and/or protocols for the computer program of example [0356] and/or some other example(s) herein.

Example [0358] includes an apparatus comprising circuitry loaded with the instructions of example [0355] and/or some other example(s) herein.

Example [0359] includes an apparatus comprising circuitry operable to run the instructions of example [0355] and/or some other example(s) herein.

Example [0360] includes an integrated circuit comprising one or more of the processor circuitry and the one or more computer readable media of example [0355] and/or some other example(s) herein.

Example [0361] includes a computing system comprising the one or more computer readable media and the processor circuitry of example [0355] and/or some other example(s) herein.

Example [0362] includes an apparatus comprising means for executing the instructions of example [0355] and/or some other example(s) herein.

Example [0363] includes a signal generated as a result of executing the instructions of example [0355] and/or some other example(s) herein.

Example [0364] includes a data unit generated as a result of executing the instructions of example [0355].

Example [0365] includes the data unit of example [0364] and/or some other example(s) herein, the data unit is a datagram, network packet, data frame, data segment, a Protocol Data Unit (PDU), a Service Data Unit (SDU), a message, or a database object.

Example [0366] includes a signal encoded with the data unit of examples [0364]-[0365] and/or some other example(s) herein.

Example [0367] includes an electromagnetic signal carrying the instructions of example [0355] and/or some other example(s) herein.

Example [0368] includes an edge compute node executing a service as part of one or more edge applications instantiated on virtualization infrastructure, wherein the service includes performing the method of examples [0313]-[0354] and/or some other example(s) herein.

Example [0369] includes an apparatus comprising means for performing the method of examples [0313]-[0354] and/or some other example(s) herein.

### 7. Terminology

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an example,” “in an implementation,” “In some examples,” or “in some implementations,” and the like, each of which may refer to one or more of the same or different examples, implementations, and/or embodiments. Furthermore, the terms “comprising,” “including,” “having,” and the like, as used with respect to (w.r.t) the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “establish” or “establishment” at least in some examples refers to (partial or in full) acts, tasks, operations, and the like, related to bringing or the readying the bringing of something into existence either actively or passively (e.g., exposing a device identity or entity identity). Additionally or alternatively, the term “establish” or “establishment” at least in some examples refers to (partial or in full) acts, tasks, operations, and the like, related to initiating, starting, or warming communication or initiating, starting, or warming a relationship between two entities or elements (e.g., establish a session, establish a session, and the like). Additionally or alternatively, the term “establish” or “establishment” at least in some examples refers to initiating something to a state of working readiness. The term “established” at least in some examples refers to a state of being operational or ready for use (e.g., full establishment). Furthermore, any definition for the term “establish” or “establishment” defined in any specification or standard can be used for purposes of the present disclosure and such definitions are not disavowed by any of the aforementioned definitions.

The term “obtain” at least in some examples refers to (partial or in full) acts, tasks, operations, and the like, of intercepting, movement, copying, retrieval, or acquisition (e.g., from a memory, an interface, or a buffer), on the original packet stream or on a copy (e.g., a new instance) of the packet stream. Other aspects of obtaining or receiving may involving instantiating, enabling, or controlling the ability to obtain or receive a stream of packets (or the following parameters and templates or template values).

The term “receipt” at least in some examples refers to any action (or set of actions) involved with receiving or obtaining an object, data, data unit, and the like, and/or the fact of the object, data, data unit, and the like being received. The term “receipt” at least in some examples refers to an object, data, data unit, and the like, being pushed to a device, system, element, and the like (e.g., often referred to as a push model), pulled by a device, system, element, and the like (e.g., often referred to as a pull model), and/or the like.

The term “element” at least in some examples refers to a unit that is indivisible at a given level of abstraction and has a clearly defined boundary, wherein an element may be any type of entity including, for example, one or more devices, systems, controllers, network elements, modules, and so forth, or combinations thereof.

The term “measurement” at least in some examples refers to the observation and/or quantification of attributes of an object, event, or phenomenon. Additionally or alternatively, the term “measurement” at least in some examples refers to a set of operations having the object of determining a measured value or measurement result, and/or the actual instance or execution of operations leading to a measured value. Additionally or alternatively, the term “measurement” at least in some examples refers to data recorded during testing.

The term “metric” at least in some examples refers to a quantity produced in an assessment of a measured value. Additionally or alternatively, the term “metric” at least in some examples refers to data derived from a set of measurements. Additionally or alternatively, the term “metric” at least in some examples refers to set of events combined or otherwise grouped into one or more values. Additionally or alternatively, the term “metric” at least in some examples refers to a combination of measures or set of collected data points.

The term “telemetry” at least in some examples refers to the in situ collection of measurements, metrics, or other data (often referred to as “telemetry data” or the like) and their conveyance to another device or equipment. Additionally or alternatively, the term “telemetry” at least in some examples refers to the automatic recording and transmission of data from a remote or inaccessible source to a system for monitoring and/or analysis. The term “telemeter” at least in some examples refers to a device used in telemetry, and at least in some examples, includes sensor(s), a communication path, and a control device.

The term “telemetry pipeline” at least in some examples refers to a set of elements/entities/components in a telemetry system through which telemetry data flows, is routed, or otherwise passes through the telemetry system. Additionally or alternatively, the term “telemetry pipeline” at least in some examples refers to a system, mechanism, and/or set of elements/entities/components that takes collected data from an agent and leads to the generation of insights via analytics. Examples of entities/elements/components of a telemetry pipeline include a collector or collection agent, analytics function, data upload and transport (e.g., to the cloud or the like), data ingestion (e.g., Extract Transform and Load (ETL)), storage, and analysis functions. The term “telemetry system” at least in some examples refers to a set of physical and/or virtual components that interconnect to provide telemetry services and/or to provide for the collection, communication, and analysis of data.

The term “signal” at least in some examples refers to an observable change in a quality and/or quantity. Additionally or alternatively, the term “signal” at least in some examples refers to a function that conveys information about of an object, event, or phenomenon. Additionally or alternatively, the term “signal” at least in some examples refers to any time varying voltage, current, or electromagnetic wave that may or may not carry information. The term “digital signal” at least in some examples refers to a signal that is constructed from a discrete set of waveforms of a physical quantity so as to represent a sequence of discrete values.

The term “instrumentation” at least in some examples refers to measuring instruments used for indicating, measuring, and/or recording physical quantities and/or physical events. Additionally or alternatively, the term “instrumentation” at least in some examples refers to the measure of performance (e.g., of SW and/or HW (sub)systems) in order to diagnose errors and/or to write trace information. The term “trace” or “tracing” at least in some examples refers to logging or otherwise recording information about a program's execution and/or information about the operation of a component, subsystem, device, system, and/or other entity; in some examples, “tracing” is used for debugging and/or analysis purposes.

The terms “ego” (as in, e.g., “ego device”) and “subject” (as in, e.g., “data subject”) at least in some examples refers to an entity, element, device, system, and the like, that is under consideration or being considered. The terms “neighbor” and “proximate” (as in, e.g., “proximate device”) at least in some examples refers to an entity, element, device, system, and the like, other than an ego device or subject device.

The term “identifier” at least in some examples refers to a value, or a set of values, that uniquely identify an identity in a certain scope. Additionally or alternatively, the term “identifier” at least in some examples refers to a sequence of characters that identifies or otherwise indicates the identity of a unique object, element, or entity, or a unique class of objects, elements, or entities. Additionally or alternatively, the term “identifier” at least in some examples refers to a sequence of characters used to identify or refer to an application, program, session, object, element, entity, variable, set of data, and/or the like. The “sequence of characters” mentioned previously at least in some examples refers to one or more names, labels, words, numbers, letters, symbols, and/or any combination thereof. Additionally or alternatively, the term “identifier” at least in some examples refers to a name, address, label, distinguishing index, and/or attribute. Additionally or alternatively, the term“identifier” at least in some examples refers to an instance of identification. The term “persistent identifier” at least in some examples refers to an identifier that is reused by a device or by another device associated with the same person or group of persons for an indefinite period. The term “identification” at least in some examples refers to a process of recognizing an identity as distinct from other identities in a particular scope or context, which may involve processing identifiers to reference an identity in an identity database.

The term “circuitry” at least in some examples refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), system on chip (SoC), system in package (SiP), multi-chip package (MCP), digital signal processor (DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “processor circuitry” at least in some examples refers to, is part of, or includes circuitry capable of sequentially and automatically carrying out a sequence of arithmetic or logical operations, or recording, storing, and/or transferring digital data. The term “processor circuitry” at least in some examples refers to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” at least in some examples refers to one or more HW devices for storing data, including random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, read-only memory (ROM), programmable ROM (PROM), erasable PROM (EPROM), electrically EPROM (EEPROM), flash memory, non-volatile RAM (NVRAM), magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

The terms “machine-readable medium” and “computer-readable medium” refers to tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP). A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, and/or the like), interpreting, loading, organizing (e.g., dynamically or statically linking), encoding, decoding, encrypting, unencrypting, packaging, unpackaging, or otherwise manipulating the information into the instructions. In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, and/or the like) on one or several remote servers. The source code packages may be encrypted when in transit over a network and decrypted, uncompressed, assembled (e.g., linked) if necessary, and compiled or interpreted (e.g., into a library, stand-alone executable, and/or the like) at a local machine, and executed by the local machine. The terms “machine-readable medium” and “computer-readable medium” may be interchangeable for purposes of the present disclosure. The term “non-transitory computer-readable medium at least in some examples refers to any type of memory, computer readable storage device, and/or storage disk and may exclude propagating signals and transmission media.

The term “interface circuitry” at least in some examples refers to, is part of, or includes circuitry that enables the exchange of information between two or more components or devices. The term “interface circuitry” at least in some examples refers to one or more HW interfaces, for example, buses, I/O interfaces, peripheral component interfaces, network interface cards, and/or the like.

The term “SmartNIC” at least in some examples refers to a network interface controller (NIC), network adapter, or a programmable network adapter card with programmable HW accelerators and network connectivity (e.g., Ethernet or the like) that can offload various tasks or workloads from other compute nodes or compute platforms such as servers, application processors, and/or the like and accelerate those tasks or workloads. A SmartNIC has similar networking and offload capabilities as an IPU, but remains under the control of the host as a peripheral device.

The term “infrastructure processing unit” or “IPU” at least in some examples refers to an advanced networking device with hardened accelerators and network connectivity (e.g., Ethernet or the like) that accelerates and manages infrastructure functions using tightly coupled, dedicated, programmable cores. In some implementations, an IPU offers full infrastructure offload and provides an extra layer of security by serving as a control point of a host for running infrastructure applications. An IPU is capable of offloading the entire infrastructure stack from the host and can control how the host attaches to this infrastructure. This gives service providers an extra layer of security and control, enforced in HW by the IPU.

The term “device” at least in some examples refers to a physical entity embedded inside, or attached to, another physical entity in its vicinity, with capabilities to convey digital information from or to that physical entity.

The term “entity” at least in some examples refers to a distinct component of an architecture or device, or information transferred as a payload.

The term “controller” at least in some examples refers to an element or entity that has the capability to affect a physical entity, such as by changing its state or causing the physical entity to move.

The term “scheduler” at least in some examples refers to an entity or element that assigns resources (e.g., processor time, network links, memory space, and/or the like) to perform tasks. The term “network scheduler” at least in some examples refers to a node, element, or entity that manages network packets in transmit and/or receive queues of one or more protocol stacks of network access circuitry (e.g., a network interface controller (NIC), baseband processor, and the like). The term “network scheduler” at least in some examples can be used interchangeably with the terms “packet scheduler”, “queueing discipline” or “qdisc”, and/or “queueing algorithm”.

The term “arbiter” at least in some examples refers to an electronic device, entity, or element that allocates access to shared resources and/or data sources. The term “memory arbiter” at least in some examples refers to an electronic device, entity, or element that allocates, decides, or determines when individual access/collection agents will be allowed to access a shared resource and/or data source.

The term “terminal” at least in some examples refers to point at which a conductor from a component, device, or network comes to an end. Additionally or alternatively, the term “terminal” at least in some examples refers to an electrical connector acting as an interface to a conductor and creating a point where external circuits can be connected. In some examples, terminals may include electrical leads, electrical connectors, electrical connectors, solder cups or buckets, and/or the like.

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like.

The term “computer system” at least in some examples refers to any type interconnected electronic devices, computer devices, or components thereof. Additionally, the terms “computer system” and/or “system” at least in some examples refer to various components of a computer that are communicatively coupled with one another. Furthermore, the term “computer system” and/or “system” at least in some examples refer to multiple computer devices and/or multiple computing systems that are communicatively coupled with one another and configured to share computing and/or networking resources.

The term “server” at least in some examples refers to a computing device or system, including processing hardware and/or process space(s), an associated storage medium such as a memory device or database, and, in some instances, suitable application(s) as is known in the art. The terms “server system” and “server” may be used interchangeably herein, and these terms at least in some examples refers to one or more computing system(s) that provide access to a pool of physical and/or virtual resources. The various servers discussed herein include computer devices with rack computing architecture component(s), tower computing architecture component(s), blade computing architecture component(s), and/or the like. The servers may represent a cluster of servers, a server farm, a cloud computing service, or other grouping or pool of servers, which may be located in one or more datacenters. The servers may also be connected to, or otherwise associated with, one or more data storage devices (not shown). Moreover, the servers may include an operating system (OS) that provides executable program instructions for the general administration and operation of the individual server computer devices, and may include a computer-readable medium storing instructions that, when executed by a processor of the servers, may allow the servers to perform their intended functions. Suitable implementations for the OS and general functionality of servers are known or commercially available, and are readily implemented by persons having ordinary skill in the art.

The term “platform” at least in some examples refers to an environment in which instructions, program code, software elements, and the like can be executed or otherwise operate, and examples of such an environment include an architecture (e.g., a motherboard, a computing system, and/or the like), one or more hardware elements (e.g., embedded systems, and the like), a cluster of compute nodes, a set of distributed compute nodes or network, an operating system, a virtual machine (VM), a virtualization container, a software framework, a client application (e.g., web browser or the like) and associated application programming interfaces, a cloud computing service (e.g., platform as a service (PaaS)), or other underlying software executed with instructions, program code, software elements, and the like.

The term “architecture” at least in some examples refers to a computer architecture or a network architecture. The term “computer architecture” at least in some examples refers to a physical and logical design or arrangement of software and/or hardware elements in a computing system or platform including technology standards for interacts therebetween. The term “network architecture” at least in some examples refers to a physical and logical design or arrangement of software and/or hardware elements in a network including communication protocols, interfaces, and media transmission.

The term “appliance,” “computer appliance,” and the like, at least in some examples refers to a computer device or computer system with program code (e.g., software or firmware) that is specifically designed to provide a specific computing resource. The term “virtual appliance” at least in some examples refers to a virtual machine image to be implemented by a hypervisor-equipped device that virtualizes or emulates a computer appliance or otherwise is dedicated to provide a specific computing resource. The term “security appliance”, “firewall”, and the like at least in some examples refers to a computer appliance designed to protect computer networks from unwanted traffic and/or malicious attacks. The term “policy appliance” at least in some examples refers to technical control and logging mechanisms to enforce or reconcile policy rules (information use rules) and to ensure accountability in information systems.

The term “gateway” at least in some examples refers to a network appliance that allows data to flow from one network to another network, or a computing system or application configured to perform such tasks. Examples of gateways include IP gateways, Internet-to-Orbit (I2O) gateways, IoT gateways, cloud storage gateways, and/or the like.

The term “user equipment” or “UE” at least in some examples refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, and the like. Furthermore, the term “user equipment” or “UE” may include any type of wireless/wired device or any computing device including a wireless communications interface. Examples of UEs, client devices, and the like, include desktop computers, workstations, laptop computers, mobile data terminals, smartphones, tablet computers, wearable devices, machine-to-machine (M2M) devices, machine-type communication (MTC) devices, Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, helmet-mounted display devices, augmented reality (AR) devices, virtual reality (VR) devices, mixed reality (MR) devices, and/or other like systems or devices.

The term “station” or “STA” at least in some examples refers to a logical entity that is a singly addressable instance of a medium access control (MAC) and physical layer (PHY) interface to the wireless medium (WM). The term “wireless medium” or WM” at least in some examples refers to the medium used to implement the transfer of protocol data units (PDUs) between peer physical layer (PHY) entities of a wireless local area network (LAN). The term “access point” or “AP” at least in some examples refers to an entity that contains one station (STA) and provides access to the distribution services, via the wireless medium (WM) for associated STAs. An AP comprises a STA and a distribution system access function (DSAF).

The term “network element” at least in some examples refers to physical or virtualized equipment and/or infrastructure used to provide and/or consume wired or wireless communication network services. In some examples, the term “network element” may be considered synonymous to and/or referred to as a networked computer, networking hardware, network equipment, network node, router, switch, hub, bridge, radio network controller, network access node (NAN), base station, access point (AP), RAN device, RAN node, gateway, server, network appliance, network function (NF), virtualized NF (VNF), UE, and/or the like.

The term “network access node” or “NAN” at least in some examples refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” may include specialized digital signal processing, network function hardware, and/or compute hardware to operate as a compute node. In some examples, a “network access node” or “NAN” may be split into multiple functional blocks operating in software for flexibility, cost, and performance. In some examples, a “network access node” or “NAN” may be a base station (e.g., an evolved Node B (eNB) or a next generation Node B (gNB)), an access point and/or wireless network access point, router, switch, hub, radio unit or remote radio head, Transmission Reception Point (TRxP), a gateway device (e.g., Residential Gateway, Wireline 5G Access Network, Wireline 5G Cable Access Network, Wireline BBF Access Network, and the like), network appliance, and/or some other network access hardware.

The term “cell” at least in some examples refers to a radio network object that can be uniquely identified by a UE from an identifier (e.g., cell ID) that is broadcasted over a geographical area from a network access node (NAN). Additionally or alternatively, the term “cell” at least in some examples refers to a geographic area covered by a NAN. The term “E-UTEAN NodeB”, “eNodeB”, or “eNB” at least in some examples refers to a RAN node providing E-UTRA user plane (PDCP/RLC/MAC/PHY) and control plane (RRC) protocol terminations towards a UE, and connected via an S1 interface to the Evolved Packet Core (EPC). Two or more eNBs are interconnected with each other (and/or with one or more en-gNBs) by means of an X2 interface. The term “next generation eNB” or “ng-eNB” at least in some examples refers to a RAN node providing E-UTRA user plane and control plane protocol terminations towards a UE, and connected via the NG interface to the 5GC. Two or more ng-eNBs are interconnected with each other (and/or with one or more gNBs) by means of an Xn interface. The term “Next Generation NodeB”, “gNodeB”, or “gNB” at least in some examples refers to a RAN node providing NR user plane and control plane protocol terminations towards a UE, and connected via the NG interface to the 5GC. Two or more gNBs are interconnected with each other (and/or with one or more ng-eNBs) by means of an Xn interface. The term “E-UTRA-NR gNB” or “en-gNB” at least in some examples refers to a RAN node providing NR user plane and control plane protocol terminations towards a UE, and acting as a Secondary Node in E-UTRA-NR Dual Connectivity (EN-DC) scenarios (see e.g., 3GPP TS 37.340 v17.2.0 (2022 Oct. 2) (“[TS37340]”)). Two or more en-gNBs are interconnected with each other (and/or with one or more eNBs) by means of an X2 interface. The term “Next Generation RAN node” or “NG-RAN node” at least in some examples refers to either a gNB or an ng-eNB. The term “IAB-node” at least in some examples refers to a RAN node that supports new radio (NR) access links to user equipment (UEs) and NR backhaul links to parent nodes and child nodes. The term “IAB-donor” at least in some examples refers to a RAN node (e.g., a gNB) that provides network access to UEs via a network of backhaul and access links. The term “Transmission Reception Point”, “TRP”, or “TRxP” at least in some examples refers to an antenna array with one or more antenna elements available to a network located at a specific geographical location for a specific area.

The term “Central Unit” or “CU” at least in some examples refers to a logical node hosting radio resource control (RRC), Service Data Adaptation Protocol (SDAP), and/or Packet Data Convergence Protocol (PDCP) protocols/layers of an NG-RAN node, or RRC and PDCP protocols of the en-gNB that controls the operation of one or more DUs; a CU terminates an F1 interface connected with a DU and may be connected with multiple DUs. The term “Distributed Unit” or “DU” at least in some examples refers to a logical node hosting Backhaul Adaptation Protocol (BAP), F1 application protocol (F1AP), radio link control (RLC), medium access control (MAC), and physical (PHY) layers of the NG-RAN node or en-gNB, and its operation is partly controlled by a CU; one DU supports one or multiple cells, and one cell is supported by only one DU; and a DU terminates the F1 interface connected with a CU. The term “Radio Unit” or “RU” at least in some examples refers to a logical node hosting PHY layer or Low-PHY layer and radiofrequency (RF) processing based on a lower layer functional split. The term “split architecture” at least in some examples refers to an architecture in which an RU and DU are physically separated from one another, and/or an architecture in which a DU and a CU are physically separated from one another. The term “integrated architecture at least in some examples refers to an architecture in which an RU and DU are implemented on one platform, and/or an architecture in which a DU and a CU are implemented on one platform.

The term “Residential Gateway” or “RG” at least in some examples refers to a device providing, for example, voice, data, broadcast video, video on demand, to other devices in customer premises. The term “Wireline 5G Access Network” or “W-5GAN” at least in some examples refers to a wireline AN that connects to a 5GC via N2 and N3 reference points. The W-5GAN can be either a W-5GBAN or W-5GCAN. The term “Wireline 5G Cable Access Network” or “W-5GCAN” at least in some examples refers to an Access Network defined in/by CableLabs. The term “Wireline BBF Access Network” or “W-5GBAN” at least in some examples refers to an Access Network defined in/by the Broadband Forum (BBF). The term “Wireline Access Gateway Function” or “W-AGF” at least in some examples refers to a Network function in W-5GAN that provides connectivity to a 3GPP 5G Core network (5GC) to 5G-RG and/or FN-RG. The term “5G-RG” at least in some examples refers to an RG capable of connecting to a 5GC playing the role of a user equipment with regard to the 5GC; it supports secure element and exchanges N1 signaling with 5GC. The 5G-RG can be either a 5G-BRG or 5G-CRG.

The term “edge computing” encompasses many implementations of distributed computing that move processing activities and resources (e.g., compute, storage, acceleration resources) towards the “edge” of the network, in an effort to reduce latency and increase throughput for endpoint users (client devices, user equipment, and the like). Such edge computing implementations typically involve the offering of such activities and resources in cloud-like services, functions, applications, and subsystems, from one or multiple locations accessible via wireless networks. Thus, the references to an “edge” of a network, cluster, domain, system or computing arrangement used herein are groups or groupings of functional distributed compute elements and, therefore, generally unrelated to “edges” (links or connections) as used in graph theory.

The term “central office” or “CO” at least in some examples refers to an aggregation point for telecommunications infrastructure within an accessible or defined geographical area, often where telecommunication service providers have traditionally located switching equipment for one or multiple types of access networks. In some examples, a CO can be physically designed to house telecommunications infrastructure equipment or compute, data storage, and network resources. The CO need not, however, be a designated location by a telecommunications service provider. The CO may host any number of compute devices for Edge applications and services, or even local implementations of cloud-like services.

The term “cloud computing” or “cloud” at least in some examples refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like).

The term “compute resource” or simply “resource” at least in some examples refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, and the like), operating systems, virtual machines (VMs), software/applications, computer files, and/or the like. A “hardware resource” at least in some examples refers to compute, storage, and/or network resources provided by physical hardware element(s). A “virtualized resource” at least in some examples refers to compute, storage, and/or network resources provided by virtualization infrastructure to an application, device, system, and the like. The term “network resource” or “communication resource” at least in some examples refers to resources that are accessible by computer devices/systems via a communications network. The term “system resources” at least in some examples refers to any kind of shared entities to provide services, and may include computing and/or network resources. System resources may be considered as a set of coherent functions, network data objects or services, accessible through a server where such system resources reside on a single host or multiple hosts and are clearly identifiable.

The term “workload” at least in some examples refers to an amount of work performed by a computing system, device, entity, and the like, during a period of time or at a particular instant of time. A workload may be represented as a benchmark, such as a response time, throughput (e.g., how much work is accomplished over a period of time), and/or the like. Additionally or alternatively, the workload may be represented as a memory workload (e.g., an amount of memory space needed for program execution to store temporary or permanent data and to perform intermediate computations), processor workload (e.g., a number of instructions being executed by a processor during a given period of time or at a particular time instant), an I/O workload (e.g., a number of inputs and outputs or system accesses during a given period of time or at a particular time instant), database workloads (e.g., a number of database queries during a period of time), a network-related workload (e.g., a number of network attachments, a number of mobility updates, a number of radio link failures, a number of handovers, an amount of data to be transferred over an air interface, and the like), and/or the like. Various algorithms may be used to determine a workload and/or workload characteristics, which may be based on any of the aforementioned workload types.

The term “cloud service provider” or “CSP” at least in some examples refers to an organization which operates typically large-scale “cloud” resources comprised of centralized, regional, and Edge data centers (e.g., as used in the context of the public cloud). In other examples, a CSP may also be referred to as a “Cloud Service Operator” or “CSO”. References to “cloud computing” generally refer to computing resources and services offered by a CSP or a CSO, at remote locations with at least some increased latency, distance, or constraints relative to edge computing.

The term “data center” at least in some examples refers to a purpose-designed structure that is intended to house multiple high-performance compute and data storage nodes such that a large amount of compute, data storage and network resources are present at a single location. This often entails specialized rack and enclosure systems, suitable heating, cooling, ventilation, security, fire suppression, and power delivery systems. The term may also refer to a compute and data storage node in some contexts. A data center may vary in scale between a centralized or cloud data center (e.g., largest), regional data center, and edge data center (e.g., smallest).

The term “network function” or “NF” at least in some examples refers to a functional block within a network infrastructure that has one or more external interfaces and a defined functional behavior. The term “network service” or “NS” at least in some examples refers to a composition of Network Function(s) and/or Network Service(s), defined by its functional and behavioral specification(s). The term “network function virtualization” or “NFV” at least in some examples refers to the principle of separating network functions from the hardware they run on by using virtualization techniques and/or virtualization technologies. The term “virtualized network function” or “VNF” at least in some examples refers to an implementation of an NF that can be deployed on a Network Function Virtualization Infrastructure (NFVI). The term “Network Functions Virtualization Infrastructure Manager” or “NFVI” at least in some examples refers to a totality of all hardware and software components that build up the environment in which VNFs are deployed. The term “management function” at least in some examples refers to a logical entity playing the roles of a service consumer and/or a service producer. The term “management service” at least in some examples refers to a set of offered management capabilities.

The term “RAN function” or “RANF” at least in some examples refers to a functional block within a radio access network (RAN) architecture that has one or more external interfaces and a defined behavior related to the operation of a RAN or RAN node. Additionally or alternatively, the term “RAN function” or “RANF” at least in some examples refers to a set of functions and/or NFs that are part of a RAN. Additionally or alternatively, the term “RAN function” or “RANF” at least in some examples refers to a set of functions in or operated by an E2 node. The term “Application Function” or “AF” at least in some examples refers to an element or entity that interacts with an NF (inside or outside of a core network), a RANF, and/or other elements in order to provide services. Additionally or alternatively, the term “Application Function” or “AF” at least in some examples refers to an edge compute node or ECT framework from the perspective of a core network (e.g., a 3GPP 5G core network). The term “edge compute function” or “ECF” at least in some examples refers to an element or entity that performs an aspect of an edge computing technology (ECT), an aspect of edge networking technology (ENT), or performs an aspect of one or more edge computing services running over the ECT or ENT. The term “management function” at least in some examples refers to a logical entity playing the roles of a service consumer and/or a service producer. The term “management service” at least in some examples refers to a set of offered management capabilities.

The term “slice” at least in some examples refers to a set of characteristics and behaviors that separate one instance, traffic, data flow, application, application instance, link or connection, RAT, device, system, entity, element, and the like from another instance, traffic, data flow, application, application instance, link or connection, RAT, device, system, entity, element, and the like, or separate one type of instance, and the like, from another instance, and the like. The term “network slice” at least in some examples refers to a logical network that provides specific network capabilities and network characteristics and/or supports various service properties for network slice service consumers. Additionally or alternatively, the term “network slice” at least in some examples refers to a logical network topology connecting a number of endpoints using a set of shared or dedicated network resources that are used to satisfy specific service level objectives (SLOs) and/or service level agreements (SLAs). The term “network slicing” at least in some examples refers to methods, processes, techniques, and technologies used to create one or multiple unique logical and virtualized networks over a common multi-domain infrastructure. The term “access network slice”, “radio access network slice”, or “RAN slice” at least in some examples refers to a part of a network slice that provides resources in a RAN to fulfill one or more application and/or service requirements (e.g., SLAs, and the like). The term “network slice instance” at least in some examples refers to a set of Network Function instances and the required resources (e.g. compute, storage and networking resources) which form a deployed network slice. Additionally or alternatively, the term “network slice instance” at least in some examples refers to a representation of a service view of a network slice. The term “network instance” at least in some examples refers to information identifying a domain. The term “service consumer” at least in some examples refers to an entity that consumes one or more services.

The term “service producer” at least in some examples refers to an entity that offers, serves, or otherwise provides one or more services. The term “service provider” at least in some examples refers to an organization or entity that provides one or more services to at least one service consumer. For purposes of the present disclosure, the terms “service provider” and “service producer” may be used interchangeably even though these terms may refer to difference concepts. Examples of service providers include cloud service provider (CSP), network service provider (NSP), application service provider (ASP) (e.g., Application software service provider in a service-oriented architecture (ASSP)), internet service provider (ISP), telecommunications service provider (TSP), online service provider (OSP), payment service provider (PSP), managed service provider (MSP), storage service providers (SSPs), SAML service provider, and/or the like. At least in some examples, SLAs may specify, for example, particular aspects of the service to be provided including quality, availability, responsibilities, metrics by which service is measured, as well as remedies or penalties should agreed-on service levels not be achieved. The term “SAML service provider” at least in some examples refers to a system and/or entity that receives and accepts authentication assertions in conjunction with a single sign-on (SSO) profile of the Security Assertion Markup Language (SAML) and/or some other security mechanism(s).

The term “Virtualized Infrastructure Manager” or “VIM” at least in some examples refers to a functional block that is responsible for controlling and managing the NFVI compute, storage and network resources, usually within one operator's infrastructure domain.

The term “virtualization container”, “execution container”, or “container” at least in some examples refers to a partition of a compute node that provides an isolated virtualized computation environment. The term “OS container” at least in some examples refers to a virtualization container utilizing a shared Operating System (OS) kernel of its host, where the host providing the shared OS kernel can be a physical compute node or another virtualization container. Additionally or alternatively, the term “container” at least in some examples refers to a standard unit of software (or a package) including code and its relevant dependencies, and/or an abstraction at the application layer that packages code and dependencies together. Additionally or alternatively, the term “container” or “container image” at least in some examples refers to a lightweight, standalone, executable software package that includes everything needed to run an application such as, for example, code, runtime environment, system tools, system libraries, and settings.

The term “virtual machine” or “VM” at least in some examples refers to a virtualized computation environment that behaves in a same or similar manner as a physical computer and/or a server. The term “hypervisor” at least in some examples refers to a software element that partitions the underlying physical resources of a compute node, creates VMs, manages resources for VMs, and isolates individual VMs from each other.

The term “edge compute node” or “edge compute device” at least in some examples refers to an identifiable entity implementing an aspect of edge computing operations, whether part of a larger system, distributed collection of systems, or a standalone apparatus. In some examples, a compute node may be referred to as a “edge node”, “edge device”, “edge system”, whether in operation as a client, server, or intermediate entity. Additionally or alternatively, the term “edge compute node” at least in some examples refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. References to a “node” used herein are generally interchangeable with a “device”, “component”, and “sub-system”; however, references to an “edge computing system” generally refer to a distributed architecture, organization, or collection of multiple nodes and devices, and which is organized to accomplish or offer some aspect of services or resources in an edge computing setting.

The term “cluster” at least in some examples refers to a set or grouping of entities as part of an Edge computing system (or systems), in the form of physical entities (e.g., different computing systems, networks or network groups), logical entities (e.g., applications, functions, security constructs, containers), and the like. In some locations, a “cluster” is also referred to as a “group” or a “domain”. The membership of cluster may be modified or affected based on conditions or functions, including from dynamic or property-based membership, from network or system management scenarios, or from various example techniques discussed below which may add, modify, or remove an entity in a cluster. Clusters may also include or be associated with multiple layers, levels, or properties, including variations in security features and results based on such layers, levels, or properties.

The term “Data Network” or “DN” at least in some examples refers to a network hosting data-centric services such as, for example, operator services, the internet, third-party services, or enterprise networks. Additionally or alternatively, a DN at least in some examples refers to service networks that belong to an operator or third party, which are offered as a service to a client or user equipment (UE). DNs are sometimes referred to as “Packet Data Networks” or “PDNs”. The term “Local Area Data Network” or “LADN” at least in some examples refers to a DN that is accessible by the UE only in specific locations, that provides connectivity to a specific DNN, and whose availability is provided to the UE.

The term “Internet of Tings” or “IoT” at least in some examples refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smarthome, smart building and/or smart city technologies), and the like. IoT devices are usually low-power devices without heavy compute or storage capabilities. The term “Edge IoT devices” at least in some examples refers to any kind of IoT devices deployed at a network's edge.

The term “protocol” at least in some examples refers to a predefined procedure or method of performing one or more operations. Additionally or alternatively, the term “protocol” at least in some examples refers to a common means for unrelated objects to communicate with each other (sometimes also called interfaces).

The term “communication protocol” at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like. In various implementations, a “protocol” and/or a “communication protocol” may be represented using a protocol stack, a finite state machine (FSM), and/or any other suitable data structure.

The term “standard protocol” at least in some examples refers to a protocol whose specification is published and known to the public and is controlled by a standards body.

The term “protocol stack” or “network stack” at least in some examples refers to an implementation of a protocol suite or protocol family. In various implementations, a protocol stack includes a set of protocol layers, where the lowest protocol deals with low-level interaction with hardware and/or communications interfaces and each higher layer adds additional capabilities.

The term “application layer” at least in some examples refers to an abstraction layer that specifies shared communications protocols and interfaces used by hosts in a communications network. Additionally or alternatively, the term “application layer” at least in some examples refers to an abstraction layer that interacts with software applications that implement a communicating component, and may include identifying communication partners, determining resource availability, and synchronizing communication. Examples of application layer protocols include HTTP, HTTPs, File Transfer Protocol (FTP), Dynamic Host Configuration Protocol (DHCP), Internet Message Access Protocol (IMAP), Lightweight Directory Access Protocol (LDAP), MQTT (MQ Telemetry Transport), Remote Authentication Dial-In User Service (RADIUS), Diameter protocol, Extensible Authentication Protocol (EAP), RDMA over Converged Ethernet version 2 (RoCEv2), Real-time Transport Protocol (RTP), RTP Control Protocol (RTCP), Real Time Streaming Protocol (RTSP), SBMV Protocol, Skinny Client Control Protocol (SCCP), Session Initiation Protocol (SIP), Session Description Protocol (SDP), Simple Mail Transfer Protocol (SMTP), Simple Network Management Protocol (SNMP), Simple Service Discovery Protocol (SSDP), Small Computer System Interface (SCSI), Internet SCSI (iSCSI), iSCSI Extensions for RDMA (iSER), Transport Layer Security (TLS), voice over IP (VoIP), Virtual Private Network (VPN), Extensible Messaging and Presence Protocol (XMPP), and/or the like.

The term “session layer” at least in some examples refers to an abstraction layer that controls dialogues and/or connections between entities or elements, and may include establishing, managing and terminating the connections between the entities or elements.

The term “transport layer” at least in some examples refers to a protocol layer that provides end-to-end (e2e) communication services such as, for example, connection-oriented communication, reliability, flow control, and multiplexing. Examples of transport layer protocols include datagram congestion control protocol (DCCP), fibre channel protocol (FBC), Generic Routing Encapsulation (GRE), GPRS Tunneling (GTP), Micro Transport Protocol (pTP), Multipath TCP (MPTCP), MultiPath QUIC (MPQUIC), Multipath UDP (MPUDP), Quick UDP Internet Connections (QUIC), Remote Direct Memory Access (RDMA), Resource Reservation Protocol (RSVP), Stream Control Transmission Protocol (SCTP), transmission control protocol (TCP), user datagram protocol (UDP), and/or the like.

The term “network layer” at least in some examples refers to a protocol layer that includes means for transferring network packets from a source to a destination via one or more networks. Additionally or alternatively, the term “network layer” at least in some examples refers to a protocol layer that is responsible for packet forwarding and/or routing through intermediary nodes. Additionally or alternatively, the term “network layer” or “internet layer” at least in some examples refers to a protocol layer that includes interworking methods, protocols, and specifications that are used to transport network packets across a network. As examples, the network layer protocols include internet protocol (IP), IP security (IPsec), Internet Control Message Protocol (ICMP), Internet Group Management Protocol (IGMP), Open Shortest Path First protocol (OSPF), Routing Information Protocol (RIP), RDMA over Converged Ethernet version 2 (RoCEv2), Subnetwork Access Protocol (SNAP), and/or some other internet or network protocol layer.

The term “link layer” or “data link layer” at least in some examples refers to a protocol layer that transfers data between nodes on a network segment across a physical layer. Examples of link layer protocols include logical link control (LLC), medium access control (MAC), Ethernet, RDMA over Converged Ethernet version 1 (RoCEv1), and/or the like.

The term “radio resource control”, “RRC layer”, or “RRC” at least in some examples refers to a protocol layer or sublayer that performs system information handling; paging; establishment, maintenance, and release of RRC connections; security functions; establishment, configuration, maintenance and release of Signaling Radio Bearers (SRBs) and Data Radio Bearers (DRBs); mobility functions/services; QoS management; and some sidelink specific services and functions over the Uu interface (see e.g., 3GPP TS 36.331 v17.2.0 (2022 Oct. 4) and/or 3GPP TS 38.331 v17.2.0 (2022 Oct. 2) (“[TS38331]”)).

The term “Service Data Adaptation Protocol”, “SDAP layer”, or “SDAP” at least in some examples refers to a protocol layer or sublayer that performs mapping between QoS flows and a data radio bearers (DRBs) and marking QoS flow IDs (QFI) in both DL and UL packets (see e.g., 3GPP TS 37.324 v17.0.0 (2022 Apr. 13)).

The term “Packet Data Convergence Protocol”, “PDCP layer”, or “PDCP” at least in some examples refers to a protocol layer or sublayer that performs transfer user plane or control plane data; maintains PDCP sequence numbers (SNs); header compression and decompression using the Robust Header Compression (ROHC) and/or Ethernet Header Compression (EHC) protocols; ciphering and deciphering; integrity protection and integrity verification; provides timer based SDU discard; routing for split bearers; duplication and duplicate discarding; reordering and in-order delivery; and/or out-of-order delivery (see e.g., 3GPP TS 36.323 v17.1.0 (2022 Jul. 17) and/or 3GPP TS 38.323 v17.2.0 (2022 Sep. 29)).

The term “radio link control layer”, “RLC layer”, or “RLC” at least in some examples refers to a protocol layer or sublayer that performs transfer of upper layer PDUs; sequence numbering independent of the one in PDCP; error Correction through ARQ; segmentation and/or re-segmentation of RLC SDUs; reassembly of SDUs; duplicate detection; RLC SDU discarding; RLC re-establishment; and/or protocol error detection (see e.g., 3GPP TS 38.322 v17.1.0 (2022 Jul. 17) and 3GPP TS 36.322 v17.0.0 (2022 Apr. 15)).

The term “medium access control protocol”, “MAC protocol”, or “MAC” at least in some examples refers to a protocol that governs access to the transmission medium in a network, to enable the exchange of data between stations in a network. Additionally or alternatively, the term “medium access control layer”, “MAC layer”, or “MAC” at least in some examples refers to a protocol layer or sublayer that performs functions to provide frame-based, connectionless-mode (e.g., datagram style) data transfer between stations or devices. Additionally or alternatively, the term “medium access control layer”, “MAC layer”, or “MAC” at least in some examples refers to a protocol layer or sublayer that performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding (see e.g., [IEEE802], 3GPP TS 38.321 v17.2.0 (2022 Oct. 1) and 3GPP TS 36.321 v17.2.0 (2022 Oct. 3) (collectively referred to as “[TSMAC]”)).

The term “physical layer”, “PHY layer”, or “PHY” at least in some examples refers to a protocol layer or sublayer that includes capabilities to transmit and receive modulated signals for communicating in a communications network (see e.g., [IEEE802], 3GPP TS 38.201 v17.0.0 (2022 Jan. 5) and 3GPP TS 36.201 v17.0.0 (2022 Mar. 31)).

The term “radio technology” at least in some examples refers to technology for wireless transmission and/or reception of electromagnetic radiation for information transfer. The term “radio access technology” or “RAT” at least in some examples refers to the technology used for the underlying physical connection to a radio based communication network. The term “RAT type” at least in some examples may identify a transmission technology and/or communication protocol used in an access network, for example, new radio (NR), Long Term Evolution (LTE), narrowband IoT (NB-IOT), untrusted non-3GPP, trusted non-3GPP, trusted Institute of Electrical and Electronics Engineers (IEEE) 802 (e.g., [IEEE80211]; see also IEEE Standard for Local and Metropolitan Area Networks: Overview and Architecture, IEEE Std 802-2014, pp. 1-74 (30 Jun. 2014) (“[IEEE802]”), the contents of which is hereby incorporated by reference in its entirety), non-3GPP access, MuLTEfire, WiMAX, wireline, wireline-cable, wireline broadband forum (wireline-BBF), and the like. Examples of RATs and/or wireless communications protocols include Advanced Mobile Phone System (AMPS) technologies such as Digital AMPS (D-AMPS), Total Access Communication System (TACS) (and variants thereof such as Extended TACS (ETACS), and the like); Global System for Mobile Communications (GSM) technologies such as Circuit Switched Data (CSD), High-Speed CSD (HSCSD), General Packet Radio Service (GPRS), and Enhanced Data Rates for GSM Evolution (EDGE); Third Generation Partnership Project (3GPP) technologies including, for example, Universal Mobile Telecommunications System (UMTS) (and variants thereof such as UMTS Terrestrial Radio Access (UTRA), Wideband Code Division Multiple Access (W-CDMA), Freedom of Multimedia Access (FOMA), Time Division-Code Division Multiple Access (TD-CDMA), Time Division-Synchronous Code Division Multiple Access (TD-SCDMA), and the like), Generic Access Network (GAN)/Unlicensed Mobile Access (UMA), High Speed Packet Access (HSPA) (and variants thereof such as HSPA Plus (HSPA+), and the like), Long Term Evolution (LTE) (and variants thereof such as LTE-Advanced (LTE-A), Evolved UTRA (E-UTRA), LTE Extra, LTE-A Pro, LTE LAA, MuLTEfire, and the like), Fifth Generation (5G) or New Radio (NR), and the like; ETSI technologies such as High Performance Radio Metropolitan Area Network (HiperMAN) and the like; IEEE technologies such as [IEEE802] and/or WiFi (e.g., [IEEE80211] and variants thereof), Worldwide Interoperability for Microwave Access (WiMAX) (e.g., [WiMAX] and variants thereof), Mobile Broadband Wireless Access (MBWA)/iBurst (e.g., IEEE 802.20 and variants thereof), and the like; Integrated Digital Enhanced Network (iDEN) (and variants thereof such as Wideband Integrated Digital Enhanced Network (WiDEN); millimeter wave (mmWave) technologies/standards (e.g., wireless systems operating at 10-300 GHz and above such as 3GPP 5G, Wireless Gigabit Alliance (WiGig) standards (e.g., IEEE 802.1 lad, IEEE 802.11ay, and the like); short-range and/or wireless personal area network (WPAN) technologies/standards such as Bluetooth (and variants thereof such as Bluetooth 5.3, Bluetooth Low Energy (BLE), and the like), IEEE 802.15 technologies/standards (e.g., IEEE Standard for Low-Rate Wireless Networks, IEEE Std 802.15.4-2020, pp. 1-800 (23 Jul. 2020) (“[IEEE802154]”), ZigBee, Thread, IPv6 over Low power WPAN (6LoWPAN), WirelessHART, MiWi, ISA100.11a, IEEE Standard for Local and metropolitan area networks—Part 15.6: Wireless Body Area Networks, IEEE Std 802.15.6-2012, pp. 1-271 (29 Feb. 2012), WiFi-direct, ANT/ANT+, Z-Wave, 3GPP Proximity Services (ProSe), Universal Plug and Play (UPnP), low power Wide Area Networks (LPWANs), Long Range Wide Area Network (LoRA or LoRaWAN™), and the like; optical and/or visible light communication (VLC) technologies/standards such as IEEE Standard for Local and metropolitan area networks—Part 15.7: Short-Range Optical Wireless Communications, IEEE Std 802.15.7-2018, pp. 1-407 (23 Apr. 2019), and the like; V2X communication including 3GPP cellular V2X (C-V2X), Wireless Access in Vehicular Environments (WAVE) (IEEE Standard for Information technology—Local and metropolitan area networks—Specific requirements—Part 11: Wireless LAN Medium Access Control (MAC) and Physical Layer (PHY) Specifications Amendment 6: Wireless Access in Vehicular Environments, IEEE Std 802.11p-2010, pp. 1-51 (15 Jul. 2010) (“[IEEE80211p]”), which is now part of [IEEE80211]), IEEE 802.11bd (e.g., for vehicular ad-hoc environments), Dedicated Short Range Communications (DSRC), Intelligent-Transport-Systems (ITS) (including the European ITS-G5, ITS-G5B, ITS-G5C, and the like); Sigfox; Mobitex; 3GPP2 technologies such as cdmaOne (2G), Code Division Multiple Access 2000 (CDMA 2000), and Evolution-Data Optimized or Evolution-Data Only (EV-DO); Push-to-talk (PTT), Mobile Telephone System (MTS) (and variants thereof such as Improved MTS (IMTS), Advanced MTS (AMTS), and the like); Personal Digital Cellular (PDC); Personal Handy-phone System (PHS), Cellular Digital Packet Data (CDPD); Cellular Digital Packet Data (CDPD); DataTAC; Digital Enhanced Cordless Telecommunications (DECT) (and variants thereof such as DECT Ultra Low Energy (DECT ULE), DECT-2020, DECT-5G, and the like); Ultra High Frequency (UHF) communication; Very High Frequency (VHF) communication; and/or any other suitable RAT or protocol. In addition to the aforementioned RATs/standards, any number of satellite uplink technologies may be used for purposes of the present disclosure including, for example, radios compliant with standards issued by the International Telecommunication Union (ITU), or the ETSI, among others. The examples provided herein are thus understood as being applicable to various other communication technologies, both existing and not yet formulated.

The term “V2X” at least in some examples refers to vehicle to vehicle (V2V), vehicle to infrastructure (V2I), infrastructure to vehicle (I2V), vehicle to network (V2N), and/or network to vehicle (N2V) communications and associated radio access technologies.

The term “channel” at least in some examples refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” at least in some examples refers to a connection between two devices through a RAT for the purpose of transmitting and receiving information.

The term “subframe” at least in some examples at least in some examples refers to a time interval during which a signal is signaled. In some implementations, a subframe is equal to 1 millisecond (ms). The term “time slot” at least in some examples at least in some examples refers to an integer multiple of consecutive subframes. The term “superframe” at least in some examples at least in some examples refers to a time interval comprising two time slots.

The term “interoperability” at least in some examples refers to the ability of STAs utilizing one communication system or RAT to communicate with other STAs utilizing another communication system or RAT. The term “Coexistence” at least in some examples refers to sharing or allocating radiofrequency resources among STAs using either communication system or RAT.

The term “reliability” at least in some examples refers to the ability of a computer-related component (e.g., software, hardware, or network element/entity) to consistently perform a desired function and/or operate according to a specification. Additionally or alternatively, the term “reliability” at least in some examples refers to the probability that a product, system, or service will perform its intended function adequately for a specified period of time, or will operate in a defined environment with a low probability of failure. Additionally or alternatively, the term “reliability” in the context of network communications (e.g., “network reliability”) at least in some examples refers to the ability of a network to carry out communication. Additionally or alternatively, the term “reliability” at least in some examples refers to the percentage value of successfully performed operations/tasks and/or delivered transmissions to a given system entity within the time constraint required by a targeted service out of all the attempted operations/tasks and/or transmissions (see e.g., 3GPP TS 22.261 v19.0.0 (2022 Sep. 23) (“[TS22261]”), the contents of which are hereby incorporated by reference in its entirety). The term “network reliability” at least in some examples refers to a probability or measure of delivering a specified amount of data from a source to a destination (or sink).

The term “redundancy” at least in some examples refers to duplication of components or functions of a system, device, entity, or element to increase the reliability of the system, device, entity, or element. Additionally or alternatively, the term “redundancy” or “network redundancy” at least in some examples refers to the use of redundant physical or virtual hardware and/or interconnections. An example of network redundancy includes deploying a pair of network appliances with duplicated cabling connecting to the inside and/or outside a specific network, placing multiple appliances in active states, and the like. The term “resilience” at least in some examples refers to the ability of a system, device, entity, or element to absorb and/or avoid damage or degradation without suffering complete or partial failure. Additionally or alternatively, the term “resilience” at least in some examples refers to a system, device, entity, or element to that maintains state awareness and/or an accepted level of operational normalcy in response to disturbances, including threats of an unexpected and malicious nature. Additionally or alternatively, the term “resilience”, “network resilience”, or “networking resilience” at least in some examples refers to a network, system, device, entity, or element to provide and/or implement a level of quality of service (QoS) and/or quality of experience (QoE), provide and/or implement traffic routing and/or rerouting over one or multiple paths, duplication of hardware components and/or physical links, provide and/or implement virtualized duplication (e.g., duplication NFs, VNFs, virtual machines (VMs), containers, and/or the like), provide and/or implement self-recovery mechanisms, and/or the like.

The term “flow” at least in some examples refers to a sequence of data and/or data units (e.g., datagrams, packets, or the like) from a source entity/element to a destination entity/element. Additionally or alternatively, the terms “flow” or “traffic flow” at least in some examples refer to an artificial and/or logical equivalent to a call, connection, or link. Additionally or alternatively, the terms “flow” or “traffic flow” at least in some examples refer to a sequence of packets sent from a particular source to a particular unicast, anycast, or multicast destination that the source desires to label as a flow; from an upper-layer viewpoint, a flow may include of all packets in a specific transport connection or a media stream, however, a flow is not necessarily 1:1 mapped to a transport connection. Additionally or alternatively, the terms “flow” or “traffic flow” at least in some examples refer to a set of data and/or data units (e.g., datagrams, packets, or the like) passing an observation point in a network during a certain time interval. Additionally or alternatively, the term “flow” at least in some examples refers to a user plane data link that is attached to an association. Examples are circuit switched phone call, voice over IP call, reception of an SMS, sending of a contact card, PDP context for internet access, demultiplexing a TV channel from a channel multiplex, calculation of position coordinates from geopositioning satellite signals, and/or the like. For purposes of the present disclosure, the terms “traffic flow”, “data flow”, “dataflow”, “packet flow”, “network flow”, and/or “flow” may be used interchangeably even though these terms at least in some examples refers to different concepts.

The term “stream” or “data stream” at least in some examples refers to a sequence of data elements made available over time. Additionally or alternatively, the term “stream”, “data stream”, or “streaming” refers to a manner of processing in which an object is not represented by a complete data structure of nodes occupying memory proportional to a size of that object, but are processed “on the fly” as a sequence of events. At least in some examples, functions that operate on a stream, which may produce another stream, are referred to as “filters,” and can be connected in pipelines, analogously to function composition; filters may operate on one item of a stream at a time, or may base an item of output on multiple input items, such as a moving average or the like.

The term “distributed computing” at least in some examples refers to computation resources that are geographically distributed within the vicinity of one or more localized networks' terminations. The term “distributed computations” at least in some examples refers to a model in which components located on networked computers communicate and coordinate their actions by passing messages interacting with each other in order to achieve a common goal.

The term “service” at least in some examples refers to the provision of a discrete function within a system and/or environment. Additionally or alternatively, the term “service” at least in some examples refers to a functionality or a set of functionalities that can be reused. The term “microservice” at least in some examples refers to one or more processes that communicate over a network to fulfil a goal using technology-agnostic protocols (e.g., HTTP or the like). Additionally or alternatively, the term “microservice” at least in some examples refers to services that are relatively small in size, messaging-enabled, bounded by contexts, autonomously developed, independently deployable, decentralized, and/or built and released with automated processes. Additionally or alternatively, the term “microservice” at least in some examples refers to a self-contained piece of functionality with clear interfaces, and may implement a layered architecture through its own internal components. Additionally or alternatively, the term “microservice architecture” at least in some examples refers to a variant of the service-oriented architecture (SOA) structural style wherein applications are arranged as a collection of loosely-coupled services (e.g., fine-grained services) and may use lightweight protocols. For the purposes of the present disclosure, the term “service” may refer to a service, a microservice, or both a service and microservice even though these terms may refer to different concepts.

The term “session” at least in some examples refers to a temporary and interactive information interchange between two or more communicating devices, two or more application instances, between a computer and user, and/or between any two or more entities or elements. Additionally or alternatively, the term “session” at least in some examples refers to a connectivity service or other service that provides or enables the exchange of data between two entities or elements. The term “network session” at least in some examples refers to a session between two or more communicating devices over a network. The term “web session” at least in some examples refers to session between two or more communicating devices over the Internet or some other network. The term “session identifier,” “session ID,” or “session token” at least in some examples refers to a piece of data that is used in network communications to identify a session and/or a series of message exchanges.

The term “quality” at least in some examples refers to a property, character, attribute, or feature of something as being affirmative or negative, and/or a degree of excellence of something. Additionally or alternatively, the term “quality” at least in some examples, in the context of data processing, refers to a state of qualitative and/or quantitative aspects of data, processes, and/or some other aspects of data processing systems. The term “Quality of Service” or “QoS’ at least in some examples refers to a description or measurement of the overall performance of a service (e.g., telephony and/or cellular service, network service, wireless communication/connectivity service, cloud computing service, and/or the like). In some cases, the QoS may be described or measured from the perspective of the users of that service, and as such, QoS may be the collective effect of service performance that determine the degree of satisfaction of a user of that service. In other cases, QoS at least in some examples refers to traffic prioritization and resource reservation control mechanisms rather than the achieved perception of service quality. In these cases, QoS is the ability to provide different priorities to different applications, users, or flows, or to guarantee a certain level of performance to a flow. In either case, QoS is characterized by the combined aspects of performance factors applicable to one or more services such as, for example, service operability performance, service accessibility performance; service retain ability performance; service reliability performance, service integrity performance, and other factors specific to each service. Several related aspects of the service may be considered when quantifying the QoS, including packet loss rates, bit rates, throughput, transmission delay, availability, reliability, jitter, signal strength and/or quality measurements, and/or other measurements such as those discussed herein. Additionally or alternatively, the term “Quality of Service” or “QoS' at least in some examples refers to mechanisms that provide traffic-forwarding treatment based on flow-specific traffic classification. In some examples, Additionally or alternatively, the term “Quality of Service” or “QoS’ at least in some examples is based on the definitions provided by SERIES E: OVERALL NETWORK OPERATION, TELEPHONE SERVICE, SERVICE OPERATION AND HUMAN FACTORS Quality of telecommunication services: concepts, models, objectives and dependability planning—Terms and definitions related to the quality of telecommunication services, Definitions of terms related to quality of service, ITU-T Recommendation E.800 (September/2008) (“[ITUE800]”), the contents of which is hereby incorporated by reference in its entirety. In some implementations, the term “Quality of Service” or “QoS” can be used interchangeably with the term “Class of Service” or “CoS”. The term “Class of Service” or “CoS’ at least in some examples refers to mechanisms that provide traffic-forwarding treatment based on non-flow-specific traffic classification. In some implementations, the term “Class of Service” or “CoS” can be used interchangeably with the term “Quality of Service” or “QoS”. The term “QoS flow” at least in some examples refers to the finest granularity for QoS forwarding treatment in a network. The term “5G QoS flow’ at least in some examples refers to the finest granularity for QoS forwarding treatment in a 5G System (5GS). Traffic mapped to the same QoS flow (or 5G QoS flow) receive the same forwarding treatment.

The term “forwarding treatment” at least in some examples refers to the precedence, preferences, and/or prioritization a packet belonging to a particular data flow receives in relation to other traffic of other data flows. Additionally or alternatively, the term “forwarding treatment” at least in some examples refers to one or more parameters, characteristics, and/or configurations to be applied to packets belonging to a data flow when processing the packets for forwarding. Examples of such characteristics may include resource type (e.g., non-guaranteed bit rate (GBR), GBR, delay-critical GBR, and/or the like); priority level; class or classification; packet delay budget; packet error rate; averaging window; maximum data burst volume; minimum data burst volume; scheduling policy/weights; queue management policy; rate shaping policy; link layer protocol and/or RLC configuration; admission thresholds; and/or the like. In some implementations, the term “forwarding treatment” may be referred to as “Per-Hop Behavior” or “PHB”.

The term “admission control” at least in some examples refers to a function or process that decides if new packets, messages, work, tasks, and/or the like, entering a system should be admitted to enter the system or not. Additionally or alternatively, the term “admission control” at least in some examples refers to a validation process where a check is performed before a connection is established to see if current resources are sufficient for the proposed connection.

The term “QoS Identifier” at least in some examples refers to a scalar that is used as a reference to a specific QoS forwarding behavior (e.g., packet loss rate, packet delay budget, and/or the like) to be provided to a QoS flow. This may be implemented in an access network by referencing node specific parameters that control the QoS forwarding treatment (e.g., scheduling weights, admission thresholds, queue management thresholds, link layer protocol configuration, and/or the like).

The term “time to live” (or “TTL”) or “hop limit” at least in some examples refers to a mechanism which limits the lifespan or lifetime of data in a computer or network. TTL may be implemented as a counter or timestamp attached to or embedded in the data. Once the prescribed event count or timespan has elapsed, data is discarded or revalidated.

The term “queue” at least in some examples refers to a collection of entities (e.g., data, objects, events, and/or the like) are stored and held to be processed later. that are maintained in a sequence and can be modified by the addition of entities at one end of the sequence and the removal of entities from the other end of the sequence; the end of the sequence at which elements are added may be referred to as the “back”, “tail”, or “rear” of the queue, and the end at which elements are removed may be referred to as the “head” or “front” of the queue. Additionally, a queue may perform the function of a buffer, and the terms “queue” and “buffer” may be used interchangeably throughout the present disclosure. The term “enqueue” at least in some examples refers to one or more operations of adding an element to the rear of a queue. The term “dequeue” at least in some examples refers to one or more operations of removing an element from the front of a queue.

The term “channel coding” at least in some examples refers to processes and/or techniques to add redundancy to messages or packets in order to make those messages or packets more robust against noise, channel interference, limited channel bandwidth, and/or other errors. For purposes of the present disclosure, the term “channel coding” can be used interchangeably with the terms “forward error correction” or “FEC”; “error correction coding”, “error correction code”, or “ECC”; and/or “network coding” or “NC”. The term “network coding” at least in some examples refers to processes and/or techniques in which transmitted data is encoded and decoded to improve network performance. The term “code rate” at least in some examples refers to the proportion of a data stream or flow that is useful or non-redundant (e.g., for a code rate of k/n, for every k bits of useful information, the (en)coder generates a total of n bits of data, of which n−k are redundant). The term “systematic code” at least in some examples refers to any error correction code in which the input data is embedded in the encoded output. The term “non-systematic code” at least in some examples refers to any error correction code in which the input data is not embedded in the encoded output. The term “interleaving” at least in some examples refers to a process to rearrange code symbols so as to spread bursts of errors over multiple codewords that can be corrected by ECCs. The term “code word” or “codeword” at least in some examples refers to an element of a code or protocol, which is assembled in accordance with specific rules of the code or protocol.

The term “PDU Connectivity Service” at least in some examples refers to a service that provides exchange of protocol data units (PDUs) between a UE and a data network (DN). The term “PDU Session” at least in some examples refers to an association between a UE and a DN that provides a PDU connectivity service. A PDU Session type can be IPv4, IPv6, IPv4v6, Ethernet, Unstructured, or any other network/connection type, such as those discussed herein. The term “MA PDU Session” at least in some examples refers to a PDU Session that provides a PDU connectivity service, which can use one access network at a time or multiple access networks simultaneously.

The term “traffic shaping” at least in some examples refers to a bandwidth management technique that manages data transmission to comply with a desired traffic profile or class of service. Traffic shaping ensures sufficient network bandwidth for time-sensitive, critical applications using policy rules, data classification, queuing, QoS, and other techniques. The term “throttling” at least in some examples refers to the regulation of flows into or out of a network, or into or out of a specific device or element. The term “access traffic steering” or “traffic steering” at least in some examples refers to a procedure that selects an access network for a new data flow and transfers the traffic of one or more data flows over the selected access network. Access traffic steering is applicable between one 3GPP access and one non-3GPP access. The term “access traffic switching” or “traffic switching” at least in some examples refers to a procedure that moves some or all traffic of an ongoing data flow from at least one access network to at least one other access network in a way that maintains the continuity of the data flow. The term “access traffic splitting” or “traffic splitting” at least in some examples refers to a procedure that splits the traffic of at least one data flow across multiple access networks. When traffic splitting is applied to a data flow, some traffic of the data flow is transferred via at least one access channel, link, or path, and some other traffic of the same data flow is transferred via another access channel, link, or path.

The term “network address” at least in some examples refers to an identifier for a node or host in a computer network, and may be a unique identifier across a network and/or may be unique to a locally administered portion of the network. Examples of identifiers and/or network addresses can include a Closed Access Group Identifier (CAG-ID), Bluetooth hardware device address (BD_ADDR), a cellular network address (e.g., Access Point Name (APN), AMF identifier (ID), AF-Service-Identifier, Edge Application Server (EAS) ID, Data Network Access Identifier (DNAI), Data Network Name (DNN), EPS Bearer Identity (EBI), Equipment Identity Register (EIR) and/or 5G-EIR, Extended Unique Identifier (EUI), Group ID for Network Selection (GIN), Generic Public Subscription Identifier (GPSI), Globally Unique AMF Identifier (GUAMI), Globally Unique Temporary Identifier (GUTI) and/or 5G-GUTI, Radio Network Temporary Identifier (RNTI) (including any RNTI discussed in clause 8.1 of 3GPP TS 38.300 v17.2.0 (2022 Sep. 29) (“[TS38300]”)), International Mobile Equipment Identity (IMEI), IMEI Type Allocation Code (IMEA/TAC), International Mobile Subscriber Identity (IMSI), IMSI software version (IMSISV), permanent equipment identifier (PEI), Local Area Data Network (LADN) DNN, Mobile Subscriber Identification Number (MSIN), Mobile Subscriber/Station ISDN Number (MSISDN), Network identifier (NID), Network Slice Instance (NSI) ID, Permanent Equipment Identifier (PEI), Public Land Mobile Network (PLMN) ID, QoS Flow ID (QFI) and/or 5G QoS Identifier (5QI), RAN ID, Routing Indicator, SMS Function (SMSF) ID, Stand-alone Non-Public Network (SNPN) ID, Subscription Concealed Identifier (SUCI), Subscription Permanent Identifier (SUPI), Temporary Mobile Subscriber Identity (TMSI) and variants thereof, UE Access Category and Identity, and/or other cellular network related identifiers), an email address, Enterprise Application Server (EAS) ID, an endpoint address, an Electronic Product Code (EPC) as defined by the EPCglobal Tag Data Standard, a Fully Qualified Domain Name (FQDN), an internet protocol (IP) address in an IP network (e.g., IP version 4 (Ipv4), IP version 6 (IPv6), and the like), an internet packet exchange (IPX) address, Local Area Network (LAN) ID, a media access control (MAC) address, personal area network (PAN) ID, a port number (e.g., Transmission Control Protocol (TCP) port number, User Datagram Protocol (UDP) port number), QUIC connection ID, RFID tag, service set identifier (SSID) and variants thereof, telephone numbers in a public switched telephone network (PTSN), a socket address, universally unique identifier (UUID) (e.g., as specified in ISO/IEC 11578:1996), a Universal Resource Locator (URL) and/or Universal Resource Identifier (URI), Virtual LAN (VLAN) ID, an X.21 address, an X.25 address, Zigbee® ID, Zigbee® Device Network ID, and/or any other suitable network address and components thereof. The term “application identifier”, “application ID”, or “app ID” at least in some examples refers to an identifier that can be mapped to a specific application or application instance; in the context of 3GPP 5G/NR systems, an “application identifier” at least in some examples refers to an identifier that can be mapped to a specific application traffic detection rule. The term “endpoint address” at least in some examples refers to an address used to determine the host/authority part of a target URI, where the target URI is used to access an NF service (e.g., to invoke service operations) of an NF service producer or for notifications to an NF service consumer. The term “port” in the context of computer networks, at least in some examples refers to a communication endpoint, a virtual data connection between two or more entities, and/or a virtual point where network connections start and end. Additionally or alternatively, a “port” at least in some examples is associated with a specific process or service.

The term “localized network” at least in some examples refers to a local network that covers a limited number of connected vehicles in a certain area or region. The term “local data integration platform” at least in some examples refers to a platform, device, system, network, or element(s) that integrate local data by utilizing a combination of localized network(s) and distributed computation.

The term “delay” at least in some examples refers to a time interval between two events. Additionally or alternatively, the term “delay” at least in some examples refers to a time interval between the propagation of a signal and its reception. The term “packet delay” at least in some examples refers to the time it takes to transfer any packet from one point to another. Additionally or alternatively, the term “packet delay” or “per packet delay” at least in some examples refers to the difference between a packet reception time and packet transmission time. Additionally or alternatively, the “packet delay” or “per packet delay” can be measured by subtracting the packet sending time from the packet receiving time where the transmitter and receiver are at least somewhat synchronized. The term “processing delay” at least in some examples refers to an amount of time taken to process a packet in a network node. The term “transmission delay” at least in some examples refers to an amount of time needed (or necessary) to push a packet (or all bits of a packet) into a transmission medium. The term “propagation delay” at least in some examples refers to amount of time it takes a signal's header to travel from a sender to a receiver. The term “network delay” at least in some examples refers to the delay of an a data unit within a network (e.g., an IP packet within an IP network). The term “queuing delay” at least in some examples refers to an amount of time a job waits in a queue until that job can be executed. Additionally or alternatively, the term “queuing delay” at least in some examples refers to an amount of time a packet waits in a queue until it can be processed and/or transmitted. The term “delay bound” at least in some examples refers to a predetermined or configured amount of acceptable delay. The term “per-packet delay bound” at least in some examples refers to a predetermined or configured amount of acceptable packet delay where packets that are not processed and/or transmitted within the delay bound are considered to be delivery failures and are discarded or dropped.

The term “packet drop rate” at least in some examples refers to a share of packets that were not sent to the target due to high traffic load or traffic management and should be seen as a part of the packet loss rate. The term “packet loss rate” at least in some examples refers to a share of packets that could not be received by the target, including packets dropped, packets lost in transmission and packets received in wrong format. The term “physical rate” or “PHY rate” at least in some examples refers to a speed at which one or more bits are actually sent over a transmission medium. Additionally or alternatively, the term “physical rate” or “PHY rate” at least in some examples refers to a speed at which data can move across a wireless link between a transmitter and a receiver. The term “latency” at least in some examples refers to the amount of time it takes to transfer a first/initial data unit in a data burst from one point to another. The term “throughput” or “network throughput” at least in some examples refers to a rate of production or the rate at which something is processed. Additionally or alternatively, the term “throughput” or “network throughput” at least in some examples refers to a rate of successful message (date) delivery over a communication channel. The term “goodput” at least in some examples refers to a number of useful information bits delivered by the network to a certain destination per unit of time.

The term “performance indicator” or “performance measurement” at least in some examples refers to performance data aggregated over a group of entities/elements, which is derived from performance measurements collected at the entities/elements that belong to the group, according to the aggregation method identified in a performance indicator or performance measurement definition. Additionally or alternatively, the term “performance measurement” at least in some examples refers to a process of collecting, analyzing, and/or reporting information regarding the performance of an entity/element. In either example, the entities/elements can include NFs, RANFs, ECFs, appliances, applications, components, controllers, devices, services, systems, and/or other entities or elements such as any of those discussed herein.

The term “application” at least in some examples refers to a computer program designed to carry out a specific task other than one relating to the operation of the computer itself. Additionally or alternatively, the term “application” at least in some examples refers to a complete and deployable package, environment to achieve a certain function in an operational environment.

The term “algorithm” at least in some examples refers to an unambiguous specification of how to solve a problem or a class of problems by performing calculations, input/output operations, data processing, automated reasoning tasks, and/or the like. The terms “instantiate,” “instantiation,” and the like at least in some examples refers to the creation of an instance. An “instance” also at least in some examples refers to a concrete occurrence of an object, which may occur, for example, during execution of program code.

The term “data processing” or “processing” at least in some examples refers to any operation or set of operations which is performed on data or on sets of data, whether or not by automated means, such as collection, recording, writing, organization, structuring, storing, adaptation, alteration, retrieval, consultation, use, disclosure by transmission, dissemination or otherwise making available, alignment or combination, restriction, erasure and/or destruction. The term “analytics” at least in some examples refers to the discovery, interpretation, and communication of patterns (including meaningful patterns) in data.

The term “application programming interface” or “API” at least in some examples refers to a set of subroutine definitions, communication protocols, and tools for building software. Additionally or alternatively, the term “application programming interface” or “API” at least in some examples refers to a set of clearly defined methods of communication among various components. An API may be for a web-based system, operating system, database system, computer hardware, or software library.

The term “datagram” at least in some examples at least in some examples refers to a basic transfer unit associated with a packet-switched network; a datagram may be structured to have header and payload sections. The term “datagram” at least in some examples may be referred to as a “data unit”, a “protocol data unit” or “PDU”, a “service data unit” or “SDU”, a frame, a packet, and/or the like.

The term “information element” at least in some examples refers to a structural element containing one or more fields. The term “field” at least in some examples refers to individual contents of an information element, or a data element that contains content. The term “data frame”, “data field”, or “DF” at least in some examples refers to a data type that contains more than one data element in a predefined order.

The term “data element” or “DE” at least in some examples refers to a data type that contains one single data. Additionally or alternatively, the term “data element” at least in some examples refers to an atomic state of a particular object with at least one specific property at a certain point in time, and may include one or more of a data element name or identifier, a data element definition, one or more representation terms, enumerated values or codes (e.g., metadata), and/or a list of synonyms to data elements in other metadata registries. Additionally or alternatively, a “data element” at least in some examples refers to a data type that contains one single data.

The term “policy” at least in some examples refers to a set of rules that are used to manage and control the changing and/or maintaining of a state of one or more managed objects. The term “policy objectives” at least in some examples refers to a set of statements with an objective to reach a goal of a policy. The term “declarative policy” at least in some examples refers to a type of policy that uses statements to express the goals of the policy, but not how to accomplish those goals.

The term “reference” at least in some examples refers to data useable to locate other data and may be implemented a variety of ways (e.g., a pointer, an index, a handle, a key, an identifier, a hyperlink, and/or the like).

The term “translation” at least in some examples refers to the process of converting or otherwise changing data from a first form, shape, configuration, structure, arrangement, embodiment, description, and/or the like. into a second form, shape, configuration, structure, arrangement, embodiment, description, and/or the like; at least in some examples there may be two different types of translation: transcoding and transformation. The term “transcoding” at least in some examples refers to taking information/data in one format (e.g., a packed binary format) and translating the same information/data into another format in the same sequence. Additionally or alternatively, the term “transcoding” at least in some examples refers to taking the same information, in the same sequence, and packaging the information (e.g., bits or bytes) differently. The term “transformation” at least in some examples refers to changing data from one format and writing it in another format, keeping the same order, sequence, and/or nesting of data items. Additionally or alternatively, the term “transformation” at least in some examples involves the process of converting data from a first format or structure into a second format or structure, and involves reshaping the data into the second format to conform with a schema or other like specification. Transformation may include rearranging data items or data objects, which may involve changing the order, sequence, and/or nesting of the data items/objects. Additionally or alternatively, the term “transformation” at least in some examples refers to changing the schema of a data object to another schema.

The term “timescale” at least in some examples refers to an order of magnitude of time, which may be expressed as an order-of-magnitude quantity together with a base unit of time. Additionally or alternatively, the term “timescale” at least in some examples refers to a specific unit of time. Additionally or alternatively, the term “timescale” at least in some examples refers to a time standard or a specification of a rate at which time passes and/or points in time. Additionally or alternatively, the term “timescale” at least in some examples refers a frequency at which data is monitored, sampled, oversampled, captured, or otherwise collected. In some examples, the concept of timescales relates to an absolute value of an amount of data collected during a duration of time, one or more time segments, and/or other measure or amount of time. In some examples, the concept of timescales relates to enabling the ascertainment of a quantity of data for a duration, time segment, or other measure or amount of time. The term “duration” at least in some examples refers to the time during which something exists or lasts. The term “duration” can also be referred to as “segment of time”, “time duration”, “time chunk” or the like.

The term “cryptographic mechanism” at least in some examples refers to any cryptographic protocol and/or cryptographic algorithm. Additionally or alternatively, the term “cryptographic protocol” at least in some examples refers to a sequence of steps precisely specifying the actions required of two or more entities to achieve specific security objectives (e.g., cryptographic protocol for key agreement). Additionally or alternatively, the term “cryptographic algorithm” at least in some examples refers to an algorithm specifying the steps followed by a single entity to achieve specific security objectives (e.g., cryptographic algorithm for symmetric key encryption). The term “cryptographic hash function”, “hash function”, or “hash”) at least in some examples refers to a mathematical algorithm that maps data of arbitrary size (sometimes referred to as a “message”) to a bit array of a fixed size (sometimes referred to as a “hash value”, “hash”, or “message digest”). A cryptographic hash function is usually a one-way function, which is a function that is practically infeasible to invert.

The term “artificial intelligence” or “AI” at least in some examples refers to any intelligence demonstrated by machines, in contrast to the natural intelligence displayed by humans and other animals. Additionally or alternatively, the term “artificial intelligence” or “AI” at least in some examples refers to the study of “intelligent agents” and/or any device that perceives its environment and takes actions that maximize its chance of successfully achieving a goal.

The terms “artificial neural network”, “neural network”, or “NN” refer to an ML technique comprising a collection of connected artificial neurons or nodes that (loosely) model neurons in a biological brain that can transmit signals to other arterial neurons or nodes, where connections (or edges) between the artificial neurons or nodes are (loosely) modeled on synapses of a biological brain. The artificial neurons and edges typically have a weight that adjusts as learning proceeds. The weight increases or decreases the strength of the signal at a connection. Neurons may have a threshold such that a signal is sent only if the aggregate signal crosses that threshold. The artificial neurons can be aggregated or grouped into one or more layers where different layers may perform different transformations on their inputs. Signals travel from the first layer (the input layer), to the last layer (the output layer), possibly after traversing the layers multiple times. NNs are usually used for supervised learning, but can be used for unsupervised learning as well. Examples of NNs include deep NN (DNN), feed forward NN (FFN), deep FNN (DFF), convolutional NN (CNN), deep CNN (DCN), deconvolutional NN (DNN), a deep belief NN, a perception NN, recurrent NN (RNN) (e.g., including Long Short Term Memory (LSTM) algorithm, gated recurrent unit (GRU), echo state network (ESN), and/or the like), spiking NN (SNN), deep stacking network (DSN), Markov chain, perception NN, generative adversarial network (GAN), transformers, stochastic NNs (e.g., Bayesian Network (BN), Bayesian belief network (BBN), a Bayesian NN (BNN), Deep BNN (DBNN), Dynamic BN (DBN), probabilistic graphical model (PGM), Boltzmann machine, restricted Boltzmann machine (RBM), Hopfield network or Hopfield NN, convolutional deep belief network (CDBN), and/or the like), Linear Dynamical System (LDS), Switching LDS (SLDS), Optical NNs (ONNs), an NN for reinforcement learning (RL) and/or deep RL (DRL), and/or the like.

The term “event” at least in some examples refers to a set of outcomes of an experiment (e.g., a subset of a sample space) to which a probability is assigned. Additionally or alternatively, the term “event” at least in some examples refers to a software message indicating that something has happened. Additionally or alternatively, the term “event” at least in some examples refers to an object in time, or an instantiation of a property in an object. Additionally or alternatively, the term “event” at least in some examples refers to a point in space at an instant in time (e.g., a location in spacetime). Additionally or alternatively, the term “event” at least in some examples refers to a notable occurrence at a particular point in time.

The term “feature” at least in some examples refers to an individual measureable property, quantifiable property, or characteristic of a phenomenon being observed. Additionally or alternatively, the term “feature” at least in some examples refers to an input variable used in making predictions. At least in some examples, features may be represented using numbers/numerals (e.g., integers), strings, variables, ordinals, real-values, categories, and/or the like.

The term “software agent” at least in some examples refers to a computer program that acts for a user or other program in a relationship of agency. The term “inference engine” at least in some examples refers to a component of a computing system that applies logical rules to a knowledge base to deduce new information. The term “intelligent agent” at least in some examples refers to an a software agent or other autonomous entity which acts, directing its activity towards achieving goals upon an environment using observation through sensors and consequent actuators (i.e. it is intelligent). Intelligent agents may also learn or use knowledge to achieve their goals.

The term “loss function” or “cost function” at least in some examples refers to an event or values of one or more variables onto a real number that represents some “cost” associated with the event. A value calculated by a loss function may be referred to as a “loss” or “error”. Additionally or alternatively, the term “loss function” or “cost function” at least in some examples refers to a function used to determine the error or loss between the output of an algorithm and a target value. Additionally or alternatively, the term “loss function” or “cost function” at least in some examples refers to a function are used in optimization problems with the goal of minimizing a loss or error.

The term “mathematical model” at least in some examples refer to a system of postulates, data, and inferences presented as a mathematical description of an entity or state of affairs including governing equations, assumptions, and constraints.

The term “machine learning” or “ML” at least in some examples refers to the use of computer systems to optimize a performance criterion using example (training) data and/or past experience. ML involves using algorithms to perform specific task(s) without using explicit instructions to perform the specific task(s), and/or relying on patterns, predictions, and/or inferences. ML uses statistics to build mathematical model(s) (also referred to as “ML models” or simply “models”) in order to make predictions or decisions based on sample data (e.g., training data). The model is defined to have a set of parameters, and learning is the execution of a computer program to optimize the parameters of the model using the training data or past experience. The trained model may be a predictive model that makes predictions based on an input dataset, a descriptive model that gains knowledge from an input dataset, or both predictive and descriptive. Once the model is learned (trained), it can be used to make inferences (e.g., predictions). ML algorithms perform a training process on a training dataset to estimate an underlying ML model. An ML algorithm is a computer program that learns from experience w.r.t some task(s) and some performance measure(s)/metric(s), and an ML model is an object or data structure created after an ML algorithm is trained with training data. In other words, the term “ML model” or “model” may describe the output of an ML algorithm that is trained with training data. After training, an ML model may be used to make predictions on new datasets. Additionally, separately trained AI/ML models can be chained together in a AI/ML pipeline during inference or prediction generation. Although the term “ML algorithm at least in some examples refers to different concepts than the term “ML model,” these terms may be used interchangeably for the purposes of the present disclosure. Furthermore, the term “AI/ML application” or the like at least in some examples refers to an application that contains some AI/ML models and application-level descriptions. ML techniques generally fall into the following main types of learning problem categories: supervised learning, unsupervised learning, and reinforcement learning.

The term “objective function” at least in some examples refers to a function to be maximized or minimized for a specific optimization problem. In some cases, an objective function is defined by its decision variables and an objective. The objective is the value, target, or goal to be optimized, such as maximizing profit or minimizing usage of a particular resource. The specific objective function chosen depends on the specific problem to be solved and the objectives to be optimized. Constraints may also be defined to restrict the values the decision variables can assume thereby influencing the objective value (output) that can be achieved. During an optimization process, an objective function's decision variables are often changed or manipulated within the bounds of the constraints to improve the objective function's values. In general, the difficulty in solving an objective function increases as the number of decision variables included in that objective function increases. The term “decision variable” refers to a variable that represents a decision to be made.

The term “optimization” at least in some examples refers to an act, process, or methodology of making something (e.g., a design, system, or decision) as fully perfect, functional, or effective as possible. Optimization usually includes mathematical procedures such as finding the maximum or minimum of a function. The term “optimal” at least in some examples refers to a most desirable or satisfactory end, outcome, or output. The term “optimum” at least in some examples refers to an amount or degree of something that is most favorable to some end. The term “optima” at least in some examples refers to a condition, degree, amount, or compromise that produces a best possible result. Additionally or alternatively, the term “optima” at least in some examples refers to a most favorable or advantageous outcome or result. The term “Bayesian optimization” at least in some examples refers to a sequential design strategy for global optimization of black-box functions that does not assume any functional forms.

The term “probability” at least in some examples refers to a numerical description of how likely an event is to occur and/or how likely it is that a proposition is true. The term “probability distribution” at least in some examples refers to a mathematical function that gives the probabilities of occurrence of different possible outcomes for an experiment or event. The term “probability distribution” at least in some examples refers to a function that gives the probabilities of occurrence of different possible outcomes for an experiment or event. Additionally or alternatively, the term “probability distribution” at least in some examples refers to a statistical function that describes all possible values and likelihoods that a random variable can take within a given range (e.g., a bound between minimum and maximum possible values). A probability distribution may have one or more factors or attributes such as, for example, a mean or average, mode, support, tail, head, median, variance, standard deviation, quantile, symmetry, skewness, kurtosis, and/or the like. A probability distribution may be a description of a random phenomenon in terms of a sample space and the probabilities of events (subsets of the sample space). Example probability distributions include discrete distributions (e.g., Bernoulli distribution, discrete uniform, binomial, Dirac measure, Gauss-Kuzmin distribution, geometric, hypergeometric, negative binomial, negative hypergeometric, Poisson, Poisson binomial, Rademacher distribution, Yule-Simon distribution, zeta distribution, Zipf distribution, and/or the like), continuous distributions (e.g., Bates distribution, beta, continuous uniform, normal distribution, Gaussian distribution, bell curve, joint normal, gamma, chi-squared, non-central chi-squared, exponential, Cauchy, lognormal, logit-normal, F distribution, t distribution, Dirac delta function, Pareto distribution, Lomax distribution, Wishart distribution, Weibull distribution, Gumbel distribution, Irwin-Hall distribution, Gompertz distribution, inverse Gaussian distribution (or Wald distribution), Chemoff's distribution, Laplace distribution, Pólya-Gamma distribution, and/or the like), and/or joint distributions (e.g., Dirichlet distribution, Ewens's sampling formula, multinomial distribution, multivariate normal distribution, multivariate t-distribution, Wishart distribution, matrix normal distribution, matrix t distribution, and/or the like).

The term “reinforcement learning” or “RL” at least in some examples refers to a goal-oriented learning technique based on interaction with an environment. In RL, an agent aims to optimize a long-term objective by interacting with the environment based on a trial and error process. Examples of RL algorithms include Markov decision process, Markov chain, Q-learning, multi-armed bandit learning, temporal difference learning, and deep RL. The term “multi-armed bandit problem”, “K-armed bandit problem”, “N-armed bandit problem”, or “contextual bandit” at least in some examples refers to a problem in which a fixed limited set of resources must be allocated between competing (alternative) choices in a way that maximizes their expected gain, when each choice's properties are only partially known at the time of allocation, and may become better understood as time passes or by allocating resources to the choice. The term “contextual multi-armed bandit problem” or “contextual bandit” at least in some examples refers to a version of multi-armed bandit where, in each iteration, an agent has to choose between arms; before making the choice, the agent sees a d-dimensional feature vector (context vector) associated with a current iteration, the learner uses these context vectors along with the rewards of the arms played in the past to make the choice of the arm to play in the current iteration, and over time the learner's aim is to collect enough information about how the context vectors and rewards relate to each other, so that it can predict the next best arm to play by looking at the feature vectors.

The term “supervised learning” at least in some examples refers to an ML technique that aims to learn a function or generate an ML model that produces an output given a labeled data set. Supervised learning algorithms build models from a set of data that contains both the inputs and the desired outputs. For example, supervised learning involves learning a function or model that maps an input to an output based on example input-output pairs or some other form of labeled training data including a set of training examples. Each input-output pair includes an input object (e.g., a vector) and a desired output object or value (referred to as a “supervisory signal”). Supervised learning can be grouped into classification algorithms, regression algorithms, and instance-based algorithms. The term “unsupervised learning” at least in some examples refers to an ML technique that aims to learn a function to describe a hidden structure from unlabeled data. Unsupervised learning algorithms build models from a set of data that contains only inputs and no desired output labels. Unsupervised learning algorithms are used to find structure in the data, like grouping or clustering of data points. Examples of unsupervised learning are K-means clustering, principal component analysis (PCA), and topic modeling, among many others. The term “semi-supervised learning at least in some examples refers to ML algorithms that develop ML models from incomplete training data, where a portion of the sample input does not include labels.

The term “vector” at least in some examples refers to a one-dimensional array data structure. Additionally or alternatively, the term “vector” at least in some examples refers to to a tuple of one or more values called scalars.

The term “service level agreement” or “SLA” at least in some examples refers to a level of service expected from a service provider. At least in some examples, an SLA may represent an entire agreement between a service provider and a service consumer that specifies one or more services is to be provided, how the one or more services are to be provided or otherwise supported, times, locations, costs, performance, priorities for different traffic classes and/or QoS classes (e.g., highest priority for first responders, lower priorities for non-critical data flows, and the like), and responsibilities of the parties involved. The term “service level objective” or “SLO” at least in some examples refers to one or more measurable characteristics, metrics, or other aspects of an SLA such as, for example, availability, throughput, frequency, response time, latency, QoS, QoE, and/or other like performance metrics/measurements. At least in some examples, a set of SLOs may define an expected service (or an service level expectation (SLE)) between the service provider and the service consumer and may vary depending on the service's urgency, resources, and/or budget. The term “service level indicator” or “SLI” at least in some examples refers to a measure of a service level provided by a service provider to a service consumer. At least in some examples, SLIs form the basis of SLOs, which in turn, form the basis of SLAs. Examples of SLIs include latency (including end-to-end latency), throughout, availability, error rate, durability, correctness, and/or other like performance metrics/measurements. At least in some examples, term “service level indicator” or “SLI” can be referred to as “SLA metrics” or the like. The term “service level expectation” or “SLE” at least in some examples refers to an unmeasurable service-related request, but may still be explicitly or implicitly provided in an SLA even if there is little or no way of determining whether the SLE is being met. At least in some examples, an SLO may include a set of SLIs that produce, define, or specify an SLO achievement value. As an example, an availability SLO may depend on multiple components, each of which may have a QoS availability measurement. The combination of QoS measures into an SLO achievement value may depend on the nature and/or architecture of the service.

The term “scheduling algorithm”, “scheduling policy”, or “scheduling discipline” at least in some examples refers to an algorithm used for distributing resources among entities that request them, where the requests for resources may be simultaneous and/or asynchronous. The term “proportional-fair scheduling” at least in some examples refers to a compromise-based scheduling algorithm that attempts to maintain a balance between maximizing a total throughput of a network while allowing all users at least a minimal level of service. The term “round-robin scheduling” at least in some examples refers to a scheduling algorithm that uses time-sharing or time slots for allocating resources in a round-robin fashion.

Although many of the previous examples are provided with use of specific cellular/mobile network terminology, including with the use of 4G/5G 3GPP network components (or expected terahertz-based 6G/6G+ technologies), it will be understood these examples may be applied to many other deployments of wide area and local wireless networks, as well as the integration of wired networks (including optical networks and associated fibers, transceivers, and/or the like). Furthermore, various standards (e.g, 3GPP, ETSI, and/or the like) may define various message formats, PDUs, containers, frames, and/or the like, as comprising a sequence of optional or mandatory data elements (DEs), data frames (DFs), information elements (IEs), and/or the like. However, it should be understood that the requirements of any particular standard should not limit the examples discussed herein, and as such, any combination of containers, frames, DFs, DEs, IEs, values, actions, and/or features are possible in various examples, including any combination of containers, DFs, DEs, values, actions, and/or features that are strictly required to be followed in order to conform to such standards or any combination of containers, frames, DFs, DEs, IEs, values, actions, and/or features strongly recommended and/or used with or in the presence/absence of optional elements.

Aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1-53. (canceled)

54. An edge compute node, comprising:
memory circuitry configured to store instructions for operating an application (app) manager and a set of edge apps; and
processor circuitry connected to the memory circuitry, wherein the processor circuitry is configured to operate the app manager to:
receive, via network interface circuitry (NIC), measurement data from a set of network access nodes (NANs) connected to the edge compute node;
receive, via the NIC, telemetry data from one or more telemetry agents implemented by the edge compute node;
determine a resource allocation for a corresponding edge app of the set of edge apps based on the measurement data and the telemetry data; and
configure at least one NAN of the set of NANs or the edge compute node according to the determined resource allocation such that resources indicated by the resource allocation are allocated to the corresponding edge app.

55. The edge compute node of claim 54, wherein the processor circuitry is configured to:
receive, via the NIC, a policy from a orchestration function, wherein the information included in the policy includes a set of key performance measurements (KPMs), key performance indicators (KPIs), service level agreement (SLA) requirements, or quality of service (QoS) requirements related to related to one or more of accessibility, availability, latency, reliability, user experienced data rates, area traffic capacity, integrity, utilization, retainability, mobility, energy efficiency, or quality of service; and
determine the resource allocation according to information included in the policy.

56. The edge compute node of claim 54, wherein the processor circuitry is configured to operate one or more machine learning models to:
determine the resource allocation; and at least one of:
correlate individual data items of the telemetry data with one or more other data items of the telemetry data;
correlate individual data items of the measurement data with one or more other data items of the measurement data;
correlate individual data items of the measurement data with the individual data items of the telemetry data;
correlate service management data with the telemetry data or the measurement data;
correlate data items of the service management data related to the received measurement data with resource allocations previously generated for the edge app;
correlate one or more data items of the service management data with one or more resource requirements of the of edge app;
correlate the one or more data items of the service management data with one or more resource requirements of a corresponding network slice in which the edge app is to operate;
correlate platform resource slices of the edge compute node with one or more network slices;
predict or inferring data to compensate missing data service management data; or
predict a reliability of individual components of the edge compute node based at least on the telemetry data.

57. The edge compute node of claim 56, wherein the resource allocation indicates to move the corresponding edge app from being operated by a first processing element of the edge compute node to be operated by a second processing element of the edge compute node, and to determine the resource allocation, the processor circuitry is configured to:
determine adjustments to hardware, software, or network resources allocated to the edge app according to a run-time priority level assigned to the edge app.

58. The edge compute node of claim 54, wherein the resource allocation indicates to:
dynamically increase or decrease power levels or frequency levels of a processing element operating the corresponding edge app;
dynamically adjust last level cache (LLC), memory bandwidth, or interface bandwidth allocated to the corresponding edge app;
scale up one or more of hardware, software, or resources for the corresponding edge app; or
scale down one or more of hardware, software, or resources for the corresponding edge app.

59. The edge compute node of claim 54, wherein the processor circuitry is configured to:
send, via the NIC, the resource allocation to a service management and orchestration framework for management of resources of multiple edge compute nodes.

60. The edge compute node of claim 54, wherein, to configure the at least one NAN, the processor circuitry is configured to:
configure a real-time (RT) control loop operated by the at least one NAN; and
configure a near-RT control loop operated by the edge compute node,
wherein the near-RT control loop operates according to a first time scale, the RT control loop operates according to a second time scale, and the first time scale is larger than the second time scale.

61. The edge compute node of claim 60, wherein individual sets of the telemetry data are classified as belonging to a corresponding tier of a set of data tiers, individual sets of the measurement data are classified as belonging to a corresponding tier of a set of data tiers, and each tier of the set of data tiers corresponds to a timescale of a control loop of a set of control loops, wherein the set of control loops includes the RT control loop and the near-RT control loop.

62. The edge compute node of claim 61, wherein a first tier of the set of data tiers includes RT reference and response data, a second tier of the set of data tiers includes data that require RT calculation or processing, a third tier of the set of data tiers includes data that require near-RT calculation or processing, and a fourth tier of the set of data tiers includes data that is used for non-RT calculation or processing.

63. The edge compute node of claim 62, wherein the set of edge apps include one or more of one or more artificial intelligence or machine learning apps, one or more radio resource management functions, one or more self-organizing network functions, one or more network function automation apps, and one or more policy apps, one or more interference management functions, one or more radio connection management functions, one or more flow management functions, and one or more mobility management functions.

64. The edge compute node of claim 54, wherein the set of NANs includes a set of radio access network functions (RANFs) of a next generation (NG) RAN architecture, the edge compute node operates a RAN intelligent controller (RIC) of an O-RAN Alliance (O-RAN) framework, and the set of edge apps include one or more non-RT RIC apps (xApps) or one or more non-RT RIC applications (rApps).

65. A non-transitory computer readable medium (NTCRM) comprising instructions for operating an application (app), wherein execution of the instructions by one or more processors is to cause an edge compute node to:
receive measurement data from a set of network access nodes (NANs) connected to the edge compute node;
receive telemetry data from one or more telemetry agents implemented by the edge compute node;
determine a resource allocation for a corresponding edge app of a set of edge apps based on the measurement data and the telemetry data; and
configure at least one NAN of the set of NANs or the edge compute node according to the determined resource allocation such that resources indicated by the resource allocation are allocated to the corresponding edge app.

66. The NTCRM of claim 65, wherein execution of the instructions is to cause the edge compute node to:
receive a policy from a orchestration function, wherein the information included in the policy includes a set of key performance measurements (KPMs), key performance indicators (KPIs), service level agreement (SLA) requirements, or quality of service (QoS) requirements related to related to one or more of accessibility, availability, latency, reliability, user experienced data rates, area traffic capacity, integrity, utilization, retainability, mobility, energy efficiency, or quality of service; and
determine the resource allocation according to information included in the policy.

67. The NTCRM of claim 65, wherein execution of the instructions is to cause the edge compute node to operate one or more machine learning models to:
determine the resource allocation; and at least one of:
correlate individual data items of the telemetry data with one or more other data items of the telemetry data;
correlate individual data items of the measurement data with one or more other data items of the measurement data;
correlate individual data items of the measurement data with the individual data items of the telemetry data;
correlate service management data with the telemetry data or the measurement data;
correlate data items of the service management data related to the received measurement data with resource allocations previously generated for the edge app;
correlate one or more data items of the service management data with one or more resource requirements of the of edge app;
correlate the one or more data items of the service management data with one or more resource requirements of a corresponding network slice in which the edge app is to operate;
correlate platform resource slices of the edge compute node with one or more network slices;
predict or inferring data to compensate missing data service management data; or
predict a reliability of individual components of the edge compute node based at least on the telemetry data.

68. The NTCRM of claim 67, wherein the resource allocation indicates to move the corresponding edge app from being operated by a first processing element of the edge compute node to be operated by a second processing element of the edge compute node, and to determine the resource allocation, execution of the instructions is to cause the edge compute node to:
determine adjustments to hardware, software, or network resources allocated to the edge app according to a run-time priority level assigned to the edge app.

69. The NTCRM of claim 65, wherein the resource allocation indicates to:
dynamically increase or decrease power levels or frequency levels of a processing element operating the corresponding edge app;
dynamically adjust last level cache (LLC), memory bandwidth, or interface bandwidth allocated to the corresponding edge app; or
one or more of hardware, software, or resources to be scaled up or scaled down for the corresponding edge app.

70. The NTCRM of claim 65, wherein execution of the instructions is to cause the edge compute node to:
send the resource allocation to a service management and orchestration framework for management of resources of multiple edge compute nodes.

71. The NTCRM of claim 65, wherein, to configure the at least one NAN, execution of the instructions is to cause the edge compute node to:
configure a real-time (RT) control loop operated by the at least one NAN; and
configure a near-RT control loop operated by the edge compute node,
wherein the near-RT control loop operates according to a first time scale, the RT control loop operates according to a second time scale, and the first time scale is larger than the second time scale.

72. The NTCRM of claim 71, wherein individual sets of the telemetry data are classified as belonging to a corresponding tier of a set of data tiers, individual sets of the measurement data are classified as belonging to a corresponding tier of a set of data tiers, and each tier of the set of data tiers corresponds to a timescale of a control loop of a set of control loops, wherein the set of control loops includes the RT control loop and the near-RT control loop.

73. The NTCRM of claim 72, wherein a first tier of the set of data tiers includes RT reference and response data, a second tier of the set of data tiers includes data that require RT calculation or processing, a third tier of the set of data tiers includes data that require near-RT calculation or processing, and a fourth tier of the set of data tiers includes data that is used for non-RT calculation or processing.
